(19) United States
(12) Patent Application Publication
(10) Pub. No.: US 2020/0148073 A1
(43) Pub. Date: May 14, 2020

(54) Battery quick-change process and system for electric vehicles

(71) Applicant: IOAN SASU, Brossard (CA)

(72) Inventor: IOAN SASU, Brossard (CA)

(21) Appl. No.: 16/190,038

(22) Filed: Nov. 13, 2018

(51) Int. Cl. B60L 53/80; B60L 53/65; B60L 50/64; B60L 53/66

(52) U.S. Cl. CPC B60L 53/80; B60L 53/65; B60W 2540/28; B60L 53/66; B60L 50/64

(57) ABSTRACT

The invention provides a new design of a battery quick-change process and system for electric vehicles, solving the important issues related to the battery recharging time, limited autonomy, high cost of the electric vehicles, making them very user friendly and ecologic, opening the era of a new generation of the electric vehicles. It is a game-changer.

The innovation consists in:
a transfer of the battery charging process from inside to outside of the vehicle;
a battery quick-change electric vehicle design;
a loading utility capable to change automatically very fast the vehicle battery packages;
introduce an intelligent management battery change system;
optimize the entire battery change process;
eliminate the vehicles equipment for battery recharge;
introduce anti-theft devices and automated payment;

The advantages are:
ensure unlimited autonomy of electric vehicles;
increase the efficiency;
reduce the cost;
make the electric vehicles ecologic and user friendly;
realize an automatic intelligent process and system.

### TECHNICAL FIELD

The present invention relates generally to a new design of battery quick-change process and system for the electric vehicles in order to eliminate the waiting time for battery recharge, to reduce the cost and to ensure an unlimited autonomy of the electric vehicles, making them more user friendly and ecologic.

This invention is pertinent and it is an important contribution in the progress of the technology in the electric vehicles field, taking into consideration that the electric and autonomous vehicles will grow-up and will have a welcome role to play in global mobility in the future. It represents a game-changer, opening a new era on the electric vehicles evolution, of all categories.

### BACKGROUND OF THE ART

The actual design of the battery electric vehicles consists in a vehicle equipped with one or many batteries, permanently attached to the vehicle, recharged on the vehicle. During the recharging time, the vehicle has to be stopped, therefore it is not in use. Unfortunately, the time of recharge is long from 30 minutes to 24 hours or more. Up to now, the research and the development was focused on the improvement of the battery, trying to reduce the recharging time, by introducing new materials.

With the great effort and progress realized in the batteries field, the recharging time of 30 minutes is still not satisfactory and it remains one of the main issues of electric vehicles. This issue is much more important for the trucks and heavy electric vehicles, which travel on long distances and require big batteries, hence, long time for recharge, increasing non-operated time of the vehicle.

The actual batteries are very heavy and the equipment used to recharge the batteries mounted on each electric vehicle are also heavy. This extra weight reduce the vehicle efficiency.

The equipment for battery recharge is expansive, takes a lot of space into the vehicle, reducing in this way the space for luggage.

### TECHNICAL ISSUES

In the actual design—permanently attached battery on the vehicle, the technical issues are related to the long battery recharging time, limited autonomy, reduced efficiency and high cost. Because the batteries are permanently attached to the electric vehicle in the battery recharging time the vehicle has to be stopped. Longer the battery recharge time, less efficiency and less autonomy of the vehicle.

In order to increase the electric vehicle autonomy, up to now, is used a large number of battery elements making the battery package very heavy. For example for an electric car the batteries are about 600 Kg, to which is added the weight of the battery recharge devices. This extra weight reduces the vehicle efficiency. The equipment to recharge the vehicle batteries is also expensive and takes a lot of space.

Because of the long time requested for battery recharge and of the reduced autonomy, the electric vehicles in the actual design are not user friendly. Also, they are much more expensive than the combustion vehicles.

### SUMMARY OF THE INVENTION

The aim of the invention is to provide a new design of a battery quick-change process and system capable to eliminate the waiting time for battery recharge, to reduce the cost and to ensure an unlimited autonomy of the electric vehicles, making them more user friendly and ecologic.

A such battery quick-change system comprises:
a driver (DR) which may be a human being or an automatic intelligent driver for an autonomous electric vehicle;
an intelligent phone (Iph);
an electric vehicle (EV) allowing to change the vehicle batteries in a very short time and to take, transmit and receive information;
a battery (BR) for electric vehicle allowing to change the vehicle battery in a very short time and to transmit information;
a loading utility (LU) for electric vehicle capable to change very fast the vehicle battery, to charge and prepare the replacing batteries for new installations outside of vehicle, to receive and transmit information;
an intelligent management battery change system (IMBC) able to interconnect the driver (DR), the electric vehicles (EV), the batteries (BR) and the loading utility (LU) for electric vehicles in order to optimize the entire battery reloading process.

The battery quick-change process for electric vehicles consists in two parallel processes:
one which involves the electric vehicle (EV) and the driver (DR) related to the battery change process including: loading utility schedule, battery change, payment, invoicing;
another one outside of the vehicle, which doesn't involve the electric vehicle (EV) either the driver (DR), including battery recharge and battery preparation for new installation.

In this way, by recharging the battery of the electric vehicle outside of the vehicle, the time that the electric vehicle is out of use is eliminated and makes useless all the battery recharging devices installed on the vehicle.

In order to apply this new technology at a large scale, for each kind of electric vehicle, a modular design and a standard battery modules are required.

The actual knowledge of technology allows a full automation of the entire quick-change battery process using an intelligent full automated battery quick-change system operating without any human intervention.

Therefore, the battery quick-change process and system allow to provide an unlimited autonomy on the Earth planet of electric vehicles, to increase their efficiency, to reduce the cost and to make the electric vehicle more user friendly and ecologic.

### DESCRIPTION OF THE DRAWINGS

In order that this invention may be readily understood, a plurality of embodiments are illustrated by way of examples, with reference to the accompanying drawings, in which:

FIG. 1. is a diagram of the battery quick-change system;

FIG. 2. is a diagram of the battery quick-change process including main steps of the process;

FIG. 3. is a diagram of the battery quick-change process of FIG. 2 describing the portion of identification & destination set-up;

FIG. 4. is a diagram of the battery quick-change process of FIG. 2 describing the portion of taking a decision on the loading utility;

FIG. 5. is a diagram of the battery quick-change process of FIG. 2 describing the portion of ordering & receiving feed-back for replacing battery;

FIG. 6. is a diagram of the battery quick-change process of FIG. 2 describing the portion of driving to destination via loading utility;

FIG. 7. is a diagram of the battery quick-change process of FIG. 2 describing the portion of battery changing in the loading utility;

FIG. 8. is a diagram of the battery quick-change process of FIG. 2 describing the portion of leaving the loading utility and driving to destination;

FIG. 9. is a diagram of the battery quick-change process of FIG. 2 describing the portion of preparation of full battery package for new installation outside of electric vehicle, in the loading utility;

FIG. 10 illustrates an electric vehicle chassis (border lines) showing the locations of the battery drawers in the IN position, using continue lines;

FIG. 11 illustrates an electric vehicle chassis, in border lines, showing the locations of the battery drawers in the OUT position (continue lines);

FIG. 12 is an isometric view from passenger-front side, illustrating a car (border lines), showing the lateral right side drawers and the front drawers IN (continue lines);

FIG. 13 is an isometric view from driver-back side, illustrating a car (border lines), showing the lateral left side drawers and the back drawers IN (continue line);

FIG. 14 is an isometric view from passenger-front side, illustrating a car (border lines), showing the lateral right side drawers and the front drawers OUT (continue line);

FIG. 15 is an isometric view from driver-back side, illustrating a car (border lines), showing the lateral left side drawers and the back drawers OUT (continue lines);

FIG. 16 is an isometric view from passenger-front side, illustrating a SUV (border lines), showing the lateral right side drawers and the front drawers IN (continue line);

FIG. 17 is an isometric view from driver-back side, illustrating a SUV (border lines), showing the lateral left side drawers and the back drawers IN (continues line);

FIG. 18 is an isometric view from passenger-front side, illustrating a SUV (border lines), showing the lateral right side drawers and the front drawers OUT (continues line);

FIG. 19 is an isometric view from driver-back side, illustrating a SUV (border lines), showing the lateral left side drawers and the back drawers OUT (continues line);

FIG. 20 is an isometric view from passenger-front side, illustrating a truck (border lines), showing the lateral right side single/double-level/double-collumns drawers and the front single/double-level/single-collumn drawers IN (continue line);

FIG. 21 is an isometric view from driver-front side, illustrating a truck (border lines), showing the lateral left side double/double-level/single-collumns drawers and the front single/double-level/single-collumn drawers IN (continue lines);

FIG. 22 is an isometric view from passenger-front side, illustrating a truck (border lines), showing the lateral right side single/double-level/double-collumns drawers one of four OUT and the front single/double-level/single-collumn drawers one of two OUT (continue lines);

FIG. 23 is an isometric view from driver-back side, illustrating a truck (border lines), showing the lateral left side double/double-level/single-collumns drawers both OUT and the front single/double-level/single-collumn drawers one of two OUT (continue lines);

FIG. 24 is an isometric view from driver-back side, illustrating a trailer (border lines), showing the lateral left side single/double-level/four-collumns drawers and the rear single/double-level/double-collumn drawers IN (continue lines);

FIG. 25 is an isometric view from passenger-back side, illustrating a trailer (border lines), showing the lateral right side double/double-level/four-collumns drawers and the rear double/double-level/single-collumn drawers IN (continue lines);

FIG. 26 is an isometric view from driver-front side, illustrating a truck with a trailer (border lines), showing for the truck the lateral left side double/double-level/single-collumns drawers and the front single/double-level/single-collumn drawers IN (continue line), and for the trailer the lateral left side single/double-level/four-collumns drawers and the rear single/double-level/double-collumn drawers IN (continue lines);

FIG. 27 is an isometric view from passenger-front side, illustrating a truck with a trailer (border lines), showing for the truck the lateral right side single/double-level/double-collumns drawers and the front single/double-level/single-collumn drawers IN (continue line), and for the trailer the left side double/double-level/double-collumns drawers and the rear single/double-level/double-collumn drawers IN (continue lines);

FIG. 28 is an isometric view from driver-back side, illustrating a school bus (border lines), showing the lateral left-middle side single/double-level/four-collumns drawers IN (continue line) and the lateral left-rear side single/double-level/single-collumn drawers IN (continue line);

FIG. 29 is an isometric view from driver-back side, illustrating a school bus (border lines), showing the lateral left-middle side single/double-level/four-collumns drawers IN and one OUT (continue line) and the lateral left-rear side single/double-level/single-collumn drawers one IN and one OUT (continue lines);

FIG. 30 is an isometric view from passenger-front side, illustrating a school bus (border lines), showing the lateral right-middle side double/-double-level/double-collumns drawers IN (continue line) and the lateral right-rear side single/double-level/single-collumn drawers IN (continue lines);

FIG. 31 is an isometric view from right-front side, illustrating a school bus (border lines), showing the lateral right-middle side double/double-level/double-collumns drawers IN and one OUT (continue lines) and the lateral right-rear side single/double-level/single-collumn drawers one IN and one OUT (continue line);

FIG. 32 is an isometric view from driver-back side, illustrating a city bus (border lines), showing the lateral left-middle side double/double-level/double-collumns drawers IN (continue lines) and the lateral left-rear side single/double-level/single-collumn drawers IN (continue lines);

FIG. 33 is an isometric view from driver-back side, illustrating a city bus (border lines), showing the lateral left-middle side single/double-level/four-collumns drawers IN and one OUT (continue line) and the lateral left-rear side single/double-/level/single-collumn drawers one IN and one OUT (continue lines);

FIG. 34 is an isometric view from right-back side, illustrating a city bus (border lines), showing the lateral right-middle side double/double-level/double-collumns drawers IN (continue line) and the centre-rear side single/double-level/single-collumn drawers IN (continue lines);

FIG. 35 is an isometric view from right-back side, illustrating a city bus (border lines), showing the lateral right-middle side double/double-level/double-collumns drawers IN and one OUT (continue lines) and the right-rear side double/double-level/double-collumn drawers IN and one OUT (continue line) and the centre-rear side single/double-level/single-collumn drawers one IN and one OUT (continue lines);

FIG. 36 is an isometric view from driver-back side, illustrating an inter-city bus (border lines), showing the lateral left-middle side single/triple-level/single-collumns drawers IN and one OUT (continue lines) and the back-left side single/triple-level/single-collumn drawers IN and the back-right side single/triple-level/single-collumn drawers IN (continue line)s;

FIG. 37 is an isometric view from right-back side, illustrating an inter-city bus (border lines), showing the lateral left-middle side single/triple-level/single-collumns drawers IN (continue lines) and the back-left side single/triple-level/single-collumn drawers IN and one OUT, and back-right side single/triple-level/single-collumn drawers IN (continue lines);

FIG. 38 is an isometric view, illustrating schematically a battery module for cars;

FIG. 39 is an isometric view, illustrating schematically a battery module for SUV;

FIG. 40 is an isometric view, illustrating schematically a battery module for mini-trucks and mini-buses;

FIG. 41 is an isometric view, illustrating schematically a battery module for trucks and buses;

FIG. 42 is an isometric view, illustrating schematically a battery package for cars;

FIG. 43 is an isometric view, illustrating schematically a battery package for SUV;

FIG. 44 is an isometric view, illustrating schematically a battery package for mini-trucks and mini-buses;

FIG. 45 is an isometric view, illustrating schematically a battery package for trucks and buses;

FIG. 46 is the cross section A1-A1 of the big attaching plastic tubular cylinders disposed on one wall of the battery modules, serving to attache the modules each other;

FIG. 47 is the cross section A2-A2 of the small attaching plastic tubular cylinders disposed on the opposite wall of the battery modules than the big attaching plastic tubular cylinders illustrated in FIG. 46, serving to attache the modules each other;

FIG. 48 shows the maximum number of these attaching plastic tubular cylinders illustrated in FIG. 46 and FIG. 47 in the assembled position, illustrating how they are positioned one in relation to another.

FIG. 49 shows a small attaching plastic tubular cylinder in contact with three big attaching plastic tubular cylinders;

FIG. 50 shows a big attaching plastic tubular cylinder in contact with six small attaching plastic tubular cylinders;

FIG. 51 illustrates another combination of the attaching plastic tubular cylinders illustrated in FIG. 46 and FIG. 47, where some small attaching plastic tubular cylinders were removed, creating a double, triple and quadrupole contact;

FIG. 52 illustrates a triple contact of a small attaching plastic tubular cylinder with three big attaching plastic tubular cylinders;

FIG. 53 illustrates a double contact of a big attaching plastic tubular cylinder with two small attaching plastic tubular cylinders;

FIG. 54 illustrates a quadrupole contact of a big attaching plastic tubular cylinder with four small attaching plastic tubular cylinders;

FIG. 55 is a cross section A3-A3 of a double contact of a big attaching plastic tubular cylinder with two small attaching plastic tubular cylinders, showing the assembly of two modules—Module # 1 and Module #2;

FIG. 56 is a detail D1 of the FIG. 49 showing the mutual deformation of the attaching plastic tubular cylinders press-fit assembled, for triple contact combination;

FIG. 57 is a detail D2 of the FIG. 50 showing the mutual deformation of the attaching plastic tubular cylinders press-fit assembled, for six contact combination;

FIG. 58 is the cross section A3-A3 of a double contact of a big attaching plastic tubular cylinder with two small attaching plastic tubular cylinders rotated, illustrating the principle of detaching the two assembled modules, using a taper shape punch pushed into a taper slot created in one of the battery boxes of one module;

FIG. 59 shows in the rotated cross section A3-A3 the two modules in proximity each other, wright after they were detached;

FIG. 60 is the detail D3 of the FIG. 59, showing the end geometry of the both attaching plastic tubular cylinder of the two modules;

FIG. 61 shows the principle of clamping shoulder of the battery modules, with the forces involved;

FIG. 62 shows the principle of manipulation shoulder of the battery modules, with the forces involved;

FIG. 63 is an isometric view illustrating an embodiment of a battery module for cars including all the elements discussed here before;

FIG. 64 is an isometric view illustrating an embodiment of a battery package for cars, including a plurality of battery modules illustrated in FIG. 63;

FIG. 65 is an isometric view illustrating an embodiment of a battery module for SUV, including all the elements discussed here before;

FIG. 66 is an embodiment of a battery package for SUV, including a plurality of battery modules illustrated in FIG. 65;

FIG. 67 is an isometric view illustrating an embodiment of a battery module for mini-trucks and mini-buses, including all the elements discussed here before;

FIG. 68 is an embodiment of a battery package for mini-trucks and mini-buses, including a plurality of battery modules illustrated in FIG. 67;

FIG. 69 is an isometric view illustrating an embodiment of a battery module for trucks and buses, including all the elements discussed here before;

FIG. 70 is an isometric view illustrating an embodiment of a battery package for trucks and buses, including a plurality of battery modules illustrated in FIG. 69;

FIG. 71 is an isometric view illustrating an embodiment of a battery module for cars including all the elements discussed here before, showing the side contacts (+) and (−), representing the side terminals of a battery module for cars;

FIG. 72 is an isometric view illustrating an embodiment of a battery module for cars including all the elements discussed here before, showing the bottom contacts (+) and (−), representing the bottom terminals of a battery module for cars;

FIG. 73 is a cross section of a battery module by plan P in V2 direction of FIG. 72, showing the bottom terminals and the side terminals for a battery module (dash lines);

FIG. 74 is an isometric front-top view of a package created by combining all four typical modules for cars, SUV, mini-trucks & mini-buses and for trucks and buses, showing the locking shoulders, the manipulation shoulders, and the attaching plastic tubular cylinders and the side terminals of all modules;

FIG. 75 is the V3 view of FIG. 74;

FIG. 76 is the detail D4 of the FIG. 75, which is a break section showing the area where the rib of a smaller battery module (like the module for cares) enter without any interference into a slot created into the big attaching plastic tubular cylinder of the higher adjacent battery module (like the module for SUV);

FIG. 77 is the cross section B1-B1 of the battery package illustrated in FIG. 75, showing for each type of battery module the attaching plastic tubular cylinders assembled;

FIG. 78 is the detail D5 of the FIG. 76 showing the area where the rib of the smaller battery module enters into the slot made in the big attaching plastic tubular cylinder of the higher adjacent battery module, without any interference;

FIG. 79 illustrates how the smaller battery modules like for cars, for SUV and for mini-trucks and mini-buses fit to the bigger battery module for trucks and buses without any interference;

FIG. 80 is an isometric view illustrating an embodiment of a battery package created by a combination of a plurality of battery modules for trucks and buses and a car battery module;

FIG. 81 is an isometric view illustrating an embodiment of a battery package created by a combination of a plurality of battery modules for trucks and buses and two SUV battery modules;

FIG. 82 is a break section into the battery module box, showing the included communication chip used for tracking and recording purposes;

FIG. 83 is a side view V5 of the FIG. 84, illustrating an embodiment of a battery module including all the elements discussed here before, showing the big attaching plastic tubular cylinders, the bottom contacts and the side contacts, the locking shoulders and the manipulating shoulders;

FIG. 84 is the bottom view of the embodiment of a battery module including all the elements discussed here before, showing the battery box, the bottom contacts, a view of the big attaching plastic tubular cylinders, and the small attaching plastic tubular cylinders in a break section;

FIG. 85 is a side view V6 of the FIG. 83 illustrating the embodiment of a battery module including all the elements discussed here before, showing the attaching plastic tubular cylinders, the locking shoulders, the manipulation shoulders, and the 3+3 unpacking taper slots for the top and for the bottom side of a battery module;

FIG. 86 is a cross section B2-B2 of the FIG. 83 illustrating the embodiment of a battery module including all the elements discussed here before, showing the two bottom terminals with their cooper elements and their protection cover, and the inside connectors of this battery module;

FIG. 87 is the detail D6 of the break section shown in FIG. 83 illustrating the embodiment of a battery module including all the elements discussed here before, showing in detail the side terminals of this battery module;

FIG. 88 is a side view V7 of the FIG. 83 illustrating the embodiment of a battery module including all the elements discussed here before;

FIG. 89 is a side view V8 of the FIG. 86 illustrating the embodiment of a battery module including all the elements discussed here before, for a bottom installation of the battery contact plate;

FIG. 90 is a side view V8 of the FIG. 86 illustrating the embodiment of a battery module including all the elements discussed here before, for a side installation of the battery plate;

FIG. 91 is the detail D7 of the FIG. 89 illustrating the embodiment of a battery module including all the elements discussed here before, showing in detail the contact plate installed on bottom of the battery module;

FIG. 92 is the detail D8 of the FIG. 90 illustrating the embodiment of a battery module including all the elements discussed here before, showing in detail the contact plate installed on the side of the battery module;

FIG. 93 is a top view of a contact plate, showing the contact plate box, the contact plate box cover, all contacts and the attaching members;

FIG. 94 is a lateral view of a contact plate, showing the contact plate box, the contact plate box cover, all contacts, the (+) & (−) terminals and the features used for mistake prove and alignment of the battery module;

FIG. 95 is the detail D9 of the top view shown in FIG. 93;

FIG. 96 is a partial cross section of the contact plate shown in FIG. 94 illustrating the structure of the contact plate, with the contacts, attachments, liner, mistake prove elements, conductors and terminals;

FIG. 97 is the cross section C5-C5 of FIG. 93 illustrated in a partial section of the assemble contact plate & battery module, showing the contact plate box, the contact plate cover, the contact plate cooper cup with the spring, which pushes it to keep contact with the cooper element of the battery module;

FIG. 98 is the cross section C5-C5 of FIG. 93 illustrating a perfect contact version of a contact plate, showing the contact plate box, the contact plate cover, the contact plate cooper cup mounted on top of a bulging element and the spring;

FIG. 99 is the cross section C5-C5 of FIG. 93 illustrated in a partial section of the assemble contact plate & battery module, for a perfect contact version of a contact plate, showing the contact plate box, the contact plate cover, the contact plate cooper cup, mounted on top of a bulging element, with the spring, which pushes it via the bulging element ensuring in this way a perfect contact with the cooper element of the battery module;

FIG. 100 is a break section of the contact plate & battery module assemble, showing the bottom contact of the battery module with its cooper element in contact with the cooper cup of the contact plate and the mistake prove log of the contact plate into the unpacking taper slot of the battery module box, as well as the contact plate (+) terminal and the internal contacts of the battery module;

FIG. 101 is a break section of the contact plate & battery module assemble, showing the side contact of the battery module with its cooper element in contact with the cooper cup of the contact plate and the mistake prove log of the contact plate into the lateral slot made on the rib of the battery module box, as well as the contact plate (+) terminal and the internal contacts of the battery module;

FIG. 102 is a chart showing the structure of a typical battery drawer;

FIG. 103 is an isometric view of a battery drawer, showing the platform, the frame and the walls;

FIG. 104 is an isometric view of a battery package installed on the platform of a battery drawer supported by two pads, with a bottom contact plate;

FIG. 105 is an isometric view of a battery package installed on the platform of a battery drawer supported by two pads with, a side contact plate;

FIG. 106 illustrates in a lateral view a first principle of a battery drawer shown in the IN position, having a side contact battery package and contact plate, with the contact plate installed on a moving element, the compression spring, the grapnel element and the retainer element, the proximity sensors for IN and OUT position of the drawer as well as their respective targets;

FIG. 107 illustrates in a lateral view the same principle as FIG. 106, showing the same battery drawer in the OUT position with respect to the electric vehicle, the contact plate being retained by the retainer element installed on the electric vehicle body, via a grapnel element installed on the moving element, compressing the spring and creating a clearance between the battery package and the contact plate in order to set free the battery package for replacing;

FIG. 108 illustrates in a top view this first principle of FIG. 106, showing the same battery drawer in the OUT position and the “travel” realized by the contact plate attached to the moving element;

FIG. 109 is the detail D11 of FIG. 108 showing all components related to the retractable contact plate in an OUT position;

FIG. 110 is the top view of the same battery drawer illustrated in FIG. 108 in an IN position, showing the contact plate contacts in contact with the side terminals of the battery package installed on the drawer;

FIG. 111 is the detail D12 of FIG. 110 showing all components related to the retractable contact plate in the IN position of the battery drawer;

FIG. 112 is the first embodiment of the first principle illustrated in FIG. 106 of a battery drawer having a side contact for the battery package and contact plate, showing in top view the battery drawer in the OUT position, using for the moving element lateral rear slides;

FIG. 113 is the detail D13 of FIG. 112 showing all components of this embodiment related to the retractable contact plate in the OUT position of the battery drawer;

FIG. 114 is the first embodiment of the first principle illustrated in FIG. 106, showing in a top view the battery drawer in the IN position, using for the moving element lateral rear slides and showing the dimensions of the required space inside of the drawer compartment of the electric vehicle;

FIG. 115 is the second embodiment of the principle illustrated in FIG. 106, showing in a top view the battery drawer in the OUT position, with the moving element sliding inside of the drawer frame;

FIG. 116 is the detail D14 of FIG. 115 showing all components of this second embodiment related to the retractable contact plate, in the OUT position of the battery drawer;

FIG. 117 is the second embodiment of the principle illustrated in FIG. 106, showing in a top view the battery drawer in the IN position, with the moving element sliding inside of the drawer frame of the electric vehicle and showing the dimensions of the required space inside of the drawer compartment;

FIG. 118 illustrates in a lateral view a third principle of a battery drawer shown in the IN position, having a side contact for battery package and contact plate, with bottom slides for the moving element on which the contact plate is installed, the traction spring installed underneath of the drawer platform, the grapnel element and the retainer element, the proximity sensors for IN and OUT position of the drawer, as well as their respective targets;

FIG. 119 illustrates in a lateral view the same third principle as FIG. 118, showing the same battery drawer in the OUT position, the contact plate being retained by the retainer element installed on the electric vehicle body, via a grapnel element installed on the moving element, stretching the tension spring and creating a clearance between the battery package and the contact plate in order to set free the battery package for replacing;

FIG. 120 illustrates in a top view this third principle of FIG. 118, showing the same battery drawer in the OUT position;

FIG. 121 is the detail D15 of FIG. 120 showing in detail all specific components related to the retractable contact plate in an OUT position of this second principle;

FIG. 122 illustrates in a top view this second principle of FIG. 118, showing the same battery drawer in the IN position and in two break sections the traction spring and the specific components of this principle;

FIG. 123 is the detail D16 of FIG. 122 showing all specific components related to the retractable contact plate in an IN position;

FIG. 124 is a lateral view of an embodiment of the principle presented in FIG. 118 to FIG. 123, with the drawer in IN position, showing a side contacts battery package, a contact plate having all elements as described herein before, and the moving element of the contact plate sliding underneath of the drawer platform, pooled by the traction spring;

FIG. 125 illustrates in a lateral view the same embodiment as FIG. 124, showing the same battery drawer in the OUT position with respect to the electric vehicle;

FIG. 126 is the detail D17 of FIG. 125 showing all specific components related to the retractable contact plate shown in an OUT position;

FIG. 127 illustrates in a rear view the same embodiment as FIG. 124, showing the sliding element of the contact plate sliding underneath of the drawer platform between two sliding guides;

FIG. 128 is the detail D18 of FIG. 127 showing all specific components around the sliding guides of this embodiment;

FIG. 129 is a top view of an embodiment illustrating the automate alignment of the battery package on the battery drawer using alignment mechanisms comprising a plurality of stoppers and pushing mechanisms;

FIG. 130 is the cross section E1-E1 of FIG. 129 illustrating the stopper and the pushing mechanism used for aligning automatically the battery package during the installation into the battery drawer of the electric vehicle, on a perpendicular direction to the side contact plate;

FIG. 131 is the detail D19 of FIG. 130 showing a pushing mechanism of this embodiment, having an articulated arm which activated by a compression spring pushes the battery package against the opposite stopper;

FIG. 132 is the cross section E2-E2 of FIG. 129 illustrating the stopper and the pushing mechanism used for aligning automatically the battery package during the installation into the battery drawer of the electric vehicle, on a parallel direction to the side contact plate,

FIG. 133 is an isometric view of a battery package including a plurality of battery modules with a plurality of clamping devices acting on the clamping shoulder of the battery package, which clamp the battery package on the battery drawer of the electric vehicle, using the principle described in FIG. 61;

FIG. 134 is V9 view of the FIG. 133 illustrating schematically a clamping mechanism using an articulated arm activated by a tension spring and a pooling electromagnet in the clamped position (continue lines) and in the unclamped position (divide lines);

FIG. 135 is the sketch of the clamping mechanism illustrated in FIG. 134, only in unclamped position, (divide lines), showing the clearance between the clamping shoulder of the battery package and the clamping pad;

FIG. 136 is V9 view of the FIG. 133 illustrating schematically a clamping mechanism using an articulated arm activated by a compression spring and a pooling electromagnet in the clamped position, having the compression spring, mounted co-axially on the sliding member of the electromagnet;

FIG. 137 is the sketch of the clamping mechanism illustrated in FIG. 136, only in unclamped position, (divide lines), showing the clearance between the clamping shoulder of the battery package and the clamping pad;

FIG. 138 is V9 view of the FIG. 133 illustrating schematically a clamping mechanism using an articulated arm activated by a compression spring and a pushing electromagnet in the clamped position;

FIG. 139 is the sketch of the clamping mechanism illustrated in FIG. 138, only in unclamped position, (divide lines), showing the clearance between the clamping shoulder of the battery package and the clamping pad;

FIG. 140 is V9 view of the FIG. 133 illustrating schematically a clamping mechanism using an articulated arm activated by a tension spring and a pushing electromagnet in the clamped position, and with divide lines it is shown in the unclamped position;

FIG. 141 is V9 view of the FIG. 133 illustrating schematically a clamping mechanism using an articulated arm activated by an elastic blade and a pooling electromagnet in the clamped position;

FIG. 142 is the sketch of the clamping mechanism illustrated in FIG. 141, only in unclamped position, (divide lines), showing the clearance between the clamping shoulder of the battery package and the clamping pad;

FIG. 143 is V9 view of the FIG. 133 illustrating schematically a clamping mechanism using a sliding pad activated by a compression spring and a pooling electromagnet in the clamped position;

FIG. 144 is the sketch of the clamping mechanism illustrated in FIG. 143, only in unclamped position, (divide lines), showing the clearance between the clamping shoulder of the battery package and the clamping sliding pad;

FIG. 145 is a lateral view of an embodiment of a battery clamping mechanism using an articulated arm, activated by a tension spring and a pooling electromagnet, in clamped position;

FIG. 146 illustrates the embodiment of the clamping mechanism presented in FIG. 145, only in unclamped position, with divide lines;

FIG. 147 is a top view of the embodiment of the clamping mechanism presented in FIG. 145;

FIG. 148 is a lateral view of an embodiment of a battery clamping mechanism using an articulated arm, activated by a tension spring and a pooling electromagnet attached on the battery drawer wall, in clamped position;

FIG. 149 illustrates the embodiment of the clamping mechanism presented in FIG. 148, only in unclamped position, with divide lines;

FIG. 150 is a top view of the embodiment of the clamping mechanism presented in FIG. 148;

FIG. 151 is a lateral view of an embodiment of a battery drawer having a battery package with a side contact plate, installed on two pads and clamped on one side by a clamping mechanism illustrated in FIG. 145 and on the opposite side clamped by a clamping mechanism illustrated in FIG. 148, in clamped position;

FIG. 152 is the embodiment illustrated in FIG. 151, having both clamping mechanisms in unclamped position, with divide lines;

FIG. 153 shows schematically a front view of a single battery drawer with side slides;

FIG. 154 shows schematically a front view of a two adjacent single battery drawer with side slides;

FIG. 155 shows schematically a front view of a twins battery drawer with individual side slides for each member;

FIG. 156 shows schematically a front view of a twins battery drawer with a pair of lateral side slides and a central bottom slide;

FIG. 157 shows schematically a front view of triples battery drawer with a pair of lateral side slides and with two symmetrical bottom slides;

FIG. 158 is a top view of an embodiment of two adjacent single battery drawers with side slides, shown one in IN position and another one in OUT position with respect to the electric vehicle;

FIG. 159 is a top view of an embodiment of twins battery drawers on both side of an electric vehicle, with slides as illustrated in FIG. 155, shown one in IN position and another one in OUT position with respect to the electric vehicle;

FIG. 160 shows schematically a top view of a single battery drawer with its cover;

FIG. 161 shows schematically a top view of a twins battery drawer with its cover;

FIG. 162 shows schematically a top view of a triplets battery drawer with its cover;

FIG. 163 shows schematically a lateral view of double level battery drawer with individual cover for each drawer;

FIG. 164 shows schematically a lateral view of double level battery drawer with single cover for both drawers, which is attached on the inferior drawer;

FIG. 165 is a partial section of the drawer entrance showing the gasket used to seal the battery drawer and the electric resistance installed into the sealing element, for defrost in the winter time the battery drawer cover;

FIG. 166 is a chart showing the structure of a typical moving IN & OUT battery drawers system;

FIG. 167 shows schematically a lateral view of a battery drawer in the IN position, with a moving IN/OUT mechanism activated by an electric motor, having an attaching element attached to the drawer platform and to the transmission mechanism via a travel adjusting member and a travel compensation device, proximity sensors for IN and OUT drawer position with their respective targets;

FIG. 168 shows schematically a lateral view of a single or triplets battery drawer in the IN position, using as moving IN/OUT mechanism a screw & nut mechanism, activated by an electric motor, having an attaching element attached to the drawer platform and to the transmission mechanism via a travel adjusting member and a travel compensation device, proximity sensors for IN and OUT drawer position with their respective targets;

FIG. 169 shows schematically in a lateral view a single or triplets battery drawer in the OUT position, using as moving IN/OUT mechanism a screw & nut mechanism, activated by an electric motor, having an attaching element attached to the drawer platform and to the transmission mechanism via a travel adjusting member and a travel compensation device, proximity sensors for IN and OUT drawer position with their respective targets;

FIG. 170 shows schematically a front view of a single battery drawer using as moving IN/OUT mechanism a screw & nut mechanism positioned underneath of the drawer;

FIG. 171 shows schematically a front view of two adjacent single battery drawers using as moving IN/OUT mechanism a screw & nut mechanism positioned underneath of each drawer;

FIG. 172 shows schematically a front view of twins battery drawers having two independent pairs of side slides, using as moving IN/OUT mechanism a screw & nut mechanism positioned on top of the battery drawer compartment of the electric vehicle, between the two drawers;

FIG. 173 shows schematically a front view of twins battery drawers having one pair of lateral side slides and a central bottom slide, using as moving IN/OUT mechanism a screw & nut mechanism positioned anywhere between the drawers above the traverse linking the two drawers each other;

FIG. 174 shows schematically a front view of triplets battery drawers having one pair of lateral side slides and two symmetrical bottom slides, using as moving IN/OUT mechanism a screw & nut mechanism positioned underneath of the battery drawer;

FIG. 175 shows a generic set-up of individual moving IN & OUT system for different drawer locations on an electric vehicle, which uses a screw-nut mechanism for each single lateral, front and rear battery drawer.

FIG. 176 is a top view of two opposite lateral battery drawers, in OUT position, using one screw-nut moving IN/OUT mechanism for each, positioned between the two drawer compartments, both of them activated by the unique electric motor with horizontal axes via a gear box;

FIG. 177 shows schematically in a lateral view the principle of twins drawers moving IN/OUT using a screw-nut mechanism, positioned between the two drawers, on top of the drawer compartment of the electric vehicle, having an electric motor, a gear box, a combined coupling and a drawer travel adjusting element, a travel compensation element and the two proximity sensors for IN/OUT position with their respective targets, in IN position;

FIG. 178 shows schematically in a lateral view the principle of twins drawers moving IN/OUT using a screw-nut mechanism, positioned between the two drawers, on top of the drawer compartment of the electric vehicle, having an electric motor, a gear box, a combined coupling and a drawer travel adjusting element, a travel compensation element and the two proximity sensors for IN/OUT position with their respective targets, in OUT position;

FIG. 179 illustrates an embodiment of the principle described in FIG. 177 and FIG. 178 of a twins drawer, showing the battery package clamped on the drawer platform with two clamping devices, the electric motor having a horizontal axes acting on a combined assemble of coupling and travel adjusting device, a threaded rod and a special nut acting on the moving IN/OUT element, which is attached to the drawer, via a travel compensation device, the threaded rod support solidly attached to the electric vehicle body, and the two proximity sensors attached to the moving element with their targets, in IN position;

FIG. 180 illustrates an embodiment of the principle described in FIG. 177 and FIG. 178 of a twins drawer, showing the battery package clamped on the drawer platform with two clamping devices, the electric motor having a vertical axes acting via a gear box on a combined assemble of coupling and travel adjusting device, a threaded rod and a special nut acting on the moving IN/OUT element, which is attached to the drawer, via a travel compensation device, the threaded rod support solidly attached to the electric vehicle body, and the two proximity sensors attached to the moving element with their targets, in IN position;

FIG. 181 illustrates an embodiment of the principle described in FIG. 176, FIG. 177 and FIG. 178 of a twins drawer, moved IN/OUT by a unique moving IN/OUT mechanism, showing for each drawer compartment the battery package clamped on the drawer platform by clamping devices, the unique electric motor having a horizontal axes acting via coupling and a gear box both moving IN/OUT screw-nut mechanisms, each one comprising a combined assemble of coupling and travel adjusting device, a threaded rod and a special nut acting on the moving IN/OUT element, which is attached to the drawer, via a travel compensation device, the threaded rod support solidly attached to the electric vehicle body, and the two proximity sensors attached to the moving element with their targets, in IN position;

FIG. 182 is the detail D20 of FIG. 181, showing in ½ view, ½ section the exit of the gear box, the combined mechanism of the coupling and travel adjusting element, and threaded rod and the nut, included into the travel compensation device, attached on the drawer;

FIG. 183 is the section E3-E3 of the FIG. 182, showing the threaded rod, the nut, the box of the travel compensation device with the attaching bolts on the drawer;

FIG. 184 is the detail D21 of FIG. 181, showing the assemble of the threaded rod end support with the plain bearing, the support attached to the vehicle body, the washer and the retaining ring;

FIG. 185 is the view V10 of the FIG. 184, showing the threaded rod end, its support, the washer and the retaining ring;

FIG. 186 is a top view of two opposite twins drawers, illustrating in principle a moving IN/OUT system using a roller chain system as a moving IN/OUT mechanism, showing the drawers in IN position, with a unique horizontal axes electric motor on the vehicle longitudinal direction, activating by a double-stand roller chain sprocket two chains, one for each drawer, having a chain tensioner, a moving element attached to the drawer, two proximity sensors for IN/OUT position with their targets on each side of the vehicle;

FIG. 187 is a top view of two opposite twins drawers, illustrating in principle a moving IN/OUT system using a roller chain system as a moving IN/OUT mechanism, showing the drawers in OUT position, with a unique horizontal axes electric motor on the vehicle longitudinal direction, activating by a double-stand roller chain sprocket two chains, one for each drawer, having a chain tensioner, a moving element attached to the drawer, two proximity sensors for IN/OUT position with their targets on each side of the vehicle;

FIG. 188 shows schematically a front view of twins battery drawers having two independent pairs of side slides, using as moving IN/OUT mechanism a roller chain system positioned on top of the battery drawer compartment of the electric vehicle, between the two drawers;

FIG. 189 shows schematically a front view of twins battery drawers having one pair of lateral side slides and a central bottom slide, using as moving IN/OUT mechanism a roller chain system positioned on top of the battery drawer compartment of the electric vehicle, between the two drawers;

FIG. 190 shows schematically a front view of twins battery drawers linked by superior traverses, having two independent pairs of side slides, using as moving IN/OUT mechanism a roller chain system positioned underneath of the traverses, between the two drawers;

FIG. 191 shows schematically a front view of twins battery drawers linked by superior traverses, having two independent pairs of side slides, using as moving IN/OUT mechanism a screw-nut mechanism, positioned underneath of the traverses, between the two drawers;

FIG. 192 illustrates schematically a lateral view of twins battery drawers using as moving IN/OUT mechanism a roller chain system, showing the drawer in IN position, with a unique horizontal axes electric motor on the vehicle longitudinal direction, activating by a double-stand roller chain sprocket two chains, one for each side of the vehicle, having a chain tensioner, a moving element attached to the drawer, two proximity sensors for IN/OUT position with their targets on each side of the vehicle;

FIG. 193 illustrates schematically a lateral view of twins battery drawers using as moving IN/OUT mechanism a roller chain system, showing the drawer in OUT position, with a unique horizontal axes electric motor on the vehicle longitudinal direction, activating by a double-stand roller chain sprocket two chains, one for each side of the vehicle, having a chain tensioner, a moving element attached to the drawer, two proximity sensors for IN/OUT position with their targets on each side of the vehicle;

FIG. 194 illustrates an embodiment of the principle described in FIG. 192 and FIG. 193 of opposite twins drawers, moved IN/OUT by a moving IN/OUT roller chain system, showing the drawers in IN position, with a unique horizontal axes electric motor on the vehicle longitudinal direction, activating by a double-stand roller chain sprocket two chains, one for each side of the vehicle, having a chain tensioner, a moving element attached to the drawer via an adjusting travel compensation mechanism, two proximity sensors for IN/OUT position with their targets on each side of the vehicle;

FIG. 195 illustrates an embodiment of the principle described in FIG. 192 and FIG. 193 of opposite twins drawers, moved IN/OUT by a moving IN/OUT roller chain system, showing the drawers in OUT position, with a unique horizontal axes electric motor on the vehicle longitudinal direction, activating by a double-stand roller chain sprocket two chains, one for each side of the vehicle, having a chain tensioner, a moving element attached to the drawer via an adjusting travel compensation mechanism, two proximity sensors for IN/OUT position with their targets on each side of the vehicle;

FIG. 196 is the detail D22 of FIG. 194, showing in the middle of the electric vehicle frame the electric motor installed on a “U” shape support, having of its shaft a double-stand roller chain sprocket, which engages the two roller chains, one for each side of the vehicle, on which are attached the moving elements via an adjusting travel compensation mechanism and two proximity sensors for IN/OUT position with their targets;

FIG. 197 is the detail D24 of FIG. 196, illustrating in detail the moving element sub-ensemble and its attachment to the chain top line and to the drawer frame via the travel compensation mechanism;

FIG. 198 is a rear view of a twins drawer showing the majority of components described here before and the support of two side slides placed in the middle of the twins drawer, solidly attached to the vehicle body;

FIG. 199 is the detail D23 of the FIG. 194 showing the embodiment of a chain tensioner mechanism comprising one-stand roller chain sprocket, engaging the chain which turns around the shaft sliding inside of an oval channel of the “U” shaped support and a tension spring acting on an articulated arm via an adjusting bolt.

FIG. 200 shows schematically a top view of a single/triplets battery drawer shown in IN position, having as moving IN/OUT mechanism a roller chain system positioned underneath of the battery drawer, comprising a vertical axes electric motor activator, the moving element combined with a travel compensation mechanism, the chain tensioner and two proximity sensors for IN/OUT position with their targets;

FIG. 201 shows schematically a top view of a single/triplets battery drawer shown in IN position, having as moving IN/OUT mechanism a roller chain system positioned underneath of the battery drawer, comprising a vertical axes electric motor activator, the moving element combined with a travel compensation mechanism, the chain tensioner and two proximity sensors for IN/OUT position with their targets;

FIG. 202 illustrates an embodiment of the principle described in FIG. 200 and FIG. 201 of opposite single/triplets drawers, moved IN/OUT by a moving IN/OUT roller chain system, showing the drawers in IN position, with a unique vertical axes electric motor, activating by a double-stand roller chain sprocket two chains, one for each side of the vehicle, having a chain tensioner, a moving element attached to the drawer via an adjusting travel compensation mechanism, two proximity sensors for IN/OUT position with their targets on each side of the vehicle;

FIG. 203 illustrates an embodiment of the principle described in FIG. 200 and FIG. 201 of opposite single/triplets drawers, moved IN/OUT by a moving IN/OUT roller chain system, showing the drawers in OUT position, with a unique vertical axes electric motor, activating by a double-stand roller chain sprocket two chains, one for each side of the vehicle, having a chain tensioner, a moving element attached to the drawer via an adjusting travel compensation mechanism, two proximity sensors for IN/OUT position with their targets on each side of the vehicle;

FIG. 204 illustrates in partial views, at a larger scale, the embodiment described in FIG. 202;

FIG. 205 illustrates in partial views, at a larger scale, the embodiment described in FIG. 203

FIG. 206 is the detail D25 of FIG. 205, illustrating in detail the moving element sub-ensemble and its attachment to the chain line and to the drawer frame via the travel compensation mechanism, as well as the chain tensioner sub-ensemble;

FIG. 207 is the rear view V11 of FIG. 205, illustrating the roller chain attached to the drawer via the travel compensation mechanism sub-ensemble, and the chain tensioner sub-ensemble;

FIG. 208 shows in a lateral view an embodiment of a drawer security device, locking the drawer on the electric vehicle compartment during the travel, comprising a sliding locking mechanism, an electromagnet actuator, a compressing elastic element and a manual opening mechanism using a flexible element and a proximity sensor with its target, in a locked position;

FIG. 209 shows in a lateral view an embodiment of the drawer security device described in FIG. 208, opened by the electromagnet actuator acting on a sliding locking mechanism, compressing the elastic element, approaching the proximity sensor to its target and the flexible element of the manual opening mechanism remaining no tensioned;

FIG. 210 shows in a lateral view an embodiment of the drawer security device described in FIG. 208, opened by the manual opening mechanism with its flexible element shown tensioned, an electromagnet actuator, a compressing elastic element, and a proximity sensor with its target;

FIG. 211 shows in a lateral view an embodiment of a drawer security device in a locked position, comprising a sliding locking mechanism, an electromagnet actuator, a compressing elastic element and a manual opening mechanism using a flexible element and an aligning device, and a proximity sensor with its target;

FIG. 212 shows in a lateral view an embodiment of a drawer security device for two opposite drawers moved IN/OUT by a unique moving IN/OUT mechanism, in a locked position, comprising for each of two drawers a sliding locking mechanism, an electromagnet actuator, a compressing elastic element and a manual opening mechanism using a flexible element and a proximity sensor with its target;

FIG. 213 shows in a lateral view an embodiment of a drawer security device for two opposite drawers moved IN/OUT by a unique moving IN/OUT mechanism, in a locked position, comprising for each of two drawers a sliding locking mechanism, an electromagnet actuator, a compressing elastic element and a proximity sensor with its target, and a unique manual opening mechanism using a flexible element and an aligning device;

FIG. 214 shows in a lateral view an embodiment of a drawer security device in a locked position, using an articulated locking mechanism, comprising an articulated arm, an electromagnet actuator, a compressing elastic element and a manual opening mechanism using a flexible element and a proximity sensor with its target;

FIG. 215 shows in a lateral view an embodiment of the drawer security device described in FIG. 214, opened by the electromagnet actuator acting on an articulated locking mechanism, compressing the elastic element, approaching the proximity sensor to its target and the flexible element of the manual opening mechanism remaining no tensioned;

FIG. 216 shows in a lateral view an embodiment of the drawer security device described in FIG. 214, opened by the manual opening mechanism with its flexible element shown tensioned, an electromagnet actuator, a compressing elastic element, and a proximity sensor with its target;

FIG. 217 shows in a lateral view an embodiment of a drawer security device in a locked position, comprising an articulated locking mechanism, an electromagnet actuator, a compressing elastic element and a manual opening mechanism using a flexible element and an aligning device, and a proximity sensor with its target;

FIG. 218 shows in a lateral view an embodiment of a drawer security device in a locked position, using an articulated locking mechanism, comprising an articulated arm, an electromagnet actuator, a tension elastic element and a manual opening mechanism using a flexible element and a proximity sensor with its target;

FIG. 219 shows in a lateral view an embodiment of a drawer security device in a locked position, comprising an articulated locking mechanism, an electromagnet actuator, a tension elastic element and a manual opening mechanism using a flexible element and an aligning device, and a proximity sensor with its target;

FIG. 220 shows in a lateral view an embodiment of a drawer security device for two opposite drawers moved IN/OUT by a unique moving IN/OUT mechanism, in a locked position, comprising for each of two drawers an articulated locking mechanism, an electromagnet actuator, a compressing elastic element, a proximity sensor with its target, and a unique manual opening mechanism for both drawers, using flexible elements;

FIG. 221 shows in a lateral view an embodiment of a drawer security device for two opposite drawers moved IN/OUT by a unique moving IN/OUT mechanism, in a locked position, comprising for each of two drawers a sliding locking mechanism, an electromagnet actuator, a compressing elastic element and a proximity sensor with its target, and a unique manual opening mechanism using a flexible element and an aligning device;

FIG. 222 shows in a top view an embodiment of a loading utility comprising at the entrance, an identification section and a waiting area, followed by a sorting section, an inspection station, a washing station, a drying station, a battery loading station, including a battery change line, an administrative section;

FIG. 223 shows in a top view an embodiment of a loading utility with two battery change lines;

FIG. 224 illustrates in a top view an embodiment of a loading utility, showing the three first sections such as the identification section, the waiting area and the sorting section, all equipped with cameras, TV sets and gates;

FIG. 225 illustrates in a generic top view an embodiment of a loading utility, showing the inspection station, equipped with a TV set in front of the electric vehicle and with four cameras, located on each side of the electric vehicle;

FIG. 226 illustrates in a generic top view an embodiment of a loading utility, showing the washing station full equipped;

FIG. 227 illustrates in a generic top view an embodiment of a loading utility, showing the drying station full equipped;

FIG. 228 illustrates in an isometric view an embodiment of the inspection station presented in FIG. 225;

FIG. 229 illustrates in a top view an embodiment of a loading utility, showing the full equipped washing station comprising a grilled floor, a front camera and TV set, and on each side of the electric vehicle a camera, a special washing machine with its power unit;

FIG. 230 is the detail D26 of FIG. 229, illustrating in detail the washing machine in action;

FIG. 231 illustrates in a top view an embodiment of a loading utility, showing the full equipped drying station comprising a grilled floor, a front camera and TV set, and on each side of the electric vehicle a camera, a special drying machine with its power unit and its evacuation air duct;

FIG. 232 is the detail D27 of FIG. 231, illustrating in detail the drying machine in action;

FIG. 233 illustrates in a cross section an embodiment of the special washing machines in action, showing the two washing machines working on each side of the electric vehicle, the unique high pressure water pomp activated by an electric motor, used for both washing machines, the stationary enclosure, the moving enclosure having attached on it the water high pressure nozzle, the moving IN/OUT mechanism for the moving enclosure, the brushes on the edges of the moving enclosure, the high pressure water pipes, the grilled floor with the collector of the used water and soil, and their automate cleaning system, a camera and a TV set in front, and two cameras, one on each side of the electric vehicle;

FIG. 234 illustrates in a cross section the embodiment of the washing station presented in FIG. 233, showing with divide line the moving enclosures with their respective high pressure water nozzles retracted inside of the stationary enclosure;

FIG. 235 illustrates in a cross section the embodiment of the washing station presented in FIG. 233, showing the washing machine in a stand-by position;

FIG. 236 illustrates in a cross section an embodiment of the special drying machines in action, showing the two drying machines working on each side of the electric vehicle, having on each side of the electric vehicle a high volume air turbine activated by an electric motor, the stationary enclosure, the moving enclosure having attached on it the air high pressure nozzle, the moving IN/OUT mechanism the moving enclosure, the brushes on the edges of the moving enclosure, the grilled floor with the collector of the used water and soil, and their automate cleaning system, a camera and a TV set in front, and two cameras, one on each side of the electric vehicle;

FIG. 237 illustrates in a cross section the embodiment of the drying station presented in FIG. 236, showing with divide line the moving enclosures with their respective high volume air nozzles retracted inside of the stationary enclosure;

FIG. 238 illustrates in a cross section the embodiment of the drying station presented in FIG. 236, showing the drying machine in a stand-by position;

FIG. 239 illustrates in a top view a generic battery change station, showing in principle four battery change sub-station, each one of them comprising means to manipulate the battery packages for all drawers of the electric vehicle, a sub-station to dispose the empty batteries, a sub-station to keep in stand-by the full recharged battery, means to clean the contacts of the contact plates of the vehicle, means to clean the contacts of the empty batteries, means to pack & unpack the battery packages, means to store the battery packages and recharge them, means to measure and control the batteries charge for each battery module stored into the sub-station, a power unit and means to transport the battery packages inside the sub-station;

FIG. 240 illustrates in a top view a portion of the battery change sub-station, showing an electric vehicle with all drawers opened and all the equipment described in the FIG. 239;

FIG. 241 illustrates in a top view a portion of the battery change sub-station, showing the racks for battery packages storage and recharge, closed/open and the packing/unpacking device;

FIG. 242 illustrates in a top view a portion of the battery change sub-station, showing the battery recharge panel and the power unit;

FIG. 243 illustrates in a top view en embodiment of the racks for battery packages storage and recharge, showing the sliding drawers with their pneumatic cylinders moving IN/OUT, on which the battery packages are installed using aligning mechanisms and side contact plates;

FIG. 244 is the detail D10 of FIG. 243, illustrating a battery drawer of a battery storage and recharging rack;

FIG. 245 is a lateral view of an embodiment of a manual battery manipulation device, showing the battery package gripped of two pair of articulated arms, activated by a tension spring and dis-activated by an electromagnet, having a plurality of buttons to control the device;

FIG. 246 illustrates in a top view the battery manipulation device described in FIG. 245;

FIG. 247 illustrates in a top view the battery manipulation device described in FIG. 245 installed on a lifting device, ready to be use for battery packages manipulation by an operator;

FIG. 248 illustrates in a top view the battery manipulation device described in FIG. 245, showing the command buttons located on the device handles;

FIG. 249 is a lateral view of an embodiment of a manual battery manipulation device having an electromagnet as gripping element;

FIG. 250 is the cross section E4-E4 of FIG. 249, illustrating the alignment principle of the gripping device and the battery package;

FIG. 251 illustrates in a top view the battery manipulation device described in FIG. 249, showing the command buttons located on the device handles, the two cameras and the two proximity sensors mounted on extended arms installed on each corner of the electromagnet;

FIG. 252 is a lateral view of an embodiment of a manual battery manipulation device having an electromagnet as gripping element installed on a rotary lifting device with a battery package attached;

FIG. 253 is a lateral view of a generic 5 axes robot used to change the battery packages on the electric vehicles drawers;

FIG. 254 is the top view of the generic 5 axes robot illustrated in FIG. 253;

FIG. 255 is a lateral view of the rotary head of the generic robot with a battery package attached via an electromagnetic gripping device;

FIG. 256 is a lateral view of the generic robot installing a battery package into a lateral battery drawer of an electric vehicle;

FIG. 257 is a lateral view of two opposite generic robots installing the battery packages on the lateral battery drawers of an electric vehicle;

FIG. 258 is a lateral view of the generic robot deposing an empty battery package on the sliding table of the sub-station dedicated to dispose the empty batteries packages;

FIG. 259 is a top view of the battery change sub-station, showing the electric vehicle with all battery drawers empty, ready to receive the recharged batteries;

FIG. 260 is a lateral view of the generic robot taking a full recharged battery package from the stand-by sub-station;

FIG. 261 is a lateral view of the four generic robots installing the battery packages on the electric vehicle drawers;

FIG. 262 is the detail D28 of FIG. 261, illustrating in a top view the generic robot installing a battery package into the drawer of an electric vehicle;

FIG. 263 is the detail D29 of FIG. 262, illustrating in a top view the generic robot electromagnetic gripping device installing the battery package into the drawer of the electric vehicle;

FIG. 264 is the top view of the stand-by sub-station with the sliding table moved OUT and loaded with a full recharged battery package;

FIG. 265 is the top view of the sub-station where the empty battery package was deposed, shown with the sliding table moved OUT with the empty battery package for storage and new recharge;

FIG. 266 is an axial cross section of a battery side contacts cleaning device, attached with the electromagnetic gripping device on the rotary head of the generic robot;

FIG. 267 is a cross section of a battery side contacts cleaning device;

FIG. 268 is the detail D30 of FIG. 266, illustrating in axial cross section the air passage of the cleaning system;

FIG. 269 is the detail D29 of FIG. 266, showing the switching mechanism of the electric grinder used to activated the battery contacts cleaning tools;

FIG. 270 is an axial cross section of a battery bottom contacts cleaning device;

FIG. 271 is a cross section of a battery bottom contacts cleaning device;

FIG. 272 is an embodiment of the stand-by sub-station, showing in a cross section the sliding table with its pneumatic cylinder actuator, the full recharged battery package installed on the table with the alignment devices, the three cleaning devices (two for side battery contacts cleaning and one for bottom battery contacts cleaning) installed on their sliding platforms, with the respective pneumatic cylinders actuators;

FIG. 273 is a top view of the embodiment of the stand-by sub-station, showing the sliding table with the full battery package in the OUT position, creating free access to the bottom battery contacts cleaning device to be taken by the generic robot;

FIG. 274 is a top view of the embodiment of the stand-by sub-station, showing the sliding table with the full battery package in the OUT position and the generic robot gripping the bottom battery contacts cleaning device;

FIG. 275 is a top view of the embodiment of the stand-by sub-station, showing the sliding table with the full battery package in the IN position and the bottom battery contacts cleaning device OUT to the battery storage area, ready to be used by the storage robot to clean the bottom contacts on a contact plate installed on one of the storage drawer;

FIG. 276 is a top view of the embodiment of the stand-by sub-station, showing the sliding table with the full battery package and the bottom battery contacts cleaning device in the IN position, and the side contacts cleaning devices moved OUT in the opposite directions, ready to be used by each of the two robots to clean the side contacts of the contacts plated installed on the electric vehicle/storage drawers;

FIG. 277 is an embodiment of the stand-by sub-station on which the empty battery package is deposed, showing in a cross section the sliding hollow table with its pneumatic cylinder actuator, the empty battery package installed on the hollow table with the alignment devices, and the bottom battery contacts cleaning device installed on its sliding platforms, with its little pneumatic cylinders actuators, moving it up and down when the table is moving OUT in order to clean the bottom contacts of the battery package;

FIG. 278 is a lateral view of the embodiment of a bottom battery contacts cleaning device;

FIG. 279 is a lateral view of the embodiment of a bottom battery contacts cleaning device;

FIG. 280 is a top view of the embodiment of a bottom battery contacts cleaning device;

FIG. 281 is a cross section of the embodiment of a bottom battery contacts cleaning device;

FIG. 282 is a lateral view of the embodiment of the stand-by sub-station, showing the generic robot gripping the bottom battery contacts cleaning device;

FIG. 283 is a lateral view of the generic robot, showing its controller and its electronic panel;

FIG. 284 is a lateral view of four generic robots used in case of the electric vehicle is equipped with front, lateral and rear battery drawers;

FIG. 285 illustrates an embodiment of the principle of unpacking operation, showing the two taper punches in an opposite position (superior and inferior) aligned to the taper slots of the battery module, before the unpacking operation starts;

FIG. 286 illustrates an embodiment of the principle of unpacking operation, showing the two taper punches in action, in the position where they just touch the taper slots;

FIG. 287 illustrates an embodiment of the principle of unpacking operation, showing the two taper punches in action, in the position where they just finish to detach the battery module to the rest of the battery package;

FIG. 288 illustrates an embodiment of a packing/unpacking device using a steady stopper, a plurality of steady inferior punches encased into the sliding table and one row of the mobile superior punches attached to the pushing head sliding on the opened sliding pads installed on the sliding table, and the hydraulic cylinder positioned axially in front of the battery module pushing the battery module via the pushing head in the packing operation;

FIG. 289 is the detail D31 of FIG. 288, illustrating the stopper, the battery package, the punches, the pushing head and partially the hydraulic cylinder;

FIG. 290 is the detail D32 of FIG. 288, illustrating the pushing head with its adjustable pressure plate.

FIG. 291 is a lateral view of the packing/unclamping device illustrated in FIG. 288 showing the battery package, the alignment device for the battery package, the sliding table and its pneumatic cylinder which moves the table IN/OUT, the opened slides of the pushing head mounted on the table and the generic single module storage robot;

FIG. 292 is the detail D33 of FIG. 291;

FIG. 293 is the detail D34 of FIG. 292, showing the opened sliding element of the pushing head and the sliding pads mounted on the device table;

FIG. 294 is a top view of the packing/unclamping device illustrated in FIG. 288;

FIG. 295 is a lateral view of the packing/unclamping device illustrated in FIG. 288 showing the battery package, the alignment device for the battery package, the sliding table in the OUT position, the pneumatic cylinder which moves the table IN/OUT, the battery package storage robot and the single battery module storage robot;

FIG. 296 illustrates an embodiment of a packing/unpacking device using a steady stopper, a plurality of steady inferior punches encased into the sliding table and one row of the mobile superior punches attached to the pushing head, sliding on the sliding pads installed on the sliding table, being reinforced by lateral sliding elements, sliding into table logs;

FIG. 297 is the detail D35 of FIG. 296, illustrating the stopper, the battery package, the punches, the pushing head and partially the hydraulic cylinder;

FIG. 298 is the detail D36 of FIG. 296, illustrating the pushing head with its adjustable pressure plate.

FIG. 299 is a lateral view of the packing/unclamping device illustrated in FIG. 296 showing the battery package, the alignment device for the battery package, the sliding table and its pneumatic cylinder which moves the table IN/OUT, the slides and the sliding logs of the pushing head mounted on the table and the generic single module storage robot;

FIG. 300 is the detail D37 of FIG. 299;

FIG. 301 is the detail D38 of FIG. 299, showing the sliding element of the pushing head, the sliding pads mounted on the device table, having a sliding log;

FIG. 302 illustrates an embodiment of a packing/unpacking device using a steady stopper, a pushing head, having attached above the battery package and underneath of the battery package one row of the mobile superior punches and one row of the mobile inferior punches, sliding on lateral slides mounted on the hollow sliding table, activated by a hydraulic cylinder coaxial with the battery package;

FIG. 303 is the detail D39 of FIG. 302;

FIG. 304 is a lateral view of the packing/unclamping device illustrated in FIG. 302 showing the battery package, the alignment device for the battery package, the hollow sliding table and its pneumatic cylinder which moves the table IN/OUT, the lateral slides of the pushing head mounted on the table and the generic single module storage robot;

FIG. 305 is the detail D40 of FIG. 304;

FIG. 306 is a top view of the packing/unclamping device illustrated in FIG. 302;

FIG. 307 illustrates an embodiment of a packing/unpacking device using a steady stopper, a pushing head, having attached above the battery package and underneath of the battery package one row of the mobile superior punches and one row of the mobile inferior punches, sliding on lateral slides mounted on the hollow sliding table, activated by a hydraulic cylinder mounted underneath of the hollow table, parallel to the battery package;

FIG. 308 is the detail D41 of FIG. 307;

FIG. 309 is a lateral view of the packing/unclamping device illustrated in FIG. 307 showing the battery package, the alignment device for the battery package, the hollow sliding table and its pneumatic cylinder which moves the table IN/OUT, the lateral slides of the pushing head mounted on the table and the generic single module storage robot;

FIG. 310 is the top view of the packing/unclamping device illustrated in FIG. 307;

FIG. 311 is a lateral view of the packing/unclamping device illustrated in FIG. 307 showing the first step of the unpacking process—unpacking the last battery module by the punches mounted on the pushing head;

FIG. 312 is a lateral view of the packing/unclamping device illustrated in FIG. 307 showing the next step of the unpacking process—the pushing head retracted;

FIG. 313 is a lateral view of the packing/unclamping device illustrated in FIG. 307 showing the next step of the unpacking process—the detached module, gripped by the single module storage robot;

FIG. 314 is the detail D42 of FIG. 314 showing the electromagnetic gripping device of the single module storage robot, with a camera installed on it;

FIG. 315 is a lateral view of the packing/unclamping device illustrated in FIG. 307 showing the next step of the unpacking process—the detached module, gripped by the single module storage robot and taken away;

FIG. 316 is a lateral view of the packing/unclamping device illustrated in FIG. 307 showing the next step of the unpacking process—the detached module, gripped by the single module storage robot and taken away and prepare to be rotated 90 degrees;

FIG. 317 is a lateral view of the packing/unclamping device illustrated in FIG. 307 showing the next step of the unpacking process—the detached module, gripped by the single module storage robot, taken away and rotated 90 degrees, ready to be stored;

FIG. 318 is a schematic isometric view of the single module storage robot, with a battery package attached above the packing/unpacking device;

FIG. 319 is the detail D43 of FIG. 318;

FIG. 320 illustrates an embodiment of a packing/unpacking device using a retractable stopper activated by a pneumatic cylinder, a sliding pushing plate activated by a coaxial hydraulic cylinder with the battery package, a row of steady superior punches and a row of the steady inferior punches;

FIG. 321 is the detail D44 of FIG. 320;

FIG. 322 is a lateral view of the packing/unclamping device illustrated in FIG. 320 showing the first step of the unpacking process—with the stopper retracted, the first battery module of the battery module is detached by the steady superior and inferior punches;

FIG. 323 is the detail D45 of FIG. 322;

FIG. 324 is a lateral view of the packing/unclamping device illustrated in FIG. 320 showing the next step of the unpacking process—with the stopper retracted, the hydraulic cylinder pushing the entire battery package forward, including the first module, which goes out of the punches area, having free access to be gripped by the single module storage robot;

FIG. 325 is the detail D46 of FIG. 324;

FIG. 326 is a partial a cross section of the packing/unclamping device illustrated in FIG. 320 showing the next step of the unpacking process—after the detached battery module was taken out of the robot, the stopper is in the “UP” position receiving the next battery module of the battery package, which is pushed forwards by the hydraulic cylinder;

FIG. 327 is the detail D47 of FIG. 326;

FIG. 328 is a top view of the packing/unclamping device illustrated in FIG. 320 showing the retractable stopper and its sliding ways, the frame of the steady superior punches, the battery package liners, the battery package pushed by the hydraulic cylinder via the pressure plate;

FIG. 329 illustrates an embodiment of a packing/unpacking device using a plurality of retractable stoppers activated by pneumatic cylinders, a sliding pushing plate activated by a short coaxial hydraulic cylinder with the battery package, a row of mobile superior punches attached to the rotary head of the single battery module storage robot having a camera mounted on it and a plurality of steady inferior punches encased on the sliding table;

FIG. 330 is the detail D48 of FIG. 329 showing the first stopper “up”, the robot head close to the battery package and the superior punches aligned with the taper slot of the battery module, ready to start the unpacking operation;

FIG. 331 is the detail D49a of FIG. 330 showing the device ready to start the unpacking operation;

FIG. 332 is the detail D49b of FIG. 330 showing the device after the first module was detached, illustrating the first stopper “down”, the robot head close to the battery package and the first battery module of the battery module detached by the mobile superior punches and inferior steady punches;

FIG. 333 is a partial view of the embodiment of a packing/unpacking illustrated in FIG. 329, showing the first battery module of the battery package taken away by the robot and the first and the second stopper “down”, preparing the next step of the unpacking process;

FIG. 334 is a top view of the packing/unclamping device illustrated in FIG. 329;

FIG. 335 is a lateral cross section of the packing/unclamping device illustrated in FIG. 329 showing the first step of the packing process, with the last mobile stopper “up”, the first battery module pushed by the short hydraulic cylinder close to the stopper and the single battery module storage robot retracted;

FIG. 336 is a lateral cross section of the packing/unclamping device illustrated in FIG. 329 showing the next step of the packing process, with the last mobile stopper “up”, the first battery module close to the stopper, the short hydraulic cylinder retracted and the single battery module storage robot bringing the second battery module to be installed;

FIG. 337 is a lateral view of the packing/unclamping device illustrated in FIG. 329 showing the next step of the packing process, with the last mobile stopper “up”, the first and the second battery module pushed against the stopper by short hydraulic cylinder via the pressure plate, and the single battery module storage robot head close to the second battery module;

FIG. 338 illustrates an embodiment of a packing/unpacking station in action, where the sliding table of the packing/unpacking device is OUT, receiving a battery package deposed on it by the battery storage robot and the single battery module storage robot is in stand-by position;

FIG. 339 illustrates an embodiment of a packing/unpacking station inside of the battery change line, showing the empty battery package taken from the electric vehicle deposed on the sliding table of the dedicated station, shown in OUT position and the battery storage robot waiting to bring it to the unpacking/packing device;

FIG. 340 illustrates the battery storage robot taking the empty battery package from the sliding table;

FIG. 341 illustrates the sliding table of the packing/unpacking device in the OUT position with the pushing head retracted, waiting to receive the empty battery package;

FIG. 342 illustrates empty battery package deposed on the sliding table of the packing/unpacking device in the OUT position and the battery storage robot retracted;

FIG. 343 illustrates the sliding table of the packing/unpacking device described in FIG. 302, in the IN position with the empty battery package deposed on it, the pushing head of the device retracted and the single battery module storage robot in stand-by position;

FIG. 344 illustrates the sliding table of the packing/unpacking device described in FIG. 302, in the IN position with the empty battery package deposed on it, the pushing head of the device detaching the last battery module from the battery package and the single battery module storage robot in stand-by position;

FIG. 345 illustrates the sliding table of the packing/unpacking device described in FIG. 302, in the IN position with the empty battery package deposed on it, having the first battery module detached, the pushing head of the device retracted and the single battery module storage robot in stand-by position ready to act;

FIG. 346 illustrates the single battery module storage robot taking the detached module from the packing/unpacking device described in FIG. 302;

FIG. 347 illustrates the single battery module storage robot with the detached module retracted, and the packing/unpacking device described in FIG. 302 with the rest of the battery package on it;

FIG. 348 illustrates the single battery module storage robot with the detached module rotated 90 degrees and the single battery module storage rack retracted;

FIG. 349 illustrates the single battery module storage robot deposing the detached module into the drawer of the single battery module storage rack, which is in OUT position;

FIG. 350 illustrates the single battery module storage rack retracted with the empty battery module in it and single battery module storage robot retracted in the stand-by position;

FIG. 351 is the detail D50 of FIG. 338 showing a schematic isometric view of the storage robot;

FIG. 352 is a schematic top view of the storage robot presented in FIG. 351;

FIG. 353 is the detail D51 of FIG. 338 showing a schematic isometric view of the single battery module storage robot;

FIG. 354 is a schematic top view of the single battery module storage robot presented in FIG. 353;

FIG. 355 is a schematic top view of the control box of the single battery module storage robot;

FIG. 356 is a schematic top view of the control box of the storage robot;

FIG. 357 illustrates in isometric view an embodiment of a battery box showing the battery terminals and the internal integrated connectors;

FIG. 358 illustrates the cover of the battery box showing the battery internal integrated connectors;

FIG. 359 illustrates the battery box full with cylindrical battery elements;

FIG. 360 illustrates an embodiment of a cylindrical battery element;

FIG. 361 illustrates an embodiment of the negative terminal of a cylindrical battery element;

FIG. 362 illustrates an embodiment of the positive terminal of a cylindrical battery element;

FIG. 363 illustrates an embodiment of a battery assemble using an independent series connector;

FIG. 364 is a lateral view of an independent series connector;

FIG. 365 is a top view of an independent series connector;

FIG. 366 illustrates partially an embodiment of a battery assemble using an integrated series connector;

FIG. 367 is a top view of a plurality of battery cylindrical elements connected in series by independent series connectors;

FIG. 368 is a bottom view of a plurality of battery cylindrical elements connected in series by independent series connectors;

FIG. 369 illustrates partially an embodiment of a battery assemble using an independent parallel connector;

FIG. 370 is a top view of the deployed part of a parallel connector for (+) terminals;

FIG. 371 is a top view of a parallel connector for the top (+) terminals;

FIG. 372 is a left side view of a parallel connector for the top (+) terminals;

FIG. 373 is a top view of the deployed part of a parallel connector for (−) terminals;

FIG. 374 is a top view of a parallel connector for the top (−) terminals;

FIG. 375 is a left side view of a parallel connector for the top (−) terminals;

FIG. 376 is a top view of the deployed part of a parallel connector for (+) terminals;

FIG. 377 is a top view of a parallel connector for the bottom (+) terminals;

FIG. 378 is a left side view of a parallel connector for the bottom (+) terminals;

FIG. 379 is a top view of the deployed part of a parallel connector for (−) terminals;

FIG. 380 is a top view of a parallel connector for the bottom (−) terminals;

FIG. 381 is a left side view of a parallel connector for the bottom (−) terminals;

FIG. 382 is a top view of a plurality of battery cylindrical elements connected in parallel by independent parallel connectors;

FIG. 383 is a bottom view of a plurality of battery cylindrical elements connected in parallel by independent parallel connectors;

FIG. 384 illustrates partially an embodiment of a battery assemble using an integrated parallel connector;

FIG. 385 is a top view of the deployed part of a mixed connector;

FIG. 386 is a top view of the half-finished part of a mixed connector;

FIG. 387 is a top view of mixed connectors—parallel to parallel;

FIG. 388 is a top view of mixed connectors—series to parallel;

FIG. 389 is a top view of mixed connectors—parallel to series;

FIG. 390 is a top view of a plurality of battery cylindrical elements using mixed connectors;

FIG. 391 is a bottom view of a plurality of battery cylindrical elements using mixed connectors;

FIG. 392 is a front view of a double female connector;

FIG. 393 is a top view of a double female connector;

FIG. 394 is a lateral view of a special connector assembled used to connect the battery element to the internal battery terminals;

FIG. 395 is a top view of a special connector assembled used to connect the battery element to the internal battery terminals;

FIG. 396 is a front view of a special connector assembled used to connect the battery element to the internal battery terminals;

FIG. 397 is a lateral view of a special connector used to connect the battery element to the (−) internal battery terminals;

FIG. 398 is a top view of a special connector used to connect the battery element to the (−) internal battery terminals;

FIG. 399 is a lateral view of a half-finished special connector used to connect the battery element to the (−) internal battery terminals;

FIG. 400 is a top view of a half-finished special connector used to connect the battery element to the (−) internal battery terminals;

FIG. 401 is a lateral view of a half-finished special connector used to connect the battery element to the (+) internal battery terminals;

FIG. 402 is a top view of a half-finished special connector used to connect the battery element to the (+) internal battery terminals;

FIG. 403 is a lateral view of a special connector used to connect the battery element to the (+) internal battery terminals;

FIG. 404 is a top view of a special connector used to connect the battery element to the (+) internal battery terminals;

FIG. 405 is a top view of a battery module box with a plurality of cylindrical battery elements, showing different types of connection, for a plurality of battery groups;

FIG. 406 is a top view of a battery module box showing the independent connectors for the battery module illustrated in FIG. 405;

FIG. 407 is a bottom view of a battery module box showing the independent connectors for the battery module illustrated in FIG. 405;

FIG. 408 is the detail D52 of FIG. 406.

FIG. 409 is the detail D54 of FIG. 406.

FIG. 410 is the detail D55 of FIG. 406.

FIG. 411 is the detail D53 of FIG. 406.

FIG. 412 is the detail D56 of FIG. 406.

FIG. 413 is the detail D57 of FIG. 406.

FIG. 414 is the detail D58 of FIG. 406.

FIG. 415 is the detail D60 of FIG. 406.

FIG. 416 is the detail D59 of FIG. 406.

FIG. 417 illustrates schematically the electric system of an electric vehicle, showing the connections of the battery packages to the power unit and the extra utility battery;

FIG. 418 is an embodiment of an automated loading utility including two battery change lines, having for each side of each line a single battery module storage robot;

FIG. 419 illustrates in detail a change battery line, including all the sections and sub-sections from beginning to the end of the battery change process;

FIG. 420 illustrates schematically the power unit and the control panel of the battery recharge station;

FIG. 421 illustrates the battery change line in action, showing the electric vehicle at the entrance in the inspection station;

FIG. 422 illustrates the battery change line in action, showing the electric vehicle in the washing station;

FIG. 423 illustrates the battery change line in action, showing the electric vehicle in the drying station;

FIG. 424 illustrates the battery change line in action, showing the electric vehicle in the battery change station, just before to open the battery drawers;

FIG. 425 illustrates the battery change line in action, showing the electric vehicle in the battery change station, with the battery drawers opened and the full recharged battery package on the stand-by station, ready to be installed on the electric vehicle;

FIG. 426 illustrates the battery change line in action, showing the electric vehicle in the battery change station, with the four battery change robots taking the empty battery packages from the battery drawers of the electric vehicle;

FIG. 427 illustrates the battery change line in action, showing the electric vehicle in the battery change station, with the four battery change robots deposing the empty battery packages to the dedicated station;

FIG. 428 illustrates the battery change line in action, showing the electric vehicle in the battery change station, with the battery drawers opened, the four battery change robots taking the side contact cleaning devices from the cleaning section, in order to clean the side contacts of the contact plates of the battery drawers of the electric vehicle;

FIG. 429 illustrates the battery change line in action, showing the electric vehicle in the battery change station, with the battery drawers opened, the four battery change robots cleaning the side contacts of the contact plates of the battery drawers of the electric vehicle;

FIG. 430 illustrates the battery change line in action, showing the electric vehicle in the battery change station, with the battery drawers opened and empty, with the four battery change robots taking the full recharged battery packages from the stand-by station;

FIG. 431 illustrates the battery change line in action, showing the electric vehicle in the battery change station, with the battery drawers opened, with the four battery change robots deposing the full recharged battery packages into the battery drawers of the electric vehicle and the battery stand-by station empty;

FIG. 432 illustrates the battery change line in action, showing the electric vehicle in the battery change station, with all full recharged battery packages installed, with the battery drawers closed, ready to leave the battery change station and the four battery change robots retracted;

FIG. 433 illustrates the battery change line in action, showing the electric vehicle leaving the loading utility;

FIG. 434 is an embodiment of an automated loading utility including two battery change lines, having for the adjacent half-lines (in the middle of the two lines) just one single battery module storage robot, serving two packing/unpacking devices;

FIG. 435 is an embodiment of an automated loading utility for heavy duty electric vehicles, like trucks or buses, showing a truck with its trailer in process to receive the full recharged battery packages, by the four battery change robots;

### DETAILED DESCRIPTION OF PREFERRED EMBODIMENTS

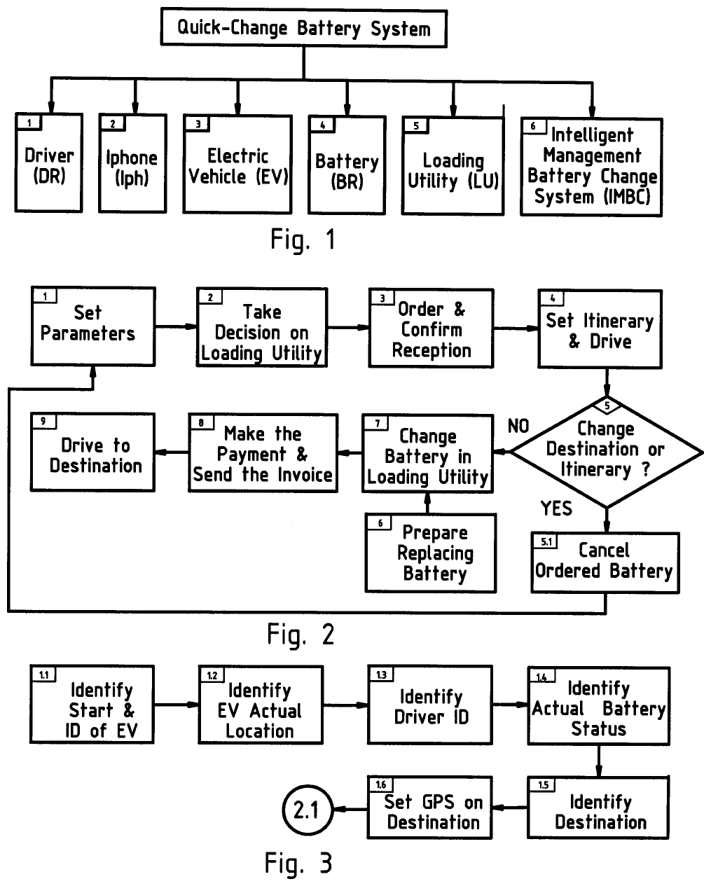

The present invention relates to a battery quick-change process for electric vehicles, capable to allow a quick battery change. This battery quick-change process is supported by a battery quick-change system presented in FIG. 1, wherein such a system comprises:
a driver (DR);
an intelligent phone (Iph)
an electric vehicle (EV) allowing to change the vehicle battery in a very short time and to take, transmit and receive information;
a battery (BR) for electric vehicle allowing to change the vehicle battery in a very short time and to transmit information. In this document “battery/batteries” means “rechargeable battery/batteries”;
a loading utility (LU) for electric vehicle capable to change very quickly the vehicle battery, to charge and prepare the replacing batteries for new installations, to receive and transmit information;
an intelligent management battery change system (IMBC) able to interconnect via Iphone and internet network the driver (DR), the electric vehicle (EV), the batteries (BR) and the loading utility (LU) for electric vehicles in order to optimize the entire battery quick-change process.

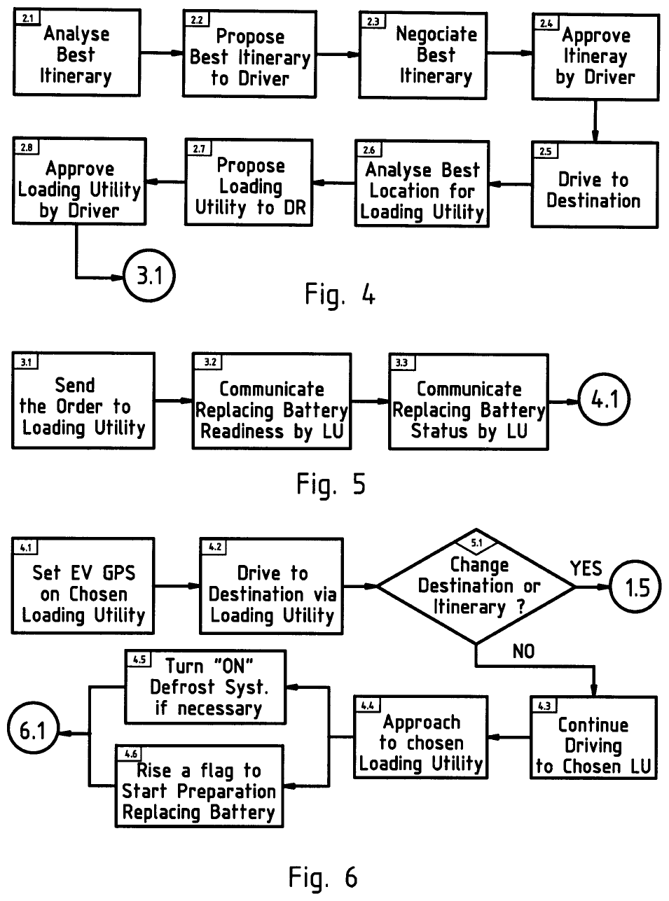

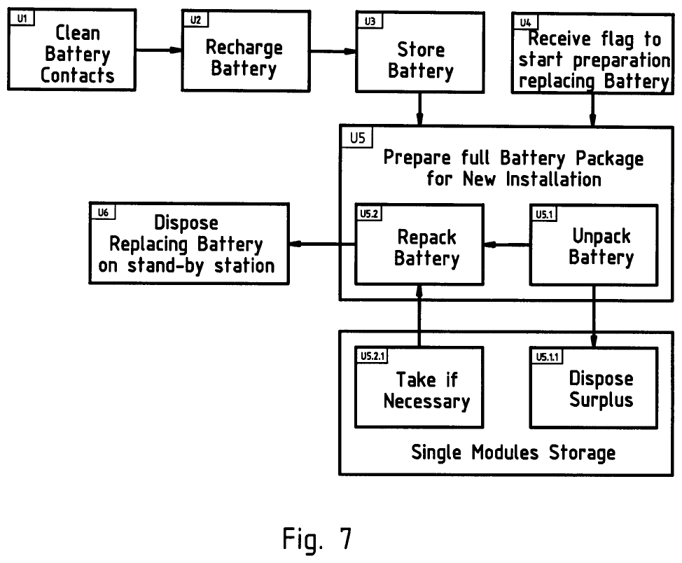

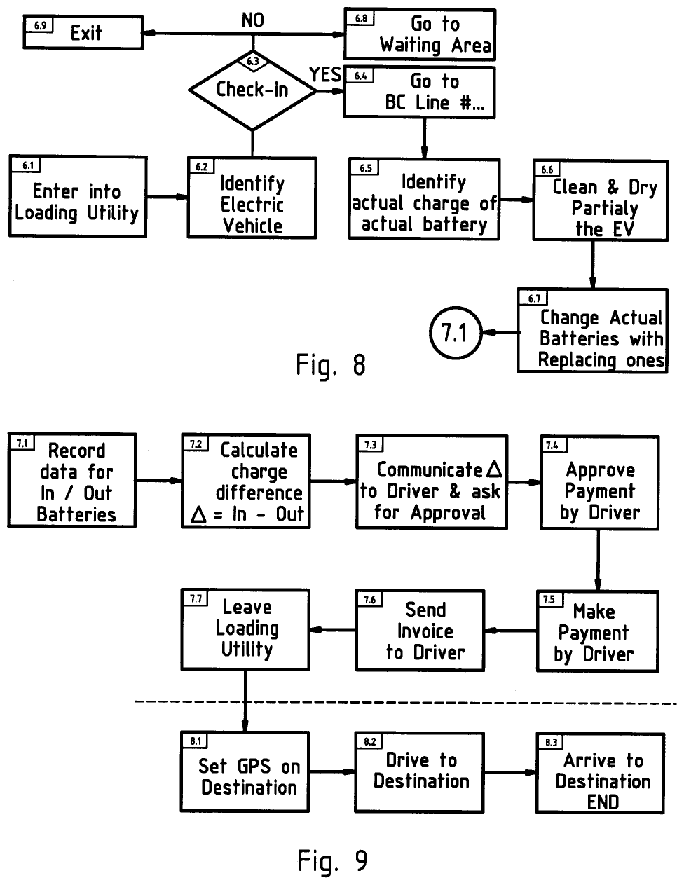

As illustrated in FIG. 2, the quick-change battery process for electric vehicles may be divided in 9 portions as following:
1. Set Parameters:
   In first portion of the process there is an exchange of information between the intelligent management battery change system (IMBC), the driver (DR) and the electric vehicle (EV) in order to establish the actual parameters of the process such as: electric vehicle ID, driver ID, battery ID, battery status (the actual battery charge), electric vehicle (EV) actual location, projected destination, set the GPS of electric vehicle to destination and start driving, see FIG. 3.
2. Take Decision on loading utility:
   The second portion of the process contains an itinerary analysis. Based on the actual parameters, on an optimization and negotiation between the intelligent management battery change system (IMBC) and the driver (DR), a decision is taken regarding itinerary, via chosen loading utility (LU), see FIG. 4.
3. Order & confirm reception:
   The third portion of the process finalize the deal, involving the driver (DR), the intelligent management battery change system (IMBC) and the loading utility (LU). The replacing battery is ordered and the driver (DR) receives all pertinent information from the chosen loading utility (LU) via (IMBC), see FIG. 5.
4. Set itinerary & drive:
   The next portion of the process sets the GPS of the electric vehicle (EV) on the chosen loading utility (LU) location and continue driving to destination via loading utility, see FIG. 6. Approaching to the chosen loading utility (LU), the intelligent management battery change system (IMBC) identify when the electric vehicle is about 15 minutes driving time to the loading utility (LU) and rise a flag to loading utility (LU) in order to start the preparation of the replacing battery. Also, based on the weather conditions, in the winter time, the intelligent management battery change system (IMBC) appreciates the requested time for defrost the battery drawers and turn “ON” automatically, in the wright time the defrost system of the electric vehicle, if necessary.
5. Change itinerary:
   If the driver decides to change the itinerary, this can be done by contacting the intelligent management battery change system (IMBC). This will cancel the battery reload order to the chosen loading utility (LU) and the process go to the setting of the new parameters, see FIG. 6.
   If the cancellation is done in a reasonable time (more than 15 minutes) before the scheduled time for the battery change, (before making the battery package for this specific electric vehicle) the cancellation is free.
   If not, if the battery package for this specific electric vehicle is already done when the cancellation is announced, there is a penalty to pay for the time related to the packaging operation. For everything else there are not penalties because the recharged modules are ready to be used for another electric vehicle in the required configuration. The itinerary may be changed any time and any times, but in the same conditions presented here before. If this itinerary change occurs, the process continues returning to the first portion of the process in order to reset the new itinerary, find other loading utility (LU) on the new itinerary and reset the electric vehicle GPS system for the new loading utility (LU) location.
6. Prepare replacing battery:
   Another portion of the process consists in the preparation of the replacing battery into the loading utility (LU), see FIG. 7. After the battery is taken out of the electric vehicle the battery contacts are cleaned, the battery is recharged and stored, waiting for a new installation. After receiving the flag to start preparation of the replacing battery from the intelligent management battery change system (IMBC), in loading utility is starting the preparation of the replacing battery by unpacking and repacking recharged batteries in the required configuration and it will be deposed on the stand-by station ready for a new installation.
7. Change battery:
   Reaching the loading utility (LU), at the entrance, in the check-in process, the loading utility (LU) system identifies the electric vehicle and checks if the electric vehicle is scheduled and if it is in time. If YES, the gate will be opened and the vehicle is conducted to one of the battery change line, record the batteries actual charge. If NO, the vehicle is conducted to the waiting area or to the exit. If necessary, the electric vehicle is partially cleaned and dry before and the batteries are changed with the replacing ones, see FIG. 8.
8. Record, payment & invoice:
   The next portion of the process shown in FIG. 9 consists in:
      record in the data base of the loading utility (LU) and in the data base of the intelligent management battery change system (IMBC) of all information related to the IN/OUT batteries;
         calculate the charge difference between the replacing battery (IN) and the actual (replaced) battery (OUT);
      communicate to the driver and ask for payment approval;
      approve payment by driver;
      make payment by driver;
      send invoice to the driver.
      leave the loading utility (LU).
9. Drive to destination:
   The last portion of the process includes the GPS setting for the final destination and drive to the final destination, arrive to destination—END, see FIG. 9.

This quick-change battery process for electric vehicles capable to allow a quick battery change time for an electric vehicle is presented in detail hereafter step by step: identify the electric vehicle ID when this is starting;
2. identify the driver ID;
3. identify the actual location of the electric vehicle;
4. identify the vehicle batteries ID's;
5. identify the actual battery status—actual charge;
6. identify the destination;
7. analyze the best itinerary;
8. make a proposition of the best itinerary to the driver;
9. negotiate the proposal;
10. approve the itinerary by driver;
11. set the electric vehicle GPS system on destination;
12. start driving;
13. analyze the best location for the loading utility;
14. make a proposition of the best loading utility location to the driver;
15. negotiate the proposition;
16. approve the loading utility location by the driver;
17. set the electric vehicle GPS system on the chosen loading utility location;
18. continue to drive to destination via chosen loading utility location;
19. send an order for the replacing battery to the loading utility;
20. communicate to the driver the status of the replacing battery;
21. if the driver change the destination or the itinerary:
22. if YES—communicate the new destination and go to step 7;
23. if NO—continue driving to the destination via chosen loading utility location and go to 24;
24. approaching to the loading utility location;
25. identify the time when the electric vehicle is about 15 minutes before to rich the loading utility location;
26. at this time, rise a flag to start preparation of the replacing battery into the loading utility;
27. turn “on” the drawer defrost system, if necessary;
28. enter into the loading utility;
29. check-in by identifying the electric vehicle, the driver and the schedule;
30. if the electric vehicle is scheduled, and if it's in time and the replacing battery package is already prepared, receive the permission to go inside the loading utility, the gate will be opened and the vehicle is conducted to one of the battery change line;
31. if it's not scheduled or if it is not in time, or the replacing battery package is not ready for change, and if there is other electric vehicle on the battery change line, receive a message to go to the waiting area and have the information for the new schedule;
32. inspection, identifying and recording the batteries and their actual charge;
33. clean & dry partially the electric vehicle;
34. change the actual batteries with the replacing ones;
35. record in the data base all information related to the in/out batteries;
36. calculate the difference of the charge between the replacing (IN) batteries and the actual (OUT) batteries;
37. communicate to the driver all details related to the payment;
38. approve the payment by the driver;
39. make the payment;
40. send the invoice to the driver;
41. leave the loading utility;
42. continue to drive to the destination;
43. arrive to destination—END.
44. inside of the loading utility start to prepare replacing batteries for a new installation—outside of the electric vehicle.

Outside of the electric vehicle, into the loading utility (LU), the process of recharging and preparation of the replacing batteries for a new installation comprises the steps of:
LU1. clean the batteries contacts;
LU2. recharge batteries;
LU3. store batteries;
LU4. prepare replacing batteries for a new installation;
LU5. dispose the replacing batteries on the stand-by station, ready for a new installation.

This battery quick-change process may be realized using a special battery quick-change system presented here before, where one of the main component is the electric vehicle.

The electric vehicle adapted to the battery quick-change process is characterized by making the battery easy accessible for change. The solution of this is to use drawers and to install the batteries into these drawers. By opening the drawers, there is full access to the battery and its quick-change in possible.

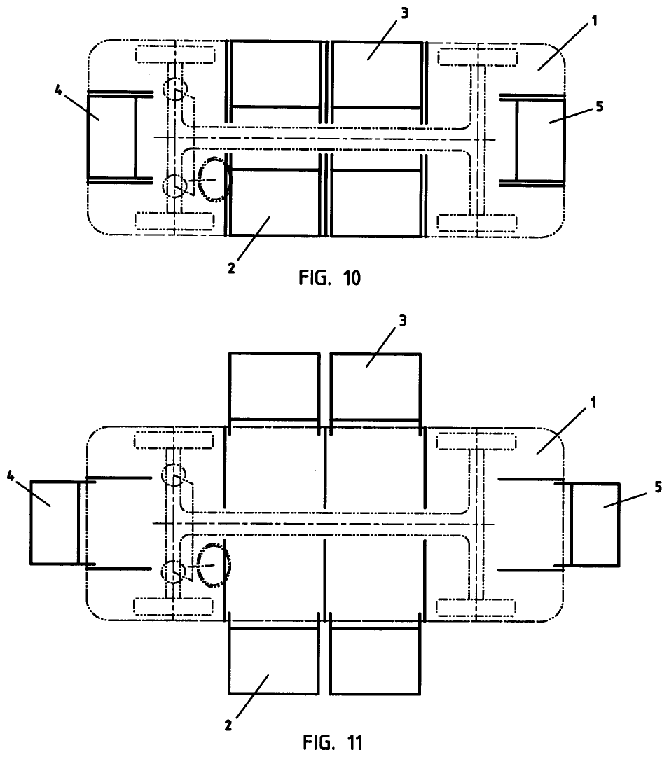

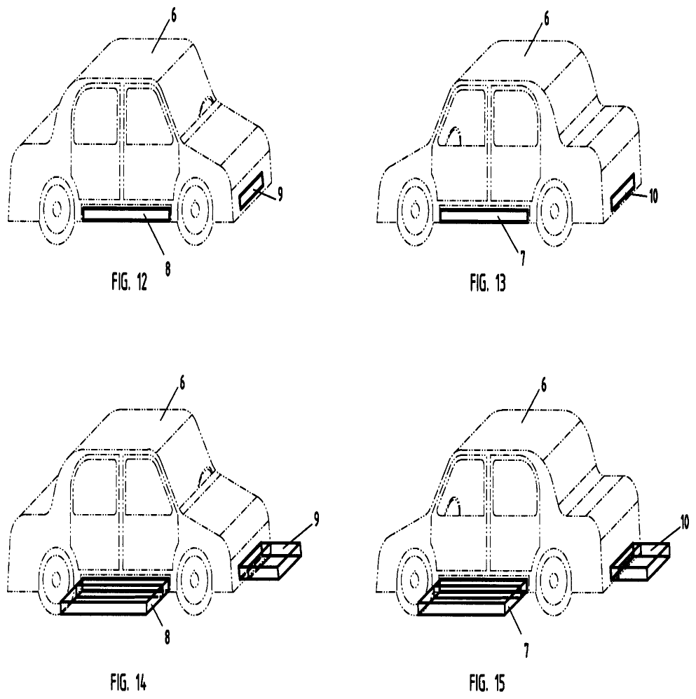

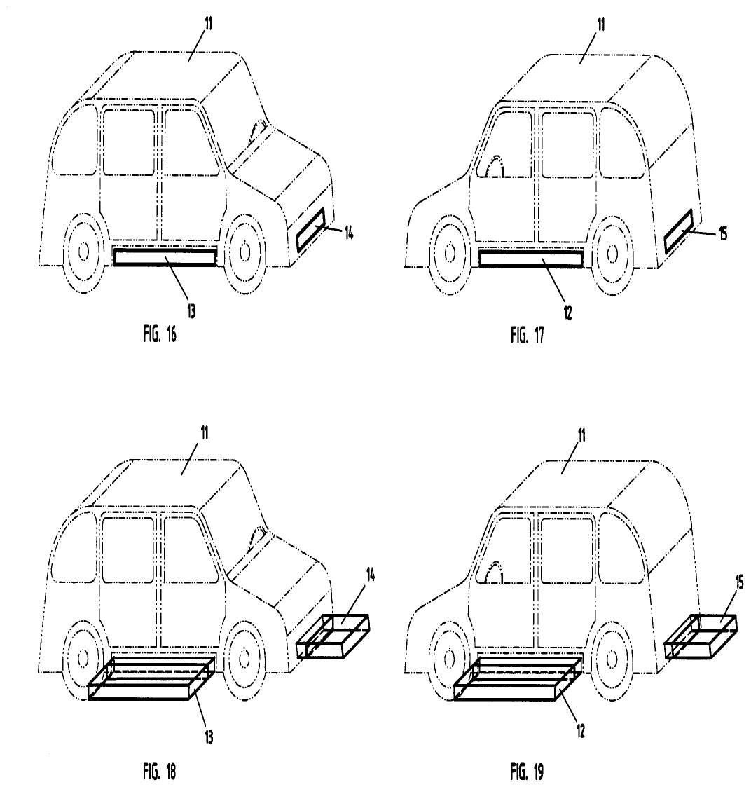

As illustrated in FIG. 10 and FIG. 11, depending on the location of the battery drawers on the vehicle 1, there are:
side drawers—opening on the left side of the vehicle—left side drawers 2, and/or on the right side of the vehicle—right side drawers 3;
front drawers 4—opening forewords;
rear drawer 5—opening backwards.

Depending on the type and the size of the electric vehicle, the location of the drawers on the vehicle and their grad of in-dependency, there are different options of battery drawers for each class of vehicles, such as:
depending on the grad of in-dependency:
single;
multiple drawers linked together, like: twins (double drawers), triplets (triple drawers), etc.
depending on the number of levels:
single level:
multiple level, like: double-levels drawers, triple-levels drawers, etc.
depending on number of drawers per level (number of columns):
single;
multiple drawers per level—multiple columns drawers, like: double-columns drawers, triple-columns drawers, etc.

Any combination of all these possibilities can be applied. The name of each kind of drawer may be done by concatenating the three characteristics: number of linked drawers/number of levels/number of columns. Also, for different combinations may be attached a cod reflecting that three characteristics. Here below are some examples of names and their corresponding codes:
single/single level/single column (1/1/1) is the name and the code of an individual drawer;
double/double level/triple columns (2/2/3) is the name and the code of double drawer on double levels and on three columns:
double/triple level/single column (2/3/1) is the name and the code of one column of drawers having three levels of double drawers.

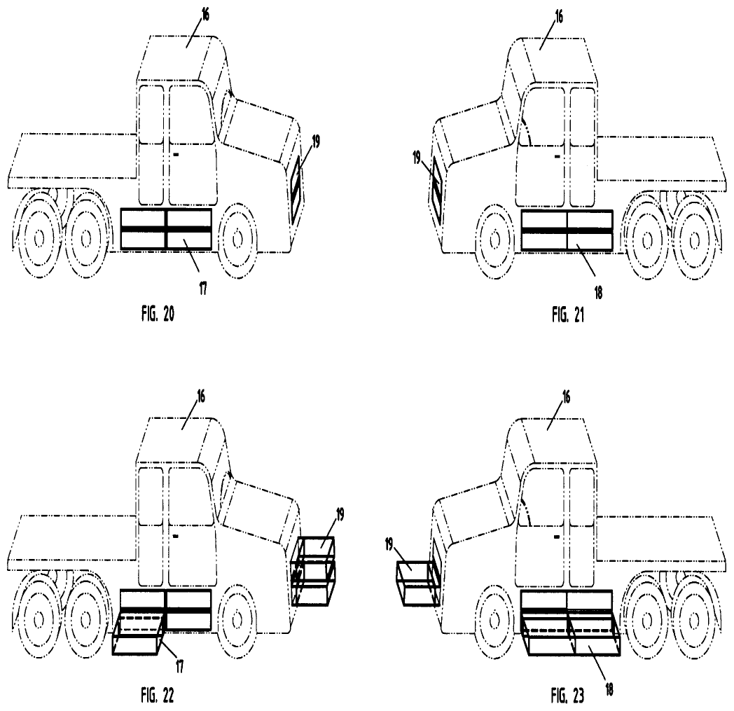

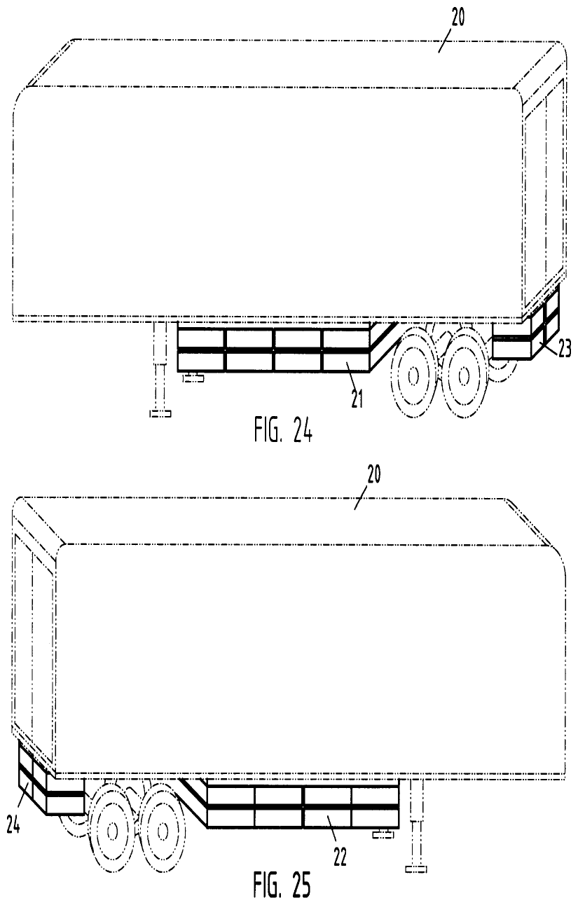

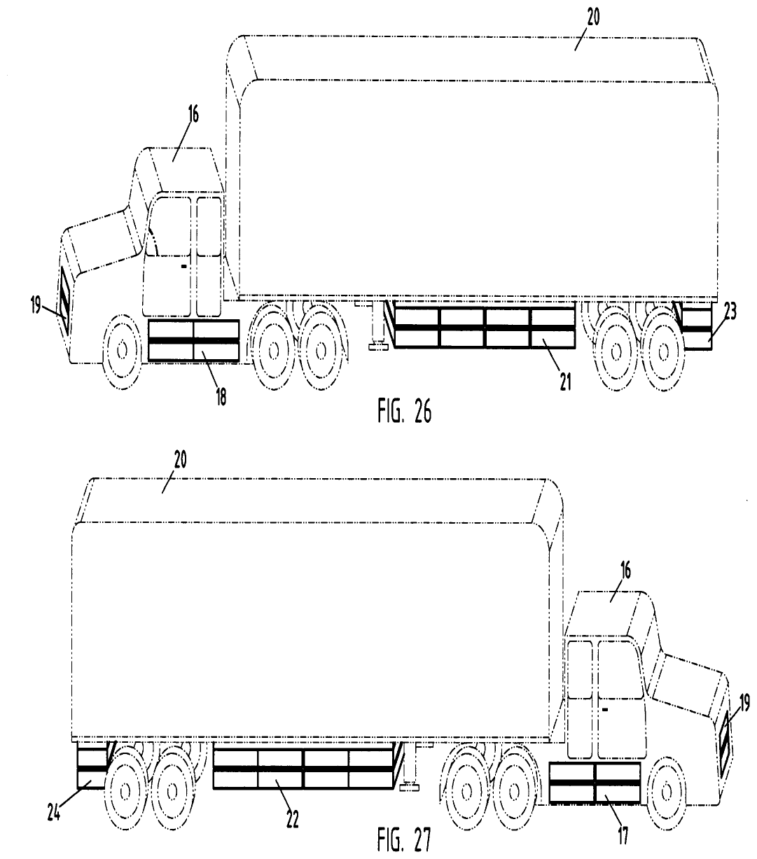

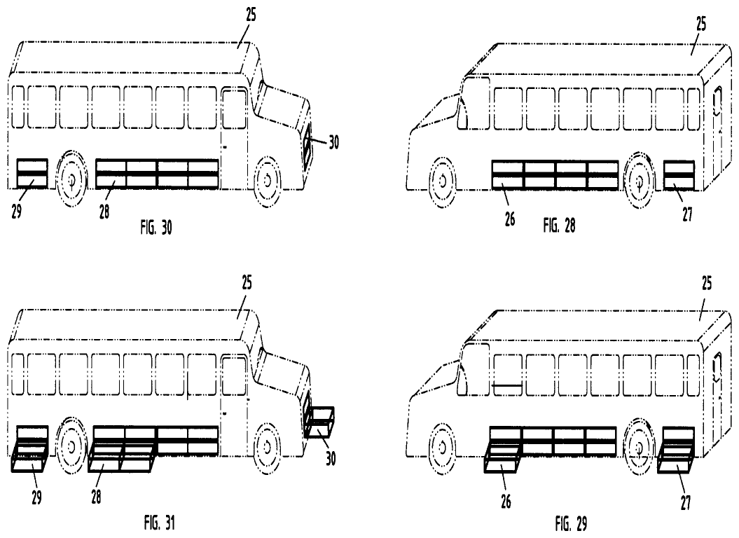

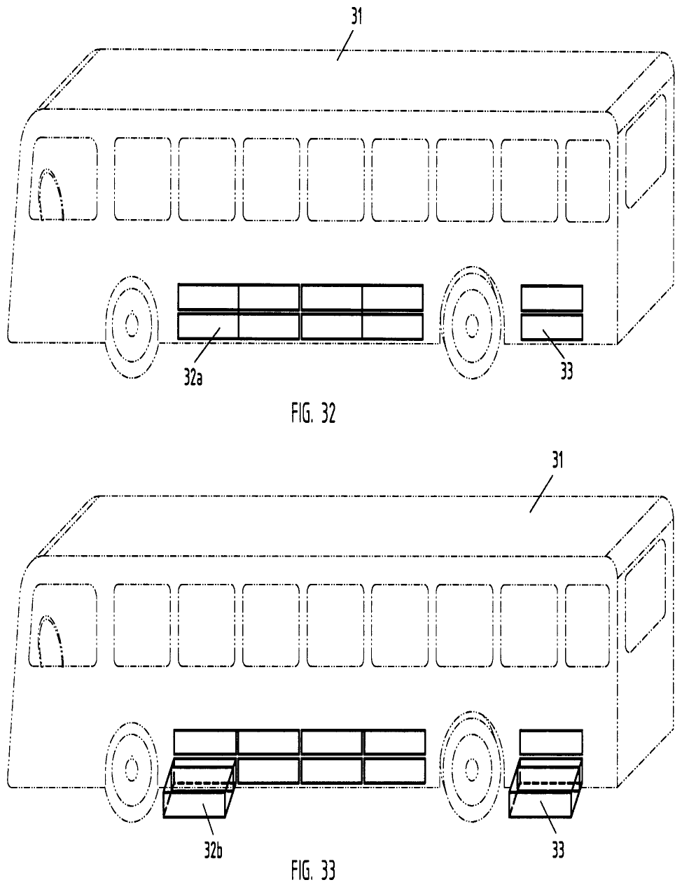

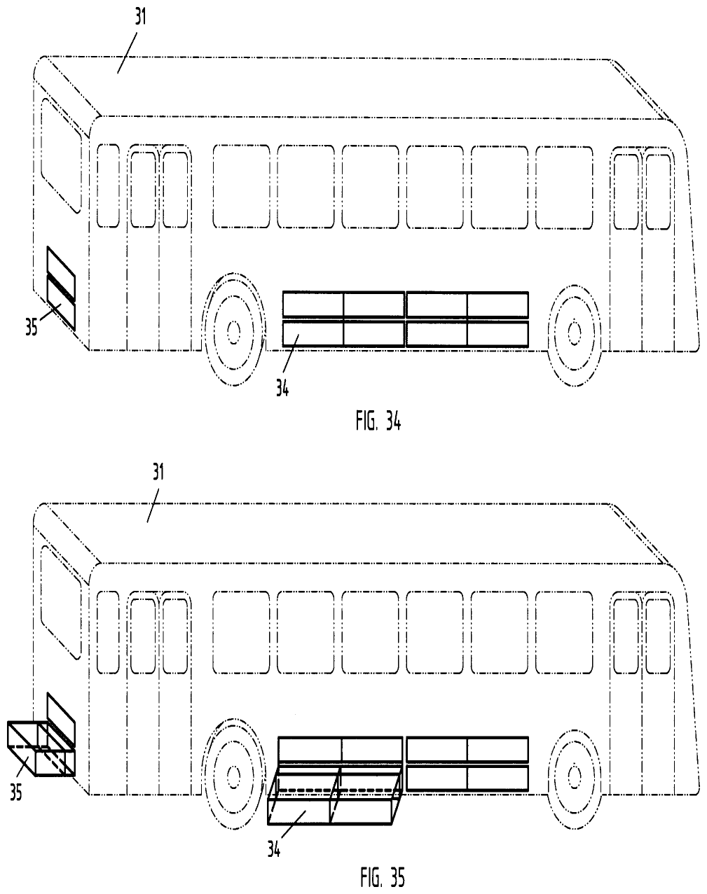

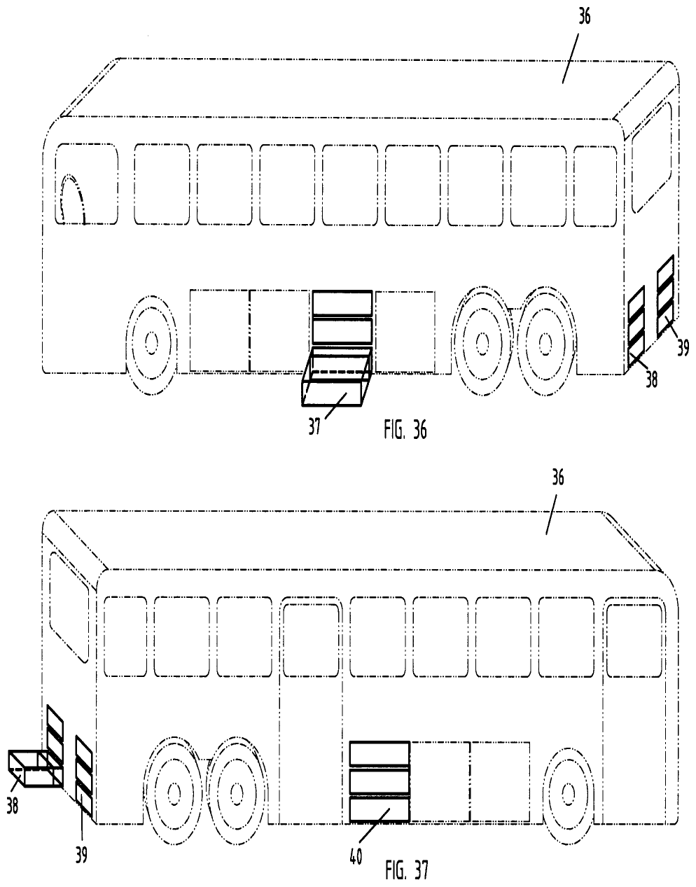

A multitude of embodiments are presented in FIG. 12 to FIG. 37, as following:
as shown in FIG. 12, FIG. 13, FIG. 14 and FIG. 15, cars 6 may be equipped, with:
side drawers located underneath of the car between the front and the rear wheels, opening laterally on left side 7 (1/1/1) (see FIG. 13—IN and FIG. 15—OUT) and on the right side 8 (1/1/1) (see FIG. 12—IN and FIG. 14 OUT);
front drawers 9 (1/1/1) (see FIG. 12—IN and FIG. 14—OUT);
rear drawers 10 (1/1/1) (see FIG. 13—IN and FIG. 15—OUT);
as shown in FIG. 16, FIG. 17, FIG. 18 and FIG. 19, the SUV 11 may be equipped with:
side drawers located underneath of the SUV between the front and the rear wheels, opening laterally on left side 12 (1/1/1) (see FIG. 17—IN and FIG. 19—OUT) and on the right side 13 (1/1/1) (see FIG. 16—IN and FIG. 18—OUT);
front drawers 14 (1/1/1) (see FIG. 16—IN and FIG. 18—OUT);
rear drawers 15 (1/1/1) (see FIG. 17—IN and FIG. 19—OUT);
as shown in FIG. 20 to FIG. 23, the trucks 16 may be equipped with:
side drawers located underneath of the truck cabin between the front and the rear wheels, opening aterally on right side 17 (1/2/2)—single/double level/double columns (see FIG. 20—IN and FIG. 22 one OUT) and on left side 18 (2/2/1) (see FIG. 21—IN and FIG. 23—one OUT);
front drawers 19 (1/2/1) (see FIG. 20 & FIG. 21—IN and FIG. 23—one OUT & FIG. 22—all OUT);
as shown in FIG. 24 and FIG. 25, the trailers 20 may be equipped with:
side drawers located underneath of the trailer 20 in front of the rear wheels, opening laterally on left side 21 (1/2/4) (see FIG. 24—IN) and on right side 22 (2/2/2) (see FIG. 25—IN);
rear drawers located underneath on the rear side of the trailer 23 (1/2/2) (see FIGS. 24) and (2/2/1) (see FIG. 25—IN);
in FIG. 26 and FIG. 27 is illustrated a truck with trailer having drawers located as discussed before.
as shown in FIG. 28 to FIG. 31 the school bus 25 may be equipped with:
lateral-middle side drawers located underneath of the bus between the front and the rear wheels, opening laterally on left side, named here below “left-middle side drawers” 26 (1/2/4) (see FIG. 28—IN and FIG. 29—IN and one OUT) and on right side, named here below “right-middle side drawers” 28 (2/2/2) (see FIG. 30—IN and FIG. 31—one OUT);
lateral-rear side drawers located underneath of the bus rear to the rear wheels, opening laterally on left side, named here below “left-rear side drawers” 27 (1/2/1) (see FIG. 28—IN and FIG. 29—one OUT)) and opening on right side, named here below “right-rear side drawers” 29 (1/2/1) (see FIG. 30—IN and FIG. 31—one OUT));
front drawers 30 (1/2/1) (see FIG. 30—IN and FIG. 31—one OUT);
as shown in FIG. 32 to FIG. 35 the city buses 31 may be equipped with:
lateral-middle side drawers located underneath of the bus between the front and the rear wheels, opening laterally on left side, named here below “left-middle side drawers” 32a (2/2/2), (see FIG. 32—IN) and 32b (1/2/4), (see FIG. 33—one OUT) and on right side, named here below “right-middle side drawers” 34 (2/2/2) (see FIG. 34—IN and FIG. 35—one OUT);
lateral-rear side drawers located underneath of the bus, rear to the rear wheels, opening laterally on left side, named here below “left-rear side drawers” 33 (1/2/1) (see FIG. 32—IN and FIG. 33—one OUT);
back drawers named here below “back-centre drawers” 35 (1/2/1) (see FIG. 34—IN and FIG. 35—one OUT);
as shown in FIG. 36 & FIG. 37 the inter-cities buses 36 may be equipped with:
lateral-middle side drawers located underneath of the bus between the front and the rear wheels, opening laterally on left side, named here below “left-middle side drawers” 37 (1/1/1) (see FIG. 36—IN and one OUT) and on right side, named here below “right-middle side drawers” 40 (1/3/1) see FIG. 37 IN);
lateral-back side drawers located underneath of the bus, rear to the rear wheels, opening backwards on left side, named here below “left-back side drawers” 38 (1/3/1) (see FIG. 36—IN and FIG. 37 IN and one OUT) and opening backwards on right side, named here below “right-back side drawers” 39 (1/3/1) (see FIG. 36—IN & FIG. 37 IN);

Depending on the needs and preferences, the electric vehicles makers may choose one or another of these versions or a combination of some of them. There are some limits related to the battery capacity, the allowable space for each location and the battery weight.

An optimization is necessary because:
bigger autonomy requests bigger capacity, bigger battery, bigger space, heavier weight, lower efficiency (to much extra weight for the actual battery technology);
higher efficiency requests lighter battery, smaller capacity, smaller battery, smaller space. But, any of the solution is chosen, the principle remains the same: for quick-change battery, battery drawers have to be used in order to have easy access to the battery.

In this design the battery is a quick-change battery. The quick-change battery is not permanently attached to the electric vehicle, for every recharge, the battery is taken out of the vehicle and is changed with another full recharged one. All batteries have to fit in their drawers. Therefore the batteries for all electric vehicles have to be standardized. Because the size and the requirements are different for cars, SUV, trucks, buses, etc., the industry has to establish the adequate dimensions for each kind of application. The battery box and some features have to be the same for all batteries manufacturers. The battery is not anymore part of the electric vehicle, it is one of the vehicle's components. Therefore, using this technology, generally, the battery is not owned by the electric vehicle owner, but by the power provider and loading utility owner.

In order to have an interchangeable battery for each category of electric vehicles, adapted for any vehicle of its class, the design of the quick-change battery has to be a modular design.

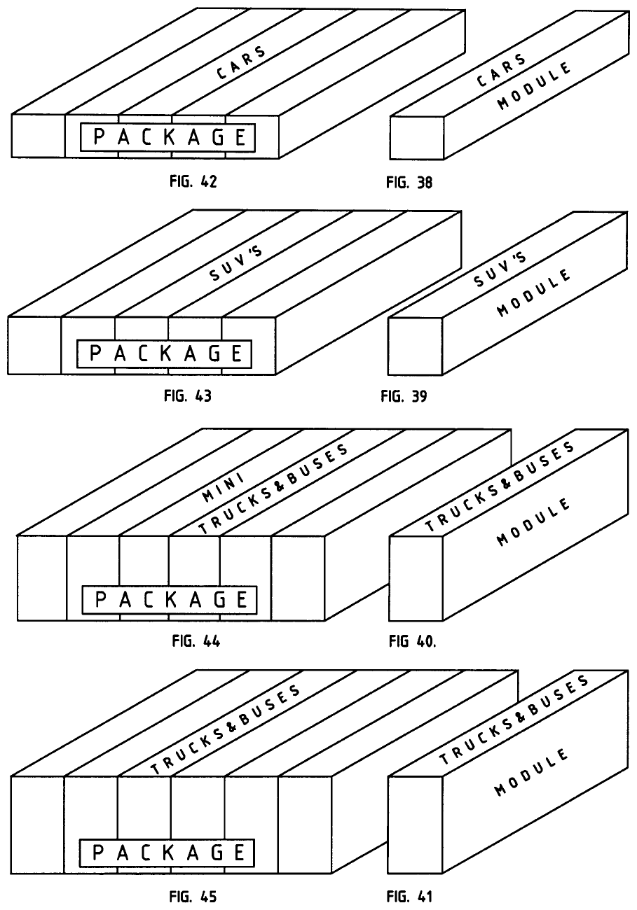

In FIG. 38 to FIG. 41 are illustrated schematically different battery modules for different categories and classes of electric vehicles. As shown in FIG. 42 to FIG. 45, for each category by merging many modules may be built different battery packages, using a plurality of battery modules.

This modular design allows to combine in different ways these modules in order to obtain different quick-change battery packages for different electric vehicles of the same class (produced by different electric vehicle manufacturers).

A quick-change battery module comprises:
means to accumulate electricity;
a plurality of internal connectors;
means to quick attach one module to another;
means to quick detach one module from another;
means to clamp the battery package on the drawer;
means to manipulate the battery package during the installation and uninstalling operation;
a plurality of (+) and (−) terminals;
a battery box;
electronic means capable to transmit wireless information to the electric vehicle computer.

The means to quick attach one module to another use a plurality of elastic elements which are assembled press-fit together, creating a friction force which keeps the modules attached each-other. These elastic elements may be small/big attaching tubular shape plastic cylinders, disposed on the opposite faces of the battery box and by pushing one battery module to another, the tubular cylinder are forced to enter each one between others, creating a little elastic deformation and in this way the attachment is realized.

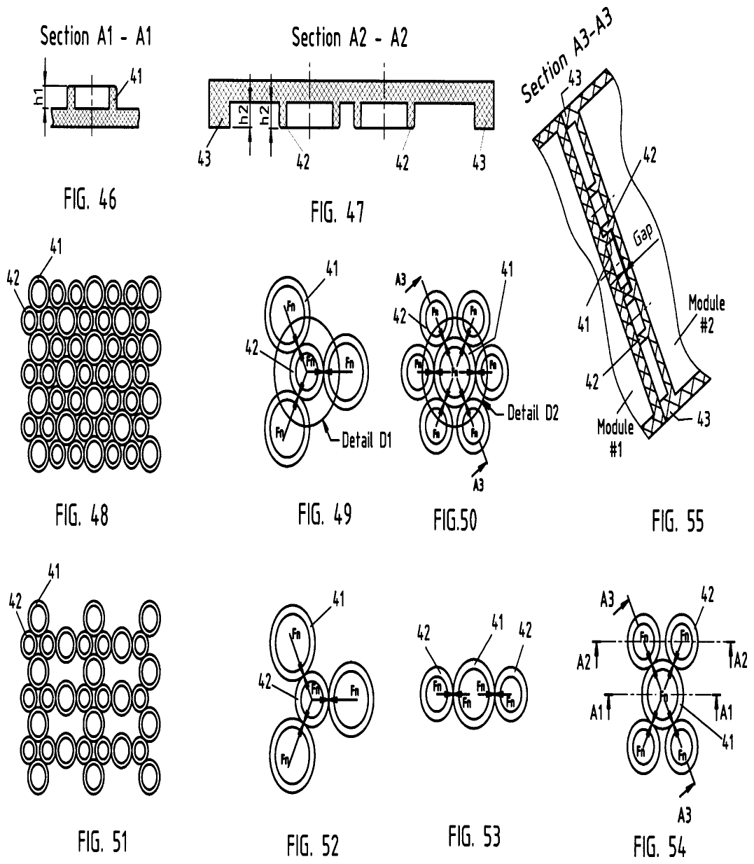

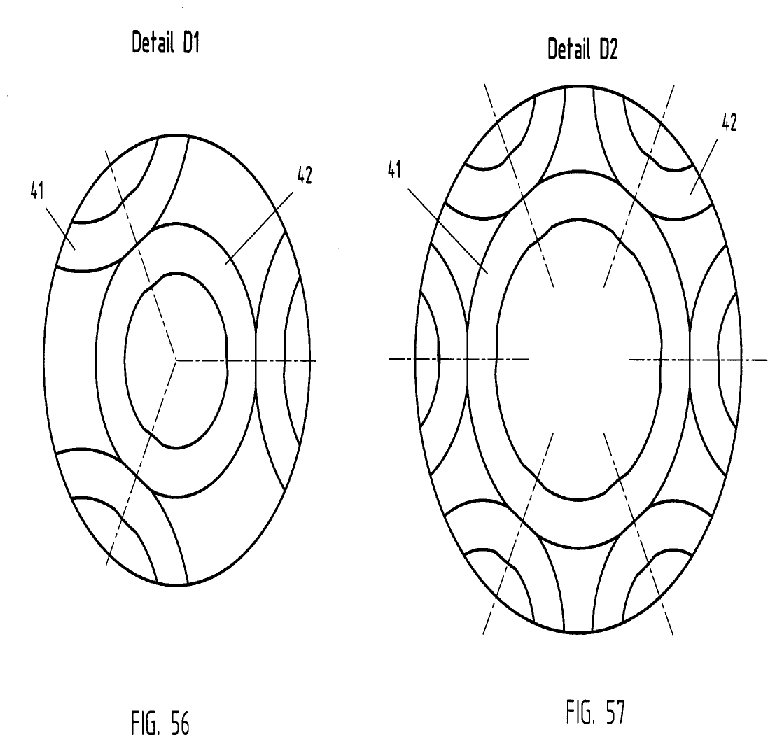

In the cross section A1-A1 of FIG. 46 is illustrated one of these big attaching plastic tubular cylinders 41 disposed on one wall of the battery box and in the cross section A2-A2 of FIG. 47 are illustrated two small attaching plastic tubular cylinders 42 of different diameter (smaller) disposed on the opposite wall of the battery box. FIG. 48 shows the maximum number of these tubular cylinders 41 and 42 in the assembled position, illustrating how they are positioned one in relation to another. As can be seen in FIG. 48, there are two different kind of number of contacts between the big attaching plastic tubular cylinders 41 and the small attaching plastic tubular cylinders 42 (three and six). In FIG. 49 can be seen a small attaching plastic tubular cylinders 42 being in contact with three big attaching plastic tubular cylinders 41. The FIG. 50 shows a big attaching plastic tubular cylinders 41 in contact with six small attaching plastic tubular cylinders 42. The FIG. 51 illustrates another combination of the tubular cylinders 41 and 42, where some small tubular cylinders 42 were removed, creating a double, triple and quadrupole contact, see FIG. 52, FIG. 53 & FIG. 54. The FIG. 55 is a double contact cross section (section A3-A3), showing the assembly of two modules—Module # 1 and Module #2. As can be seen, Module #2 is provided with a rib 43 all around the battery box placed on the same face with the small attaching plastic tubular cylinders 42, having the height equal with the height of the small attaching plastic tubular cylinders 42, stiffening the attachment assembly by providing a full contact between the two modules on entire perimeter.

As is seen in FIG. 55, the height of the big attaching plastic tubular cylinders 41 is a little smaller than the height of small attaching plastic tubular cylinders 42, creating a Gap between the top of the tubular cylinders 41 of Module #1 and the opposite surface of Module #2, on which the tubular cylinders 42 are encased. In this way an interference and a miss placement of the two modules is avoided. In FIG. 49, FIG. 50, FIG. 52, FIG. 53 & FIG. 54 are represented the big attaching plastic tubular cylinders 41 in contact with the small attaching plastic tubular cylinders 42. In the contact zone, the press-fit assembly creates a normal force Fn on the big/small attaching plastic tubular cylinders 41 and 42 generating a mutual elastic deformation in the contact area, which is not a point-like area anymore (see Detail D1 of FIG. 49 in FIG. 56 and Detail D2 of FIG. 50 in FIG. 57).

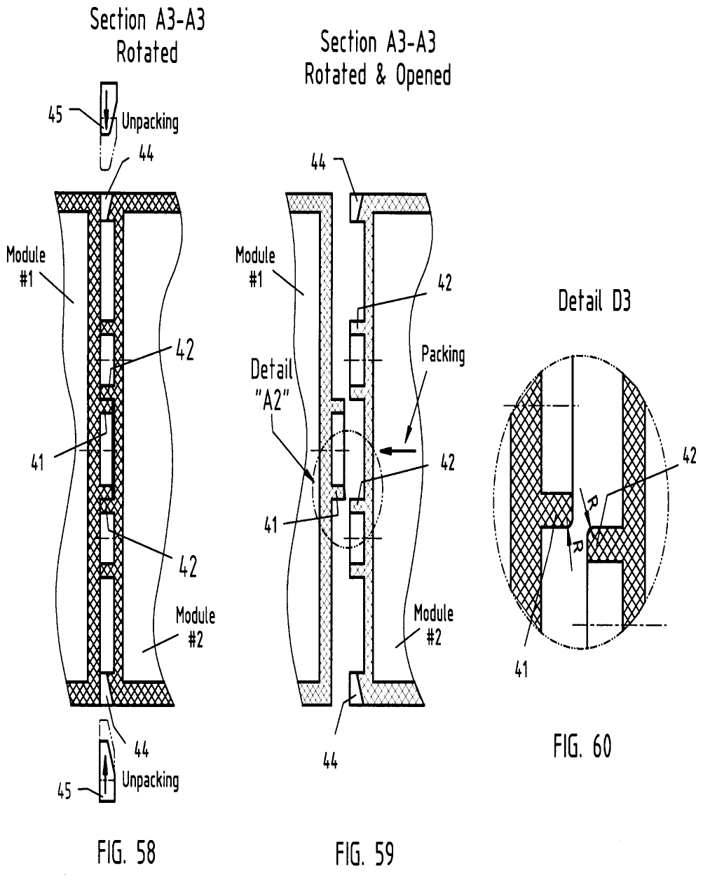

In FIG. 59 can be seen the two modules one a side of another before assembly, and in FIG. 58 can be seen the two modules after assembly. In order to facilitate assembly, each tubular cylinder is round ended, as is shown in Detail D3 in FIG. 60.

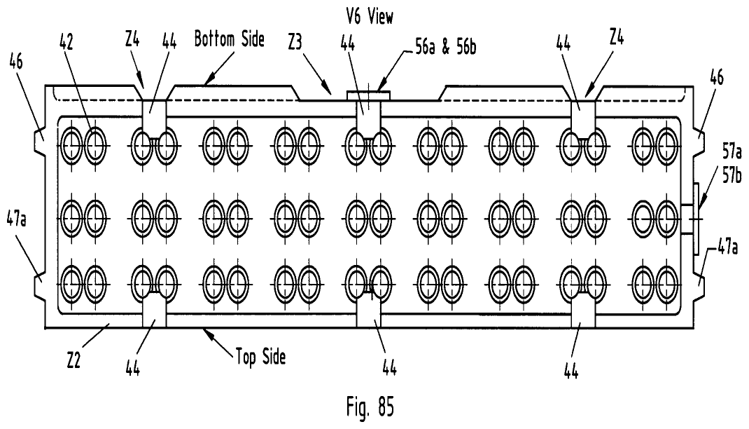

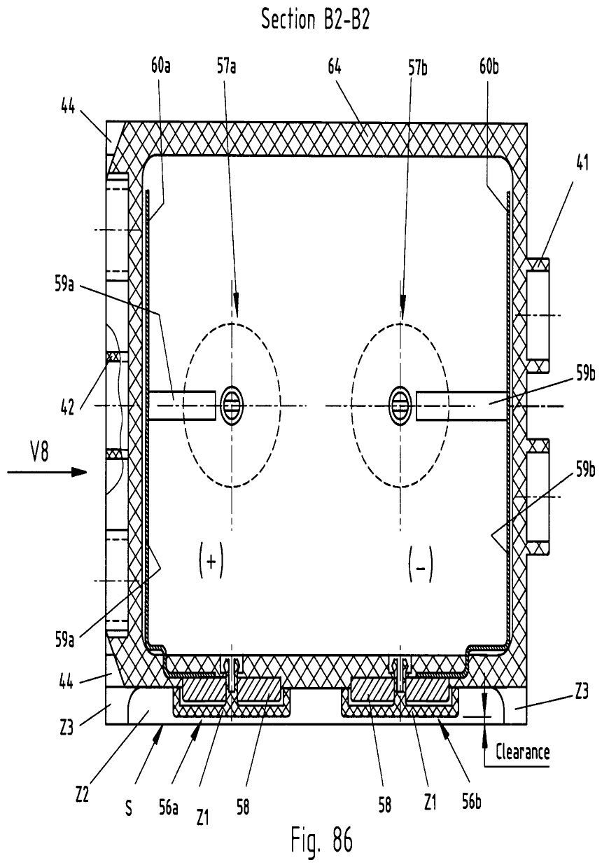

In order to unpack one module from the battery package, in the shoulder 43 may be create a plurality of unpacking taper slots 44, seen in FIG. 58, FIG. 59, FIG. 84, FIG. 85 and in Detail D4 & D5 of FIG. 88. By pushing IN a taper punch 45 seen in FIG. 58, which creates an axial component to the tubular cylinders, the two modules will be taken apart. For better control, is recommended to have pairs of taper slots 44 in opposite position of the modules (top and bottom), as shown in FIG. 57, FIG. 59, FIG. 84, FIG. 85 and FIG. 86.

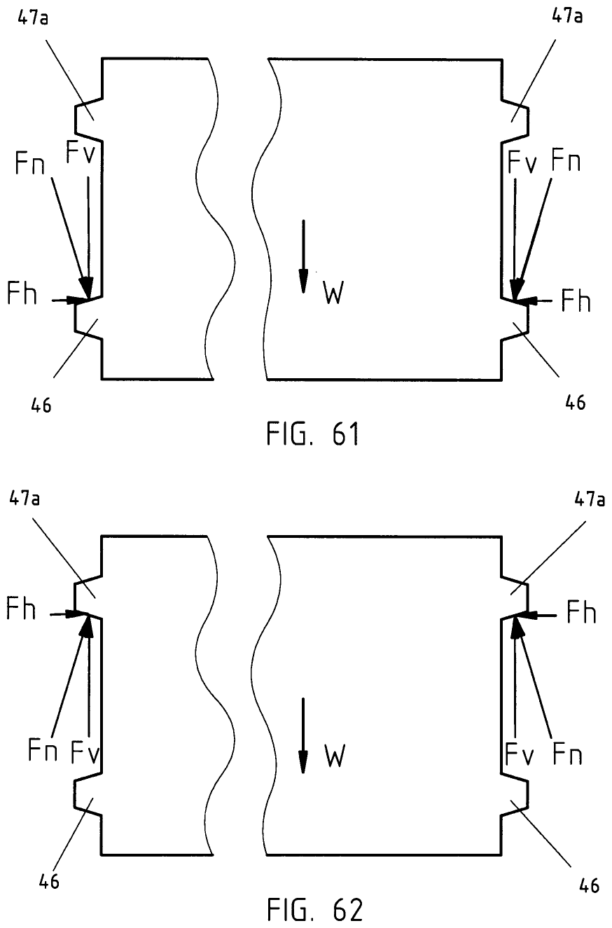

The means to clamp the package into the drawer may be designed as in FIG. 61, where a taper shoulder 46 is used. A clamping element creates a normal force Fn on the taper shoulder 46 which generates a component Fv normal to the battery module base (added to the battery weight), which secures the battery on the drawer, and another component Fh aiming the battery box. In this way, the battery is attached to the drawer and doesn't move during the travel. Similar shoulders 47 may be used as illustrated in FIG. 62 in order to support the battery package during installation, using an adapted manipulation device.

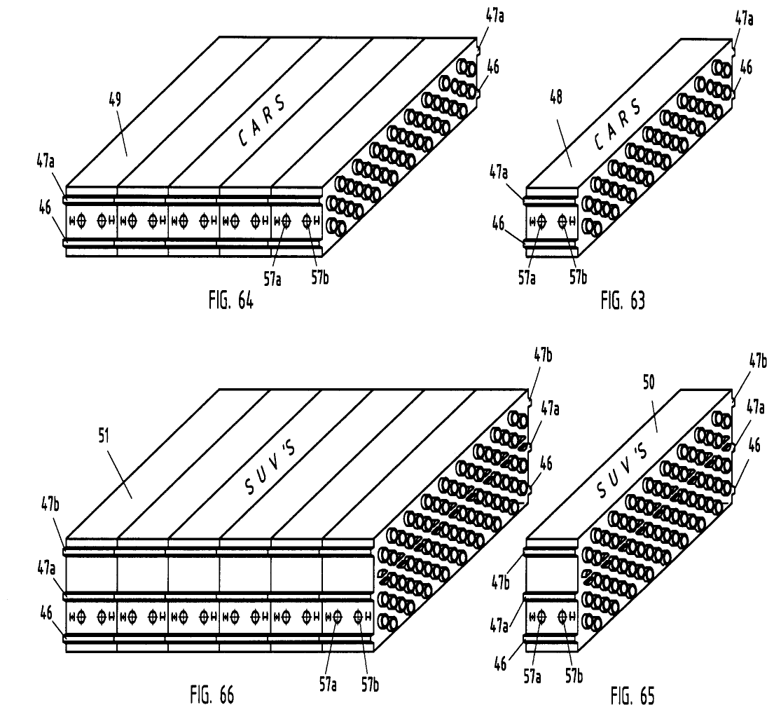

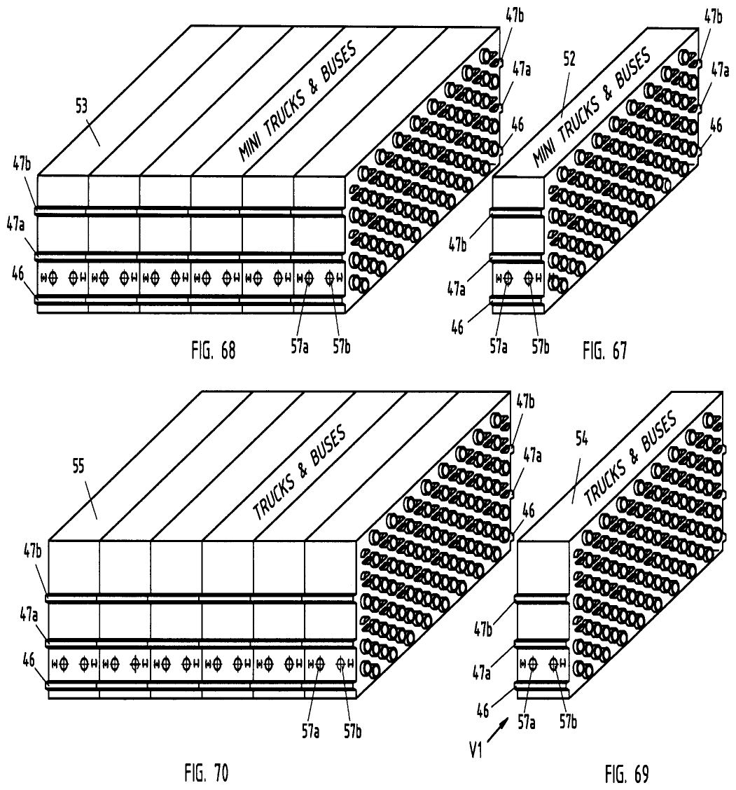

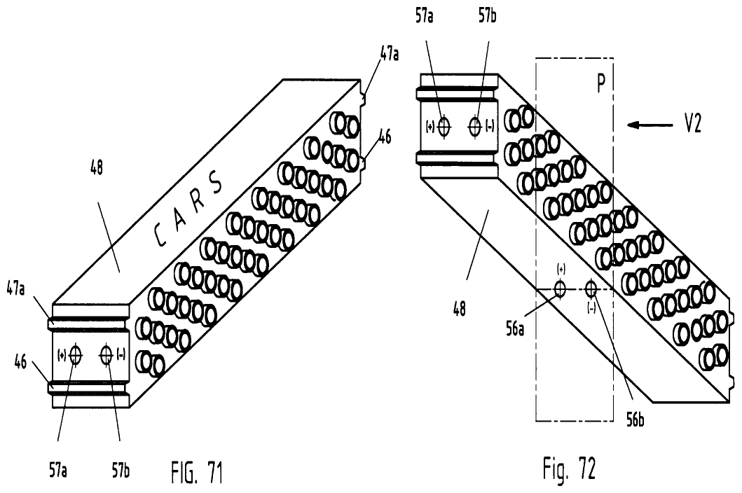

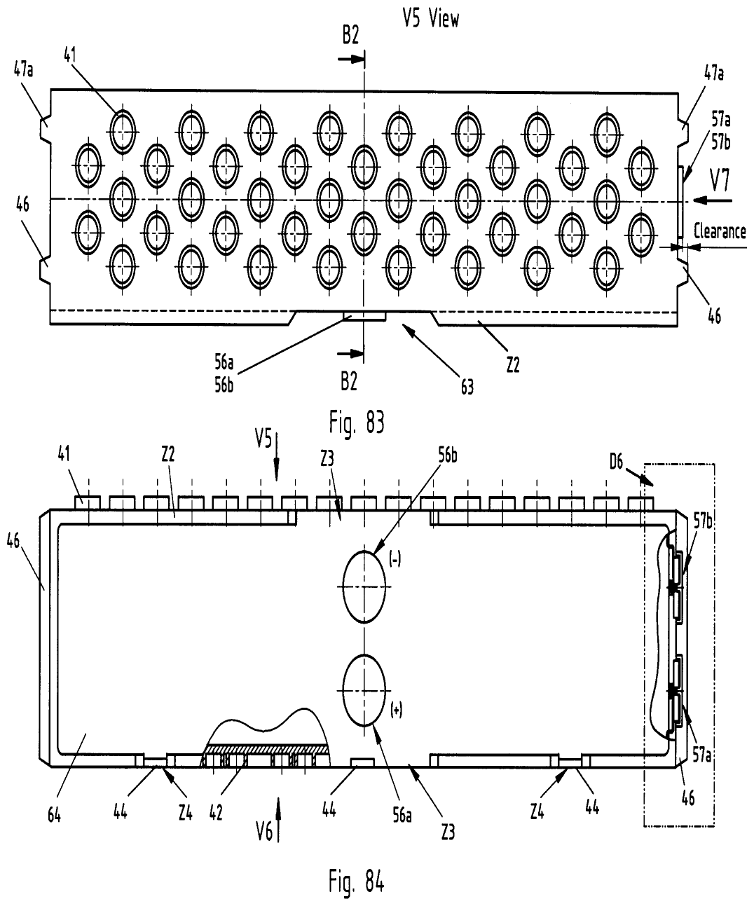

Embodiments including all these features of the battery modules are illustrated in FIG. 63 to FIG. 72, in FIG. 74 & FIG. 75, in FIG. 79 to FIG. 81 and in FIG. 83 to FIG. 85. Based on the actual categories and classes of vehicles, are presented four battery modules: module 48 for cars, see FIG. 63, module 50 for SUV see FIG. 65, module 52 for mini trucks & mini buses see FIG. 67, module 54 for trucks & buses see FIG. 69. Using the same kind of modules, may be built battery packages like package 49 in FIG. 64 for cars, like package 51 in FIG. 66 for SUV, like package 53 in FIG. 68 for mini trucks & mini buses, like package 55 in FIG. 70 for trucks & buses.

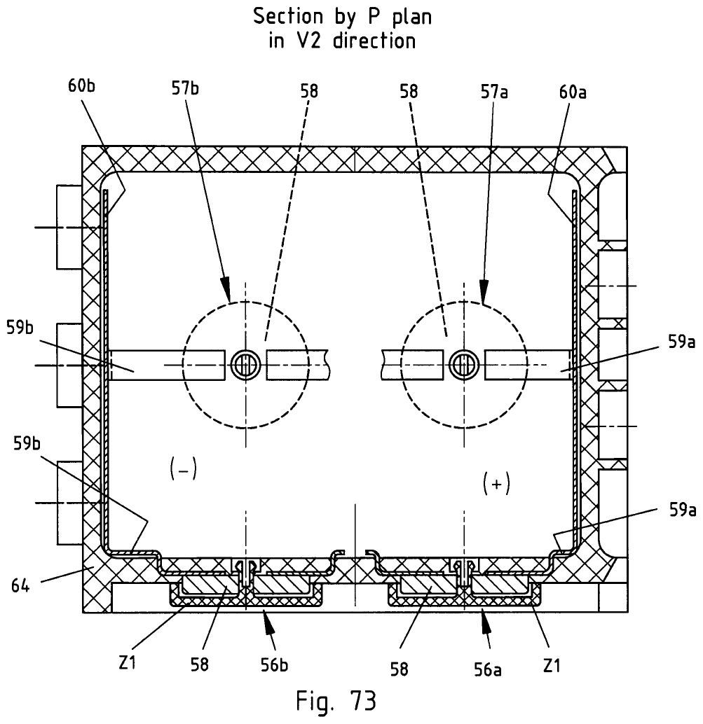

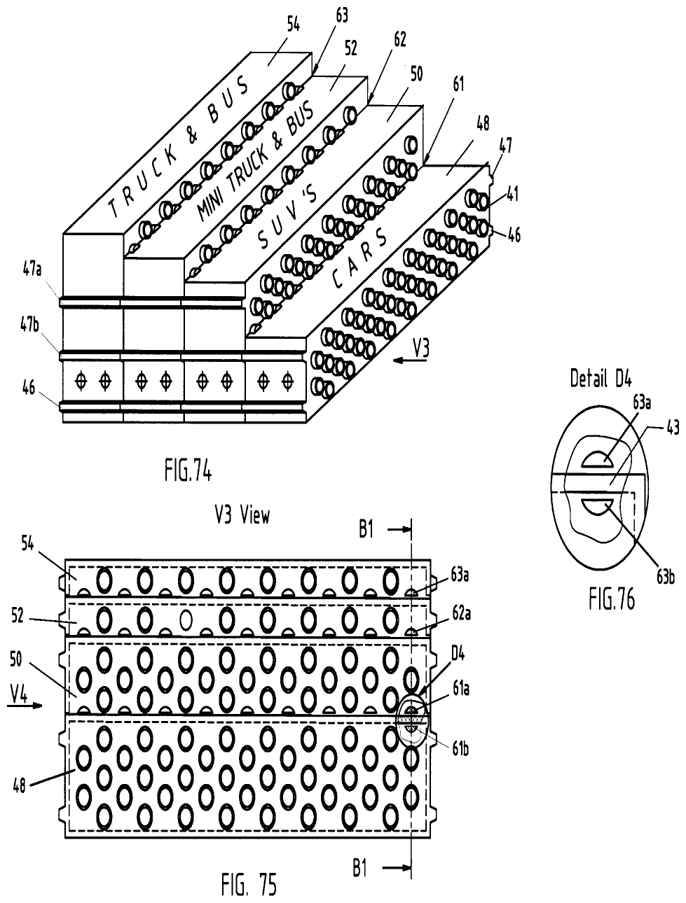

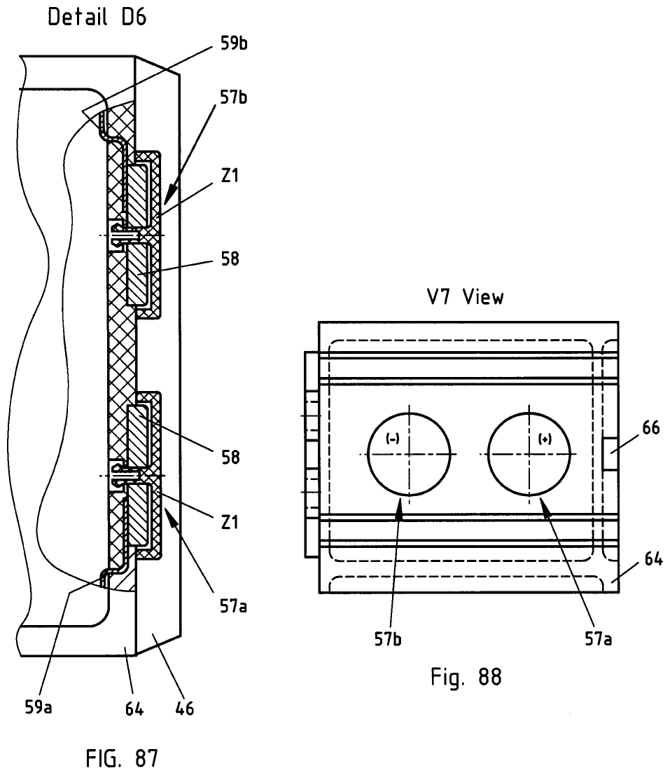

Each battery module is designed with two pair of (+) and (−) terminals positioned: one pair on the button of the battery box 56a (+) and 56b (−), see FIG. 72 and another pair on one side of the box 57a (+) and 57b (−), see FIG. 71 and FIG. 72, all incorporated into the battery box 64. In this way, the battery may be charged from button or from one side of the battery package. The electrical battery terminal is realized by a cooper element 58, see FIG. 73, FIG. 86 and FIG. 87.

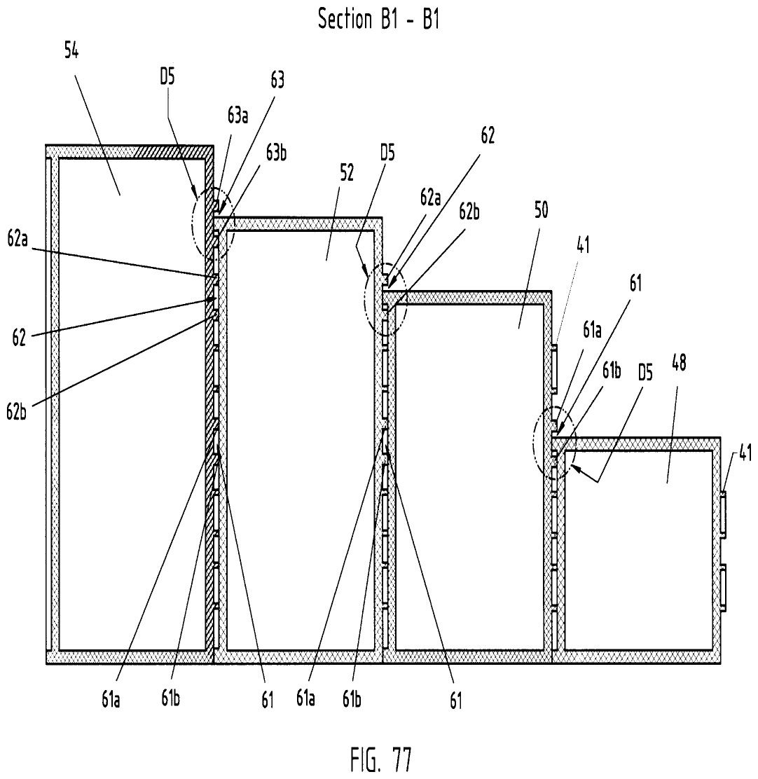

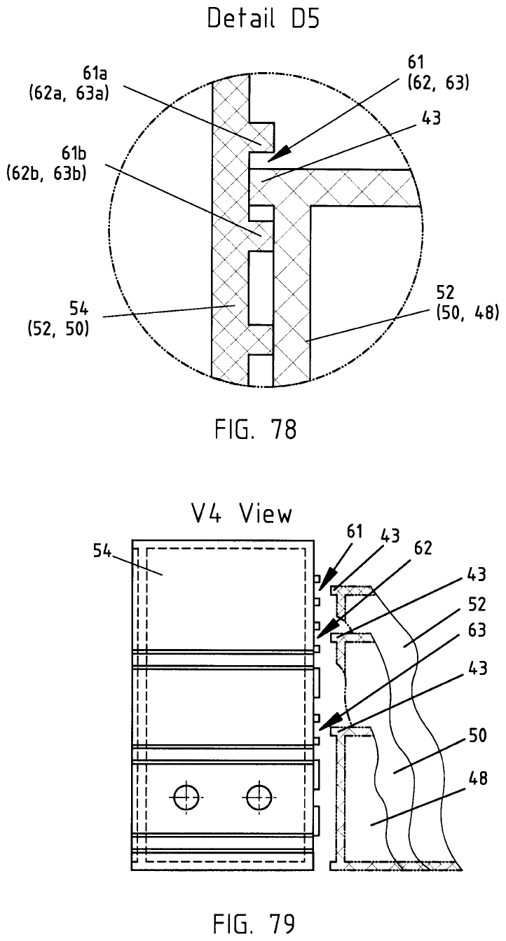

Each electrical battery terminal has a flat outside portion, which is free to be touched. Each cooper element 58 is connected by a connection element 59 to each other and by connection element 60 to the means capable to accumulate electricity inside of the battery box. The design of each of these modules allows to combine any of these four kinds of battery modules as shown in FIG. 74 (isometric view), FIG. 75 (front view) and FIG.77 (cross section B1-B1). To be able to do these combinations, each of the higher modules (for SUV, mini trucks & mini buses and trucks & buses) has to have a row of slots on the big attaching plastic tubular cylinders 41 at different levels 61, 62, & 63 to allow the shoulder 43 of a smaller module to enter into it, see FIG. 74 to FIG. 79. These rows of slots divide the tubular cylinders 41 into two pieces a & b see Detail D4 of FIG. 75 in FIG. 76 and Detail D5 of FIG. 77 in FIG. 78. In order to enforce their rigidity, these two pieces a & b may be full material showing like two semi moons, see Detail D4 of FIG. 75 in FIG. 76. As shown in FIG. 77, the row of slots 61 (61a & 61b) accommodates cars battery modules, the row of slots 62 (62a & 62b) accommodates SUV battery modules, the row of slots 63 (63a & 63b) accommodates mini trucks and mini buses battery modules.

Depending of the height of each kind of battery module, see FIG. 77 and FIG. 79, there are:
one row of slots 61 for SUV battery module 50;
two rows of slots 61 & 62 for Mini trucks and mini buses battery modules 52;
three rows of slots 61, 62 & 63 for trucks and buses battery modules 54.

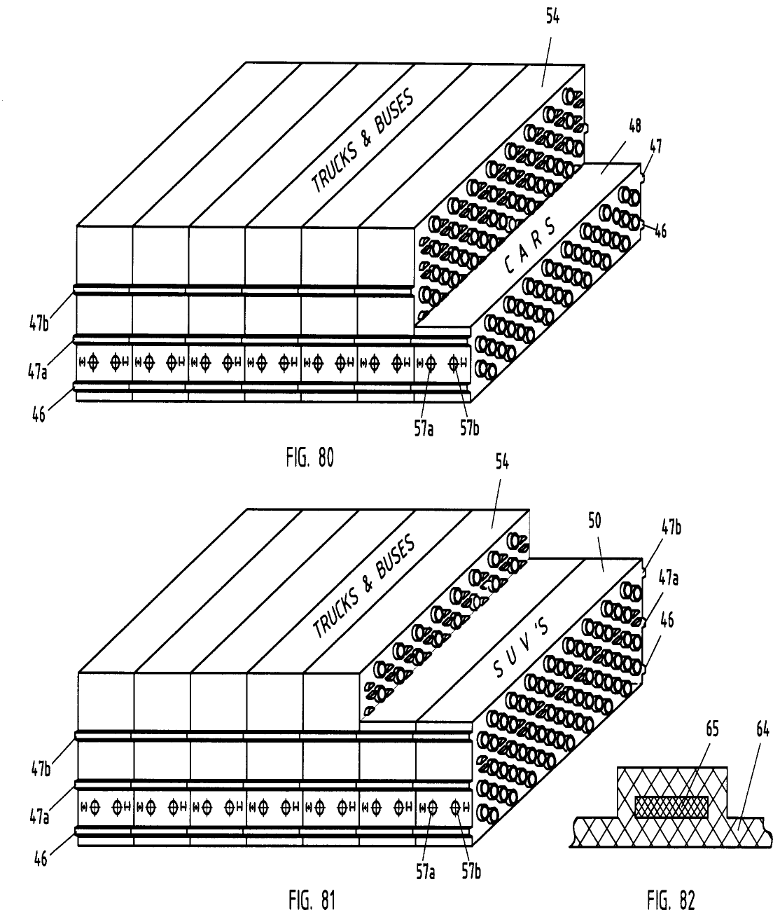

The FIG. 74 is an isometric front-top view of a package of the all four typical modules showing the locking shoulders 46, the manipulation shoulders 47, and the attachment elements—big attaching plastic tubular cylinders 41. In order to be able to do all the possible combinations, the locking shoulders have to be at the same height for all four kind of battery module, as in FIG. 74. The three higher modules (except car modules), they may have a manipulation shoulder closer to the top—47a—for easier access when the package uses identical modules, see FIG. 64, FIG. 66, FIG. 68 and FIG. 70, and another one 47b at the same level like for the car modules 47a—in case the package uses a combination of battery modules, see FIG. 74, FIG. 75, FIG. 79, FIG. 80 and FIG. 81.

In order to transmit information and to communicate with the electric vehicle, with the loading utility and with the intelligent management change battery system, each battery module has to have a communication chip 65 incorporated into the battery box 64, as shown in FIG. 82, containing information related to each module like: part number, producer, date of fabrication, and other useful information which will be pertinent at a certain time in the future. The battery box 64 of a quick-change battery module, as shown here before, may have a prismatic shape with different dimensions related to the category and the class of the electric vehicle incorporating all the components of a battery module presented here before.

An embodiment of a car battery module comprising all these features presented herein is illustrated in FIG. 83 to FIG. 88, as following:

The FIG. 84 is the bottom view of the battery module showing the base, in a rectangular shape, of the battery box 64, the bottom terminal 56a & 56b, a view of the big attaching plastic tubular cylinders 41, and the small attaching plastic tubular cylinders 42 in a break section. In another break section—Detail D6, can be seen the side terminals 57a & 57b. Are also shown the three unpacking taper slots 44 for the bottom side and a bottom view of the locking shoulders 46. The FIG. 83 is a side view V5 of the battery module, showing the big attaching plastic tubular cylinders 41, the bottom terminals 56a & 56b and the side terminals 57a & 57b, the locking shoulders 46 and the manipulating shoulders 47a. The FIG. 85 is a side view V6 of the battery module, showing the small attaching plastic tubular cylinders 42, the locking shoulders 46, the manipulating shoulders 47a, and the 3+3 unpacking taper slots 44 for the top and for the bottom side.

In FIG. 86 are illustrated, in a cross section, the two bottom terminals 56a & 56b, comprising a cooper element 58, a connector 59a & 59b and a contact protection cover Z1. The connector 59a connects the positive bottom terminal 56a with the positive side terminal 57a, and the connector 59b connects the negative bottom terminal 56b with the negative side terminal 57b. The connectors 59a & 59b are connected to the means for accumulating electricity by the connectors 60a & 60b. In FIG. 87, which is the Detail D6 of FIG. 84 are illustrated the side terminals 59a & 59b, showing the cooper element 58 and their terminals protection cover Z1.

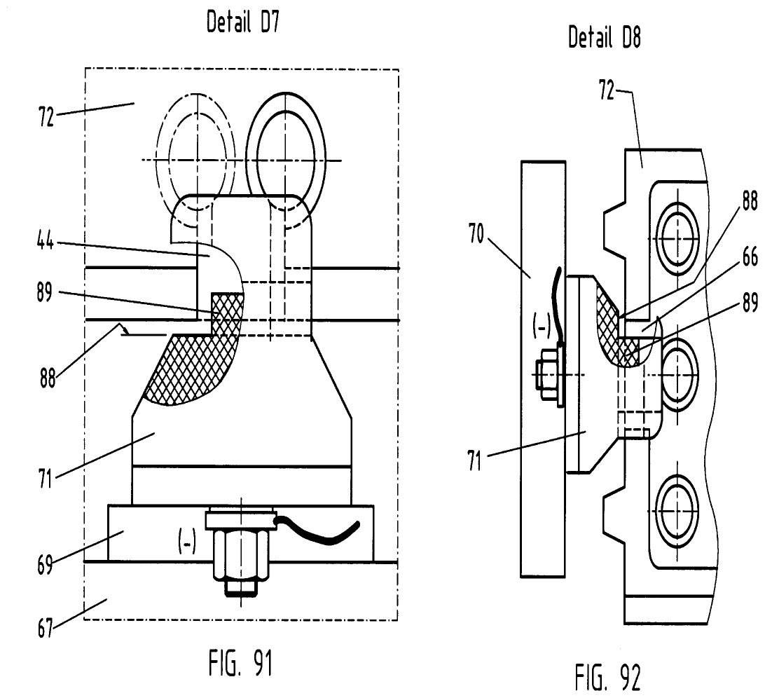

For the battery bottom terminals protection when the battery lies on the bottom surface S, see FIG. 86, the battery box has a rib frame Z2 on the entire bottom perimeter having the height greater than the height of terminals (including the terminals protection cover Z1), ensuring a clearance between the terminals protection cover Z1 and the surface S. As seen in FIG. 83 to FIG. 85 this rib Z2 is interrupted on both sides by a window Z3 near the bottom terminals 56a & 56b in order to allow easy access for the terminals cleaning, and by two other windows Z4 near the unpacking taper slots 44 on the bottom side of the battery box. The side terminals are protected by the locking and the manipulating shoulder 46 & 47a, which are greater than the terminals protection cover Z1, ensuring a clearance as shown in FIG. 83. In order to protect the battery against wrong installation a mistake-prove element is incorporated into the battery box 64. For side installation this mistake-prove is a log 66 made on the battery box 64 on the terminals side, see FIG. 88 & FIG. 92. For the bottom installation the mistake-prove element is the central-bottom unpacking taper slot 44, see FIG. 91.

This kind of quick-change battery package may be installed on the electric vehicle using a contact plate, which is capable to connect to all battery modules and to create the right connections between all of them. A such of contact plate comprises:
a plurality of contacts capable to transfer the electricity from the battery package to the electric vehicle;
a plurality of elastic elements, which push the contacts against the cooper elements 58 of the battery package terminals and maintain the contact all the time the battery is on the electric vehicle;
main terminals (+) & (−), which connect the battery package to the electric system of the electric vehicle;
connectors capable to connect the modules together and to the main terminals (+) & (−) of the contact plate;
a contact plate box;
means to attache the contact plate box to the electric vehicle;
connectors capable to connect the contact plate to the electric system of the electric vehicle.

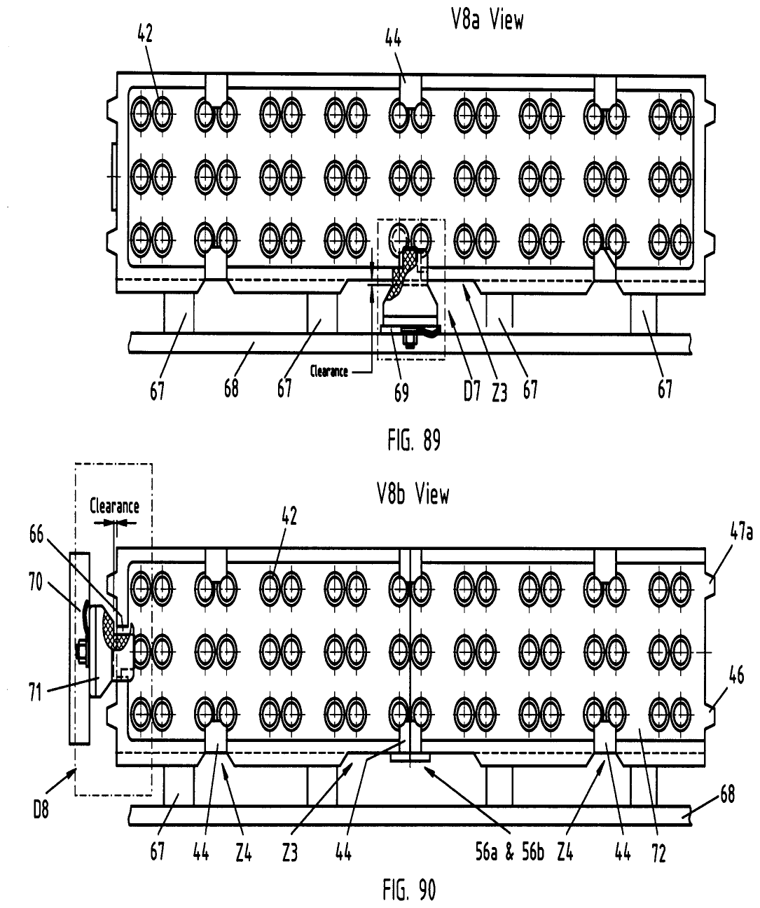

Depending on the space available for each particular electric vehicle, the same contact plate 71 may be positioned in two ways with respect to the battery package 72: on the bottom of the battery package, for the bottom contacts see FIG. 89, or on one side of the battery package, for the side contacts, see FIG. 90. Depending on the number of modules installed on each package, for each electric vehicle the contact plate has to be adapted to the appropriate number of modules.

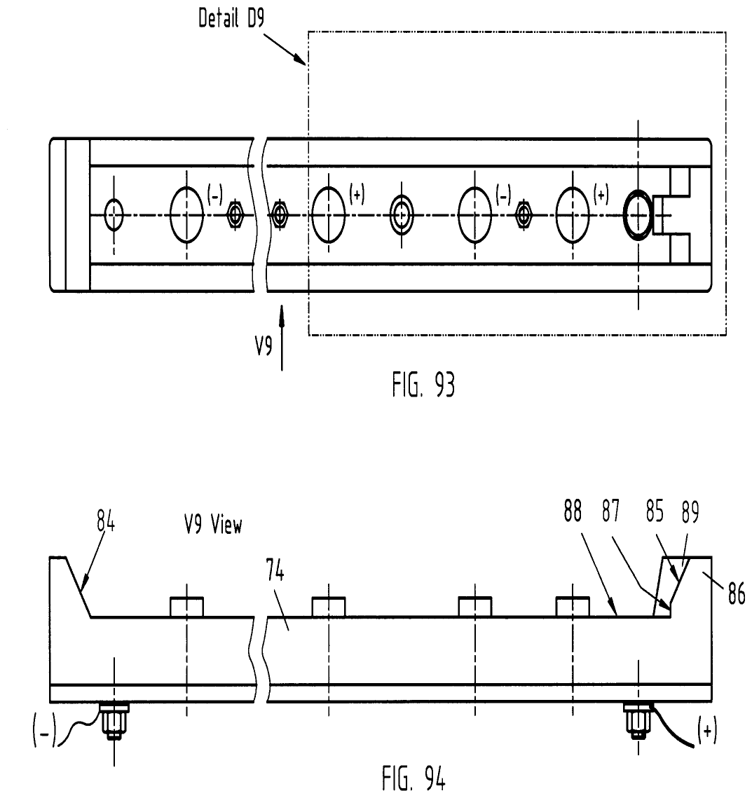

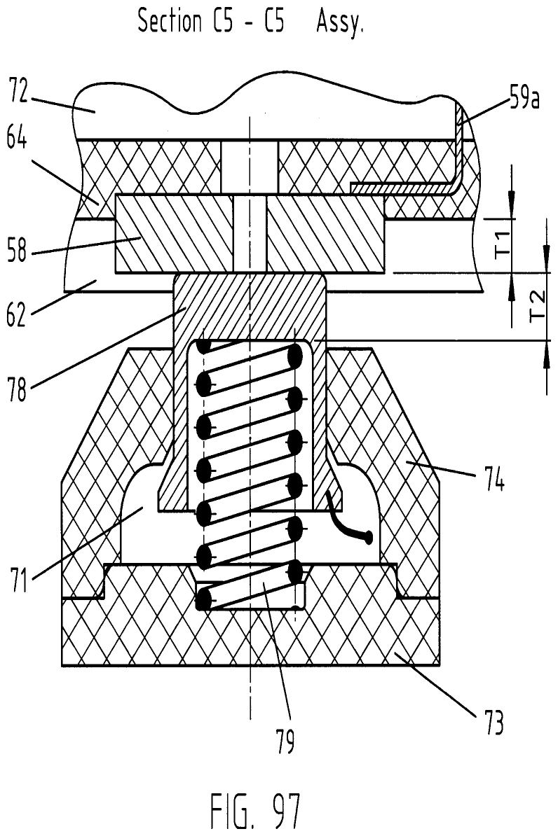

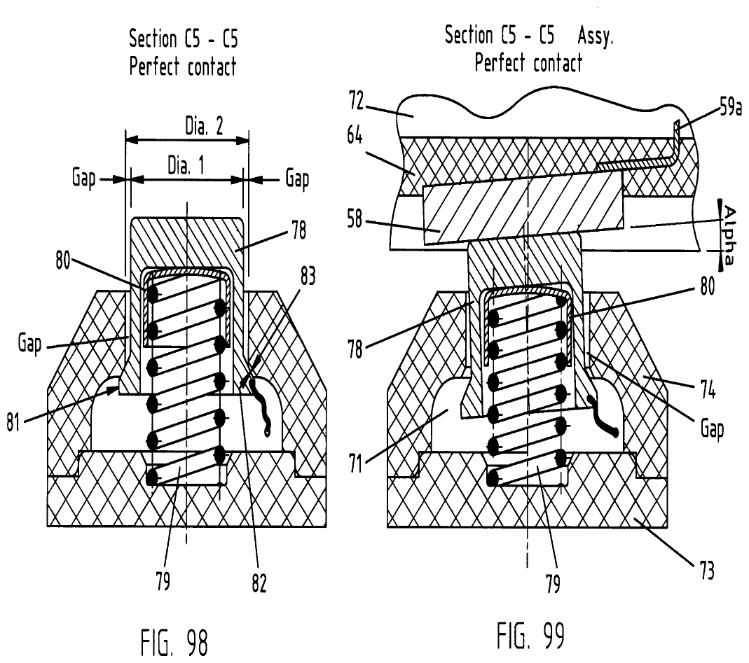

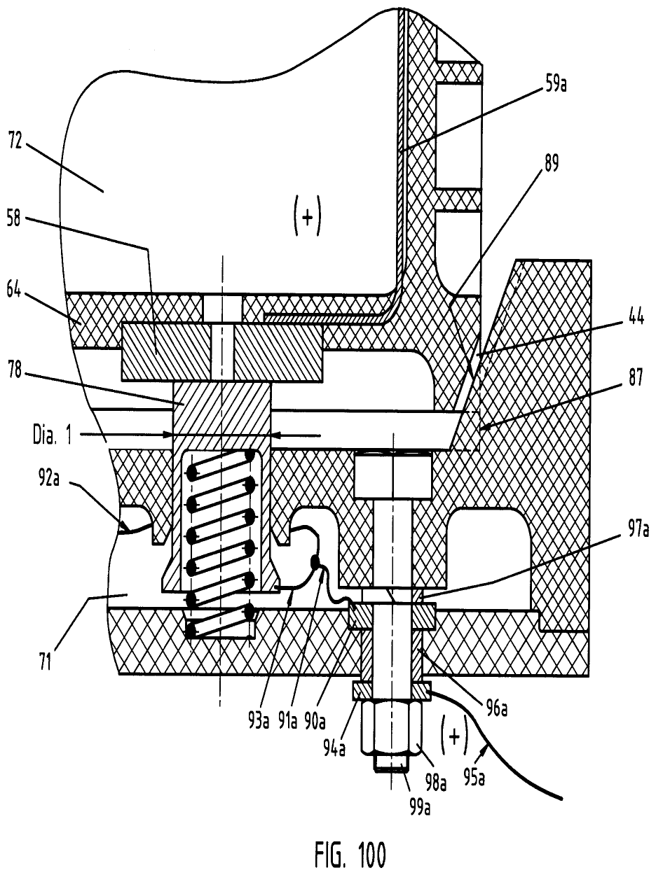

An embodiment of a generic contact plate is illustrated in FIG. 89 to FIG. 101. As seen in FIG. 96, the contact plate 71 comprises a contact plate box having a base 73 and a cover 74. These two components are kept together by a plurality of bolts 75 and nuts 76. The nuts 76 are encapsulated into the battery contact plate cover 74 and they don't exceed the top level of it. The entire contact plate box is attached to the electric vehicle by a plurality of bolts 77. For each battery module is necessary to have plurality of pairs of (+) & (−) contacts, which fit with each module. For example, for five modules are requested five pair of contacts. In FIG. 97 are illustrated in a partial cross section an assembly of a contact plate 71 with a battery package 72. The electrical contact between the battery 72 and the contact plate 71 is realized by the battery cooper element 58 which is in contact with the cooper cup 78 of the contact plate. In order to ensure a permanent contact between the battery and the contact plate, and to cover all the dimension variation of the manufacturing and maintenance process, the cooper cup 78 of the contact plate is pushed against the cooper element 58 of the battery module by the elastic elements 79. In order to ensure a good contact between the battery modules and each cooper cup 78 of the contact plate, even in case when the cooper element 58 is not very parallel with the bottom surface of the battery module box, a special design is presented in FIG. 98 & FIG. 99. In this case, between the elastic element 79 and the cooper cup 78 is interposed a bulging element 80, having the convex shape in contact with the inside portion of the cooper cup 78, pushing into a point-like area the cooper cup 78 against the cooper element 58, and giving the possibility to the cooper cup 78 to lie down on the cooper element 58 on entire surface. In order to maintain the cooper cup 78 attached to the contact plate when the battery is taken out (free outside pressure), this contact cup is designed having a shoulder 81 grater than the hole of the contact plate cover, see FIG. 96 & FIG. 98. For a better positioning of the cooper cup 78 on the cover 74 the shoulder 81 has a conical surface 82 for seating on a conical surface 83 of the contact plate cover 74. When a bulging element 80 is used, see FIG. 98 & FIG. 99, the outside diameter of the contact cup Dia.1 and the inside diameter Dia.2 of the hole in the contact plate cover 74 has to be designed in a way that the Gap between the diameters (IN & OUT) of these two components is big enough allowing to the cooper cup 78 to take different angular positions when it is in contact with the cooper element 58 on full surface. When the battery package 72 is installed on the contact plate 71, the cooper cup 78 is pushed axially creating a Gap between the two conical surfaces 82 & 83 of the two components 78 and 74, see FIG. 97, FIG. 99 and FIG. 100. The cooper element 58 incorporated into the battery box 64, as new part, has to have the thickness in a way that it exceeds by a significant thickness T1 the battery box, see FIG. 97. This extra material may be removed in time during the contacts cleaning operation by abrasion. In the same scope, the cooper cup 78 is thick—thickness T2, see FIG. 97 to FIG. 101.

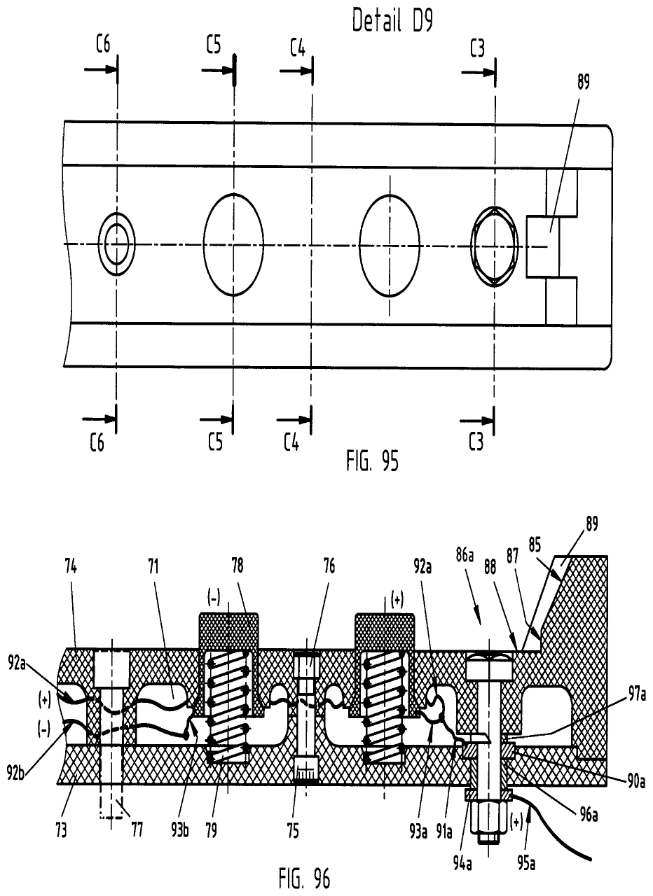

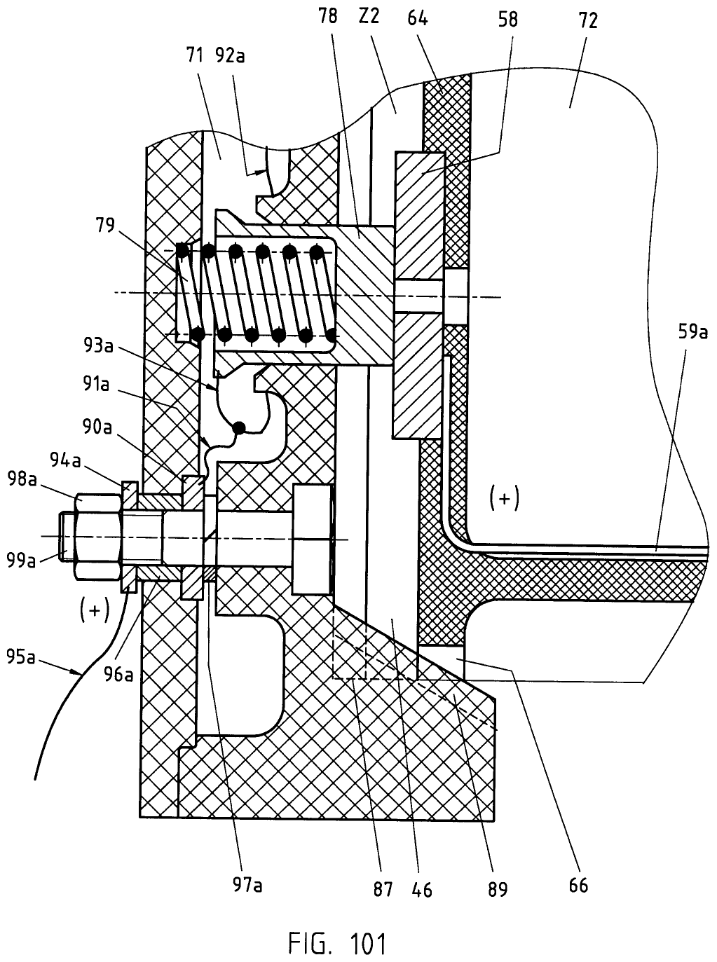

In order to facilitate the battery package centring on the contact plate during installation, the contact plate cover 74 has taper shaped ends 84 and 85, see FIG. 94. As shown in FIG. 96, on the side close to the positive main terminal 86a, the taper shaped end 85 has a stopper 87, normal to the top surface 88 of the contact plate cover 74, seen in FIG. 100 & FIG. 101 as well. This stopper 87 ensures a good repeatability of the battery installation, for both cases: bottom and side installation see FIG. 100 & FIG. 101. The contact plate may be designed mistake-prove, avoiding a miss installation of the battery on the contact plate and reversing the polarity. In this scope the contact plate cover 74 has on the end close to the positive main terminal 86a, a log 89, see FIG. 94, FIG. 95 & FIG. 96, which enters into a slot 66 of the battery box 64. For the side installation this slot 66 is on the rib Z3 on line with the side terminals 57a & 57b, see FIG. 90, FIG. 92 & FIG. 101. For a bottom installation the unpacking taper slot 44 of the battery box 64 may be used as a mistake-prove slot, see FIG. 89, FIG. 91 & FIG. 100.

In this way, the same mistake-prove log 89 of the contact plate 71 works for both cases: bottom and side installation.

In FIG. 96 to FIG. 101 is illustrated the main contact plate terminals design, comprising: an inner cooper washer 90a & 90b connected by the cable 91a & 91b to the cable 92a & 92b, which connects all identical contacts, 92a for (+) to (+) & 92b for (−) to (−) inside of the contact plate box 71, for a series configuration. Each cooper cup 78 is connected to the cable 92a & 92b by a cable 93a & 93b, see FIG. 96. An outer cooper washer 94a & 94b is connected by the cable 95a & 95b to the electrical system of the electric vehicle. A cooper bushing connector 96a & 96b connects the two copper washers 90a to 93a and 90b to 93b. An elastic element, which may be a spring washer 97a & 97b, creates a permanent pressure on the cooper washers 90a & 90b and 94a & 94b, via the bushing 96a & 96b when the nut 98a & 98b is tighten on the bolt 99a & 99b.

In order to avoid the contact between the battery package 72 with the contact plate cover face 88, see FIG. 94 and FIG. 96, when the battery package is installed on the electric vehicle, for a bottom installation of the contact plate, a plurality of pads are used—bottom pads 67 supported by bottom pads supports 68 see FIG. 89 to FIG. 91. The contact plate 71 has to be installed on a contact plate support 69 for bottom installation and 70 for the side installation, see FIG. 89 to FIG. 92.

This design allows to use the same contact plate for both versions of the battery modules terminals: for the bottom terminals 56a & 56b and for the side terminals 57a & 57b. Each of these possibilities has advantages and disadvantages, as following: A side installation allows to minimize the height of the drawers because no space is required underneath of the battery package. The disadvantages are related to the installation of the contact plate on the vehicle body, close to the centre in a hidden area—not visibility and not control. This disadvantage may be overcome by installing the contact plate on the drawer for the side installation using a retractable contact plate support. A bottom installation places the battery package inside of the drawers, being visible during the installation when the drawers are out, offering better control. But it requires some extra space underneath of the battery package (the height of the contact plate), increasing the height of drawers.

Taking into consideration all these advantages and disadvantages for each possibility of contact plate installation, for each application one or another may be the ideal solution, depending on the space available. For example, for cars and even SUV the space underneath of vehicle is pretty limited, therefore the side installation is recommended. For trucks, buses and trailers, with more space on vertical direction, the bottom installation is recommended.

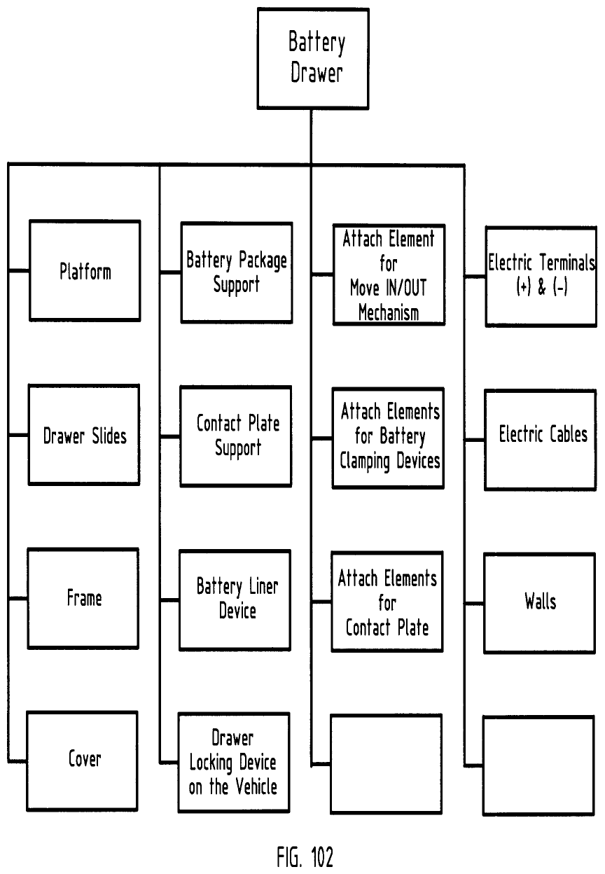

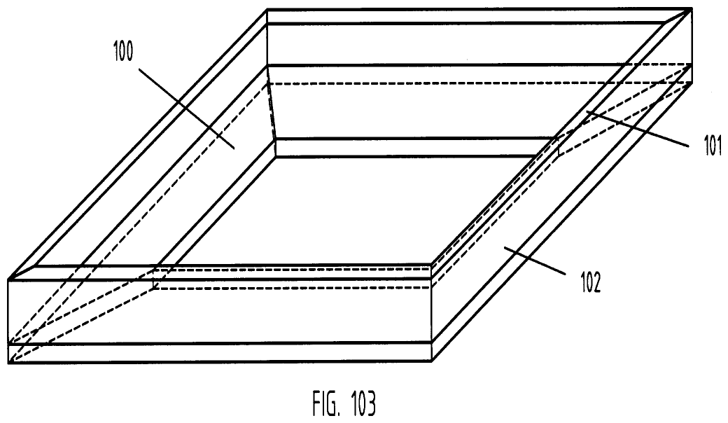

The structure of a typical battery drawer is presented in FIG. 102.

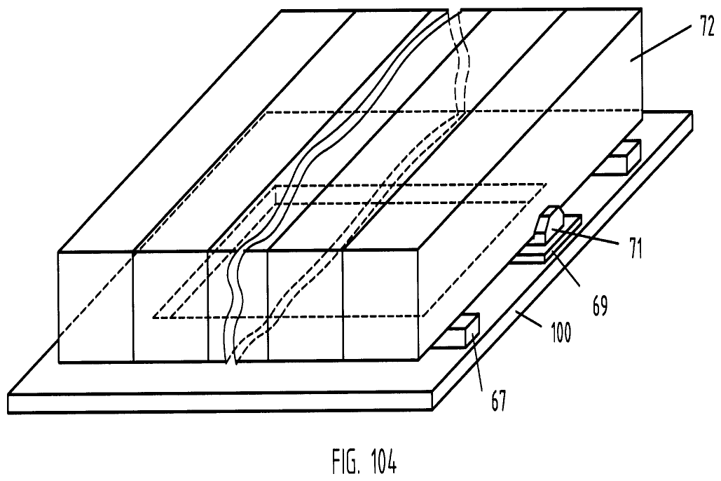

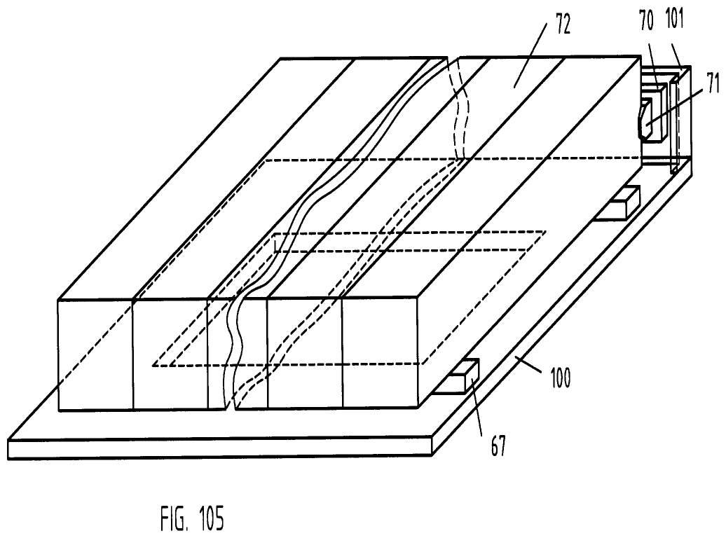

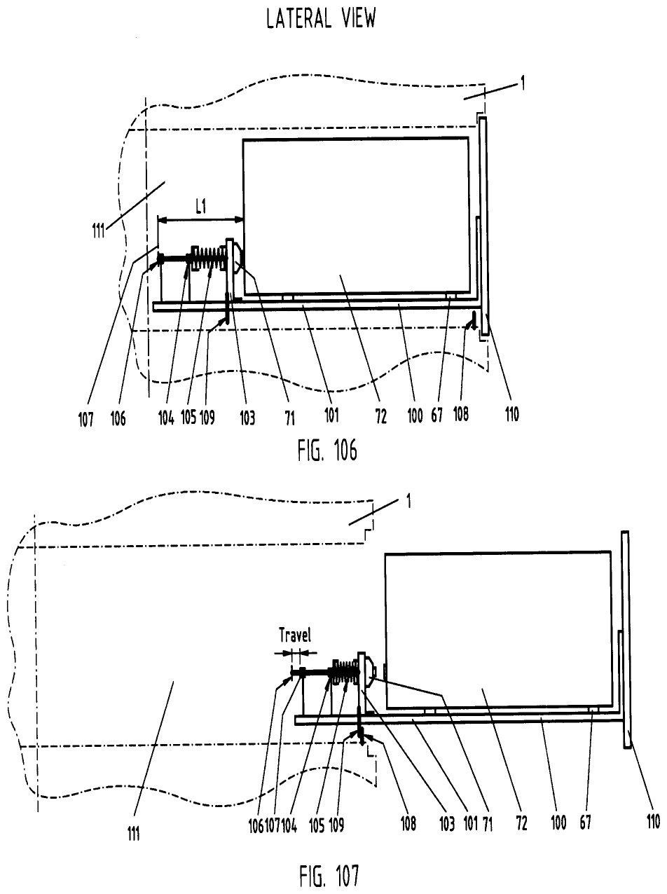

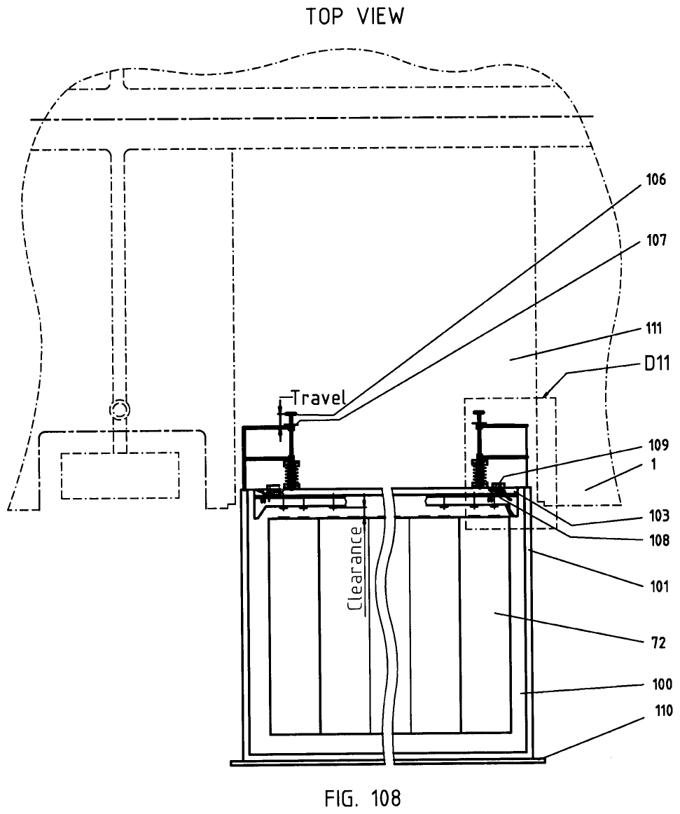

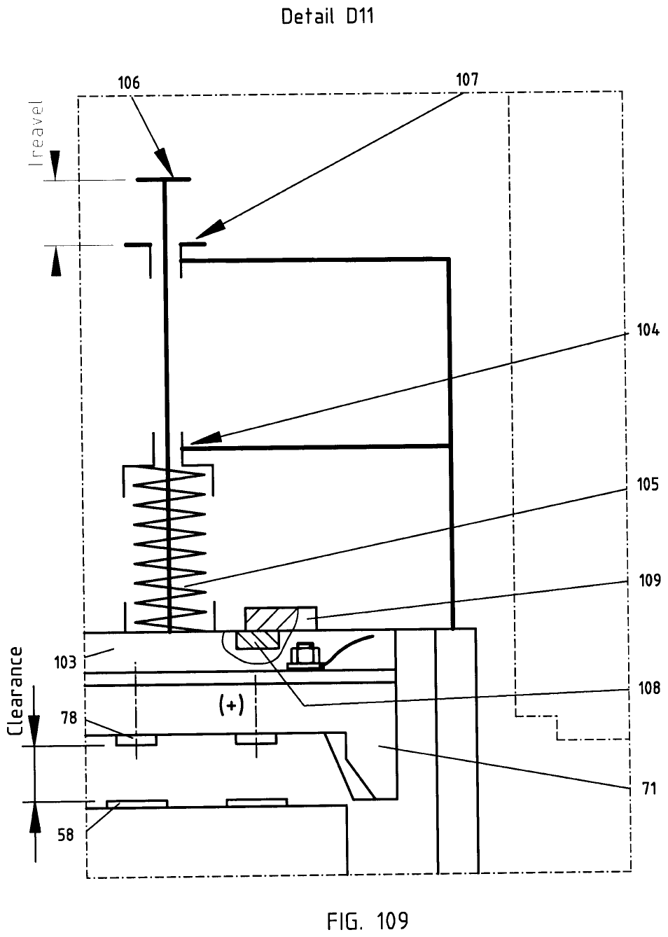

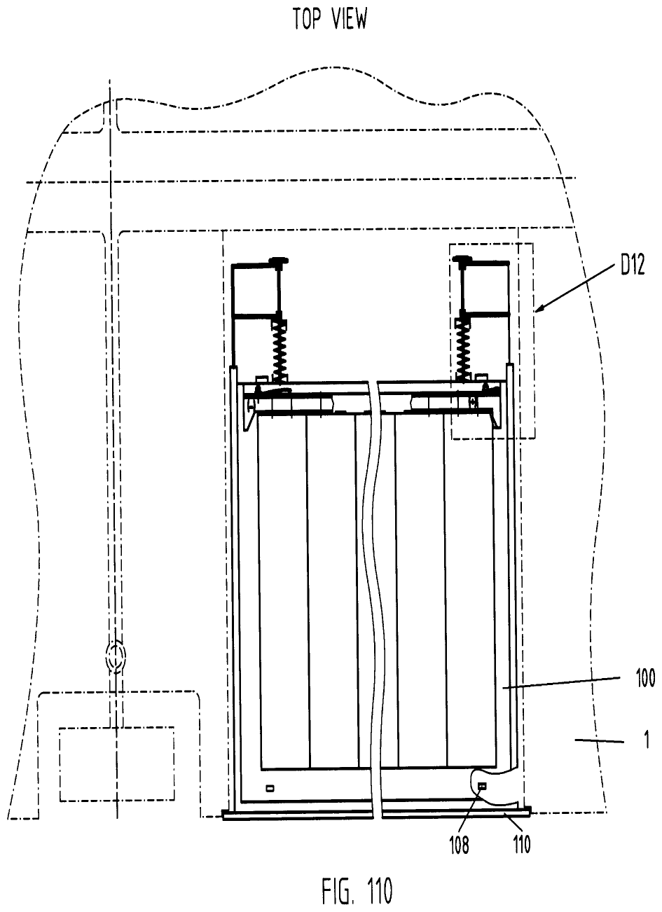

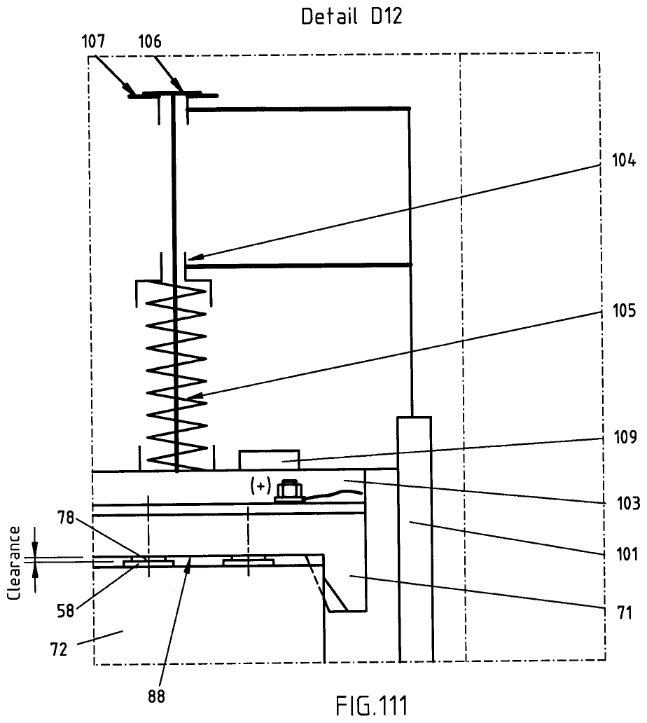

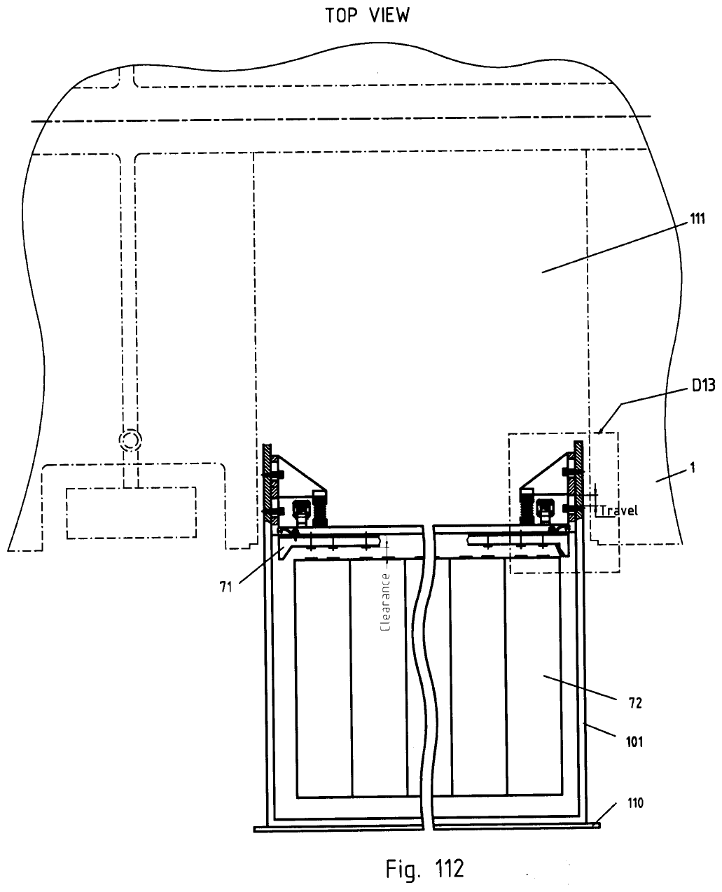

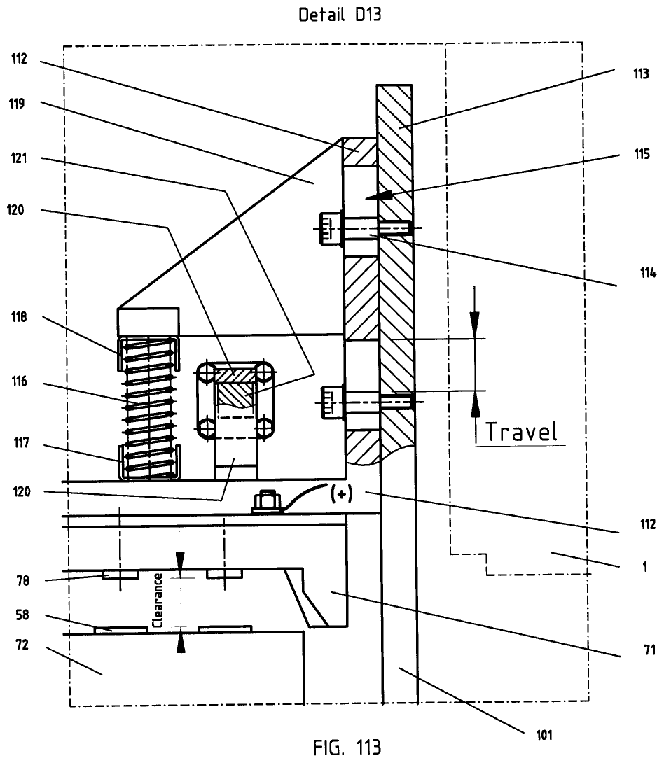

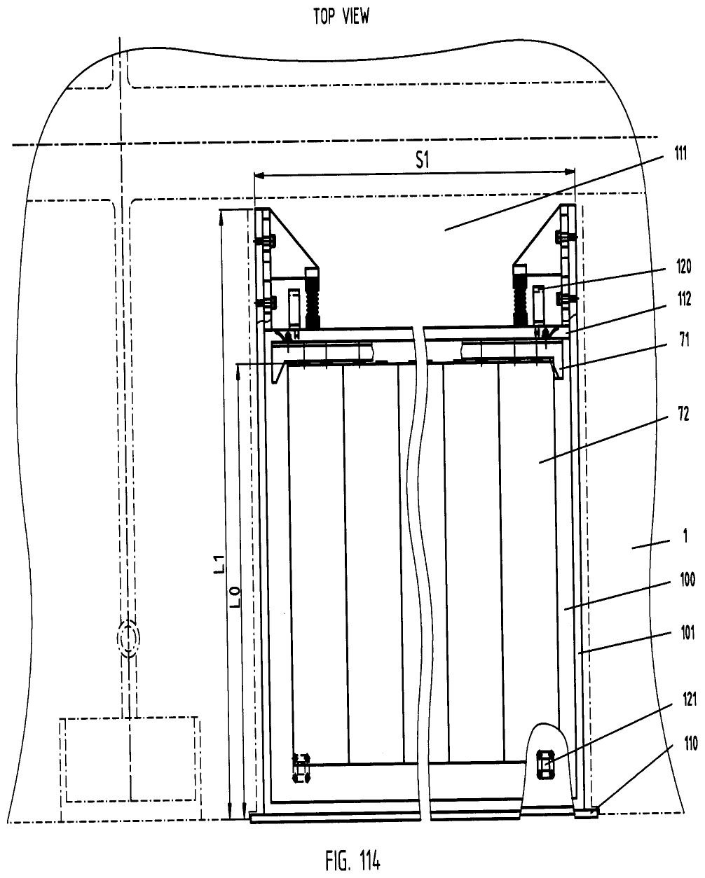

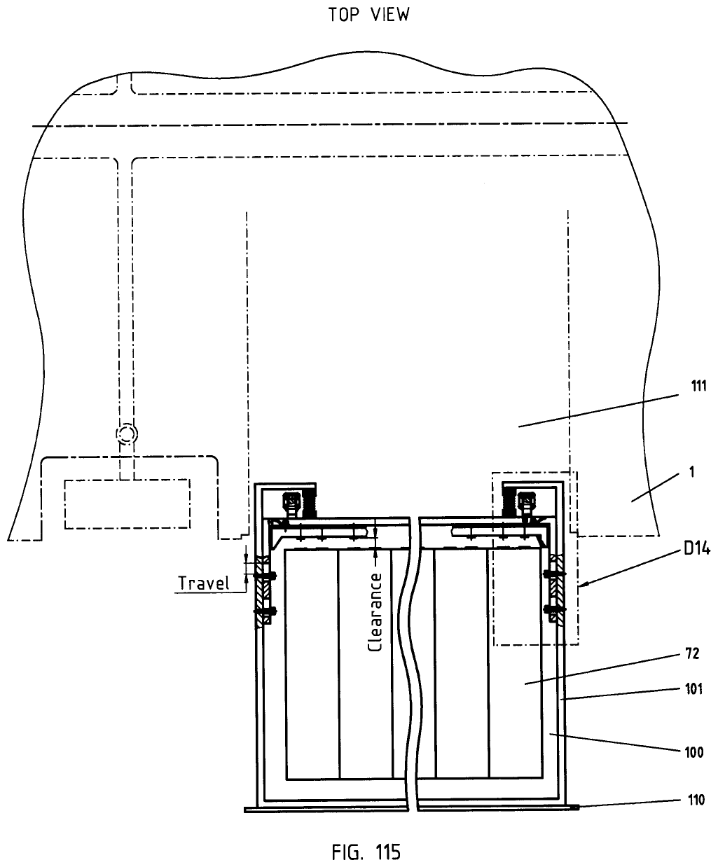

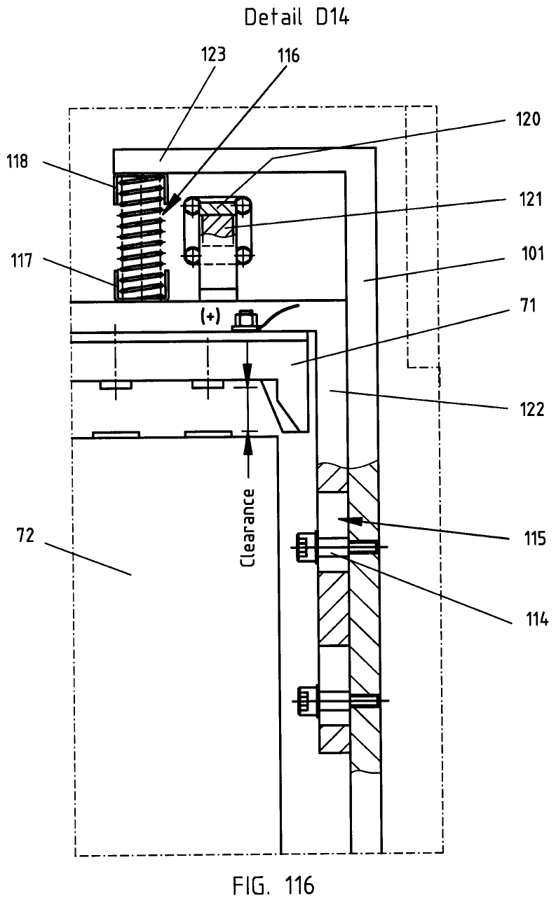

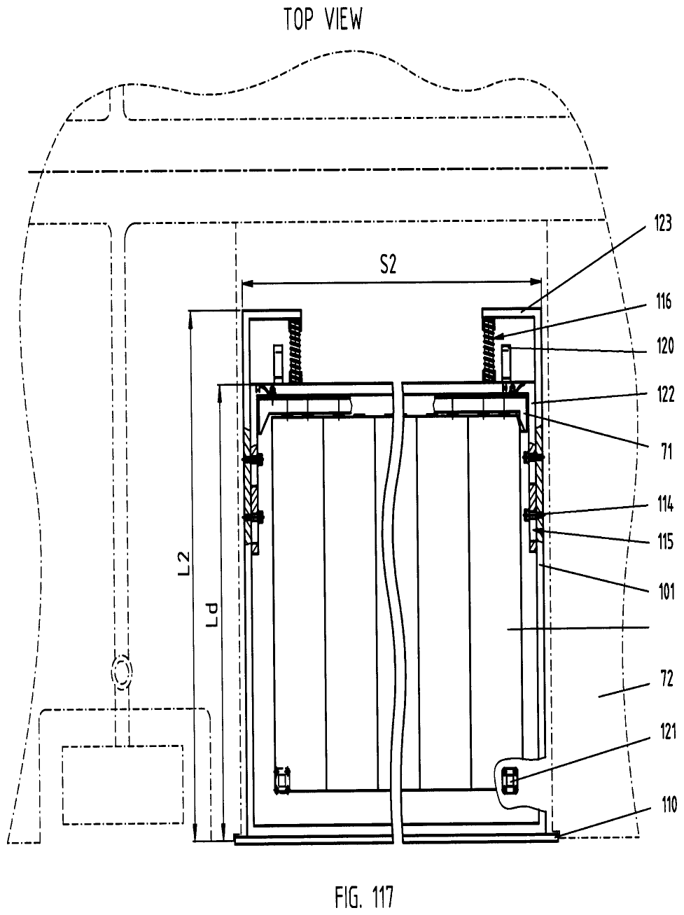

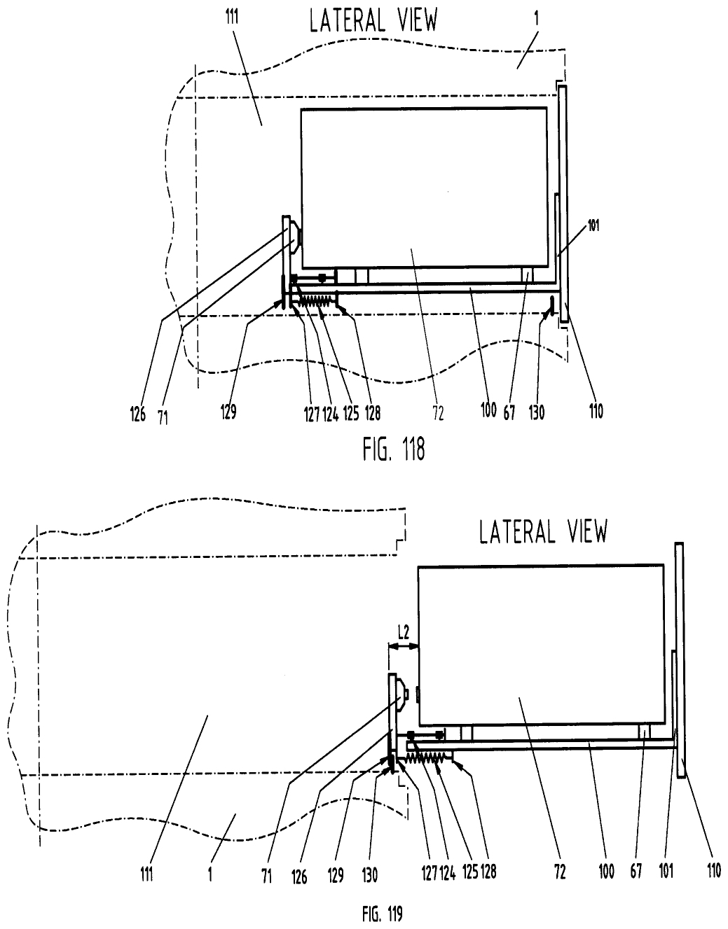

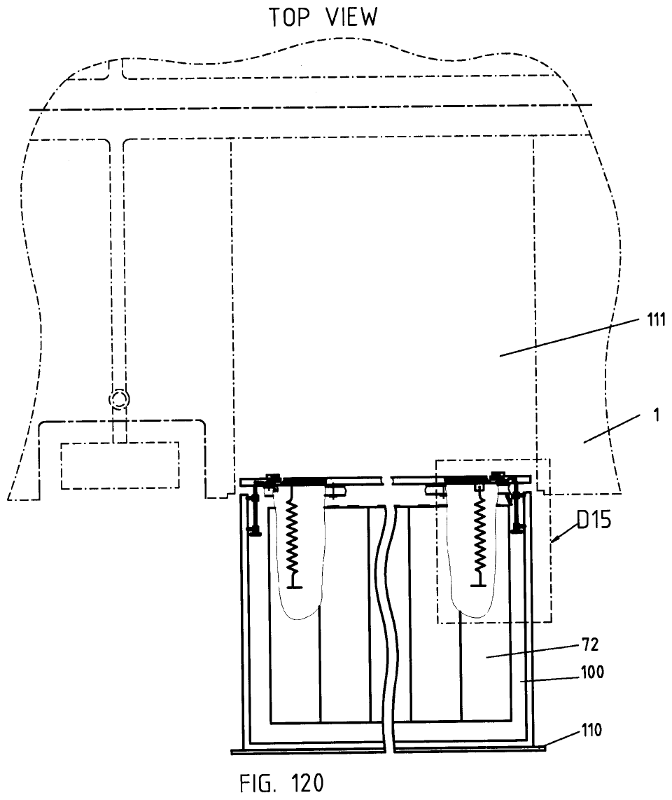

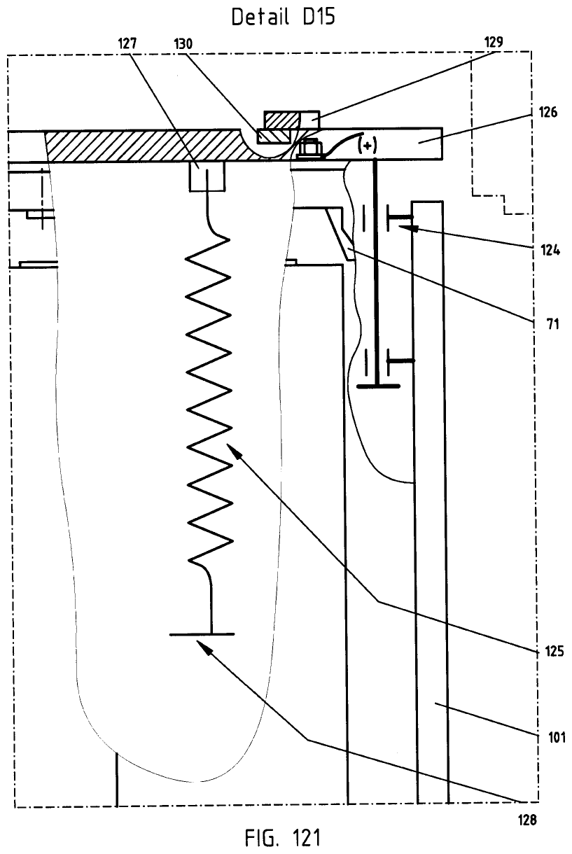

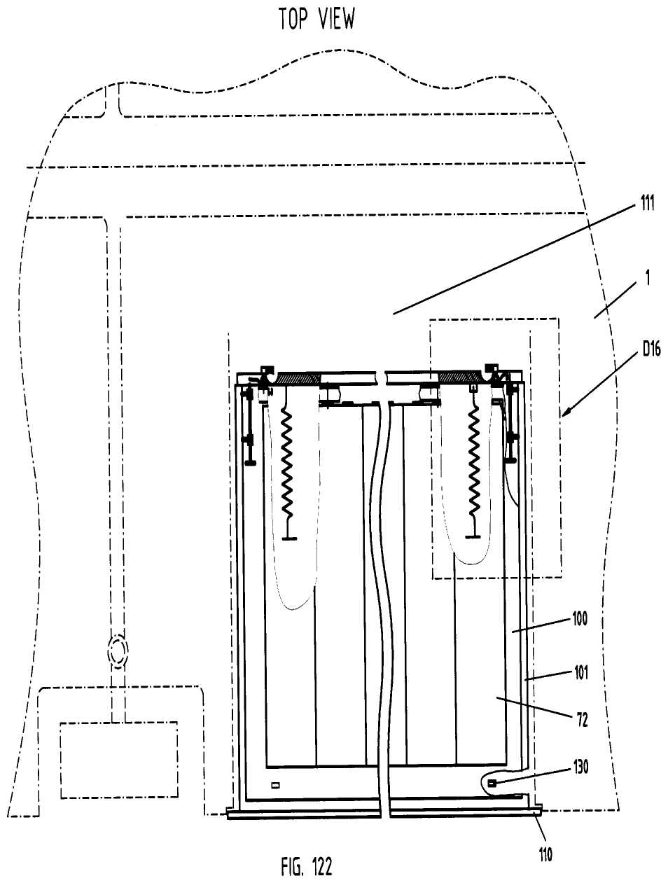

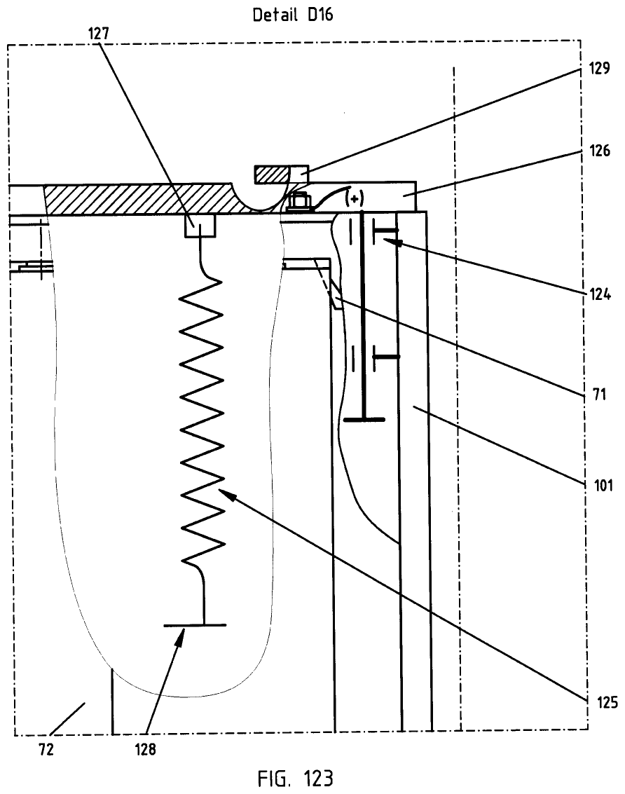

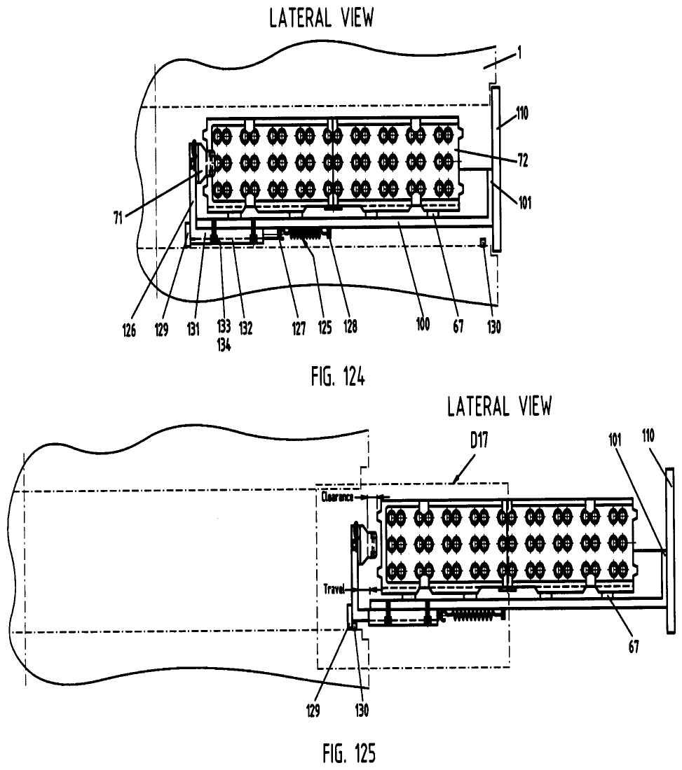

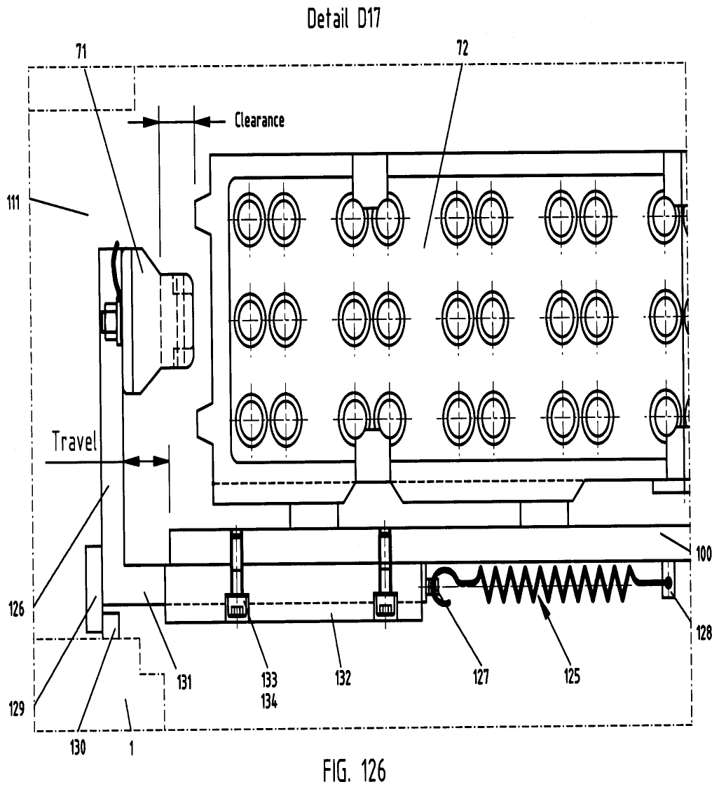

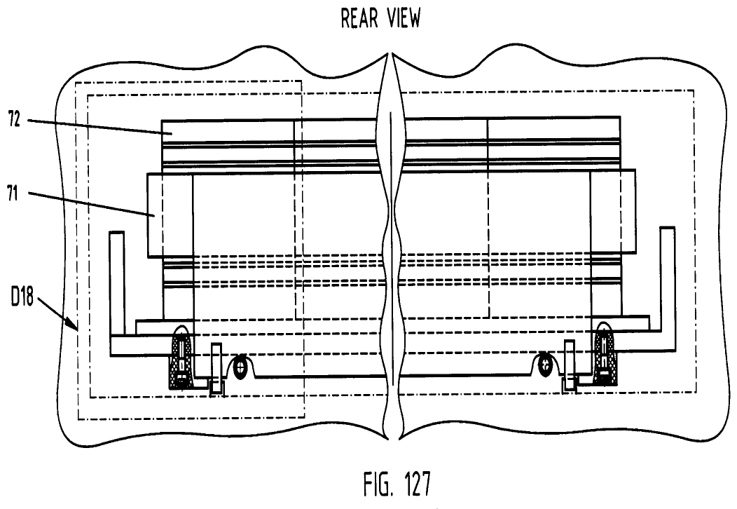

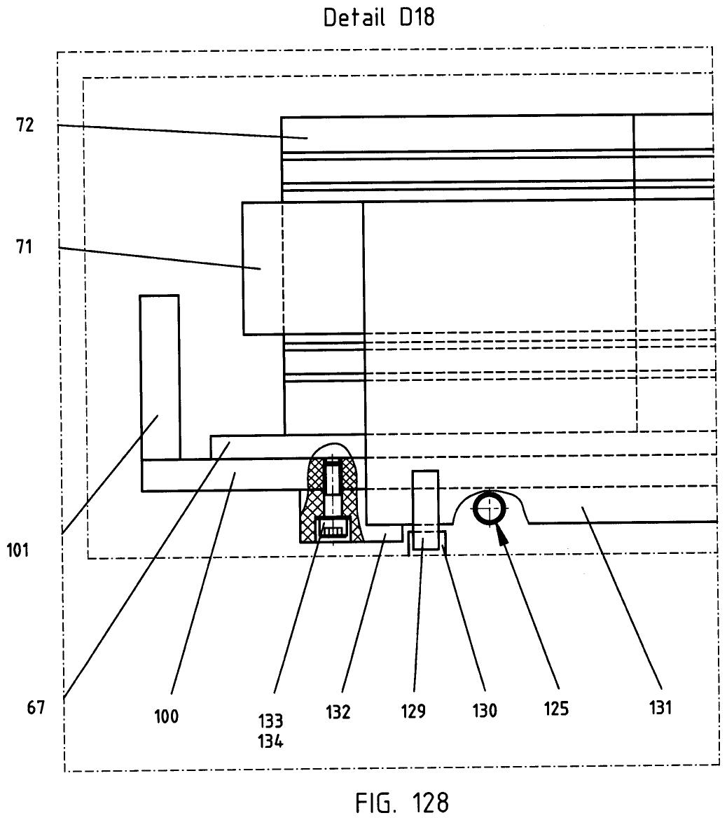

Essentially, a battery drawer comprises a platform 100, a frame 101 and walls 102, see FIG. 103. The battery package 72 is installed on the platform 100 via some battery pads 67, see FIG. 104 & FIG. 105. As it was described before, the contact plate 71 may be installed on the bottom of the battery package, see FIG. 104 on a contact plate support 69, or on the side of the battery package, see FIG. 105, on a contact plate support 70. For the bottom installation of the contact plate, the access to it is very easy and the contacts are realized automatically by disposing the battery package 72 on the battery pads 67. For side installation of the contact plate, see FIG. 105, the contact plate 71 installed in the drawer, is mounted on the contact plate support 70, which is attached to the drawer frame 101. This version has the inconvenient that requires complicate manipulation when the battery package is changed, due to the permanent contact between the contact plate and the battery package. In order to solve this problem, the contact plate has to be disconnected from the battery package when the drawer is out, creating a space between the contact plate and the battery package for easy access during the battery change, and to bring the contact plate out for easy access for cleaning operation. These are realized by mounting the contact plate on a moving element with respect to the drawer and by using a retainer element which retains the contact plate in an accessible position when the drawer continue to go out. The principle of such a drawer design is illustrated in FIG. 106 to FIG. 111. As seen in FIG. 106, FIG. 110 and FIG. 111 of Detail D12, the contact plate 71 is mounted on a moving element 103 capable to move on slides 104. When the drawer is inside of the electric vehicle 1, the contact plate 71 and the moving element 103 are pushed by a compressing elastic element 105, creating the contacts with the battery package. Their travel is limited by the stopper 106 lying on the surface 107 rigidly attached to the drawer frame 101. This allows a good contact between the cooper element 58 of the battery package 72 and the cooper cup 78 of the contact plate 71, but in the same time makes sure to have a clearance between the contact plate surface 88 and the cooper element 58 of the battery package 72. In this way the contact is provided by the elastic element 79 of the contact plate, see FIG. 101, which pushes the cooper cup 78 against the cooper element 58. When the drawer moves out, see FIG. 106 to FIG. 108, at the moment the contact plate is accessible, the grapnel element 109 attached solidly to contact plate moving element 103, is retained by a retainer 108, which is installed on the bottom of the battery compartment 111 of the electric vehicle 1, stopping the contact plate to go further. In this way the contact plate 71 remains in this position when the drawer continues to go out for a distance, in order to create a clearance between the battery package and the contact plate. The distance on which the drawer travels with the contact plate stopped is noted in FIG. 107 & FIG. 108 by “Travel”. This is the distance between the stopper 106 and the face 107 on which it is lying when the drawer is retracted, generating the “Clearance”, see FIG. 108 and the detail D11 in FIG. 109. In the retracted position of the drawer, see FIG. 110 and FIG. 111, the stopper 106 is in contact with the surface 107 due to the force provided by the elastic element 105, and the cover 110 closes the vehicle drawer compartment 111. Applying this principle two embodiments are presented and illustrated in the following drawings. One embodiment shown in FIG. 112 to FIG. 114 uses lateral rear slides. The moving element of the contact plate support 112 slides laterally on an extension 113 of the drawer frame 101 via special bolts 114, which are sliding into the slots 115. The compressing elastic element is a compression cylindrical spring 116 having one end sitting on a spring cup 117 attached to the moving element of the contact plate support 112 and the another end sitting on a spring cup 118 attached to the drawer frame extension 113 by a rigid element 119. The grapnel is a rigid element 120 attached to the contact plate moving element 112, which is stopped by the retainer 121 bolted on the bottom of the vehicle drawer compartment 111. The disadvantage of this embodiment consists in the fact that the overall dimension L1 of the drawer is very long in comparison with the battery package dimension LO, requiring a deep drawer compartment of the vehicle 111, see FIG. 114. In order to reduce the overall length of the drawer, in a second embodiment presented in FIG. 115 to FIG. 117, the sliding element of the contact plate support 122 slides inside of the drawer frame 101. The overall length of the drawer extends only with the length of the spring 116 and its support 123. All other components are similar to the components used for the first embodiment. Even if the space required in the drawer compartment 111 of the vehicle 1 is smaller than for the first embodiment, L2<L1, this exceeds the minimum length Ld taken only for the drawer, the contact plate and its support, see FIG. 117. Instead, the width S2>S1 because it takes extra space inside the drawer for the slides, see FIG. 117. In order to overcome these inconveniences, in FIG. 118 to FIG. 123 is presented another principle of the drawer design. This one allows to minimize the size of the drawers in length and width, by using bottom slides for the moving element of the contact plate and as an elastic element a traction spring, which pulls the moving element of the contact plate. In this design the sliding element 124 is on the bottom of the drawer, underneath of the battery package 72, see FIG. 118 & FIG. 119. The traction spring 125 is installed underneath of the drawer platform 100 and its moving end is attached to the moving element of the contact plate 126 by an attaching element 127 and the opposite end is attached on the bottom side of the platform 100 by the attaching element 128. The grapnel 129, attached to the moving element 126 of the contact plate, when arrives in contact with the retainer element 130, solidly attached to the vehicle body 111, keeps the contact plate in place when the drawer continue to go out, see FIG. 119, FIG. 120 & FIG. 121. Applying this principle an embodiment is illustrated in FIG. 124 to FIG. 128. The contact plate 71 is mounted on the contact plate support 126, which is attached to a sliding element 131. This sliding element is sliding underneath of the platform 100 between two sliding guides 132, see FIG. 127 and Detail D18 in FIG. 128. The sliding guides 132 are attached to the platform 100 by bolts 133 and spring washers 134. The traction spring 125 is attached with the moving end on the sliding element 131 by the attaching element 127 and the opposite end is attached to underneath of the platform 100 by an attaching element 128. The grapnel 129 is attached rigidly on the sliding element 131 and it will be in contact with the retainer 130 when the drawer goes out, see FIG. 125 and the Detail D17 in FIG. 126. The retainer element 130 is attached solidly to the bottom of the battery compartment of the vehicle 111.

In order to position the battery package 72 on the drawer in a way to align the cooper elements 58 of the contact plate 71 with the cooper cup 78 of each battery module, are used a plurality of lining and pushing mechanisms. The principle is to have a lining mechanism consisting in a rigid element permanently fixed on the drawer platform 100 acting as a stopper, which not allows to the battery package to overpass it, and a pushing mechanism capable to push the battery package against this stopper to make sure the battery package is in contact with this stopper all the time. This principle is applied on two perpendicular directions of the platform.

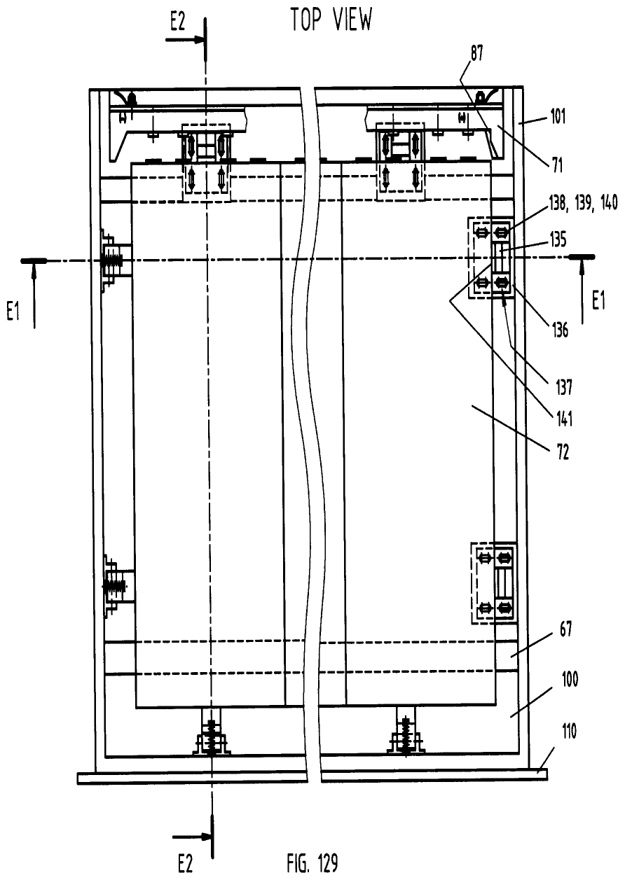

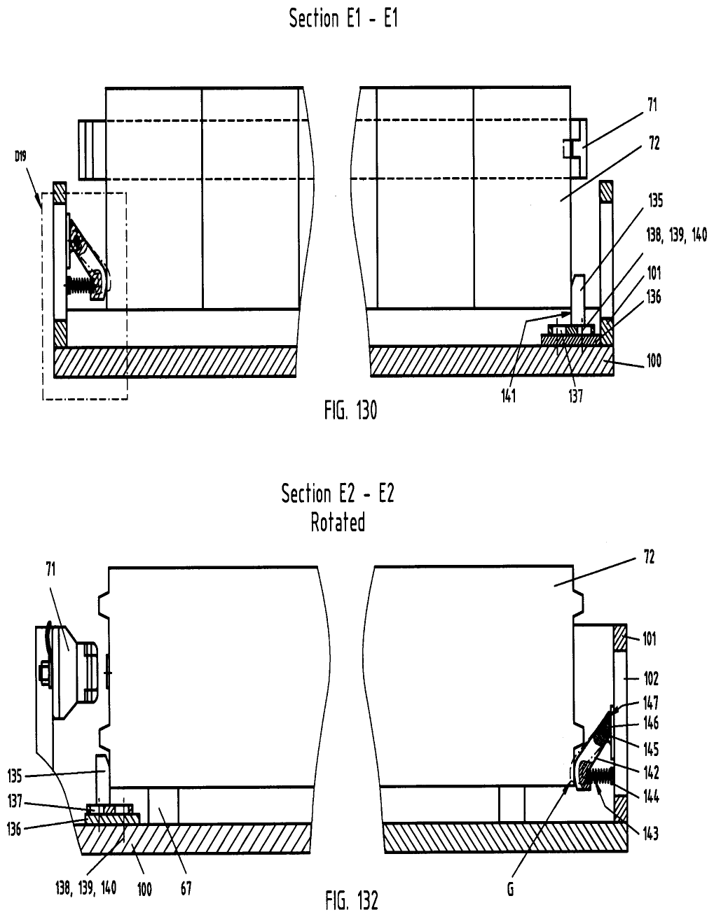

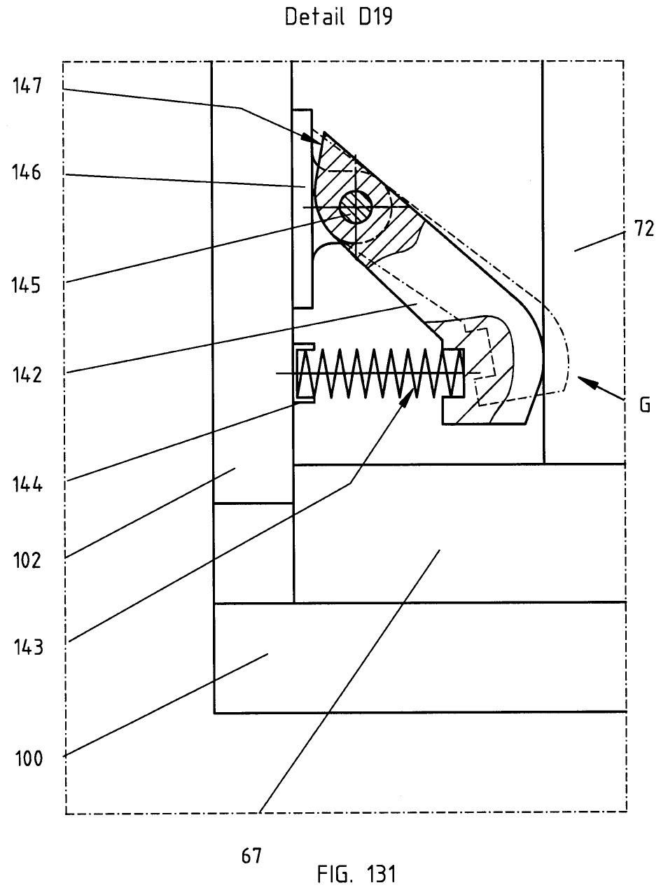

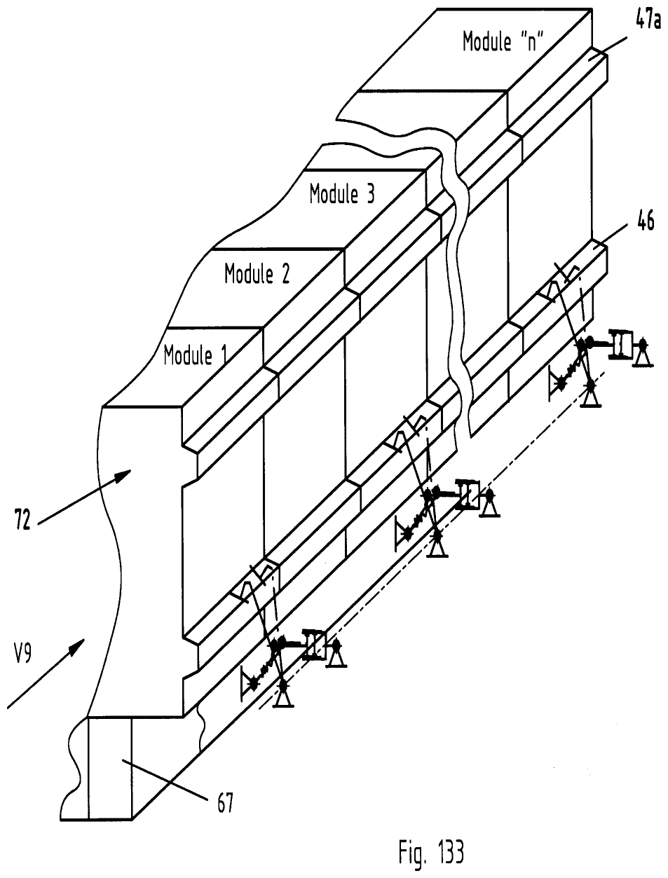

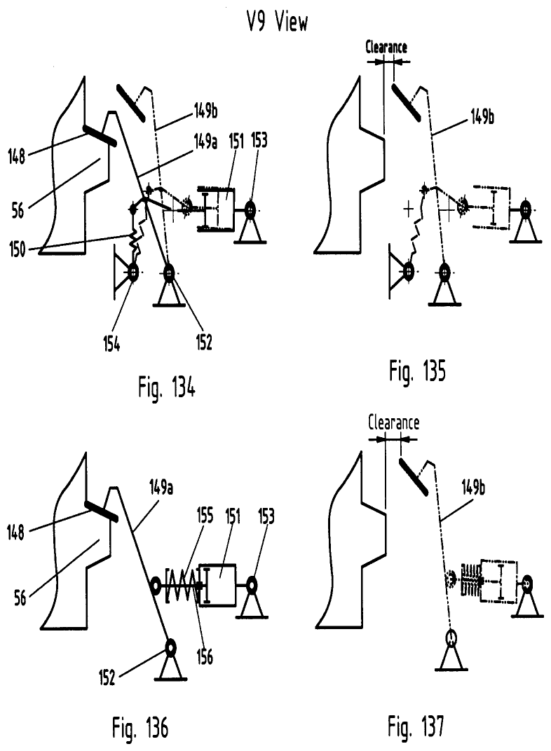

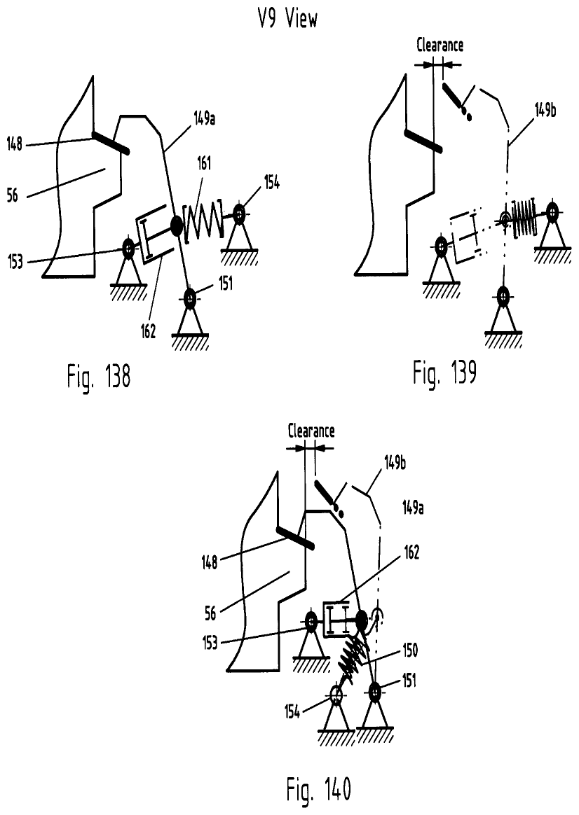

In FIG. 129 to FIG. 132 is illustrated an embodiment of this principle. The stopper 135 is mounted on a support 136, which is solidly set on the platform 100. The stopper 135 may be adjusted by the oval slots 137, using a plurality of bolts 138, washers 139 and spring washers 140. For one direction (normal to the face of the side terminals 57a, 57b of the battery package 72), the adjustment is made in order to align the face 141 of the stopper 135 (FIG. 130) to the face 87 of the contact plate 71, (FIG. 129). For another direction (parallel to the face of the side terminals 57a, 57b of the battery package 72), the adjustment is made in order to ensure a good contact and the allowable clearance between the battery package and the contact plate surface 88 when the drawer is retracted completely into the electric vehicle, see FIG. 90 & FIG. 92. On the opposite position with respect to the battery package, there is a pushing mechanism, which ensure the contact between the battery package 72 and the stopper 135. This pushing mechanism consists in an articulated arm 142 pushed against the battery package by a compressing spring 143. This compressing spring 143 has one end set on the drawer wall 102 by a spring cup 144 and another end on a cavity of the articulated arm 142. The articulated arm 142 can turn around the spindle 145 set on the support 146, which is rigidly mounted on the 102 wall, see Detail D19 of FIG. 130 in FIG. 131. The articulated arm rotation is limited by a flat surface 147, which stops the rotation of the articulated arm 142 in the position “G”, see FIG. 131, when the battery package is out of the drawer. The same kind of lining and pushing mechanism is used for both directions. The pushing mechanism in the direction parallel to the contact plate 71 acts also as a package assembly keeper, ensuring that the battery package 72 stays compact all the time the battery package remains installed into the vehicle drawer.

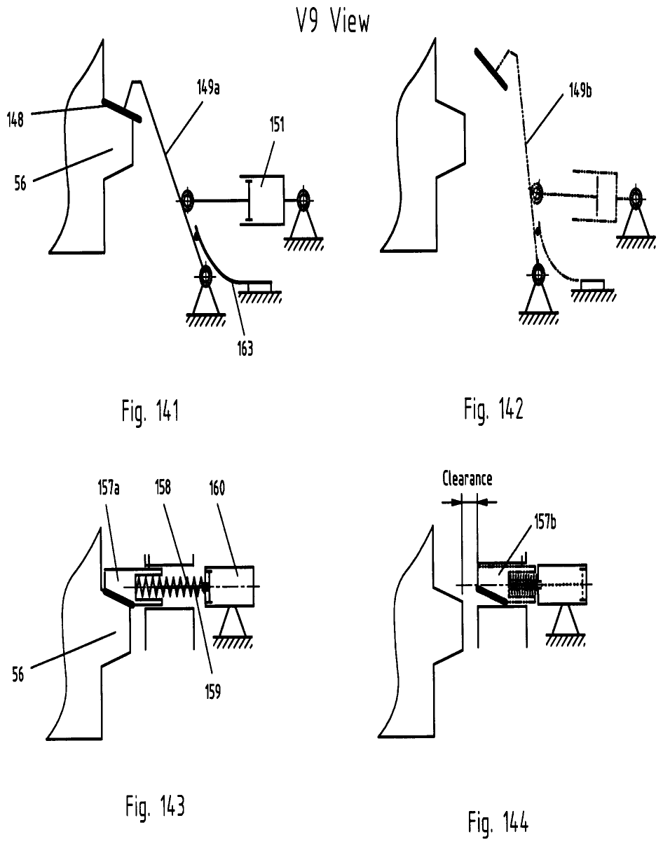

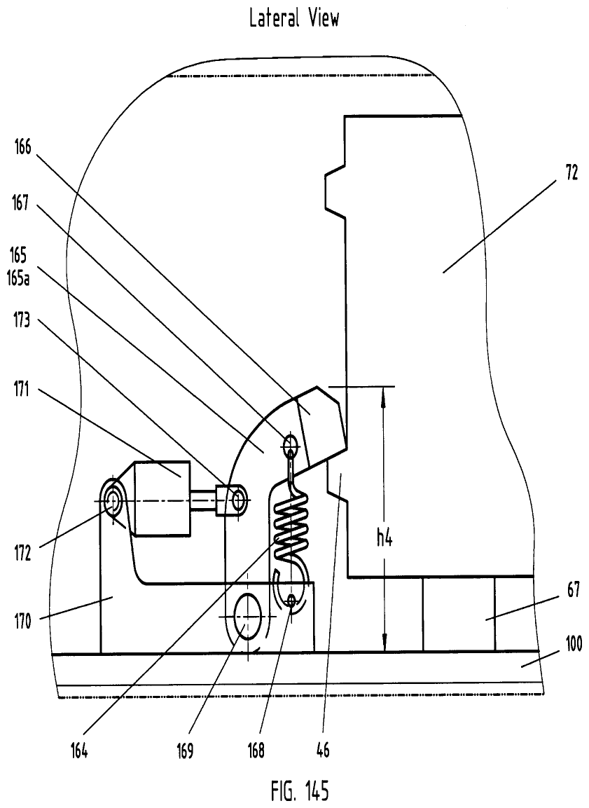

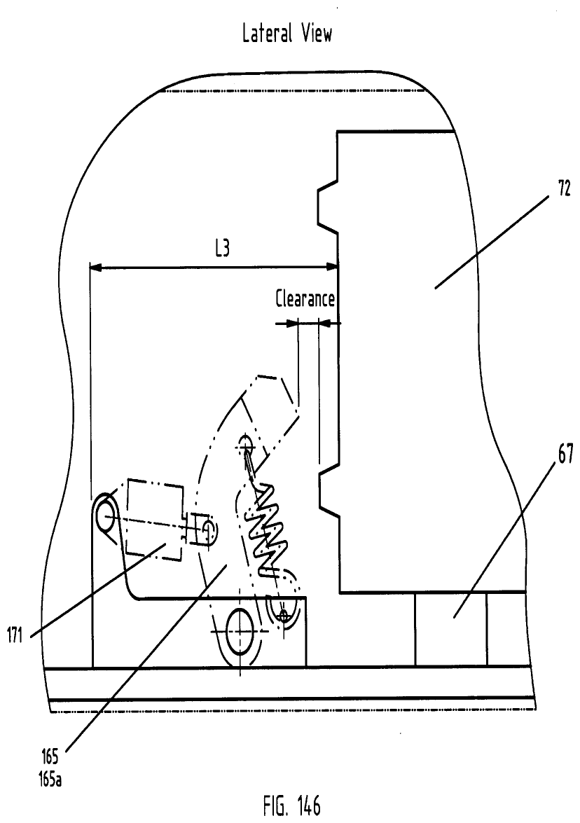

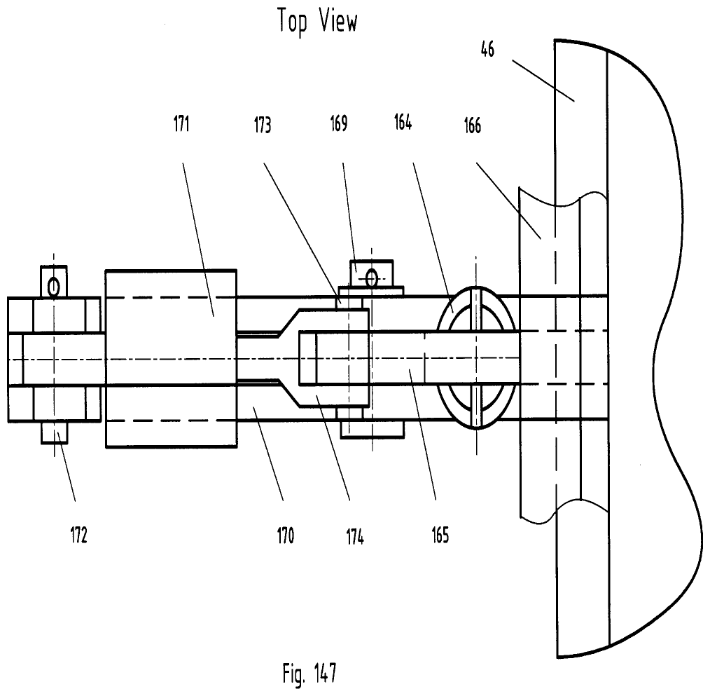

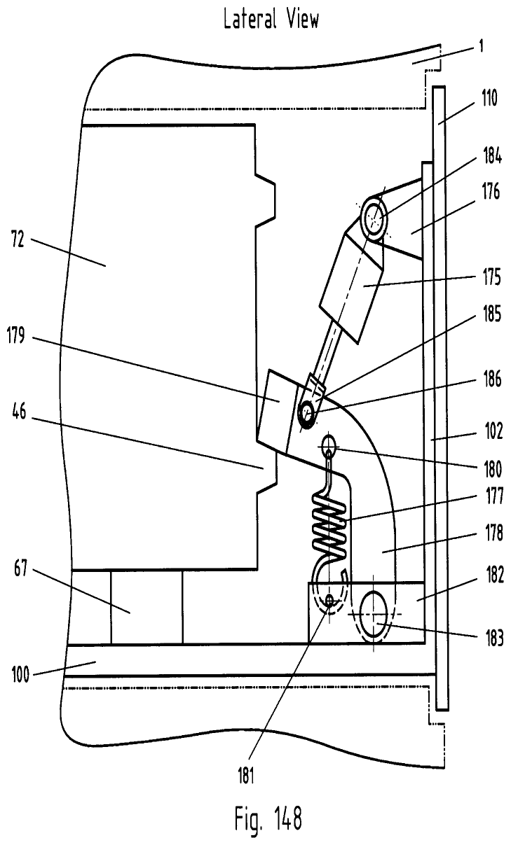

In order to set the battery package into the drawer, a clamping mechanism is used, as a locking mechanism, based on the principle described before and shown in FIG. 61. A plurality of the clamping mechanisms may be imagined using this principle. Generally, each mechanism comprises an actuator to clamp and keep the battery package on the drawer platform and another actuator to unclamp and release the battery package in order to be removed from the drawer. Depending of the kind of actuators, different design schemes and embodiments are presented in FIG. 133 to FIG. 152. Generally for the security reasons and for better efficiency, as a clamping actuator is used an elastic element, strong enough to keep in place the battery package all the time. As unclamping actuator, generally is used an electromagnet. Depending on the kind of elastic element and the kind of electromagnet, a plurality of solutions may be designed. On each side of the battery package a plurality of clamping mechanisms may be installed, as shown in FIG. 133. As illustrated schematically in FIG. 134, a pad 148 is in contact and clamps on the shoulder 46 of each battery module. This pad 148 is attached to a clamping arm 149, which has two positions: clamped 149a and unclamped 149b. In the clamped position 149a, the clamping arm 149 is pulled by a traction elastic element 150, and in the unclamped position 149b, it is pulled by the electromagnet 151. In FIG. 134 is illustrated the mechanism in both positions: clamped (using continue lines) and unclamped (using the divide lines), showing each element of the mechanism on both positions. It is very important in the unclamped position 149b to create a “Clearance” between the battery shoulder 46 and the pad 148 in order to be able to take out vertically the battery package and change it, see FIG. 135. The three stationary articulations 152, 153 and 154 are steadied on the drawer platform or drawer wall. In FIG. 134 to FIG. 144 are presented different versions of battery clamping mechanism in clamped and unclamped positions, using different kinds of actuators and mechanisms, as following: The FIG. 134 & FIG. 135 illustrates an articulated mechanism with a traction spring 150 and a pulling electromagnet 151; The FIG, 136 & FIG. 137 shows an articulated mechanism with a compression spring 155 mounted on the sliding element 156 of a pulling electromagnet 151; The FIG. 138 & FIG. 139 shows an articulated mechanism with a compression spring 161 opposing a pushing electromagnet 162; The FIG. 140 illustrates an articulated mechanism with a traction spring 150, and with a pushing electromagnet 162; The FIG. 141 & FIG. 142 shows an articulated mechanism with an elastic blade 163 and a pulling electromagnet 151. The FIG. 143 & FIG. 144 shown a sliding mechanism with a taper sliding pad 157, a compression spring 158 mounted on the sliding element 159 of a pulling electromagnet 160. For each of these schemes may be designed a respective embodiment. Two of these kind of embodiments are illustrated in FIG. 145 to FIG. 152. In FIG. 145 is shown an embodiment for an articulated mechanism, in the clamped position, using a traction spring 164 pulling the arm 165. The pad 166 is rigidly attached to the arm 165, clamping on the battery shoulder 46. The spring 164 is attached to the arm 165 by a hole 167 and to the drawer platform by a spring pin 168 via the support 170. The arm 165 turns around the shaft 169, which is attached to a support 170 mounted on the drawer platform 100. The electromagnet 171 turns around the 172 shaft, which is attached to the drawer platform 100 via the support 170. The mobile end of the electromagnet 171 is attached to the arm 165 via a sliding bolt 173. In FIG. 146 is shown the same clamping mechanism in an unclamped position. The arm 165 is in the 165b position pulled by the electromagnet 171, opening and unclamping the battery package 72, and creating the “Clearance” requested to take out the battery package during the quick-change battery process. In FIG. 147 which is a top view of the mechanism presented in FIG. 145, is shown a portion of the pad 166 (which clamps on the entire length of the battery package shoulder 46), the articulated arm 165, which turns around the shaft 169, and is pulled by the traction spring 164 to clamp on the battery shoulder 46. Also, is shown the “U” kind profile support 170. The electromagnet 171 has a fork kind mobile end 174, pulling the arm 165 via the shaft 173. The advantage of this design consists in a reduce height of the mechanism h4, see FIG. 145. It is a “low clamping mechanism” style.

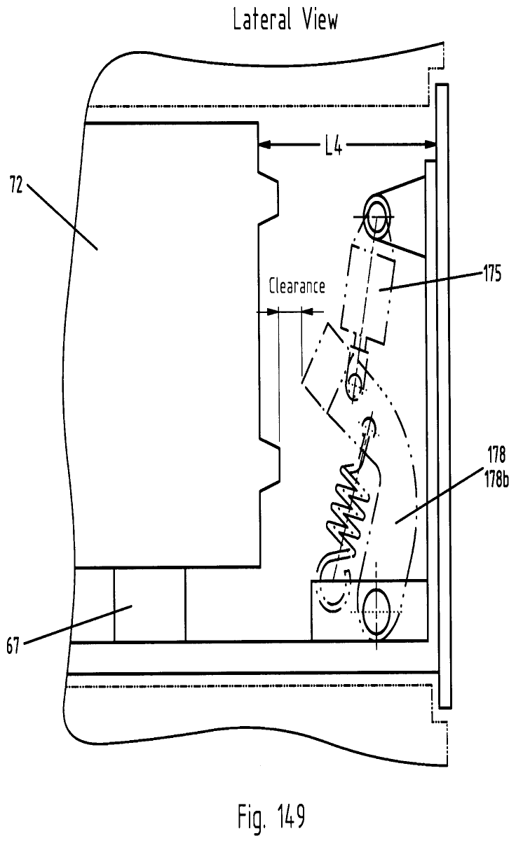

The disadvantage is related to the large required space, which is imposed by the dimension L3, shown in FIG. 146. In order to overcome this impediment, using the same principle, another embodiment of the battery package clamping mechanism is presented in FIG. 148 to FIG. 150, a “short clamping mechanism” style. Just changing the position of the stationary end of the electromagnet 175 on the drawer wall 102, by using a different support 176, the required space of the entire clamping mechanism is reduced to the length L4 (L4<L3), see FIG. 146 and FIG. 149. As shown in FIG. 148 this embodiment is also an articulated mechanism, illustrated in the clamped position, using a traction spring 177 pulling the arm 178 (in a clamping position 178a). The pad 179 is rigidly attached to the arm 178, which clamps on the battery shoulder 46. The spring 177 is attached to the arm 178 by a hole 180 and to the drawer by a spring pin 181 via the support 182.

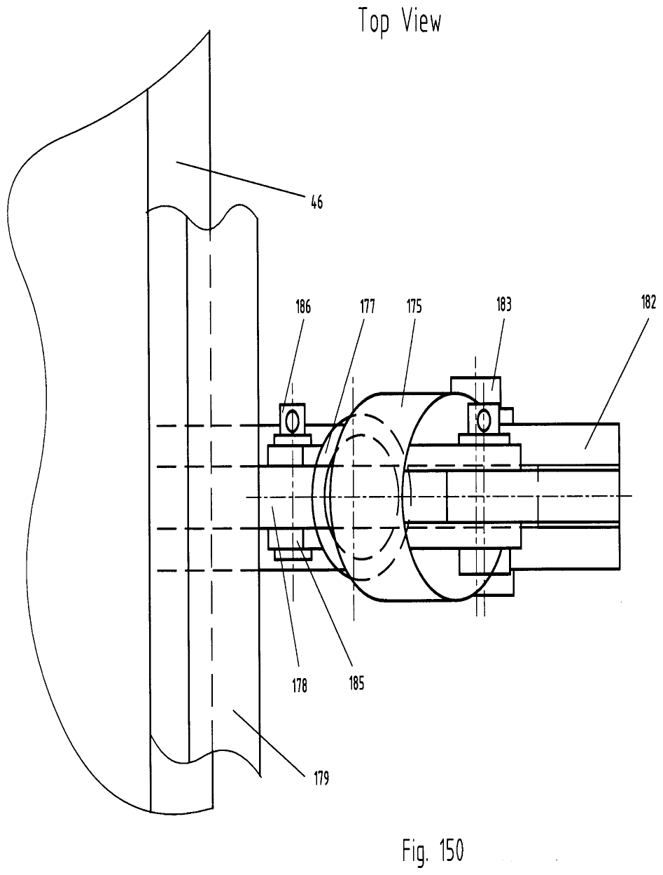

The arm 178 turns around the shaft 183, which is attached to a support 182 mounted on the drawer platform 100. The electromagnet 175 turns around the 184 shaft, which is attached to the drawer wall 102 via the support 176. The mobile end of the electromagnet 175 is attached to the arm 178 via a fork 185 and a sliding bolt 186. In FIG. 149 is shown the same clamping mechanism in an unclamped position. The arm 178 is in the 178b position pulled by the electromagnet 175, opening and unclamping the battery package 72, and creating the “Clearance” requested to take out the battery package during the quick-change battery process. The FIG. 150 is a top view of the mechanism presented in FIG. 148 showing a portion of the pad 179 (which clamps on the entire length of the battery packet shoulder 46), the articulated arm 178, which turns around the shaft 183, and is pulled by the traction spring 177 to clamp on the battery shoulder 46. Also, it is shown the “U” kind profile support 182, the 185 fork and the 186 sliding bolt. This design is a “short clamping mechanism” style, being more compact horizontally, but requiring more space vertically. Taking into consideration the characteristics of each of both solutions, a design of a drawer having a low clamping mechanism 187 close to the contact plate 71, and a short clamping mechanism 188 on the opposite side, closed to the drawer cover 110, is shown in FIG. 151—clamped, and in FIG. 152—unclamped.

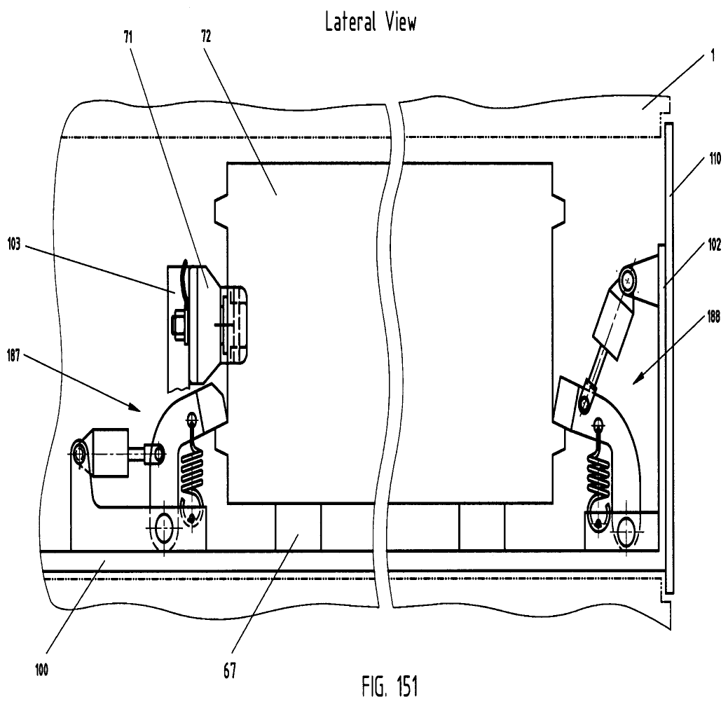

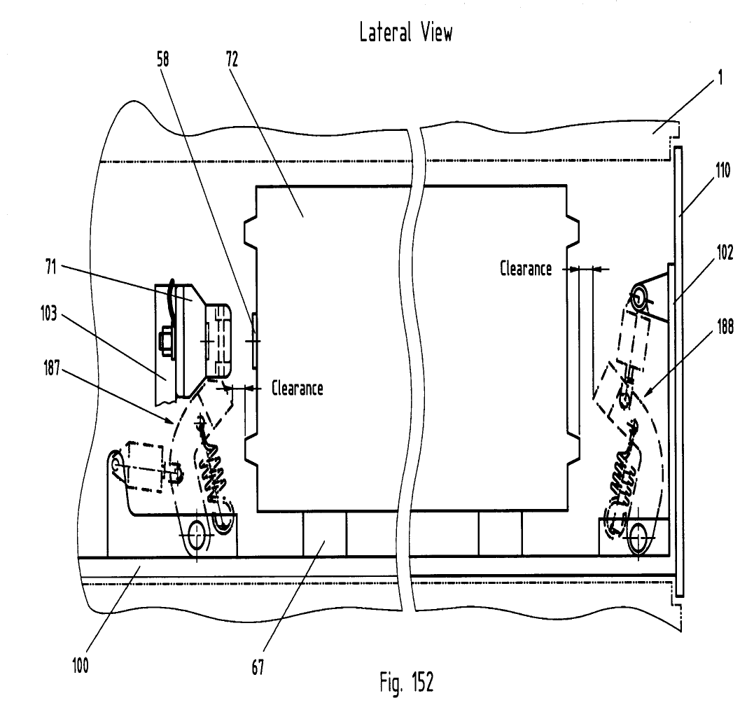

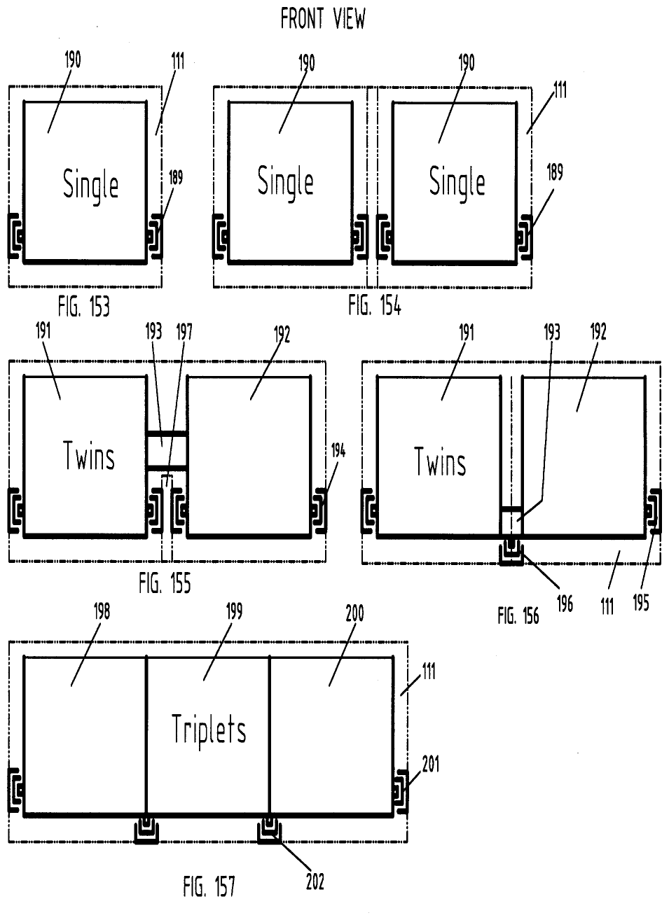

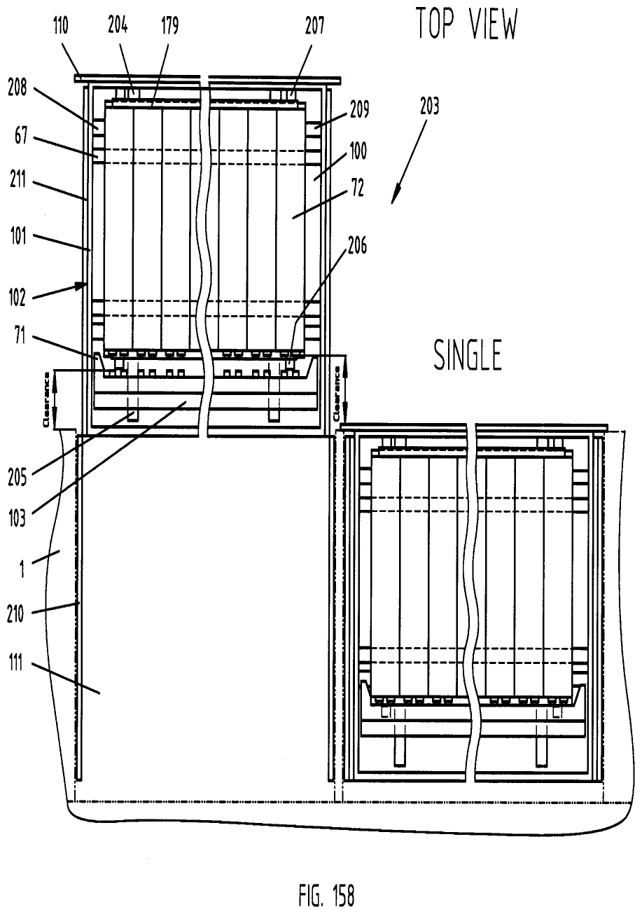

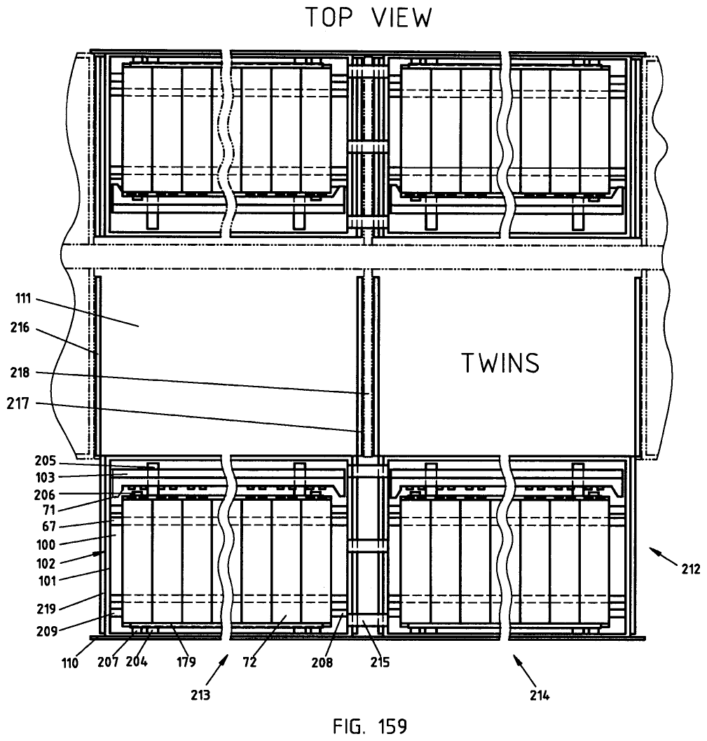

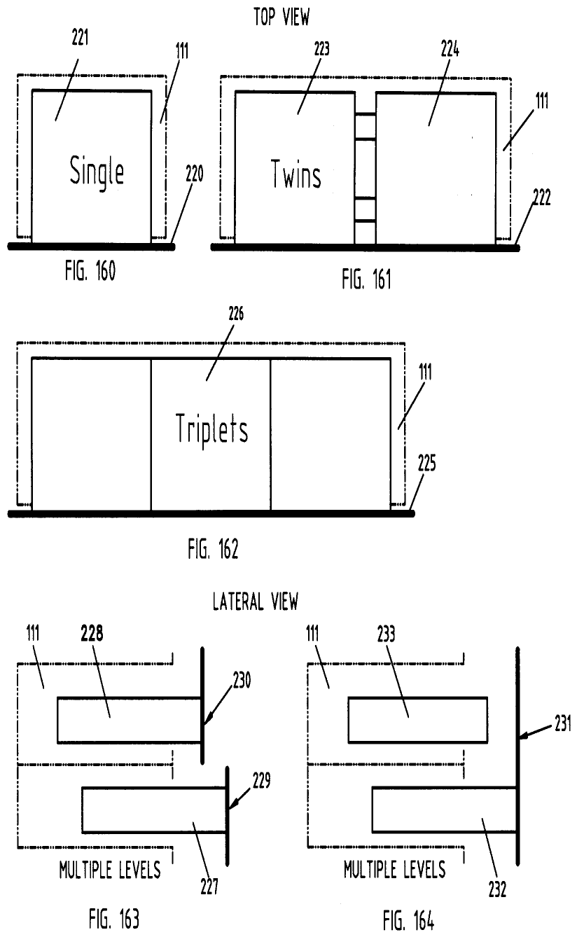

One definition of a drawer says that a drawer is a “boxlike storage compartment without a lid, made to slide horizontally in and out of a desk, chest, or other piece of furniture.” So, one of the most important functions of a drawer is to slide IN and OUT, using some “slides”. In order to have access to the entire compartment, extensible slides were designed, even in a heavy duty version. Therefore, the battery drawers may go out far enough in order to ensure a good “Clearance” for battery package manipulation during the battery change process. As discussed before, depending on each category and class of the electric vehicle, there are different configurations of battery drawers, like: single, double or triple, single or multiple levels, or single or multiple columns. For each version, the slides are adapted to one of these configurations. For example: for single drawers, side slides 189 are very appropriate to be installed of each side of the drawer compartment 190, see FIG. 153 and FIG. 154. For double drawers—twins, which comprise two compartments 191 and 192 on the same level, attached one to another by attaching elements 193, there are two possibilities: to use two pair of side slides 194 placed on the lateral and middle walls of each compartment like in FIG. 155 or, to use one pair of side slides 195 placed on the lateral walls of the twins and a bottom slide 196 placed in the middle, underneath of the drawer, like in FIG. 156. For the version presented in FIG. 155 is absolutely necessary to have in the middle of the drawer compartment of the vehicle 111 a support 197, to support the middle side slides. Also, is very important that the attaching element 193 to be positioned on top of the 197 support to avoid any interference, see FIG. 155. For the second version, the slide support may be avoided, and the attaching element 193 may be positioned anywhere between the two drawer compartments 191 and 192, or even may be avoid in certain circumstances. The advantage of the first version is its great rigidity (the side slides are more rigid than the bottom slides for the same thickness of their components). The second version is more compact, which may be a great advantage in certain circumstances. Depending on the available space and on the weight of the battery packages, each manufacturer may decide which version is the most appropriate for each application. For triple drawers—triplets, having three drawers compartments 198, 199 and 200, see FIG. 157, may be used two side slides 201 laterally, and two bottom slides 202. For any kind of slides, lateral or bottom mounted, ball bearing slides are recommended, known of their high performance. In FIG. 158 is illustrated an embodiment of a single drawer version with side slides, shown in IN & OUT position. The drawer 203 comprises all the elements discussed here before: the platform 100, the drawer frame 101, the cover 110, the battery package supports 67, the battery package 72, the contact plate 71, the contact plate support 103, the front clamping mechanism 204 with the clamping pad 179, and the rear clamping mechanism 205, the lining stopper element 206 and the pushing mechanism 207 of a longitudinal alignment battery package system, and the lining stopper element 208 and the pushing mechanism 209 of a lateral alignment battery package system. The side slides of this drawer comprise a fixed element 210 mounted on the wall of the vehicle drawer compartment 111 and a moving element 211 installed on the side wall 102 of the drawer. In FIG. 159 is illustrated an embodiment of a double drawers—twins version of drawers, with two pairs of side slides, shown in IN & OUT position. The drawer 212 comprises two compartments 213 and 214, connected by attaching elements 215, moving IN & OUT together. Each of these two drawer compartments comprises all the elements discussed here before: the platform 100, the drawer frame 101, the battery package supports 67, the battery package 72, the contact plate 71, the contact plate support 103, the front clamping mechanism 204 with the clamping pad 179, and the rear clamping mechanism 205, the lining stopper element 206 and the pushing mechanism 207 of a longitudinal alignment battery package system, and the lining stopper element 208 and the pushing mechanism 209 of a lateral alignment battery package system. The twins drawer has installed two pair of side slides each one of them having a fixed elements 216 mounted on the lateral walls on the vehicle drawer compartment 111 and another one 217 mounted on the slide support 218, which is placed between the two drawer compartments, fixed on the vehicle body. The moving element 219 of these side slides are installed on the lateral walls 102 of each drawer compartment. Both compartments have a common single cover 110. The design of the drawer cover 110 is adapted to each kind of drawer. In FIG. 160 is shown a cover 220 for a single drawer 221, in FIG. 161 a cover 222 for twins drawer 223 & 224, and in FIG. 162 a cover 225 for triplets drawer 226. For multiple level drawers, each level may have their own covers. In FIG. 163 are illustrated two level drawers 227 & 228 with their respective covers 229 & 230. Another possibility is to have a single cover 231 installed on the lower drawer 232 covering entire column, in this case both drawers 232 and 233, see FIG. 164. During the battery package change on the low level drawer, the upper drawers have to be closed to ensure a good access.

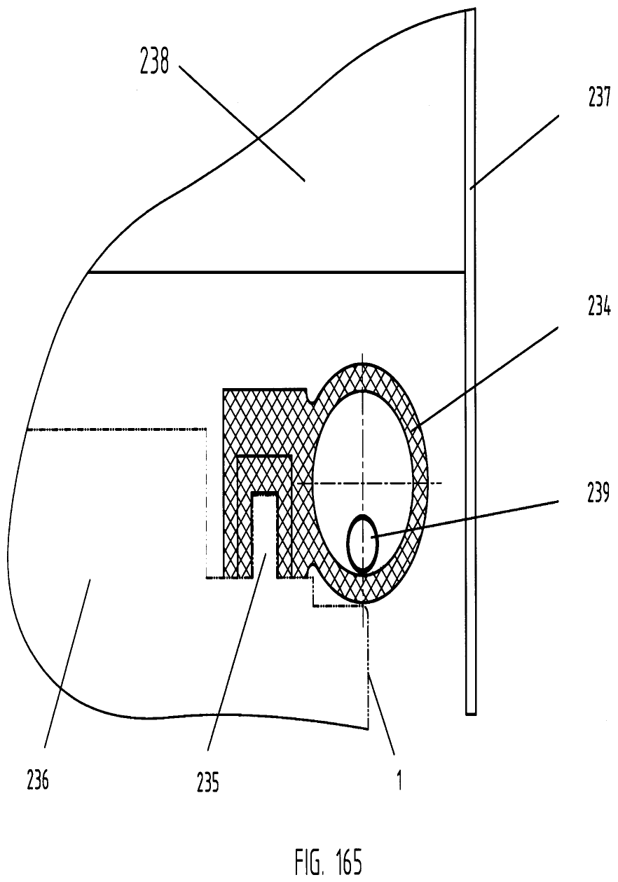

In order to seal the drawers compartments, a sealing element 234 is installed on a rib 235 of the vehicle body 1 on the entire perimeter of the vehicle compartments 236, on which the cover 237 of the drawer 238 is tighten, like in FIG. 165.

In order to defrost the drawers in the winter time, an electrical resistance 239 may be installed inside of the sealing element 234, see FIG. 165.

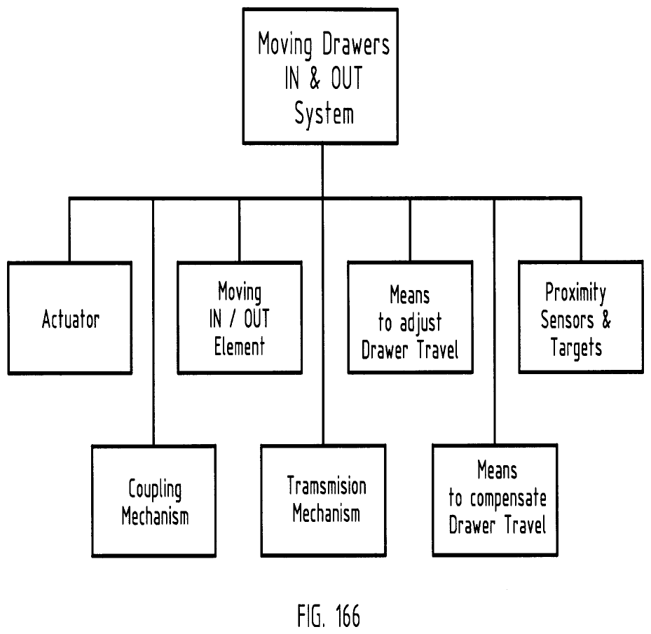

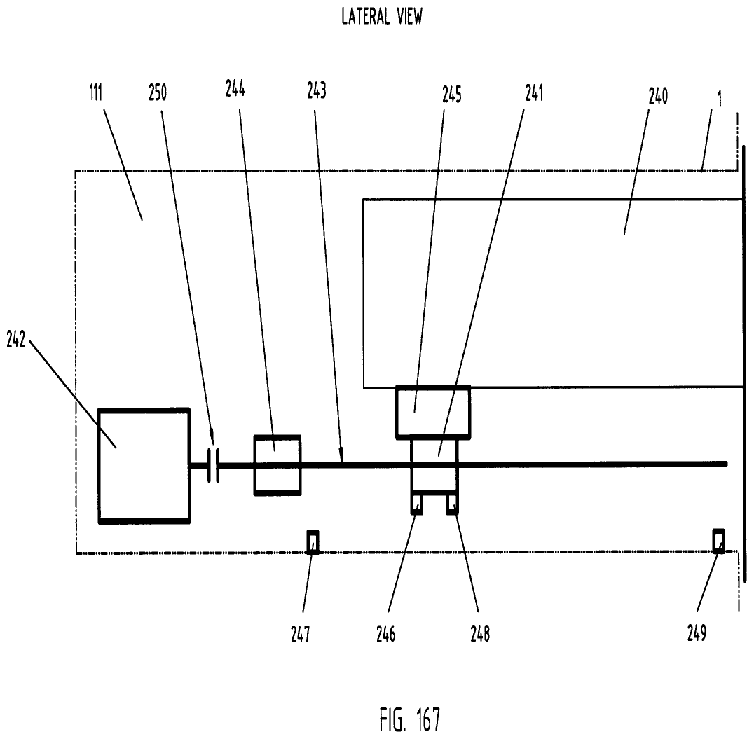

Every drawer requires some means to move it IN & OUT. The structure of a such a moving IN & OUT system is like in FIG. 166. These are schematically shown in FIG. 167. For a drawer 240 the means to move the drawer IN & OUT comprise a moving IN & OUT element 241, an IN & OUT actuator 242, a moving IN & OUT transmission mechanism 243, means to adjust the drawer travel 244, means to compensate the variation of the drawer travel 245 and a proximity sensor 246 for IN and its target 247, and a proximity sensor 248 for OUT and its target 249. The actuator is connected to the transmission mechanism by a coupling element 250. Generally, as actuator 242 is used an electric motor. The configuration of the moving IN & OUT element 241, the configuration of means to adjust the drawer travel 244, and the configuration of means to compensate the variation of the drawer travel 245 depends on the kind of the moving IN & OUT transmission mechanism 243. As moving IN & OUT transmission mechanism may be used a screw & nut mechanism or a chain mechanism.

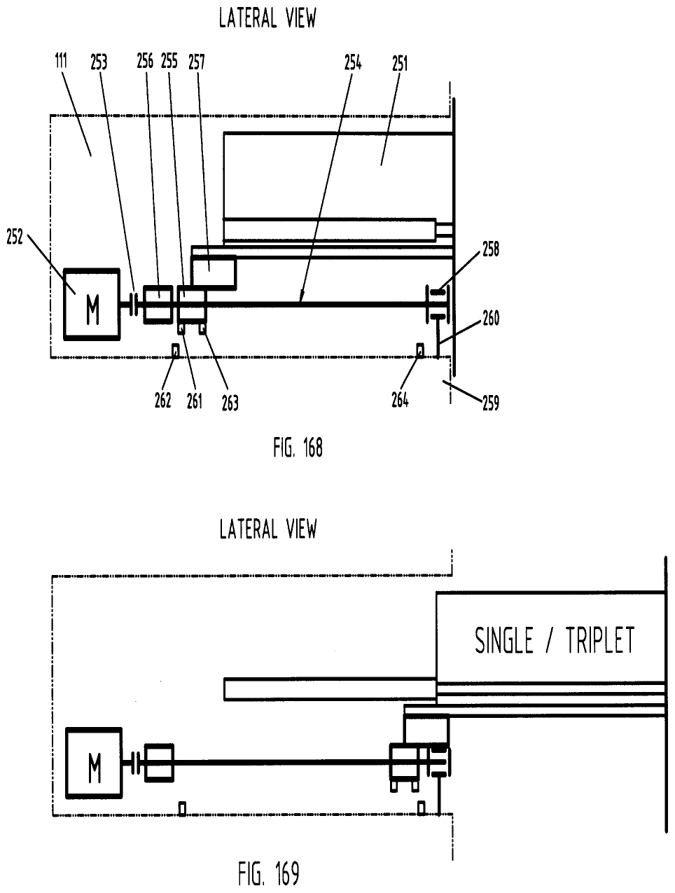

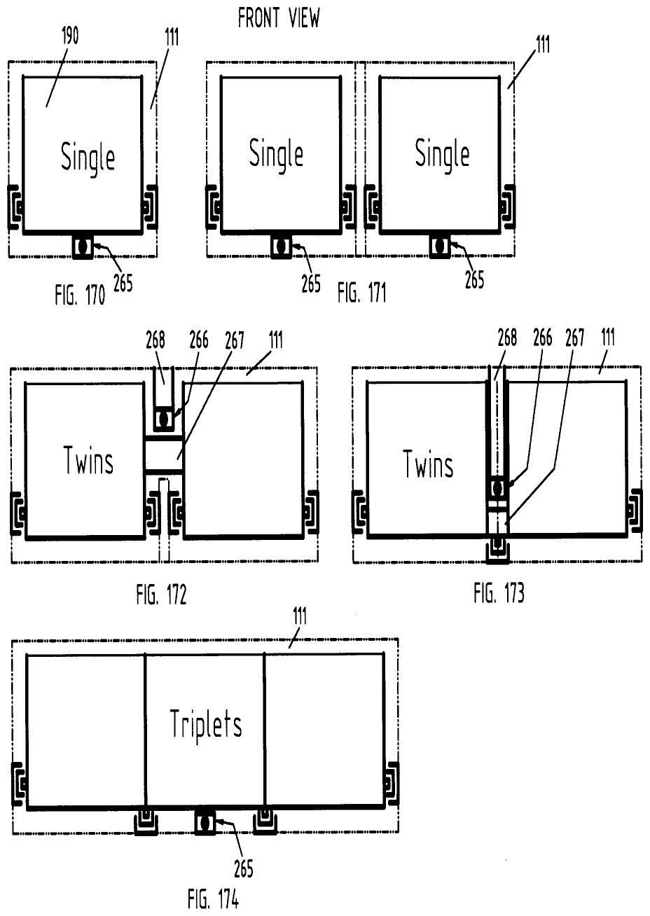

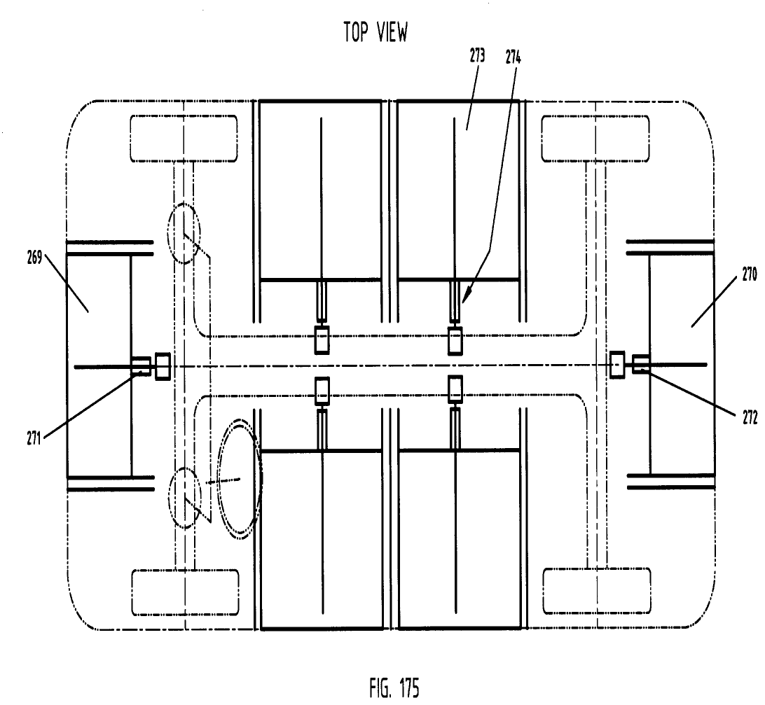

In FIG. 168 is illustrated schematically a drawer 251, in the IN position, which is moved IN & OUT by a screw & nut mechanism, where the actuator 252, via a coupling element 253, turns the threaded rod 254 and moves IN & OUT the nut 255, via means to adjust the drawer travel 256 and means to compensate the variation of the drawer travel 257. In order to increase rigidity of the threaded rod 254, its opposite end slides in a plain bearing 258 attached to the vehicle body 259 by a support 260. In FIG. 169 is shown the same drawer in the OUT position. The drawer travel is controlled for IN position by a proximity sensor 261 and a target 262, and for the OUT position by a proximity sensor 263 and a target 264. In general, the drawers move IN & OUT independently, therefore for each drawer is required a moving IN & OUT mechanism. The advantage of the twins and triplets is the fact that for double or triple compartments is possible to use a unique moving IN & OUT mechanism, reducing the cost and the required space for installation. More than that, for the lateral drawers (left and right side of the vehicle) is possible to use the same actuator for both sides.

In FIG. 170 to FIG. 174 are shown generic set-ups for different kind of drawers. For the SINGLE and TRIPLETS drawers having side slides, the moving IN & OUT system 265 is positioned underneath of the drawers. For single and triplets drawers, in order to balance the drawer during the pulling/pushing action, is recommended to install the moving IN & OUT mechanism in the middle of the drawer, like in FIG. 170, FIG. 171 & FIG. 174. The support 265 of the opposite end of the threaded rod is attached on the bottom of the drawer compartment of the vehicle 111. For the TWINS drawers, for the both versions (with double side slides and side and bottom slides), the moving IN & OUT system 266 is positioned between the two drawers, above the traverse 267, which links the two drawers. The support 268 of the opposite end of the threaded rod is attached on the top of the drawer compartment of the vehicle 111.

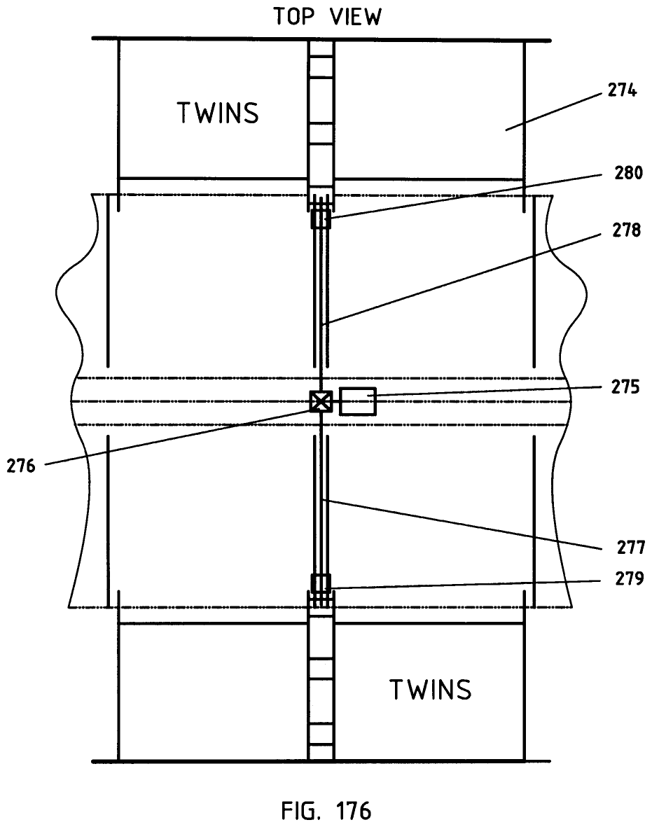

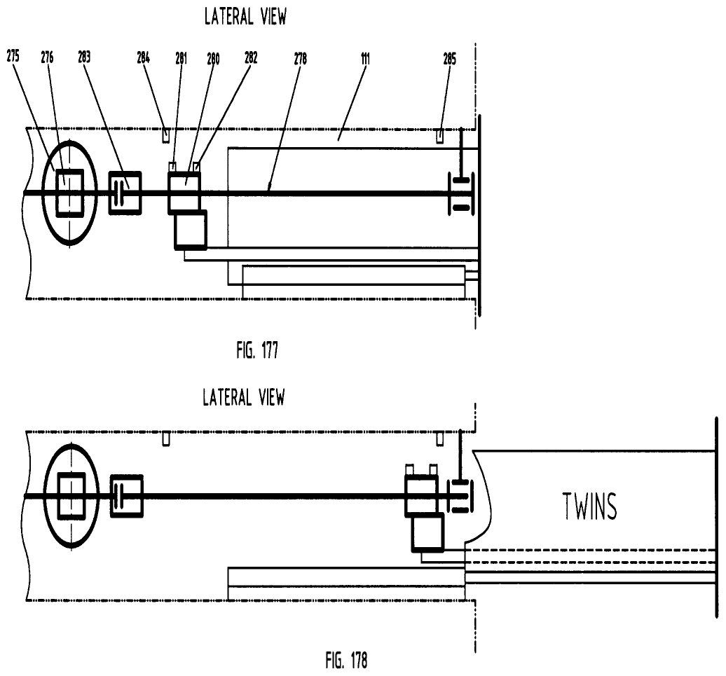

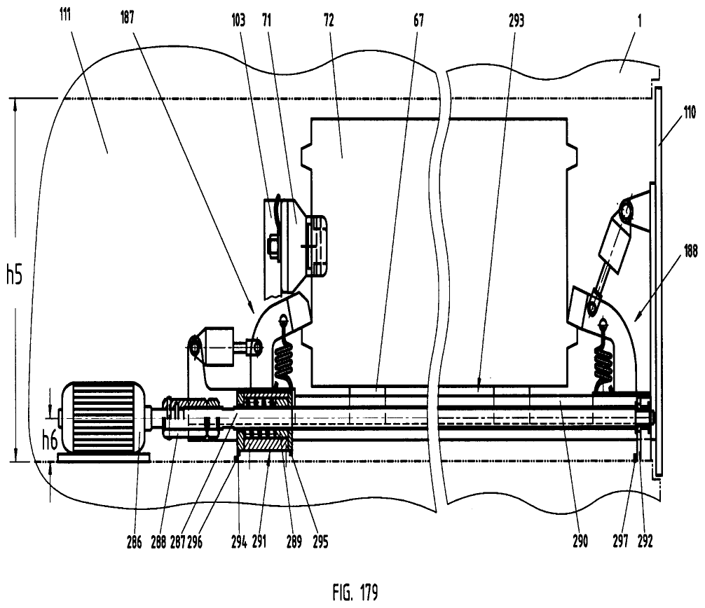

In FIG. 175 is shown a generic set-up of individual moving IN & OUT system for different drawer locations on an electric vehicle. For the front and the rear drawers are used single drawers 269 & 270 with individual moving IN & OUT mechanisms, respective 271 & 272. The lateral single drawers 273 are moved IN & OUT by an individual mechanism 274. For the lateral drawers, preferentially may be used a twins version of drawers 274, as seen in FIG. 176, FIG. 177 and FIG. 178, where the moving IN & OUT system is installed between the two compartments, having a unique actuator 275, which, via a gear box 276 turns the transmission elements (in this case a threaded rod) 277 and 278. Both threaded rods 277 & 278 have the same kind of thread (right or left helix) for both sides of the vehicle, for the same direction of rotation of the actuator 275. Each drawer is attached to a moving element 279 and respective 280. The principle of a moving IN & OUT system for TWINS is illustrated in a lateral view in FIG. 177 (IN) and in FIG. 178 (OUT). The transmission element 278 is connected to the gear box shaft by a connecting element 283, which combines a coupling and a drawer travel adjusting device. The moving IN & OUT element 280 comprises as well a travel compensation mechanism. The proximity sensors 281 and 282 are installed on top side of the moving element 280 and the targets 284 and 285 are fixed on the ceiling of the drawer compartment of the vehicle 111.

In FIG. 179 to FIG. 185 are presented embodiments of different versions of a moving IN & OUT system using a screw & nut mechanism. In FIG. 179 is illustrated an embodiment of an individual moving IN & OUT system, using a screw and nut mechanism with an electric motor 286 with horizontal axes in line with the threaded rod 287. The shaft of the electric motor 286 is attached to the threaded rod 287 by a sub-ensemble 288. The nut 289 is attached to the drawer frame 290 via a travel compensation mechanism 291. The opposite end of the threaded rod is supported by a supporting sub-ensemble 292. In order to minimize the height of the drawer, the threaded rod may be installed close to the battery package 72, interrupting the battery package supports 67 for a portion. The entire moving IN & OUT mechanism is protected by a covet 293, which is attached to the drawer floor, closing the drawer. The proximity sensors 294 & 295 are positioned on the bottom of the travel compensation mechanism 291 and the targets 296 & 297 are installed on the floor of the drawer compartment 111 of the electric vehicle 1. The disadvantage of this first version consists in the fact that overall height of the drawer h5 is too great in comparison with the battery package, due to the height h6 of the motor axes.

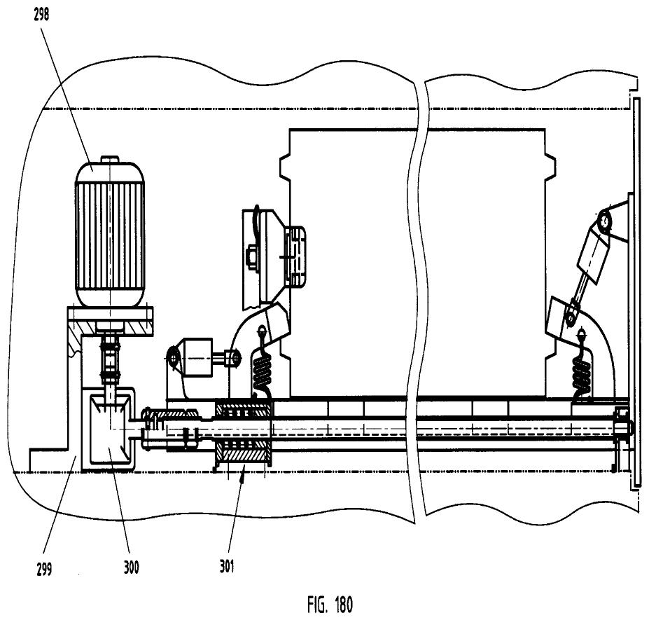

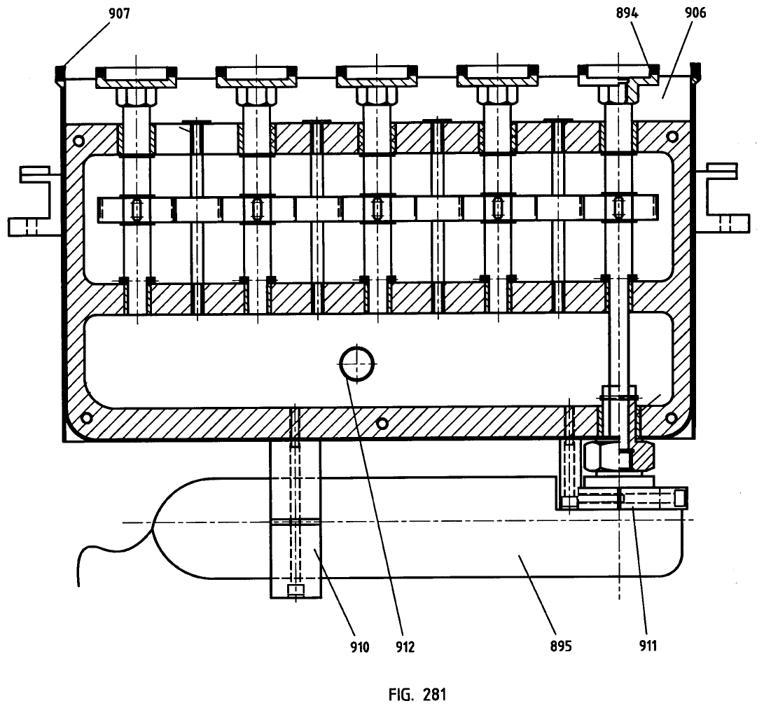

This impediment may be solved by using an electric motor installed with the axes in vertical direction. An embodiment of this second version is shown in FIG. 180, where the electric motor 298 is installed on the drawer compartment floor of the electric vehicle by the support 299 with the axes in vertical position. By a gear box 300, the rotation is changed in a horizontal direction and coupled to the moving IN & OUT mechanism 301 presented here before. An embodiment of lateral twins drawers 302 & 303 is illustrated in FIG. 181, where a unique electric motor 304, via a coupling mechanism 305 and a gear box 306, turns both transmission mechanisms of the opposite drawers 302 and 303, each one comprising: a combined coupling and adjusting system 307, a threaded road 308, a nut and a travel compensation mechanism sub-ensemble 309.

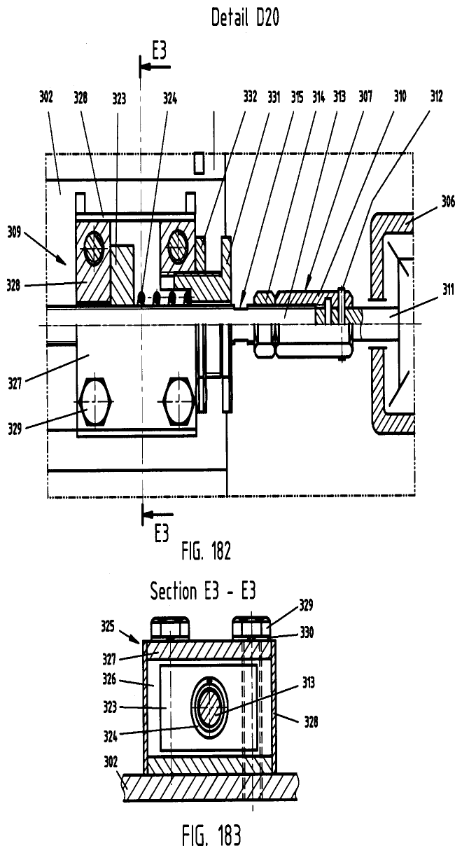

The travel compensation mechanism sub-ensemble 309 is illustrated in the Detail D20 in FIG. 182. As can be seen, the 310 component receives the gear box shaft 311 and the spring pin 312 is acting as a coupling element. On the opposite end, this 311 component has an inner threaded portion with the same thread than the threaded rod 313. This allows to adjust the threaded rod in the wright axial position in order to ensure the complete closing of the drawers 302 & 303. After the adjustment is done, the lock-nut 314 secure the threaded rod 313 using the flat portion 315 of the threaded rod 313.

When a unique actuator is used for two different opposite drawers, a travel compensation mechanism, for travel variation, is necessary because it is very difficult to adjust and keep the adjustment in time in order to close both drawers correctly. As can be seen in FIG. 181, a travel compensation mechanism is used in combination with two proximity sensors 316 & 317, for IN position and with two proximity sensors 318 & 319, for OUT position, and with two targets 320 & 321 for IN position and other two targets 322 & 323, for OUT position. The electric motor continue to turn both threaded rods till it receives the signal from both proximity sensors installed on each moving element of each drawer. In this way, after the first signal is received, (for the first drawer closed), the motor continue to turn in order to close the second drawer. But, in this time, is turned also the threaded rod of the first drawer, which moves IN the respective nut, which pushes on an elastic element deforming it.

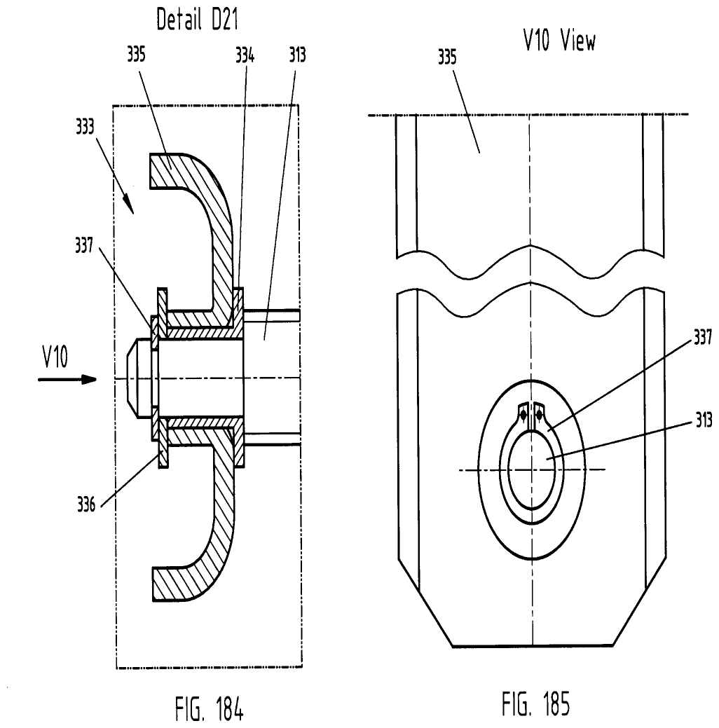

In FIG. 182, which is the Detail D20 of the FIG. 181 is shown an embodiment of the travel compensation system for a screw & nut transmission mechanism, comprising the special nut 323 engaged on the threaded road 313, a compressing elastic element 324 around the threaded rod, a case 325 having the main component 326, a top cover 327 and two lateral covers 328. The case 325 is attached to the drawer 302 by attaching means which may be the 329 bolts, and the 330 spring washers, see FIG. 183. The compression spring 324 will be deformed by the nut 323 when the drawer is closed (the drawer and the case 325 is not moving anymore), in time that the motor and the threaded rod 313 continue to turn to close the opposite drawer. The force of the elastic element 324 may be adjusted by the special threaded member 331, which engages the elastic element 324 and its threaded portion engages the main member of the case 325. This special threaded member 331 is locked in the right position by a lock-nut 332. The FIG. 183 is a cross section E3-E3 of the sub-ensemble 309 shown in FIG. 182. The FIG. 184, which is the Detail D21 of FIG. 181, illustrates the design of the sub-ensemble 333, which supports the opposite end of the threaded rod 313. This sub-ensemble 333 comprises a plain bearing 334, supported by the support 335 attached to the vehicle body. The washer 336 and the retaining ring 337 secure the threaded rod 313, see FIG. 185 as well.

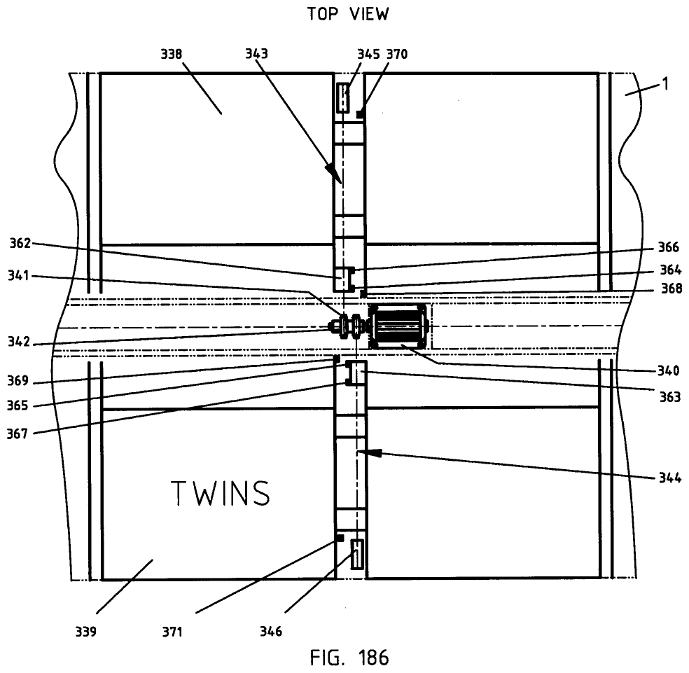

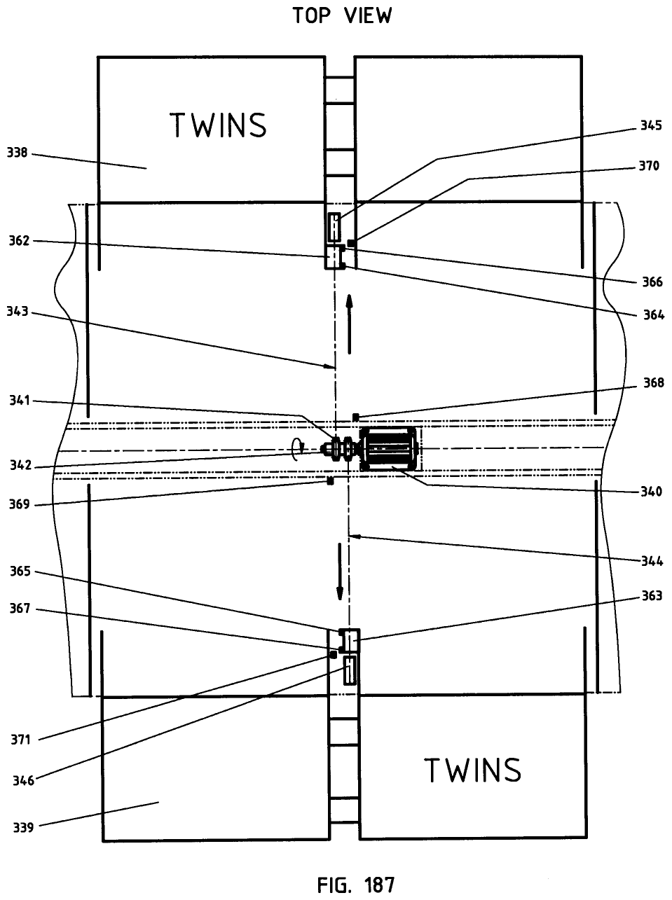

Another possibility to move IN & OUT the drawers is to use as moving IN & OUT mechanism a roller chain system. The most obvious application of this principle is for lateral TWINS drawers. As illustrated in FIG. 186 and FIG. 187, between the opposite drawers 338 & 339 of an electric vehicle 1, such a system comprises an actuator 340 positioned in the middle of the vehicle between the drawers, having horizontal axes on the longitudinal direction of the vehicle, a double-stand roller chain sprocket 341 mounted on the actuator shaft 342 and for each drawer a chain 343 & 344 engaged with the double-stand roller chain sprocket 341. For each chain there is a chain tensioner 345 & 346 installed on the vehicle body close to the drawer entrance. In FIG. 186 and in FIG. 187 is shown as well, a moving element 362 & 363 for each side, attached on each of the roller chains 343 & 344, which includes a travel compensation mechanism. On the moving element 362 is installed a proximity sensor 364 for IN position and another proximity sensor 366 for OUT position. On the opposite moving element 363 is installed a proximity sensor 365 for IN position and another proximity sensor 367 for OUT position. On the vehicle body is installed on each side a target 368 & 369 for IN position and a target 370 & 371 for OUT position, see FIG. 186 for drawer IN and FIG. 187 for drawer OUT.

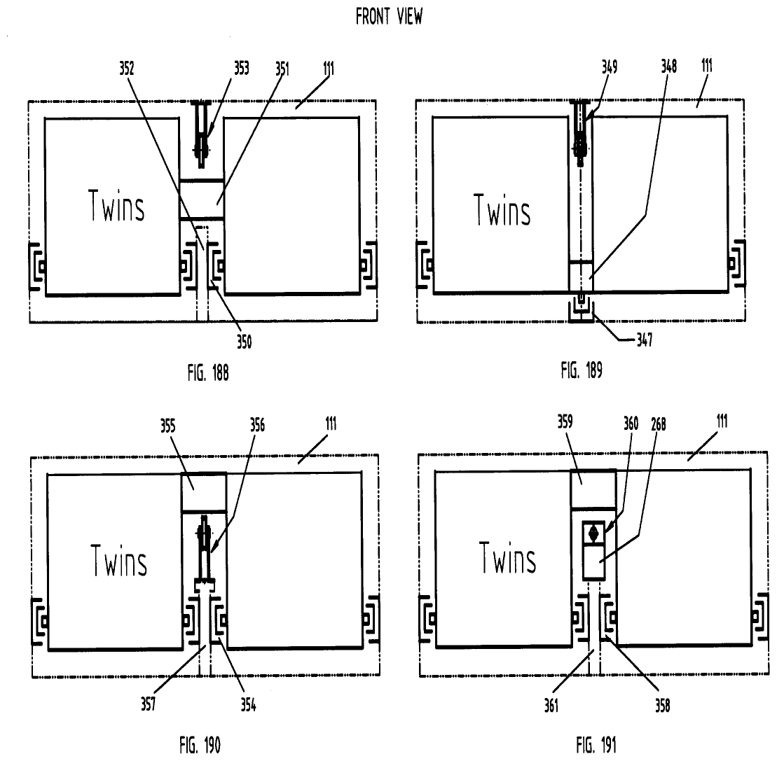

Depending on the type of slides used and on the way the two drawers of the TWINS are linked, there two possibilities to attache the chain tensioner to the vehicle body. If the side slides 350 are used on the middle of the TWINS drawer, see FIG. 188, by linking the two drawers using the traverses 351 placed on the bottom, near to the slides support 352, the sub-ensemble chain tensioner 353 has to be placed between the two drawers, above the traverses 351, and it has to be attached on the ceiling of the drawer compartment of the electric vehicle 111. As seen in FIG. 189, if the middle slide is a bottom mounted slide 347, and the two drawers are linked by a traverse 348, placed on top of the bottom mounted slide 347, the only possibility is to attache the chain tensioner 349 on the ceiling of the drawer compartment of the electric vehicle 111. If the side slides 354 are used on the middle of the TWINS drawer, as shown in FIG. 190, by linking the two drawers by traverses 355 placed on the superior portion of the drawers, the sub-ensemble chain tensioner 356 has to be placed between the two drawers and has to be attached underneath of the traverses 355, on the slides support 357, which is solidly attached to the floor of the drawer compartment of the electric vehicle 111.

Applying the same principle for the moving IN & OUT mechanism screw & nut, as seen in FIG. 191, in case when the side slides 358 are used for TWINS drawers, linked by traverses 359 placed on the superior portion of the drawers, the sub-ensemble of the moving element 360 has to be placed between the two drawers and has to be attached underneath of the traverses 359, on the slides support 361, which is solidly attached to the floor of the drawer compartment of the electric vehicle 111.

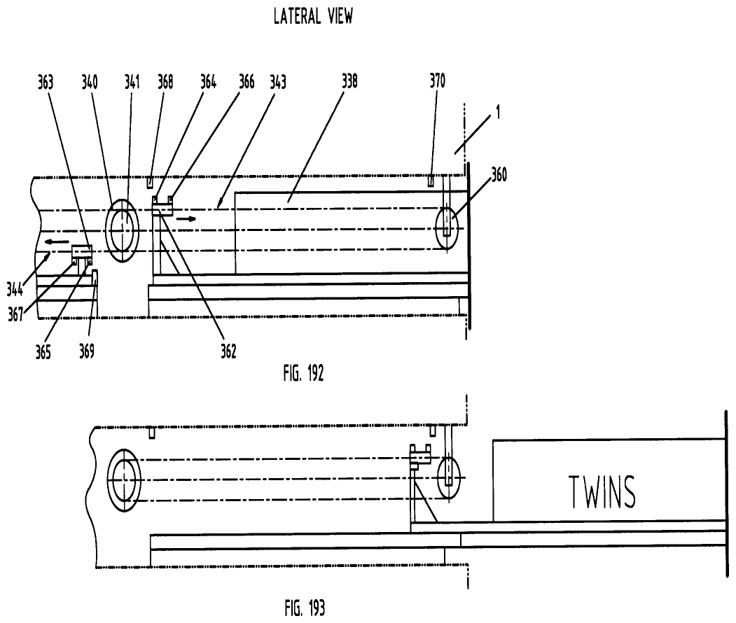

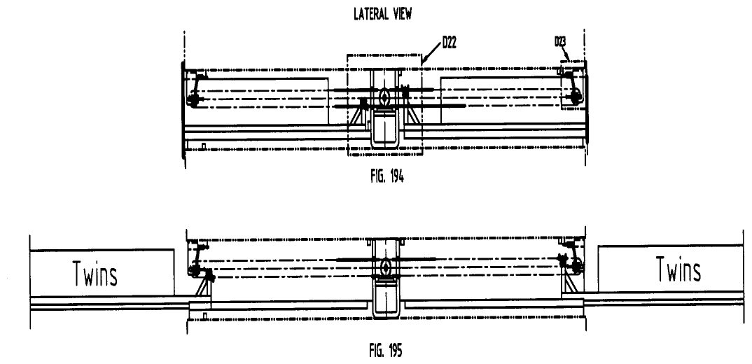

The principle of twins drawers moved IN & OUT by a chain mechanism is illustrated in FIG. 192 & FIG. 193, which are partial lateral views of these moving IN & OUT systems.

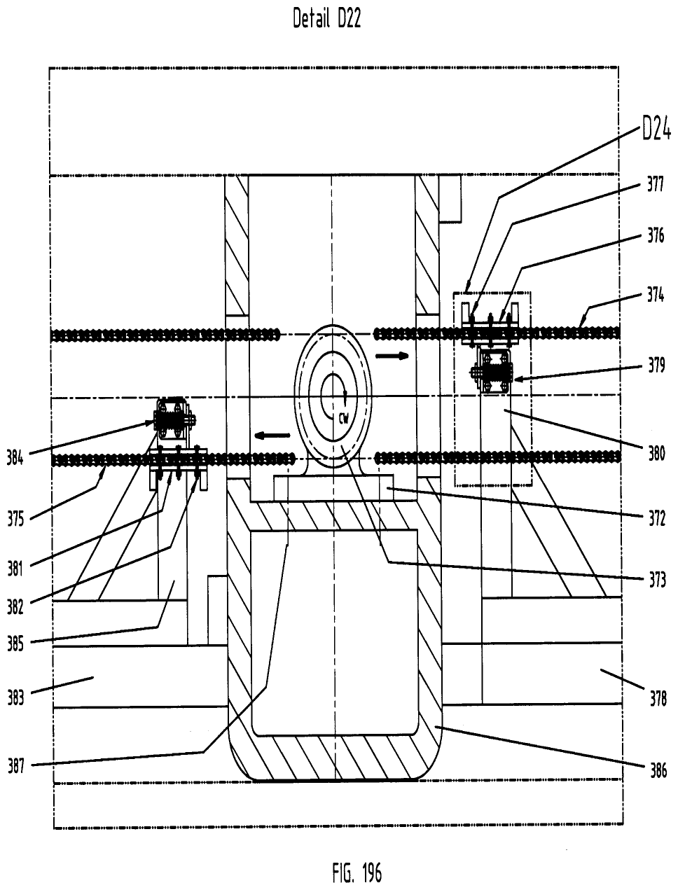

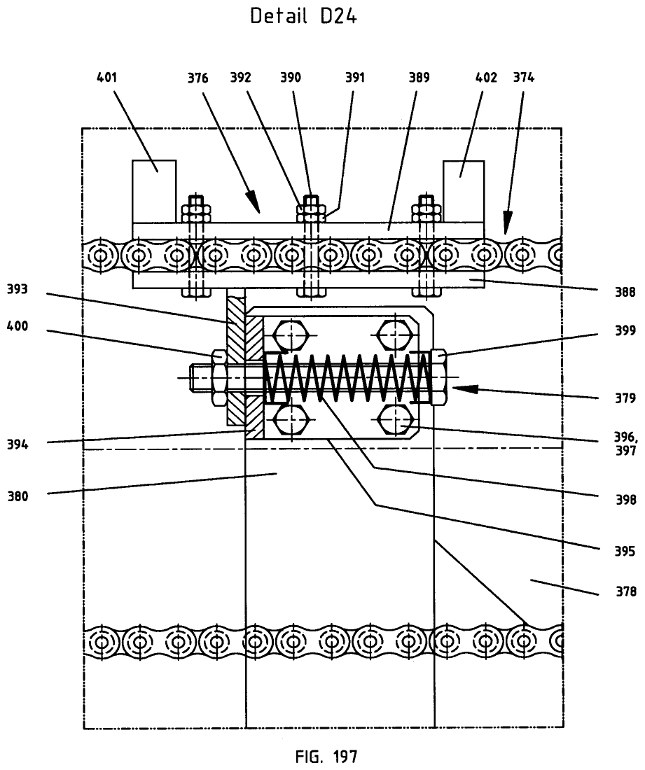

Applying this principle, in FIG. 194 & FIG. 195 is shown, in a lateral views, an embodiment of a roller chain IN & OUT system for TWINS drawers. The FIG. 196 is the Detail D22 of FIG. 194, representing the electric motor 372 turning CW the double-stand roller chain sprocket 373, which moves the chain top line 374 to the right, and the chain bottom line 375 to the left. The moving element sub-ensemble 376 attached to the chain top line 374 by attaching means 377, and to the drawer 378 via a travel compensation mechanism 379 and via the drawer frame 380, moves the drawer 378 OUT. On the opposite side, the moving element sub-ensemble 381 attached to the chain bottom line 375 by attaching means 382, and to the drawer 383 via a travel compensation mechanism 384 and via the drawer frame 385, moves the drawer 383 OUT, in the same time with the drawer 378. The electric motor 372 is installed on the central structural element of the vehicle body 386, by attaching means 387. The FIG. 197 is the Detail D24 of FIG. 196, illustrating the moving element sub-ensemble 376 and its attachment to the chain top line 374 and to the drawer frame 380 via the travel compensation mechanism 379. Therefore, the moving element sub-ensemble 376 comprises a “T” shaped element having one arm 388 attached to the chain 374 using an opposite plate 389 and a plurality of bolts 390, nuts 391 and lock-nuts 392.

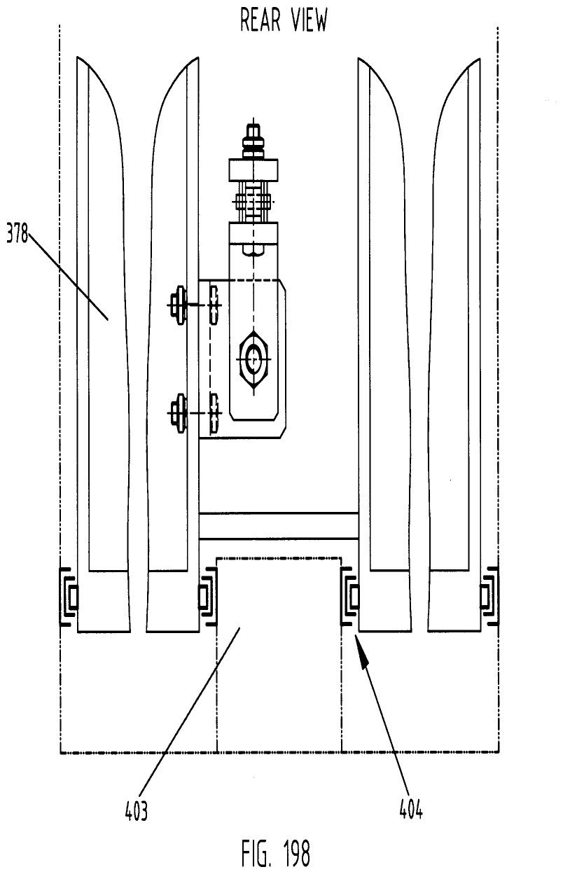

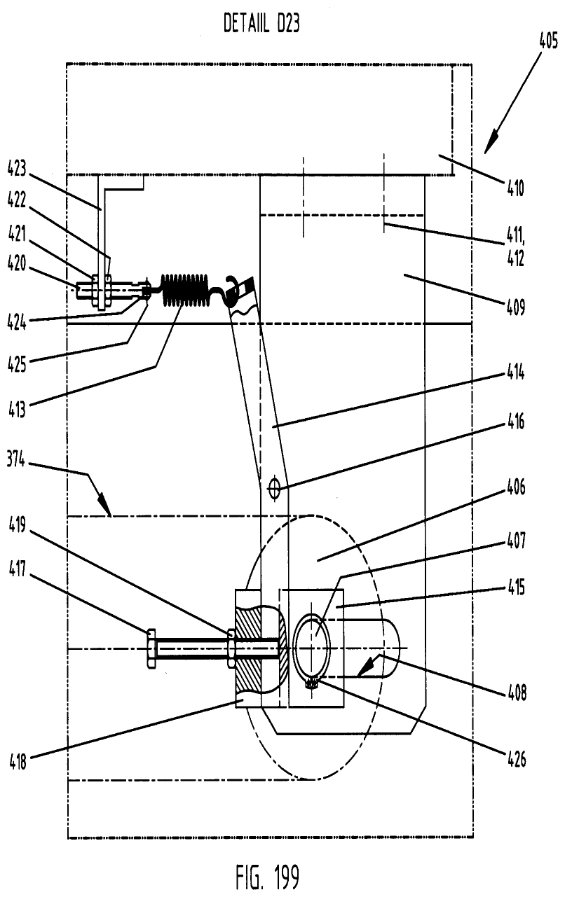

Another arm 393 of the “T” shaped element is elastically attached to the travel compensation mechanism sub-ensemble 379 in a way that it is in firm contact with the 394 stand on the rear side of the stand. This 394 stand is one side of a “L” shaped plate 395, which is attached with another side to the drawer 378 via the drawer frame 380 by attaching means, like bolts 396 and spring washer 397. When the electric motor turns CW, the arm 393 of the “T” shaped element, which is in firm contact with the stand 394, on its rear side, pushes out the drawer 378. In reverse, when the electric motor turns CCW, the moving element sub-ensemble 376 attached to the chain 374 moves in opposite direction, pulling IN the drawer 378 via an elastic element 398, which is compressed if necessary. The tension of the compression elastic element 398 may be adjusted by adjusting means, comprising a bolt 399 threading into the stand 394 and locked into a firm position by the lock-nut 400. On top of the plate 389 are installed two proximity sensors 401 for IN position and 402 for OUT position. The FIG. 198 is a rear view of a TWINS drawer 378 on which can be seen the majority of components described here before. Is also shown the support 403 of two side slides 404 placed in the middle of the TWINS drawer, solidly attached to the vehicle body. The FIG. 199 is the Detail D23 of the FIG. 194 showing the embodiment of a chain tensioner mechanism 405 comprising a one-stand roller chain sprocket 406 engaging the chain 374 which turns around the shaft 407. The shaft 407 slides inside of the oval channel 408 made on the “U” shaped support 409, which is attached to the electric vehicle body 410 by attaching means like bolts 411 and spring washer 412. The tension on the sprocket is done by the force created by an elastic element, which in this embodiment is a tension spring 413, acting on the articulated arm 414, which pushes the sprocket 406 via two components 415 mounted on the two extremities of the shaft 407. The articulated arm 414 with a pressed-fit pin 416 in its articulation hole, slides into an articulation hole of the “U” shaped support 409. In this embodiment the adjustable element of the sprocket position is a bolt 417, which is threaded into the plate 418 solidly attached to the articulated arm 414. The bolt 417 is locked in the wright position by the lock-nut 419. The tension of the spring 413 may be adjusted by a tension adjusting element, which in this embodiment is a threaded rod 420 and the nut 421, locked in the wright position by the lock-nut 422. The tension adjusting element is supported by the “L” shaped component 423, which is attached solidly to the vehicle body 410. The tension force of the spring 413 may be amplified by the articulated arm 414 by choosing the adequate position of the articulation. The elastic element 413 is attached to the threaded rod 420 by a fork shape end 424 of the threaded rod and a spring pin 425. The retaining ring 426 keeps together all the components mounted on the 407 shaft.

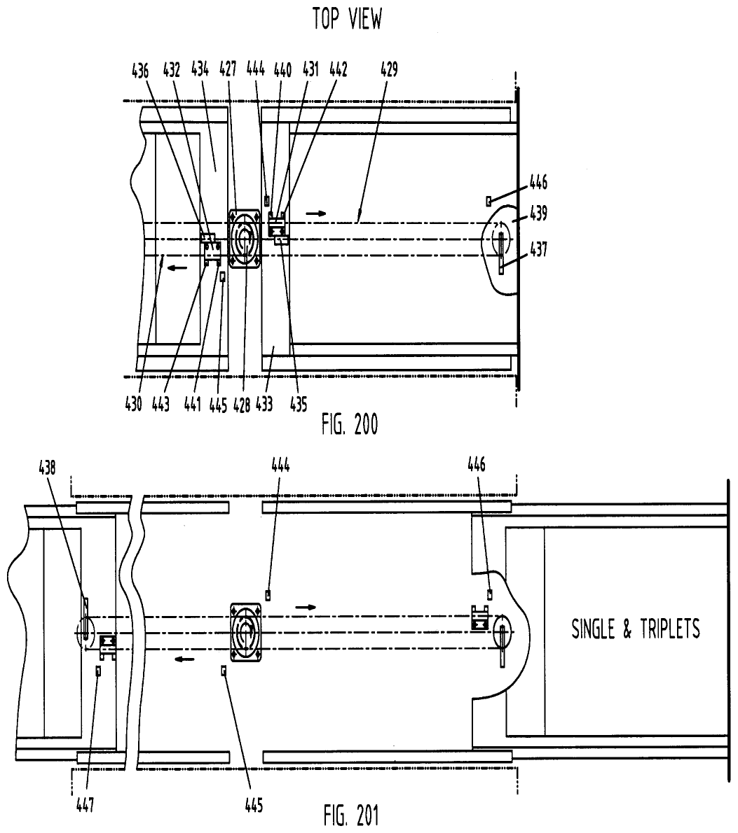

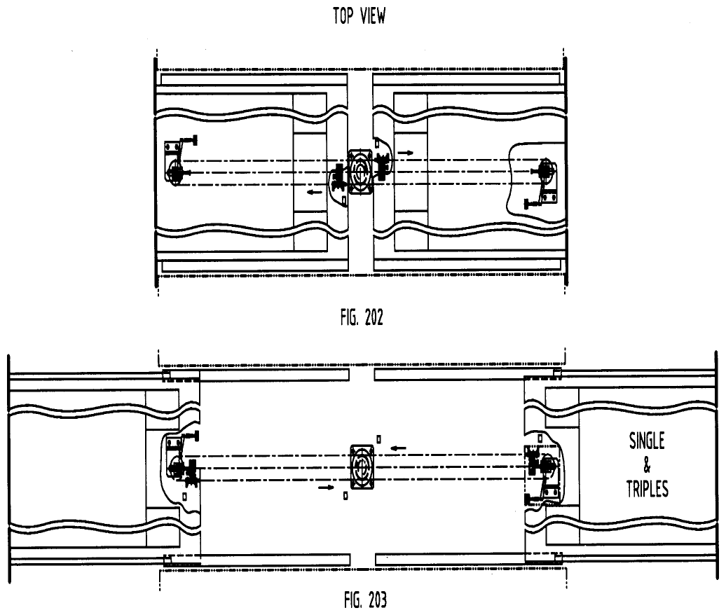

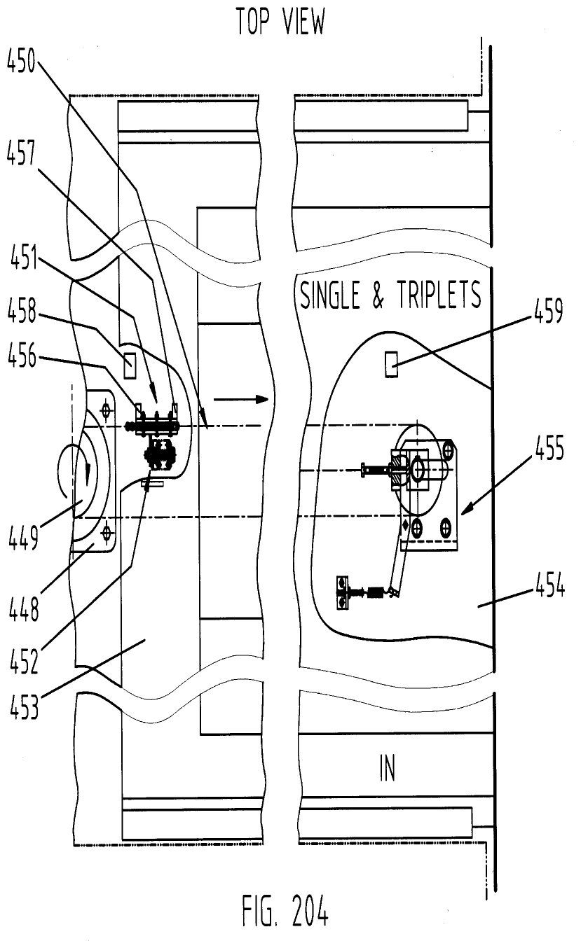

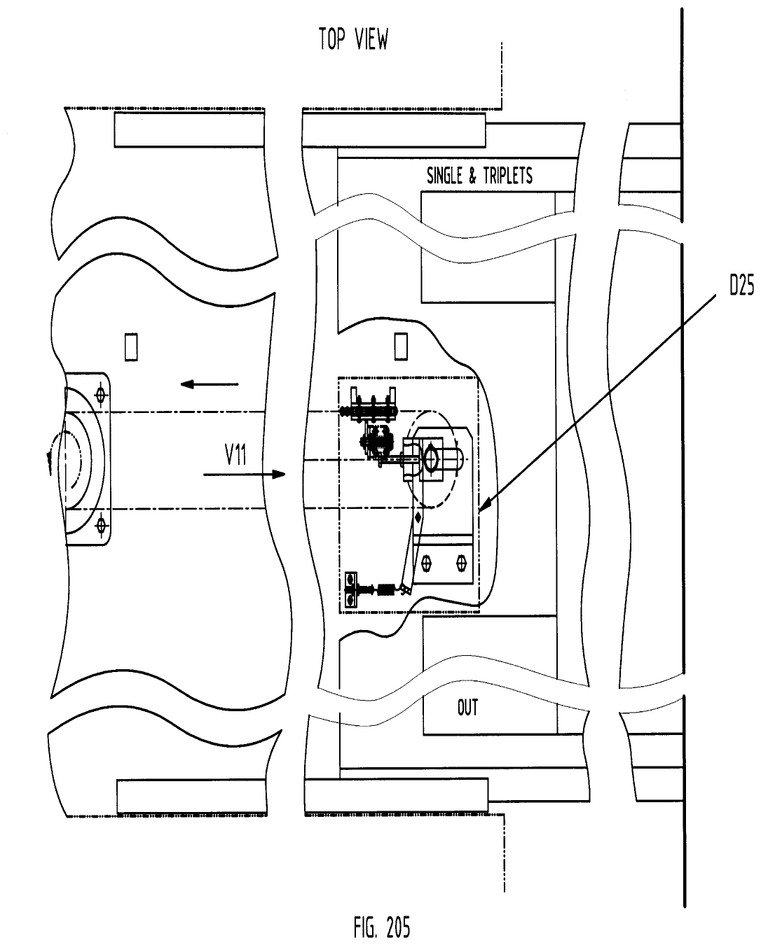

For the SINGLE drawers, in order to minimize the height of the drawer, the moving IN & OUT mechanism uses a chain acting in horizontal plan. Therefore, a vertical axes electric motor is required. The principle of a such system is shown in FIG. 200 & FIG. 201, where the electric motor 427 turns the double-stand roller chain sprocket 428, which engage the chains 429 and 430, on which the moving elements 431 & 432 are attached. The moving elements 431 and 432 are attached to the drawer frame 433 & 434 by the travel compensation mechanism 435 & 436. A pair of chain tensioners 437 & 438 are installed solidly to the vehicle body 439 in the opposite position, closed to the drawer outing. In order to control the IN & OUT drawer positions, a proximity sensors 440 and 441 for IN and 442 and 443 for OUT position are installed on each moving element 431 &, 432 working with the two pairs of targets 444 & 445 for IN and 446 & 447 for OUT position. In FIG. 202 & FIG. 203 is illustrated an embodiment of this principle for SINGLE and TRIPLES drawers. The FIG. 204 & FIG. 205 are partial top views of this embodiment showing the drawer in the IN and the OUT position. For this embodiment is illustrated the electric motor having a vertical axes 448, the double-stand roller chain sprocket 449 engaging the chain 450, on which is attached the moving element sub-ensemble 451 combined with a travel compensation mechanism 452, which is attached to the drawer frame 453. On the entrance of the drawer, is installed on the floor of the battery compartment of the vehicle 454 a chain tensioner sub-ensemble 455. On the moving elements sub-ensemble 451 are installed the proximity sensors 456 for IN position and 457 for OUT position. On the floor of the battery compartment of the electric vehicle are adjustable installed the targets 458 for IN position and 459 for OUT position.

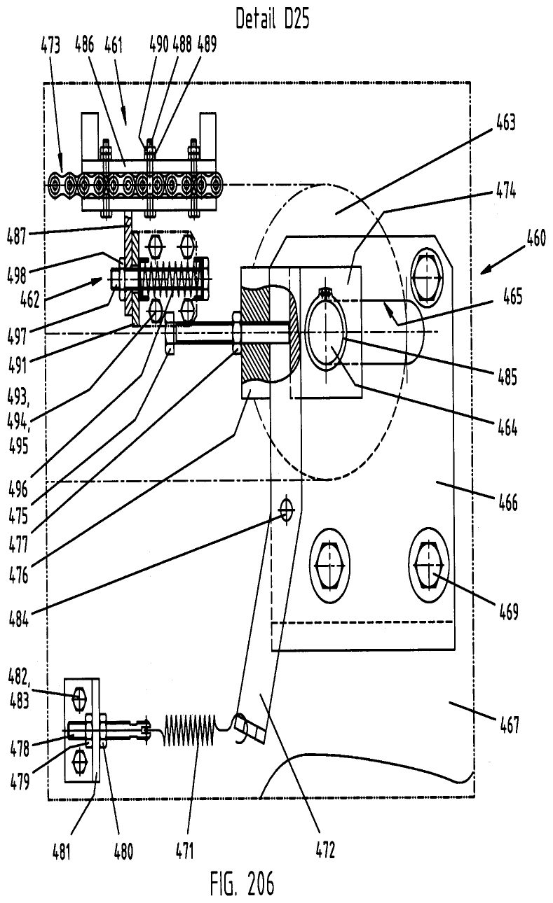

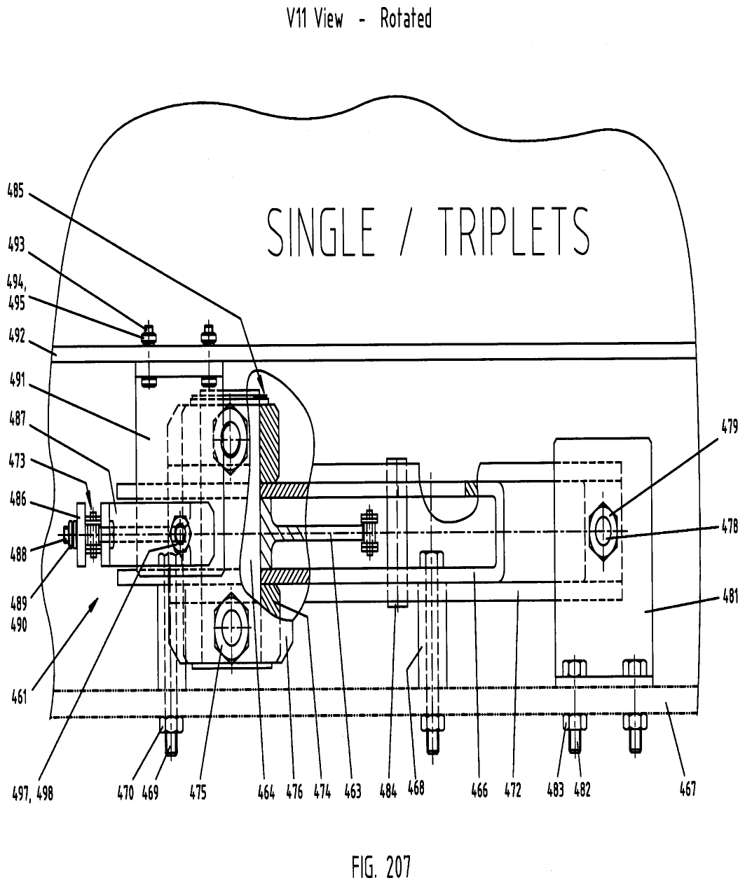

In FIG. 206 is shown the Detail D25 of the FIG. 205 illustrating the embodiment of the chain tensioner mechanism sub-ensemble 460, the moving element sub-ensemble 461 and the travel compensation mechanism sub-ensemble 462, for the OUT position of the drawer (see FIG. 205). The design of these components is illustrated as well in the V11 view shown in FIG. 207, which is a rear view of the drawer and the moving IN & OUT mechanism. In FIG. 206 & FIG. 207 can be seen the single-stand roller chain sprocket 463, mounted on the shaft 464, which can slide in the oval slot 465 of the “U” shaped support 466 mounted on the floor of the battery compartment of the electric vehicle 467 using a plurality of spacers 468, a plurality of bolts 469 and a plurality of nuts 470 welded on the bottom side of the vehicle floor 467 (see FIG. 207). The tension on the sprocket is done by the force created by the elastic element 471, which in this embodiment is a tension spring, acting on the articulated arm 472, which pushes the sprocket 463 to tension the roller chain 473, via two components 474 mounted on the two extremities of the shaft 464. The position of the sprocket 463 has to be adjustable. In this embodiment, the adjustable element of the sprocket position is a bolt 475, which is threaded into the plate 476, which is solid attached to the articulated arm 472. The bolt 475 is locked in the wright position by the lock-nut 477. The tension in the spring 471 may be adjusted by an adjusting element, which in this embodiment is a threaded rod 478 and the nut 479, locked in the wright position by the lock-nut 480.

The adjusting element is supported by the “L” shaped component 481, which is attached to the floor of the battery compartment of the electric vehicle 467 by attaching elements, which are in this embodiment a plurality of bolts 482 and the nuts 483 welded on the vehicle body 467. The tension force of the spring 471 may be amplified by the articulated arm 472 by chosen the adequate position of the articulation realized by the pin 484. The pin 484 is pressed-fit into the articulated arm 472 and they slide inside of a hole made in the 466 support. All the components mounted on the 464 shaft are kept together by the retaining ring 485. In FIG. 206 & FIG. 207 is illustrated also, the moving element sub-ensemble 461 comprising a plate 486 and a “T” shaped component 487, which are attached on the top line of the roller chain 473 by attaching elements, in this embodiment a plurality of bolts 488, nuts 489 and lock-nuts 490. The “T” shaped component portion, which is normal to the roller chain 473 is in contact with the “L” shaped member 491, on its rear side. The “L” shaped member 491 is attached to the bottom side of the drawer floor 492, by the attaching elements, which in this embodiment are a plurality of bolts 493, nuts 494 and spring washer 495, see FIG. 207. In order to compensate the drawer travel, when it is retracted, an elastic mechanism is used, comprising an elastic element, which may be a compression spring 496 mounted on an adjustable tension element which may be a bolt 497, threaded into the normal member to the chain of the “T” shaped component 487, locked in the wright position by a lock-nut 498. This mechanism allows to the moving element sub-ensemble 461 to be retracted after the drawer cover is in contact with the vehicle body (the drawer is closed) and the electrical motor continues to turn in order to close the opposite drawer. For multiple-level drawers an individual moving IN & OUT mechanism per each level is required.

Each drawer has to be equipped with a security device, in order to make sure the drawer doesn't open accidentally. For this purpose the principle consists in using a locking mechanism activated by an elastic element for closed position, a powered actuator for automate opening and a manual opening mechanism to open the drawer when the powered actuator doesn't work. There are a plurality of possibilities to design this security device, as following: sliding or articulated locking mechanism, electric or pneumatic actuator, compression or tension elastic element, rigid or flexible manual opening mechanism.

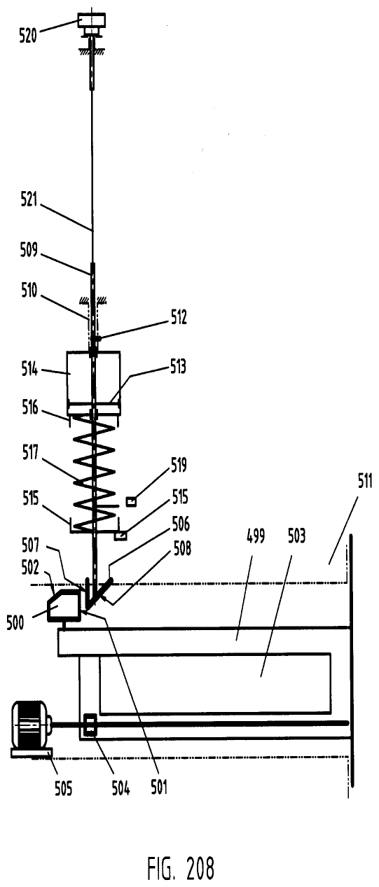

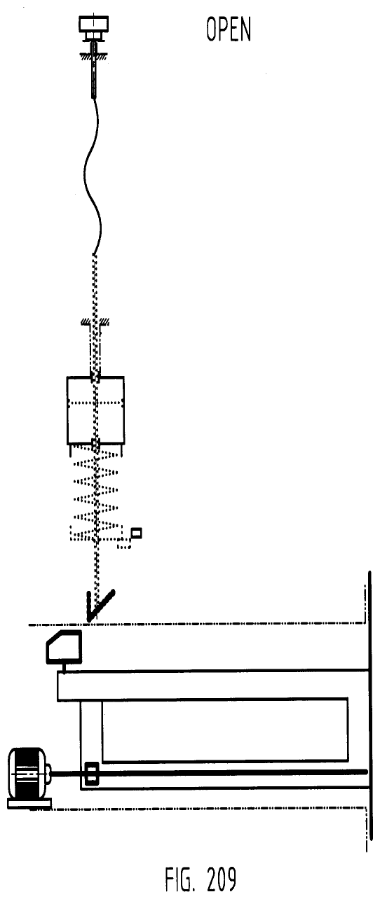

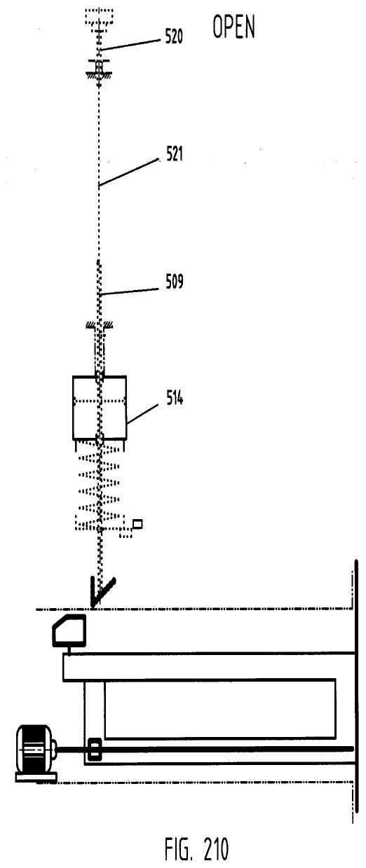

For the drawers moved IN & OUT by an independent moving IN & OUT system, the principle of a security device is illustrated in FIG. 208, comprising a sliding locking mechanism, an electromagnet actuator, a compressing elastic element and a manual opening mechanism using a flexible element. As can be seen, on the drawer frame 499 is solidly attached a shoulder kind element 500, having the front drawer side vertical flat surface 501 and a taper top surface 502. The drawer 503 is moved IN & OUT by a moving IN & OUT mechanism 504 activated by the electric motor 505. The sliding locking mechanism comprises a stopper 506, having opposite to the vertical flat surface 501 of the shoulder element 500 a vertical flat surface 507, and on the bottom a taper surface 508. This stopper 506 is rigidly attached to a sliding central rod 509, which slides into the sliding element 510 integrated to the electric vehicle body 511. The sliding rod 509 is prevented from rotation by the pin 512 sliding into a longitudinal slot of the sliding element 510. On the sliding rod 509 is rigidly attached the moving element 513 of the electromagnet 514 and as well the spring cup 515, near the stopper 506. Another cup spring 516 is installed on the electromagnet case and between the two cups is mounted the compression spring 517. The compression spring 517 pushes the stopper 506 via the cup spring 515 and the sliding rod down, in a way that the flat surface 507 is facing the flat surface 501 of the shoulder 500, securing the drawer. The travel of the sliding rod 509 is controlled by the length of the longitudinal slot in which the pin 512 is moving. When the electric motor 505, via a moving IN & OUT mechanism 504 moves IN the drawer, the top taper surface 502 of the shoulder element 500 pushes the stopper 506 on the taper surface 508 and compresses the compression spring 517, via sliding rod 509 and the cup spring 515. Continuing the drawer moving IN, after the flat surface 501 of the shoulder element 500 passes the flat surface 507 of the stopper 506, the spring 517 pushes the stopper 506 down in its lower position, where the flat surface 507 faces flat surface 501. In case that there are any accidentally situation when the drawer is not retained anymore by the moving IN & OUT mechanism, the drawer can not go OUT because to the stopper 506, which is down. Before the motor 505 receives the commend to move OUT the drawer 503, the electromagnet 514 is activated, pooling the sliding rod 509, compressing the spring 517 and retracting the stopper 506. In order to avoid any collision, on the sliding portion of the sliding mechanism may be installed a proximity sensor 518 and a target 519 on the vehicle body. If the proximity sensor is not activated, the motor does not start. In case that the automate opening system doesn't work, or in an emergency situation, the drawer is unlocked by using the manual opening mechanism, which in this design comprises a sliding element 520, attached to the sliding rod 509 by a flexible element 521. The compression spring 517 keeps the flexible element 521 always tensioned. In FIG. 209, the sliding mechanism is shown in the retracted position by the electromagnet 517, giving free way to the drawer to move OUT. The sliding element 520 is not activated and the flexible element 521 of the manual opening mechanism is not tensioned anymore. In FIG. 210 is illustrated the sliding mechanism retracted by the manual opening mechanism by pooling the sliding element 520, acting on the sliding rod 509 via the flexible element 521, which is tensioned now. It is important for a correct functionality, the sliding mechanism to be activated axially. Therefore, for the manual opening mechanism, the flexible element 521 preferably has to be aligned with the sliding rod 509 and with the sliding element 520, like in FIG. 208, FIG. 209 and FIG. 210.

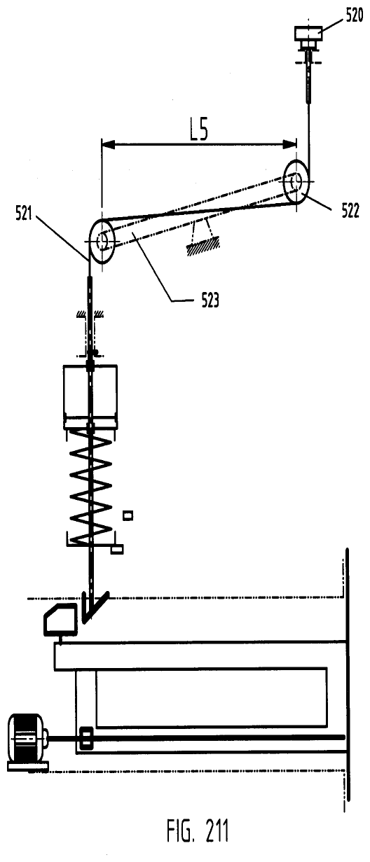

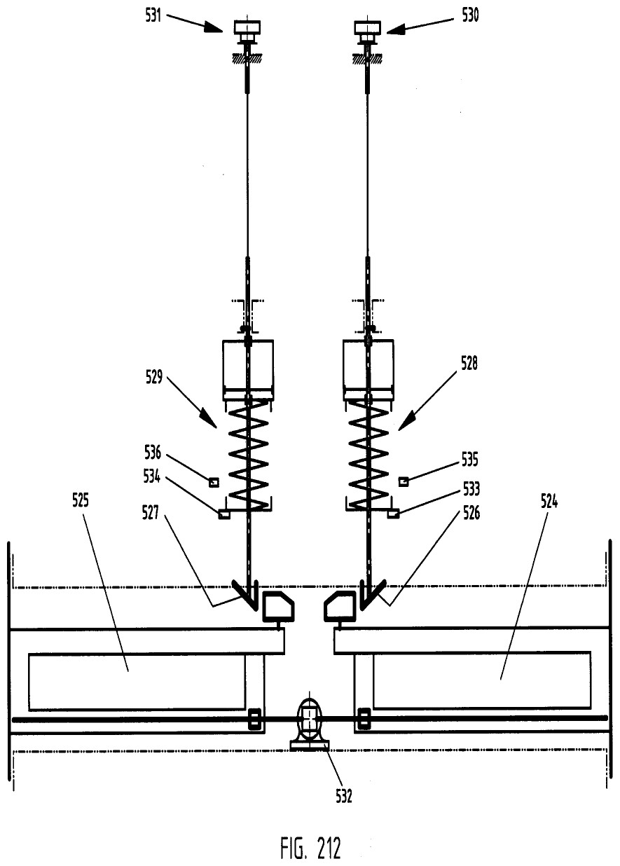

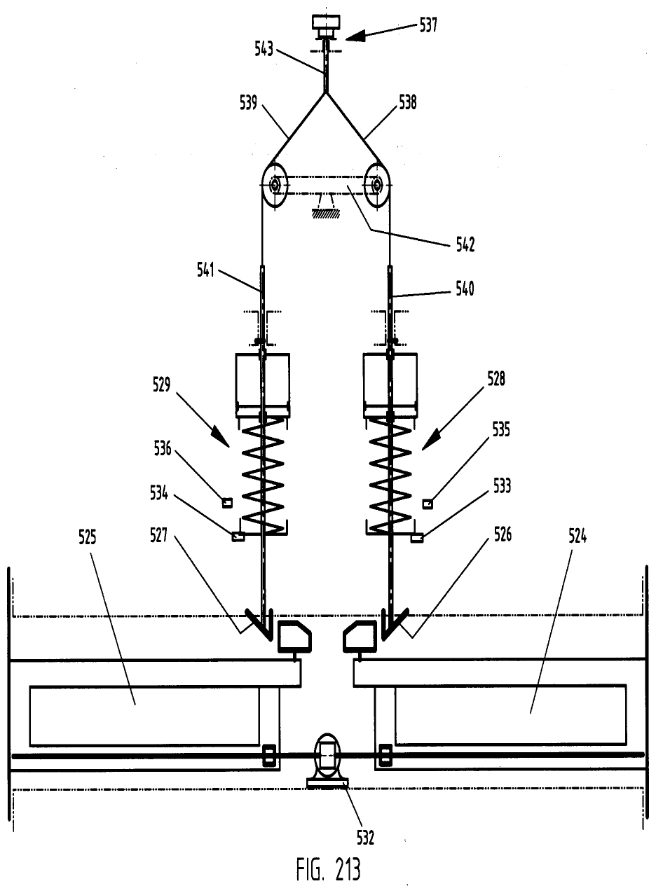

Depending of the configuration of the electric vehicle cabin, the location of the sliding element of the manual opening mechanism is chosen. In case where this location is not possible to be on line with the sliding rod axes, an aligning device may be used, see FIG. 211. This aligning device comprises a plurality of rollers 522 mounted on a rigid element 523 solidly attached to the vehicle body 1. The position of each roll is such that the flexible element 521 is kept in line with the sliding rod 509 by the first roll, near the sliding rod, and the last roll is in position to align the flexible element 521 with the sliding element of the manual opening mechanism 520 installed into the cabin. Depending of the configuration, the distance L5 is established and other rollers may be used between the first and the last roll. For opposite drawers moved IN & OUT both by the same actuator of the moving IN & OUT system, the principle of a security device is illustrated in FIG. 212 and FIG. 213. In FIG. 212, for each drawer, 524 and 525 there is an independent security system each one comprising their own stopper 526 and 527, their own sliding mechanism 528 and 529, and everyone having its own manual opening mechanism 530 and 531. Each security system works independently, but, the common actuator 532 doesn't start to move out the drawers till it receives the signal from both proximity sensors 533 and 534 mounted on the sliding element of each sliding mechanism 528 and 529, after both of them reach the target 535 and 536 confirming the retracted position of the stoppers 526 and 527. In FIG. 213 is illustrated a security system for opposite drawers moved IN & OUT by a common actuator 532, having independent stoppers 526 and 527, independent sliding mechanisms 528 and 529, independent proximity sensors 533 and 534, independent targets 535 and 536, but a common actuator for the manual sliding opening mechanism 537, which is attached to both flexible elements 538 and 539, each of them being attached to the sliding rod 540 and 541 of the respective sliding mechanism 528 and 529. In order to align the flexible elements 538 and 539 with the sliding rods 540 and 541, an alignment device 542 may be used. For balancing the forces in the sliding element 543 of the 537 actuator of the manual opening mechanism, it is recommended a symmetric position of the sliding rods 540 and 541 with respect to the sliding actuator 537. If it is not possible, another rollers may be added to the alignment device 542.

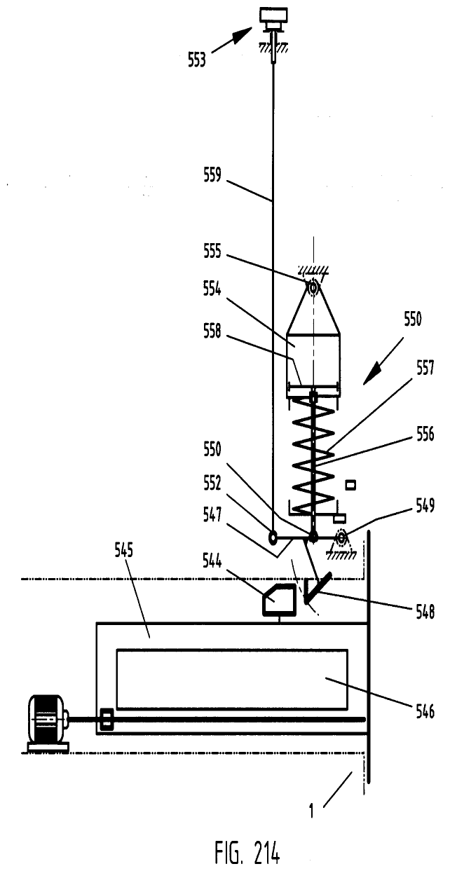

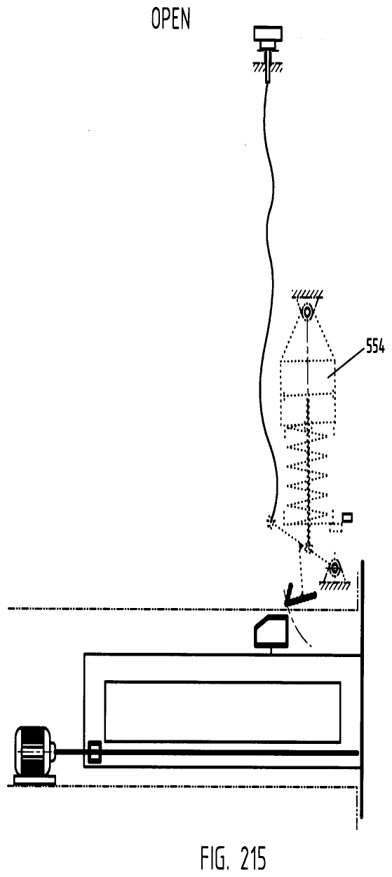

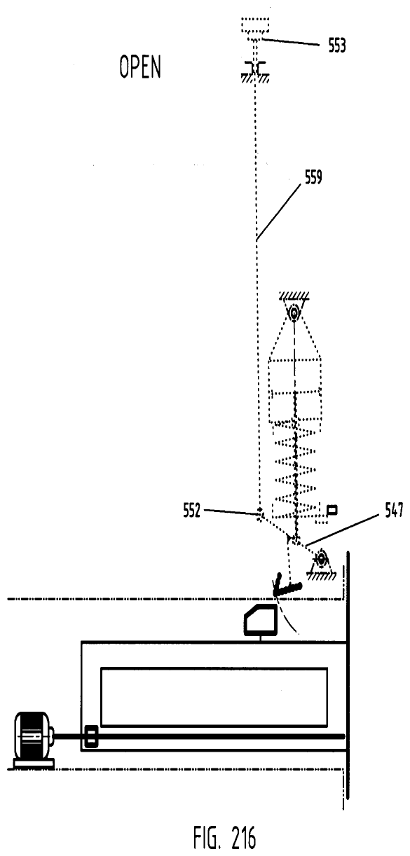

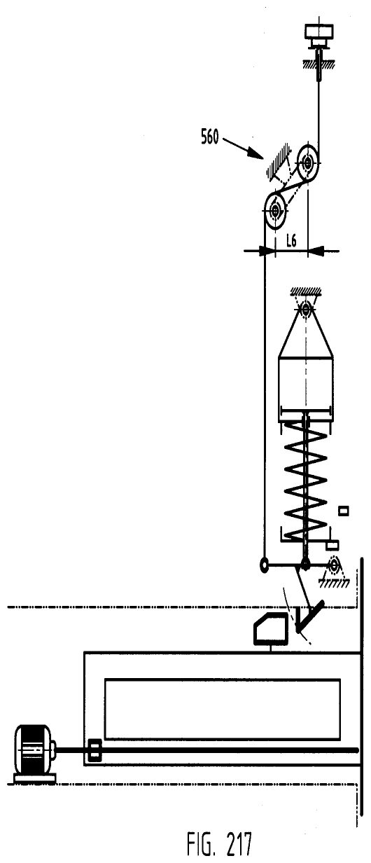

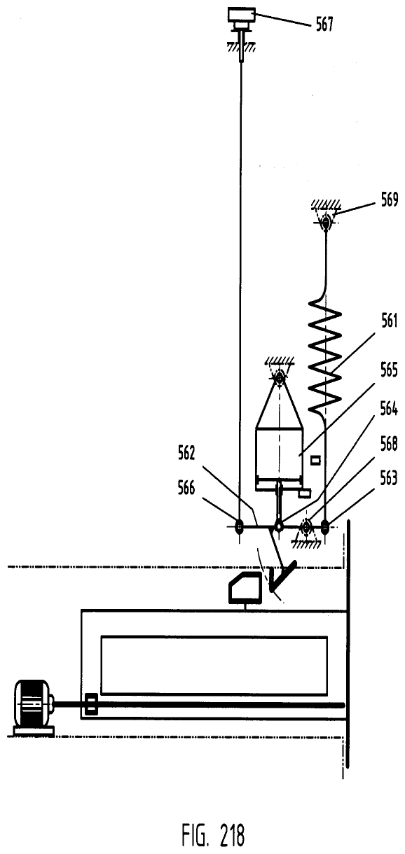

The security system may be also designed using an articulated mechanism as a retaining element, see FIG. 214 to FIG. 221. The principle consists in using an articulated arm turning around an articulation rigidly mounted on the vehicle body, on which is solidly attached a stopper. The stopper is kept in stopping position by an elastic element and is dis-activated by an actuator, which deforms the elastic element and turns the articulated arm to set the drawer free. The articulated arm may be turned out from the vehicle cabin by a manual opening device acting in an accidentally situation. In FIG. 214 is shown a such a security system comprising: a shoulder kind element 544, similar to the shoulder element 500 of FIG. 208, described here before. This shoulder element 544 is rigidly mounted on the drawer frame 545 of the 546 drawer. In the locked position, the articulated arm 547 has a stopping element 548, similar to the stopper 506 of FIG. 208. The aim 547 turns around the articulation 549 mounted on the vehicle body. As seen in FIG. 214, on the arm 547 there are also other two articulations, one 550 for the sliding mechanism 551 and another one 552 for the manual opening device 553. The sliding mechanism 551 comprises an electromagnet 554 having the case attached to the articulation 555 fixed on the vehicle body, and the end of the sliding rod 556 attached to a mobile articulation 550 on the arm 547. Coaxial with the electromagnet sliding rod 556, the compression spring 557 is compressed installed, keeping the sliding element 558 of the electromagnet 554 on the lower position. This lower position of the sliding element 558 of the electromagnet 554 sets the lower position of the stopping element 548, on which the drawer is secured. Activating the electromagnet 554, its sliding element 558 moves up, turning the arm 547 with the stopping element 548 and setting free the drawer. The FIG. 215 illustrates the security system in the OPEN position, realized by activating the electromagnet 554. In FIG. 216 is shown the security system open by activating the arm 547 by the manual opening device 553, attached to the arm 547 on the articulation 552, via the flexible element 559. In case when the location of the manual opening device 553 can not be installed in the vehicle cabin without any collision, an alignment device 560 may be used, like the one described here before in FIG. 211, see FIG. 217. By choosing the Wright distance between the rollers L6, any collision may be avoided. The FIG. 218 illustrates an articulated security system, using as elastic element a tension spring 561, which is attached to the articulated arm 562 on the articulation 563, placed on the opposite side of the articulation 564, for the electromagnet 565 and of the articulation 566, for the manual opening device 567, with respect to the fixed articulation 568, attached to the vehicle body. The opposite end of the tension spring 561 is attached to the vehicle body via the articulation 569.

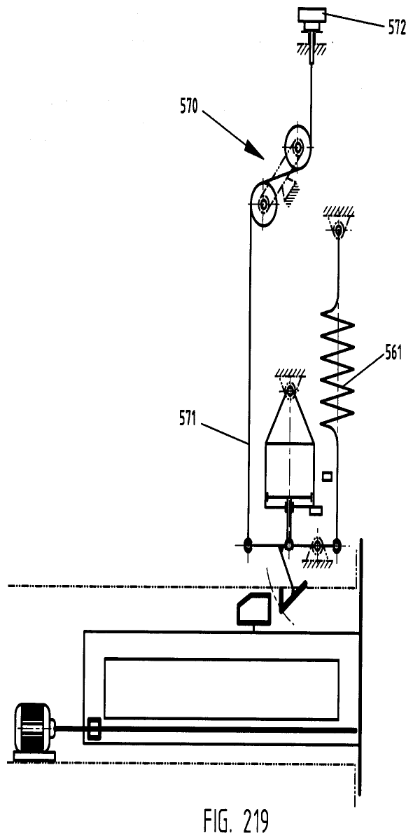

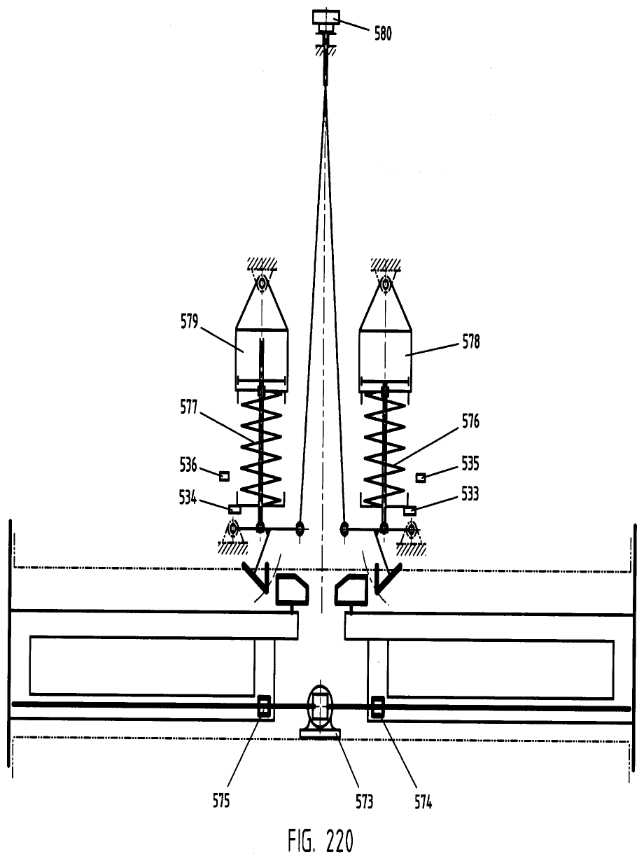

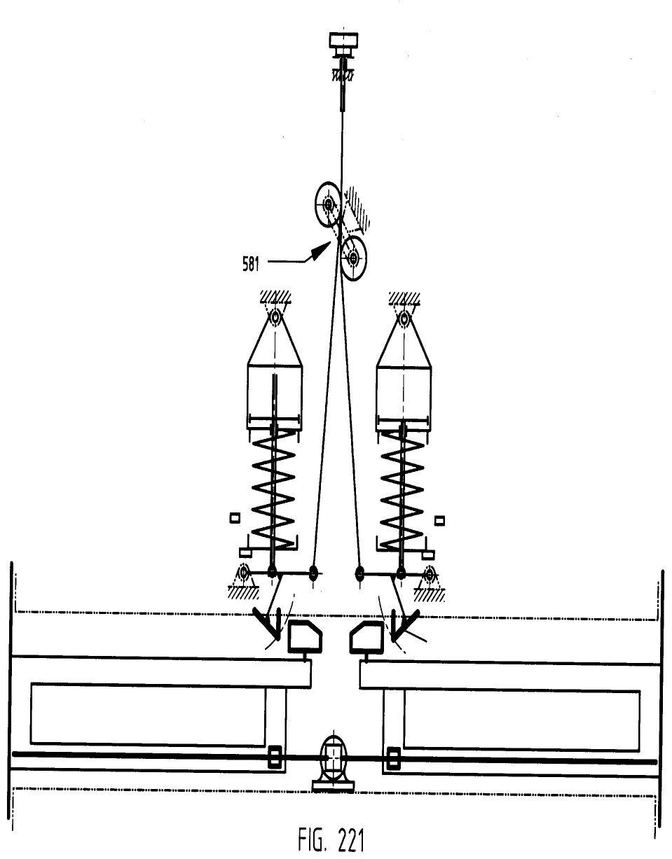

In FIG. 219 is shown an articulated security system using a tension spring 561 and an alignment device 570, in order to avoid collision of the flexible element 571 by locating the manual opening device 572 in an adequate position in the vehicle cabin. For opposite drawers having a common actuator 573 for their moving IN & OUT mechanisms 574 and 575, the security system is presented in FIG. 220. For each drawer is used an articulated security system with a compression spring 576 and 577, as elastic element, an electromagnet 578 and 579 and a unique manual opening device 580. In order to avoid collisions or drawer blocking, for each system is used a proximity sensor 533 and 534 and the target 535 and 536, working in the way described herein before. The FIG. 221 shows articulated security systems for opposite drawers with a common actuator for their moving IN & OUT mechanisms, using an alignment device 581 for their unique manual opening device.

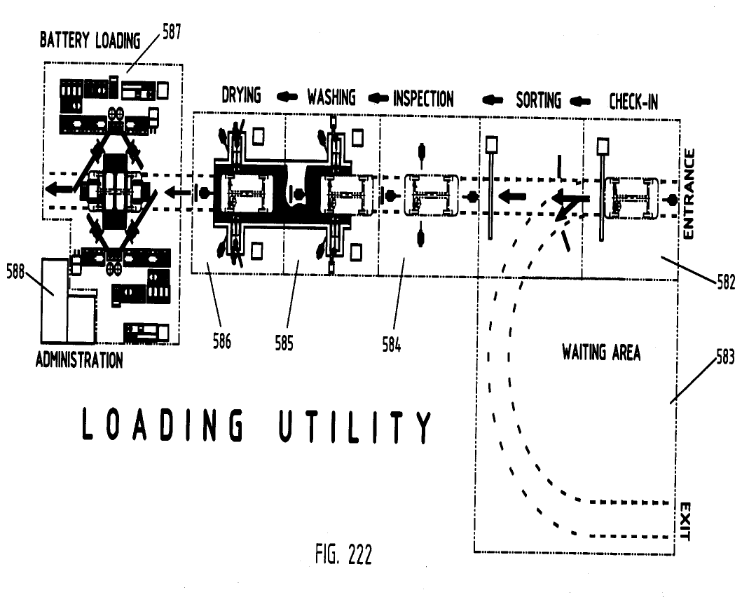

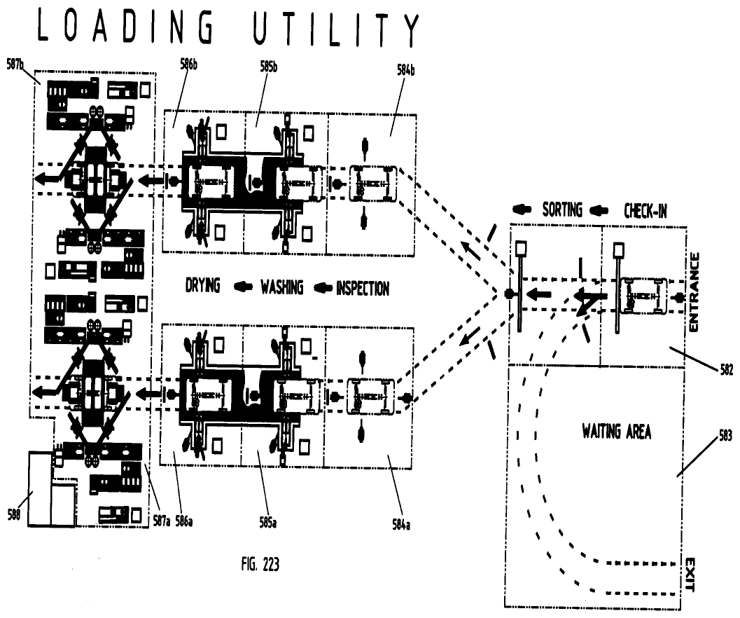

The battery quick-change system comprises, as well, a loading utility (LU) for electric vehicle, capable to change very quickly the vehicle battery, charge and prepare the replacing batteries for new installations and receive and transmit information. A such loading utility for one line is shown in FIG. 222 and for multiple lines (tow lines) is presented in FIG. 223.

At the entrance into Loading Utility, there is an “CHECK-IN” station 582, where the electric vehicle, the driver and the schedule are identified. If the electric vehicle is scheduled, and if it's in time and the replacing battery package is already prepared, the vehicle receives the permission to go inside of the loading utility, the gate will be opened and the vehicle is conducted to the next station. If it's not scheduled or if it is not in time, or the replacing battery package is not ready for change, and if there is other electric vehicle on the battery change line, it receives a message to go to the waiting area and have the information for the new schedule. The driver has to confirm his decision if accepts or not to wait. If he accepts, a request is issued and the vehicle has to move to the waiting area 583 of the Loading Utility. The intelligent management battery change system (IMBC) will communicate with the driver when the vehicle must go to the battery change line.

Inside the Loading Utility the first is the “INSPECTION” station 584, where the intelligent management battery change system (IMBC) takes and confirms the information about the electric vehicle and the driver such as EV ID, batteries ID's, actual charge, driver ID, and give permission to the vehicle to go to the next station. The next on line is a “WASHING” station 585 where, based on the information received from the inspection station 584, the drawer covers on the both sides of the electric vehicle are washed, if necessary. The next on the line is a “DRYING” station 586, where, if the electric vehicle was washed, in this station it is dry. The next step on the line is a “BATTERY CHANGE AND BATTERY RECHARGE” station 587, where the empty batteries of the electric vehicle are changed with full recharged batteries, and the empty batteries will be recharged and prepared for another installation. At the exit of the line is the “ADMINISTRATION” building 588, including “ADMINISTRATION”, “CUSTOMER SERVICE”, “COMPUTER CENTRE” and “SECURITY” departments.

The FIG. 223 illustrates a multiple line loading utility, having for tow lines only one ADMINISTRATION building with the four departments: “ADMINISTRATION”, “CUSTOMER SERVICE”, “COMPUTER CENTRE” and “SECURITY”.

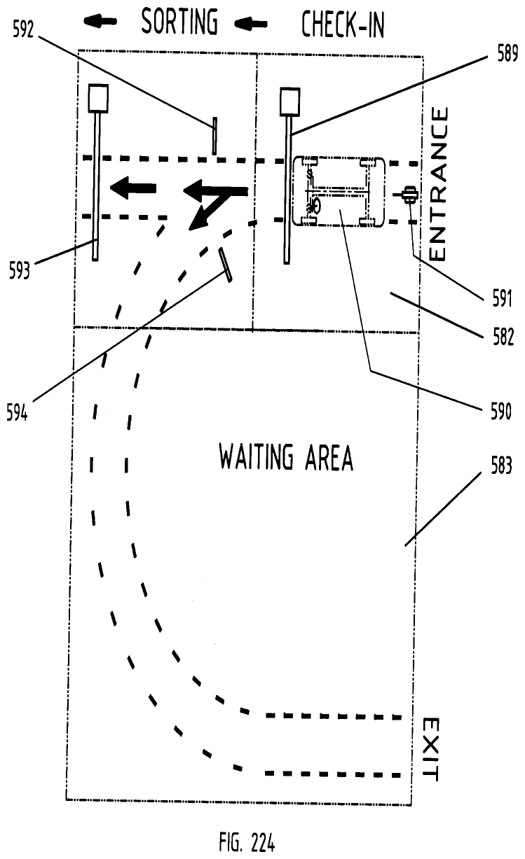

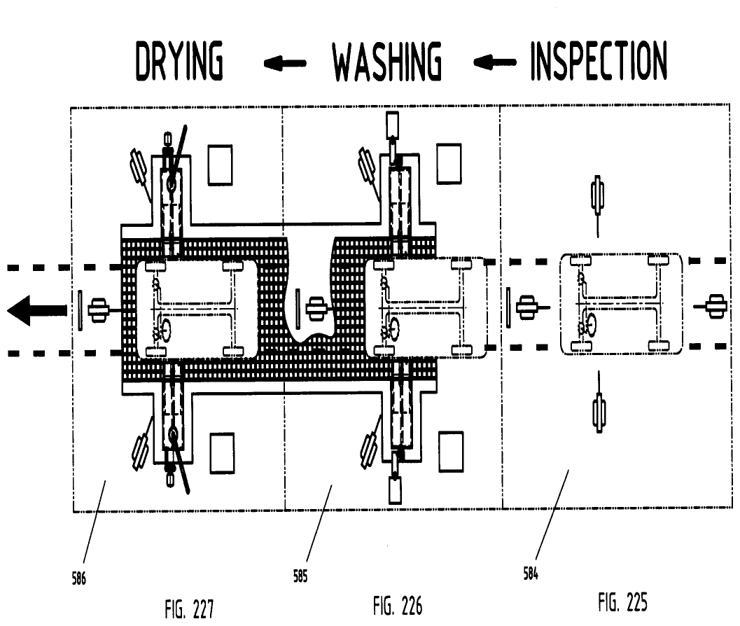

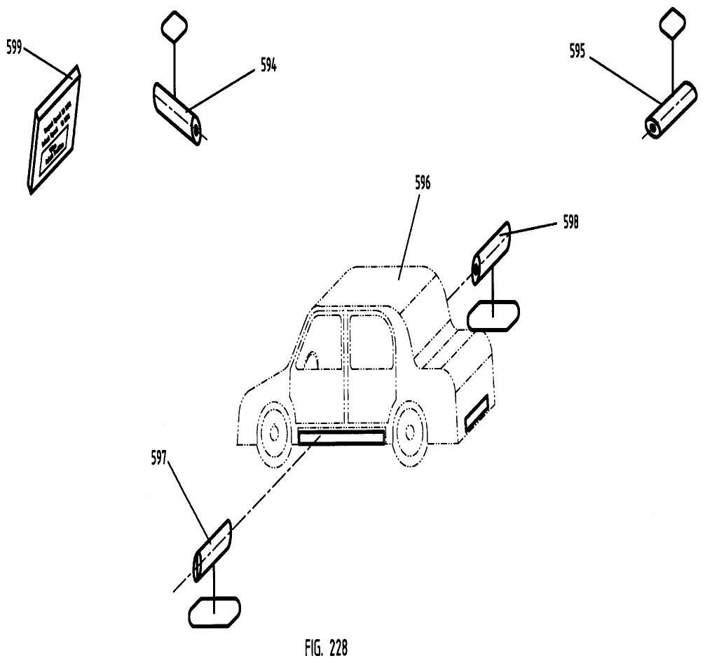

The FIG. 224 is a general view of an embodiment of the CHECK-IN station. As seen in FIG. 224, at the entrance into the loading utility there is a gate 589 stopping the electric vehicle 590. A camera 591 installed on the rear side of the vehicle takes information on the vehicle and transmit this information to the intelligent management battery change system (IMBC), for check-in. If there is a battery change request approved, if the vehicle is in the schedule and if the battery change line is ready for a new installation, the intelligent management battery change system (IMBC) gives the permission to the vehicle to enter into the loading utility opening the gate 589 and the vehicle goes forward as indicated on the sign 592 “Battery Change”, and the second gate 593 will open. The vehicle goes to the INSPECTION station. If there is not a battery change request approved, or if the vehicle is not in the schedule (it is earlier or later), the intelligent management battery change system (IMBC) analysis the actual situation and decides (depending on other vehicles schedule). If the decision is positive, the barrier 589 is opened and the vehicle goes forward as indicated on the sign 592 “Battery Change”, and the second barrier 593 will open. If the decision is “not jet” the intelligent management battery change system (IMBC) communicates to the driver the waiting time. If the driver accepts to wait, the vehicle follows the sign 594 “Waiting area or EXIT”. The second barrier 593 doesn't open, it remains closed. If the driver doesn't accept to wait, the vehicle leaves the loading utility going to the EXIT.

The FIG. 225 to FIG. 227 is a general view of an embodiment of the three preparation points—inspection 584, washing 585 and drying 586.

The FIG. 228 is a detail of the INSPECTION station comprising a front camera 594 and a rear camera 595, which identify the electric vehicle 596 and transmits information to the intelligent management battery change system (IMBC). On each side of the electric vehicle 596 there is a camera 597 and 598 focused on the battery drawer cover, taking information on the level of cleanness of this portion of the electric vehicle. This information (pictures) are sent to the intelligent management battery change system (IMBC), which analysis this information and takes decision if there is or not need to clean the drawer covers. In front of the electric vehicle there is a TV set 599 giving to the driver information about the speed limits required on the line, actual speed of the vehicle, life video with the position of the vehicle on the marked line, registration plate number, driver name, etc. The driver must confirm if the information is correct or has to make the required correction before to move forward.

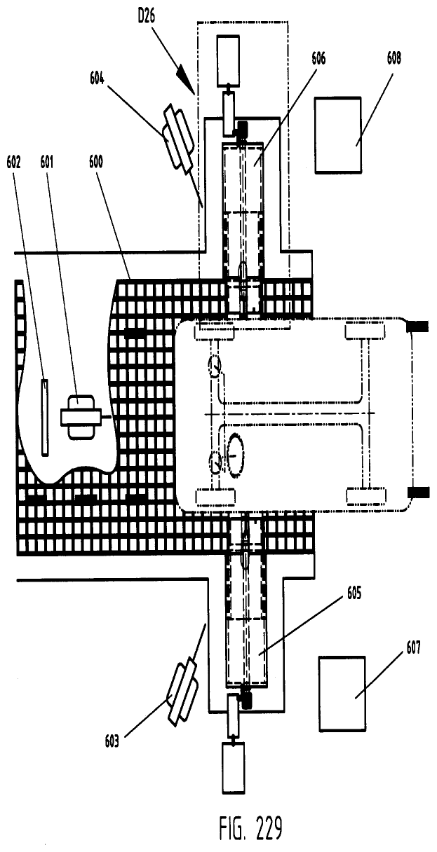

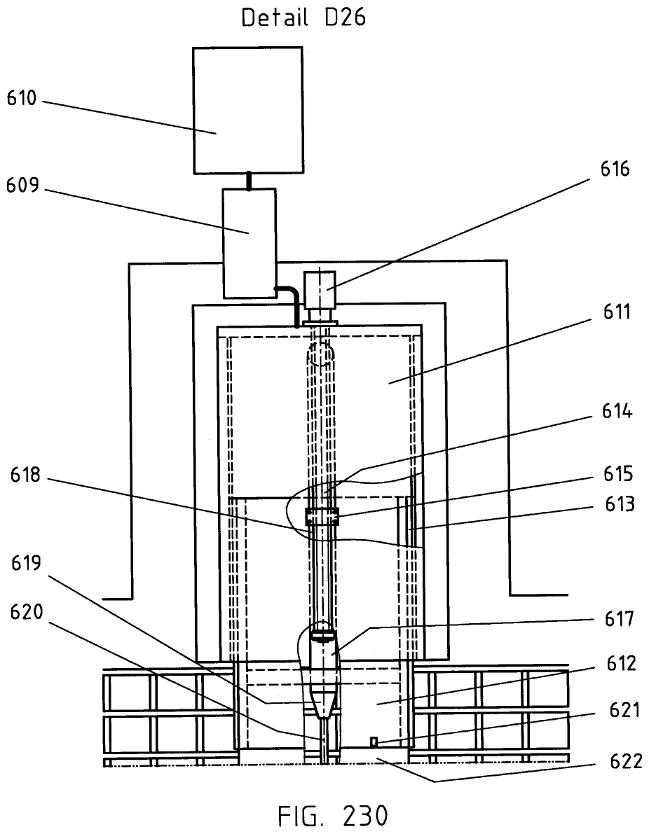

The FIG. 229 is a general embodiment of a WASHING station comprising a grilled floor portion 600 to collect the water and the soil, a front camera 601 taking life video on the vehicle, which is shown on the TV set 602 to help the driver to follow the right way inside the station, two lateral cameras 603 and 604, one for each side of the vehicle, two washing machines 605 and 606, one for each side of the vehicle, each one equipped with a controller 607 and 608. The two cameras 603 and 604 take information on the vehicle position and send it to the controller. In FIG. 230 is presented the detail D26 showing the washing machine, which comprises: a high pressure water pump 609 activated by the electric motor 610, a stationary enclosure 611 and a moving enclosure 612 moving IN and OUT on two lateral slides 613, using a moving IN & OUT mechanism. In this embodiment this moving IN & OUT mechanism is a screw & nut mechanism comprising the screw 614 and the nut 615 activated by an electric motor 616. On the moving IN & OUT enclosure 612 is attached the high pressure water head 617 via a flexible hose 618. On the high pressure water head is installed a nuzzle 619, which generates a flat water jet 620 in a vertical plane. On top of the moving enclosure 612 is installed a proximity sensor 621, which controls the distance between the vehicle and the moving enclosure 612. A kind of brush 622 is installed on the three walls of the moving enclosure (two lateral and one on top of the moving enclosure), which are in non destructive contact with the vehicle in the washing area, inclosing the water during the washing operation. The washing takes place during the vehicle moving, with the speed indicated on the TV screen.

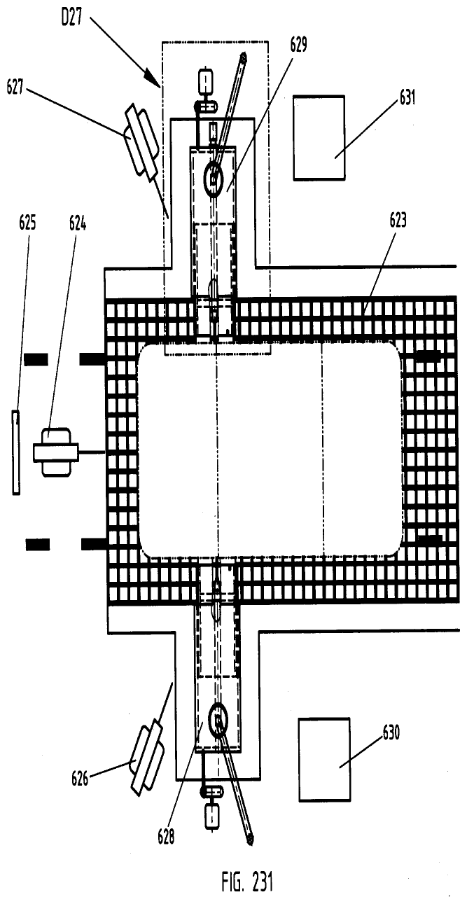

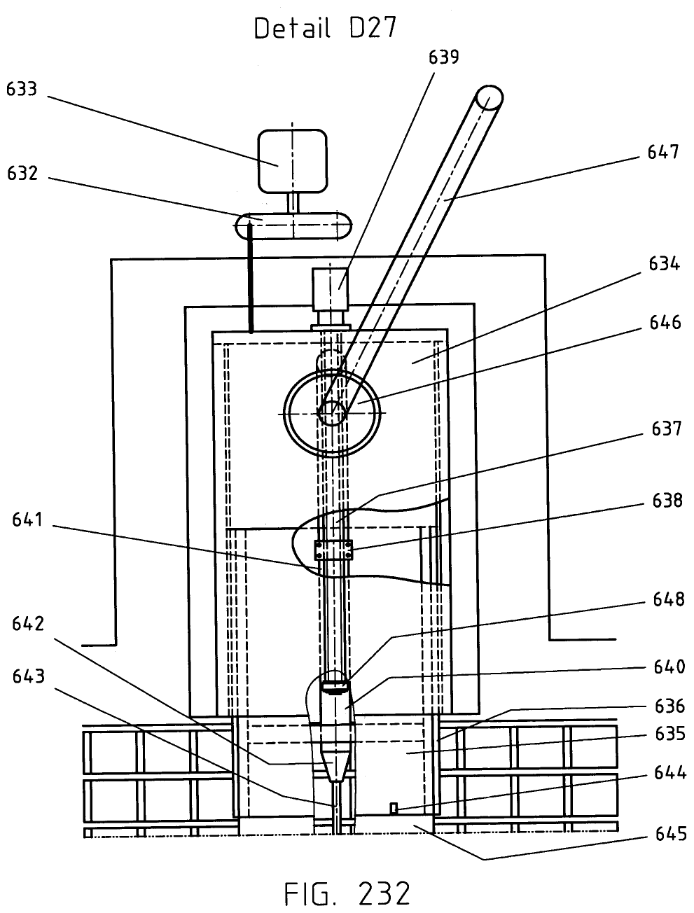

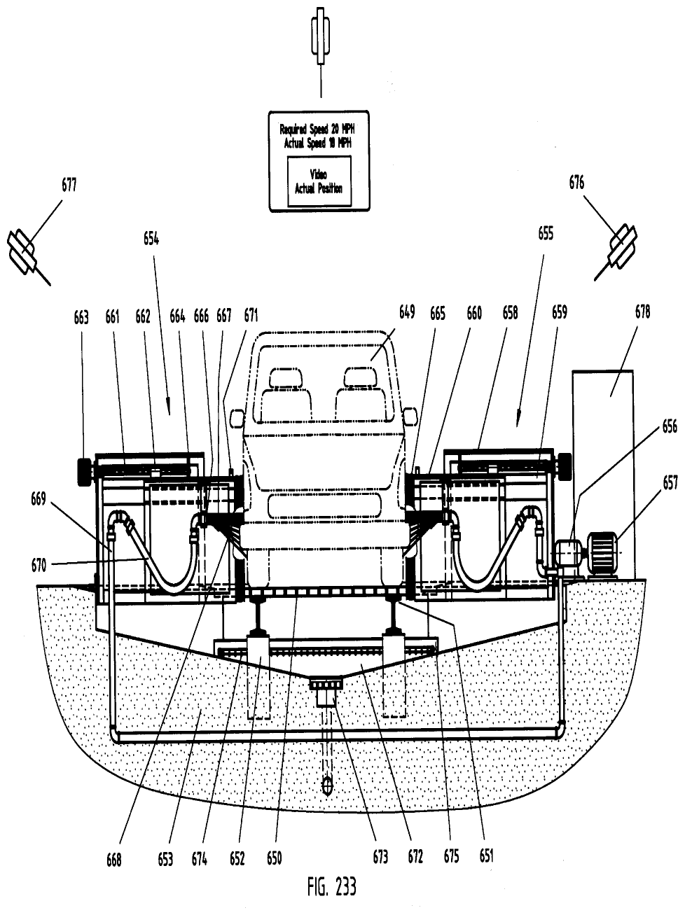

After the washing station, the vehicle moves into the drying station, which is similar with the washing station, changing the water by air. The FIG. 231 is a general embodiment of a DRYING station comprising a grilled floor portion 623 to collect the water, a front camera 624 taking life video on the vehicle, which is shown on the TV set 625 to help the driver to follow the wright way inside the station, two lateral cameras 626 and 627, one for each side of the vehicle, two DRYING machines 628 and 629, one for each side of the vehicle, each one equipped with a controller 630 and 631. The two lateral cameras 626 and 627 take information on the vehicle position and send it to the controller. In FIG. 232 is presented the detail D27 showing the drying machine, which comprises: an air turbine 632 activated by the electric motor 633, a stationary enclosure 634 and a moving enclosure 635 moving IN and OUT on two lateral slides 636, using a moving IN & OUT mechanism. In this embodiment this moving IN & OUT mechanism is a screw & nut mechanism comprising the screw 637 and the nut 638 activated by an electric motor 639. On the moving IN & OUT enclosure 635 is attached the high volume air head 640 via a flexible hose 641. On the high volume air head is installed a nuzzle 642, which generates a flat air jet 643 in a vertical plane. On top of the moving enclosure 635 is installed a proximity sensor 644, which controls the distance between the vehicle and the moving enclosure 635. A kind of brush 645 is installed on the three walls of the moving enclosure (two lateral and one on top of the moving enclosure), which are in non destructive contact with the vehicle in the drying area, inclosing the air full of water during the drying process. A high volume turbine 646 installed on top of the stationary enclosure takes the air full of water and push it away via a pipe network 647. The end of screw 637 is supported by the support 648 solidly attached to the stationary enclosure 634. The drying takes place during the vehicle moving, with the speed indicated on the TV screen.

The FIG. 233 is a cross section of the embodiment of a washing station using a machine for which the generic design was presented in FIG. 230. For this embodiment, the electric vehicle 649 is running on the grilled floor 650 supported by “I” shaped beams 651, mounted on the supports 652 embedded into the soil collector floor 653. On each side of the vehicle, there is a washing machine 654 and 655, both provided with high pressure water by unique high pressure pump 656, activated by the electric motor 657. Each machine comprises a stationary enclosure 658 installed on top of a water collector in a way that their walls go down underneath of the floor level of the station, making sure no water overflowing on the station floor, see FIG. 233. This stationary enclosure supports the side slides 659 on which the moving enclosure 660 is sliding IN & OUT driven by a moving IN & OUT mechanism comprising a screw 661, a nut 662, an electric motor 663 and a screw support 664. In order to inclose the water during the washing operation, the moving enclosure 660 has on lateral and top walls a kind of brush 665, which stays in contact with the vehicle in movement all the washing time. On the moving enclosure is attached the pressure head 666 with its nuzzle 667 generating a water jet 668 on a vertical plane. The washer head is connected to the high pressure pipe 669 with a flexible hose 670. On top of the moving enclosure 660 is installed a proximity sensor 671 in order to control the distance between the vehicle and the moving enclosure during the operation. In this way any accidents or damages of the vehicle are avoided. Underneath of the grilled floor, there is a basin kind area 672, collecting all water and soil produced by washing. This has a sloped floor directing the water and the soil to a central collector 673 to be evacuated. In order to clean the basin 672 it is a cleaning system all around of the basin, comprising a plurality of nuzzles 674, which flushes time to time the basin floor. In order to be protected, these nuzzles are installed in a niche 675. Both washing machines are working automatically using a controller 678 and two cameras 676 and 677, which give information to the system on the vehicle position. The controller 678 gives all commends and controls the machines cycle, which has the following sequences:
1. with the moving enclosure retracted, let the vehicle to go into the station in front of the washing machines up to the drawer covers;
2. move the moving enclosure out till it touches the vehicle body;
3. confirm the contact between the vehicle body with both moving enclosure by the two proximity sensors;
4. start water jets on both sides;
5. continue driving the vehicle and the washing, till the cameras identify the end of the last drawer cover;
6. stop the washer jets;
7. retract the moving enclosure;
8. continue to drive the vehicle and exit the washing station;
9. approach to the drying station;
10. clean the basin floor.

During all this washing process the vehicle is moving. It doesn't stop at all.

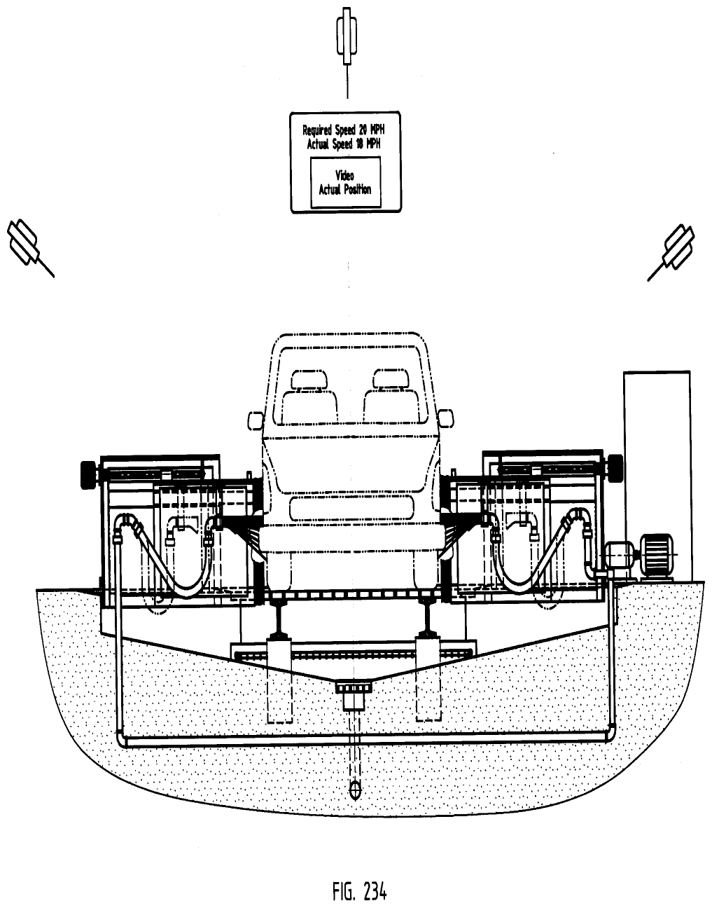

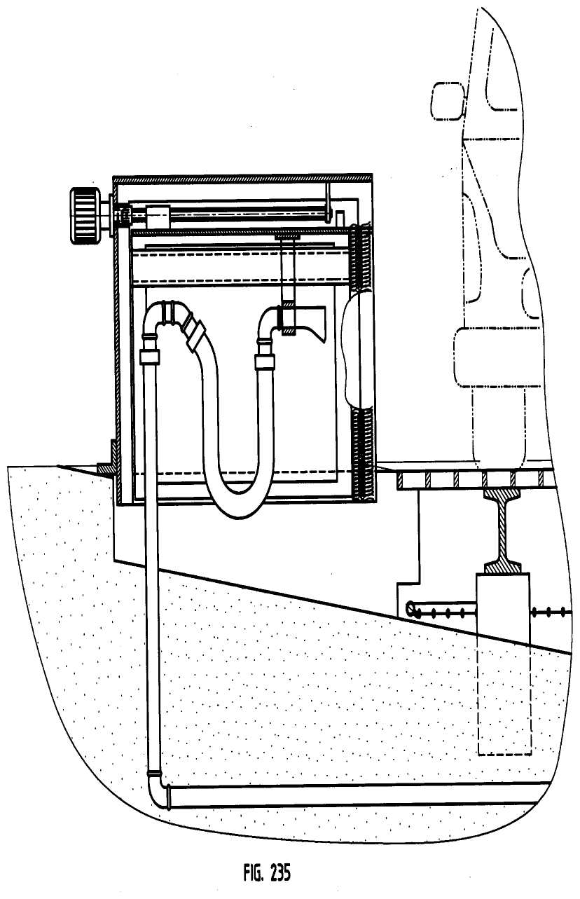

The FIG. 234 is the same cross section of the embodiment presented in FIG. 233, showing the moving enclosure retracted with dividing lines. The FIG. 235 is a partial portion of the cross section of one of the washing machines, showing the moving enclosure complete retracted and the clearance between the washing machine and the vehicle.

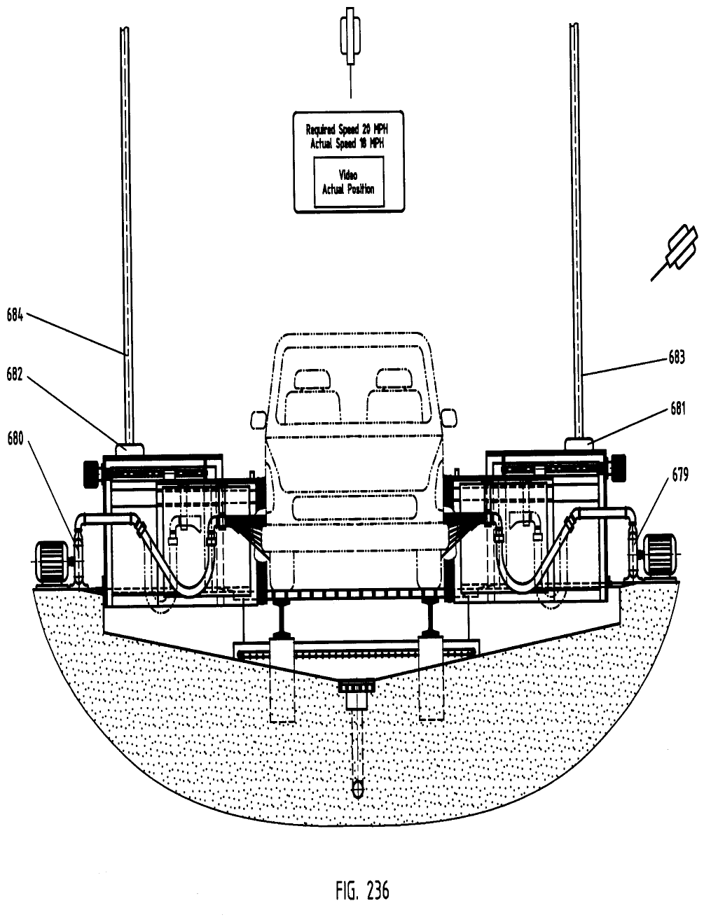

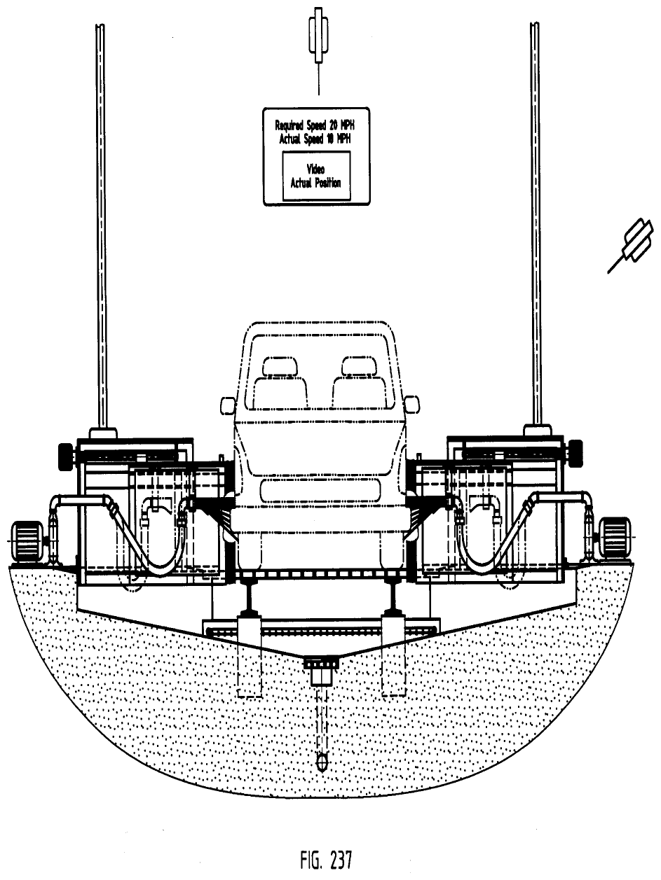

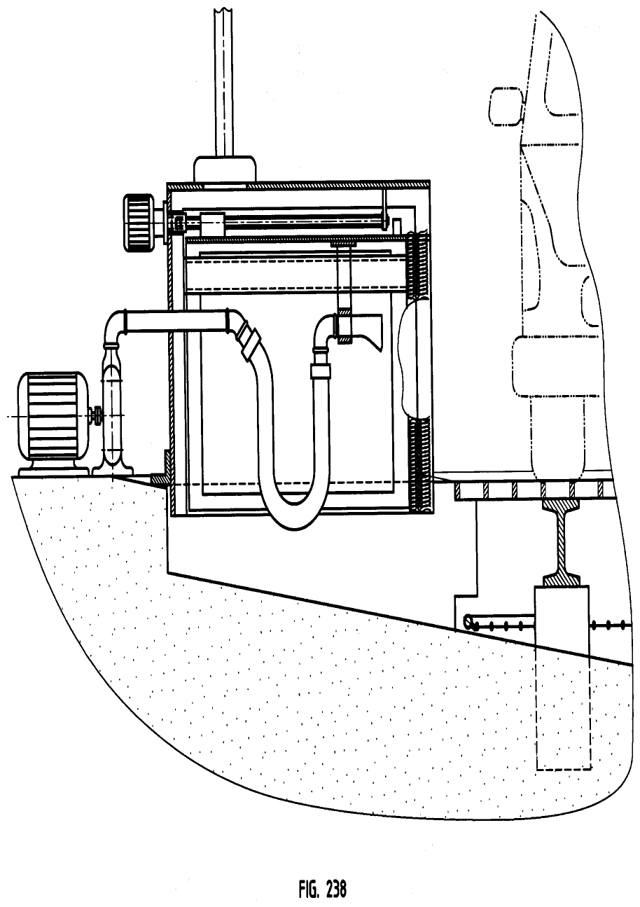

The FIG. 236 is a similar cross section made on the drying machines, where the main difference consists in the fact that the water is changed to air. Consequently, the air is pushed IN by a high volume turbine 679 and 680 and it is taken OUT by another turbine 681 and 682. The air full of humidity is pushed out by a pipe network 683 and 684. The FIG. 237 is similar with FIG. 234 and the FIG. 238 is similar with FIG. 235.

From the drying station, the vehicle goes to the battery change station, where the empty battery packages are changed by full recharged batteries. In order to guide the driver, there are a camera 875 in front of the electric vehicle like in the previous sub-sections giving information related to the position of the vehicle on the line. Also, there is another camera 876 on the lateral position, targeting the vehicle drawers, and giving information to the driver when to stop the vehicle for the best position related to the lifting devices. In front of the vehicle there is a TV screen 777 on which all the information are displayed. After the vehicle is stopped in the battery change station, the drawers will be opened and the battery packages are unclamped, ready to be changed.

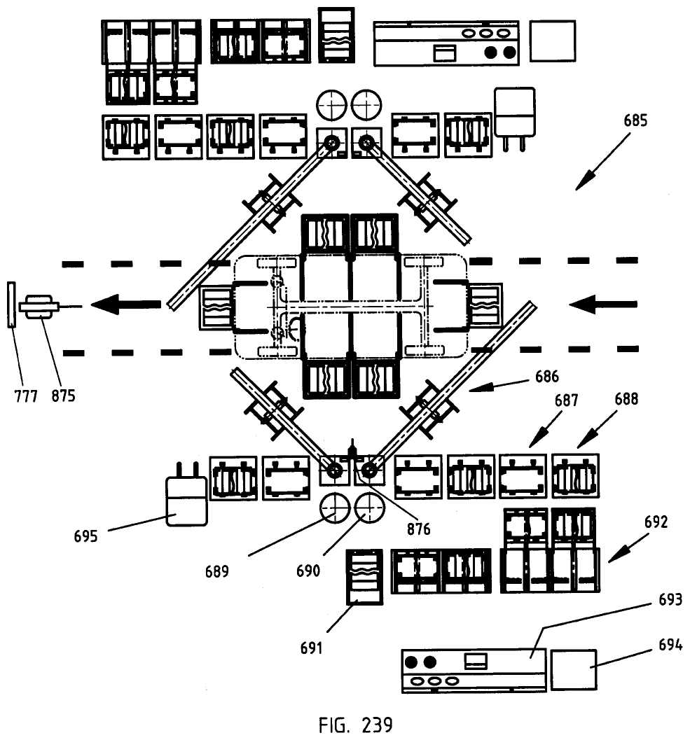

In principle, as shown in FIG. 239, the battery change station 685 comprises means to manipulate the battery packages for all drawers of the vehicle 686, sub-stations to dispose the empty batteries 687, sub-station to keep in stand-by the full recharged batteries 688, means to clean the contacts of the contact plates of the vehicle 689, means to clean the contacts of the empty batteries 690, means to pack & unpack the battery packages 691, means to store the battery packages and recharge them 692, means to measure and control the batteries charge for each battery module stored into the station 693, a power unit 694, means to transport the battery packages inside the station 695.

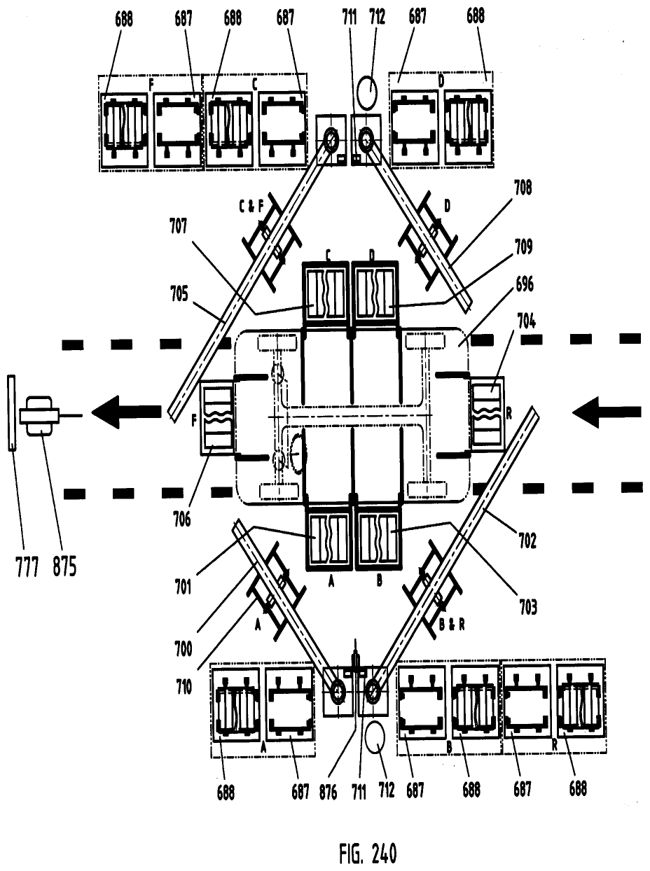

In FIG. 240 is presented the detail of the battery change sub-station, where the vehicle 696 after arriving, opens all drawers. In the most general case, the vehicle is equipped with lateral drawers—A & B for the left side and C&D for right side of the vehicle, front drawers—F, and rear drawers—R. For each of these drawers there is a dedicated sub-station 687 to dispose the empty battery package and a dedicated sub-station 688 to keep in stand-by the full recharged battery package. In case of a manual operation of the battery change station, when the battery change is done by an operator, on each side of the vehicle there are two lifting devices to install and take out the battery package from the vehicle, each one being dedicated to certain drawer or drawers. For example, on the left side of the vehicle there is a lifting device 700 dedicated to serve the lateral front drawer 701, and a lifting device 702 dedicated to serve the lateral rear drawer 703 and the rear drawer 704. On the right side of the vehicle there is the lifting device 705 dedicated to serve the front drawer 706 and the lateral front right drawers 707, and there is the lifting device 708 dedicated to serve the lateral rear right drawer 709. On each lifting device there is a battery griping device 710. For contact cleaning purposes, the operator may use a powered wire brush 711 and a vacuum device 712. The same equipment may be used in order to clean the contacts of the empty battery.

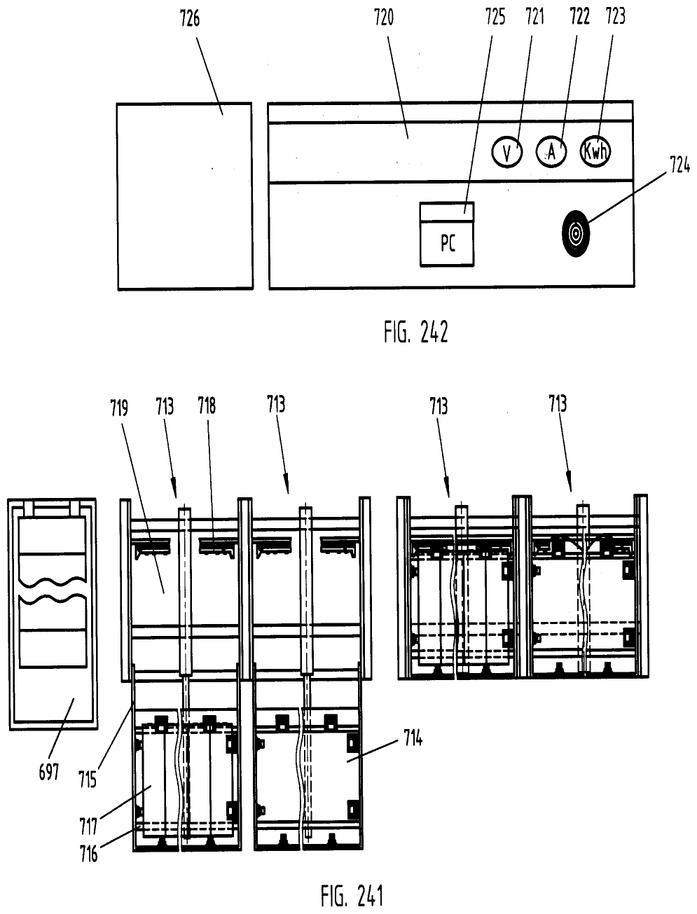

In FIG. 241 are shown the racks 713 for battery storage and battery recharge. These racks are multiple level and multiple columns racks. For one battery package there is a kind of drawer—storage drawer—coming IN & OUT of the rack, which are designed in a similar way as the electric vehicle drawers. Each drawer has a platform 714 installed on side slides 715. On each platform 714 are mounted the battery pads 716 supporting the battery package 717. For each compartment there is a contact plate 718, which will be in contact with the battery package terminals, when the storage drawer is in IN position. Each storage drawer is moved IN & OUT by a moving IN & OUT mechanism, which may be a pneumatic cylinder 719.

The storage drawer is designed to accommodate battery packages for each class of electric vehicles. For each class of electric vehicles, the number of modules is equal with the most common number of modules of the industry for the respective class. Because the battery packages of different vehicles of the same class may be different than the majority of the vehicles for which the storage drawer was designed, and for eliminating some damaged modules of the certain battery packages, there is a sub-section 697 for packing & unpacking the battery packages. In this sub-section are unpacked the oversized packages (battery packages with a number of modules bigger than the common one). Also, are unpacked some damaged modules, if is the case. In this sub-section are packed modules in order to achieve the wright number of module for each order.

In FIG. 242 is illustrated the battery recharging and monitoring section for all battery packages stored into the storage section. On the control panel 720 are installed a voltmeter 721, an ammeter 722 and an Kwh meter 723. The electric panel comprises as well some kind of switch 724 capable to connect to these measurement instruments each contact plate and each battery module. In this way all the information related to the charge of each module may be monitored and recorded by a computer 725, which is in communication with the intelligent management battery change system (IMBC). The entire station is powered by a power station 726, which transforms the electricity received from the city power network to the parameters required for battery recharge.

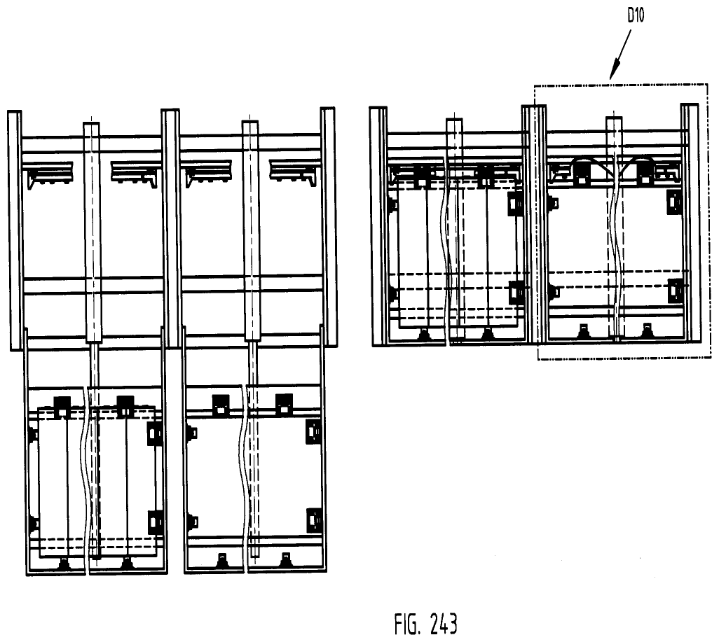

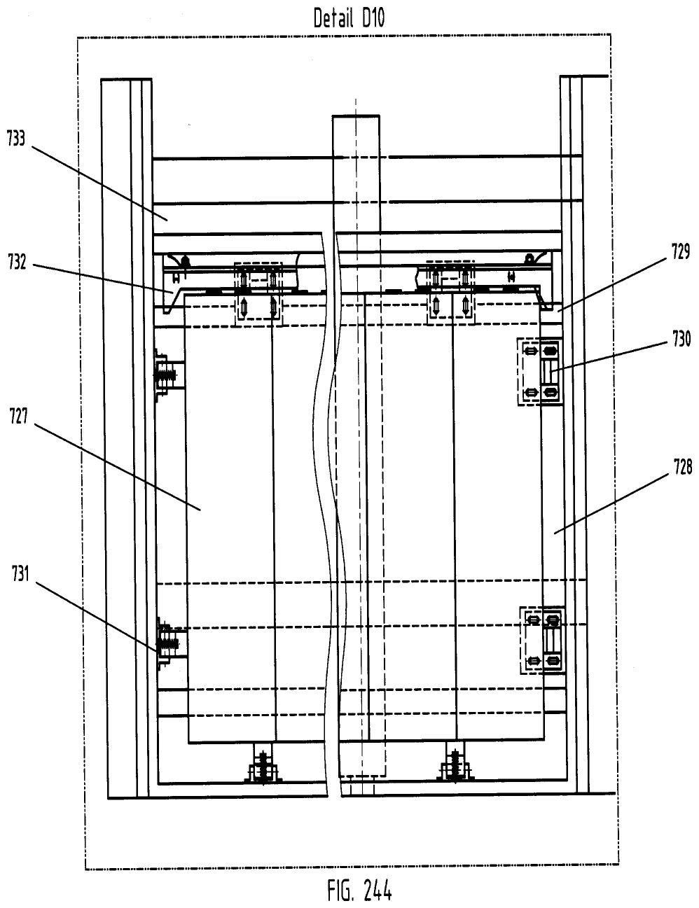

The FIG. 243 shows an embodiment of storage racks and storage drawers, using the same principle and solutions as on the vehicle drawers. Therefore, as can be seen on FIG. 244, which is the Detail D10 of the FIG. 243, the battery package 727 is installed on the platform 728 on two pads 729 being centred on two directions by two pairs of stoppers 730 and two pairs of pushing mechanisms 731. The contact plate 732 is installed on a contact plate support 733, which is attached to the storage drawer via the same kind of mechanism like on the vehicle drawers, allowing to have access to the contact plate for contact cleaning, when the storage drawer goes OUT. The design of the storage drawers and of the contact plate used on storage drawers may be the same like the design of the vehicle drawers and vehicle contact plates. Using the same design and configuration, this allows to drop the cost down.

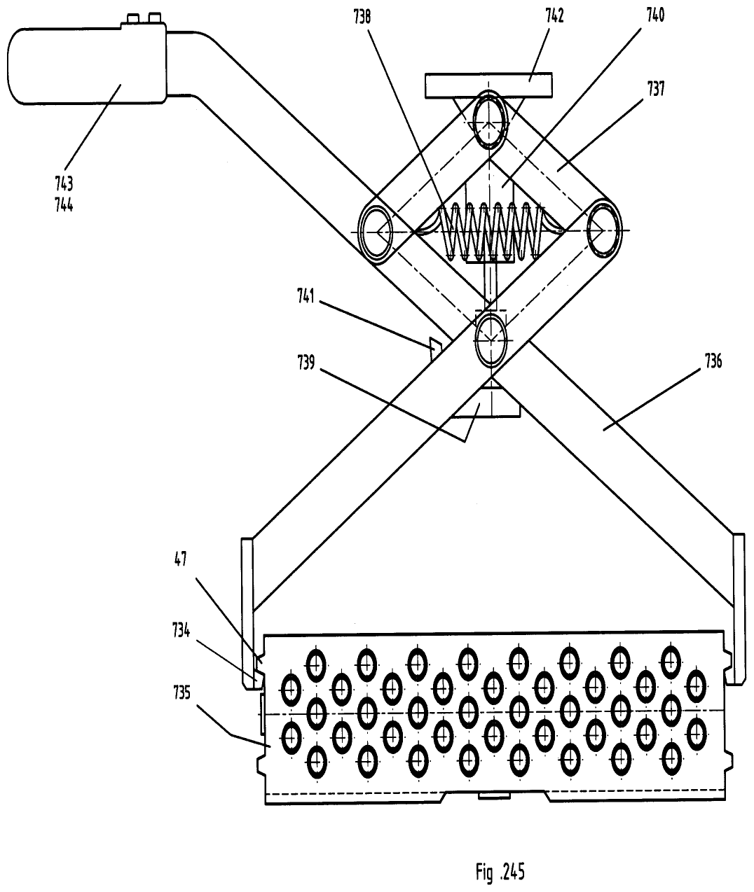

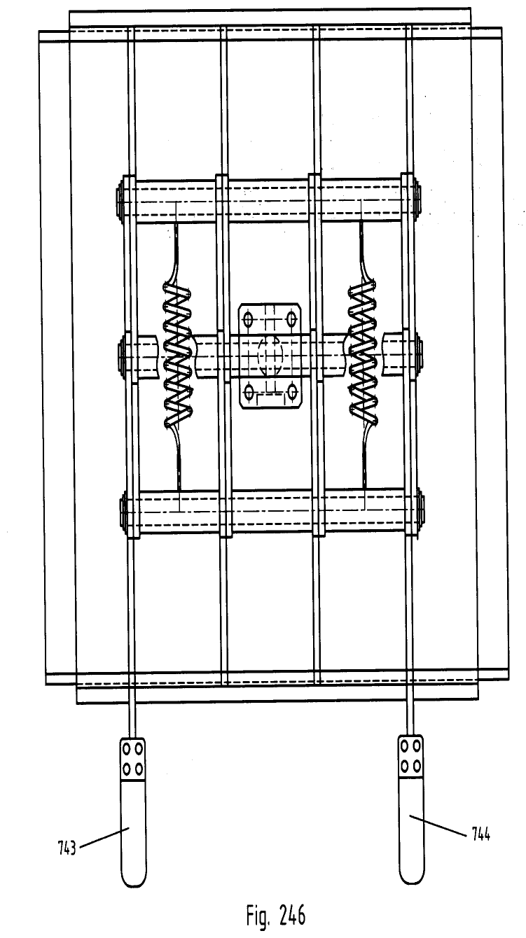

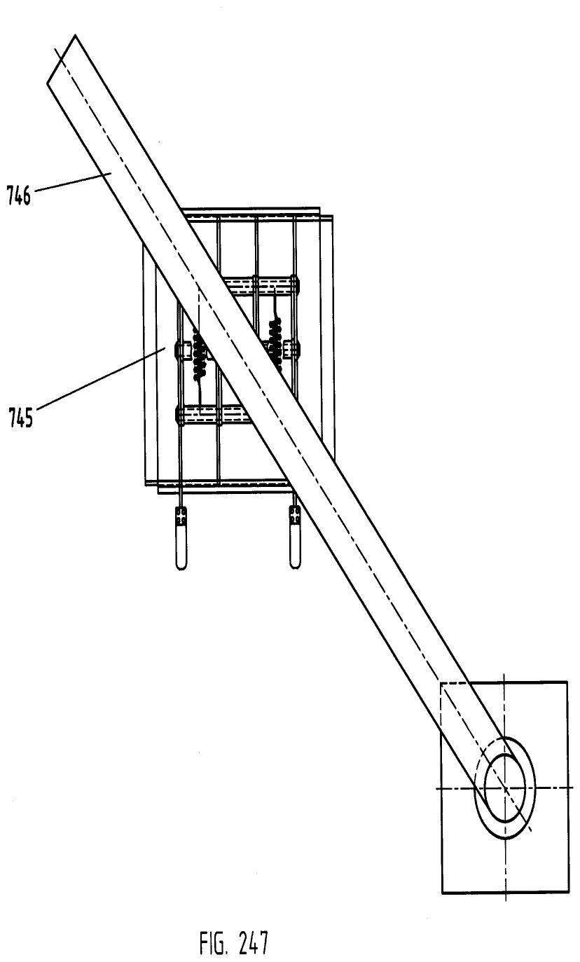

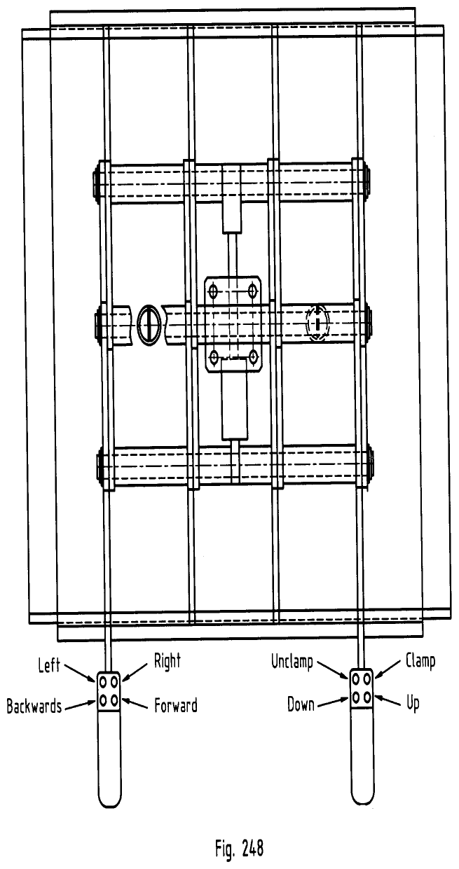

For a manual manipulation of the battery package during the installation on the electric vehicle, a griping device may be used, attaching the battery package to the lifting device. En embodiment of a such a manual griping device is illustrated in FIG. 245 comprising two pads 734 having the shape adapted to fit to the shoulders 47 of the battery package 735, mounted on a quadrilateral mechanism having two pairs of big arms 736 and two pairs of small arms 737, articulated. The pads are kept close on the battery package by the elastic element 738, which in this embodiment is a traction spring. In order to not damage the battery package by a too high pressure exercised by the traction spring 738, the pads position is controlled by the stopper 739, which limits the angle between the two arms when they close. The arms 736 remain closed during the battery transportation. To release the battery package, the arms 736 are opened by the electromagnet 740, acting on the opposite articulations than the traction spring. The opening of the aims 736 is limited by the stopper 741 in order to control the manipulation device and not damage anything of the electric vehicle when the battery package is released on the vehicle drawer. The device is attached to the lifting device by an attaching member 742. For manual manipulation, two parallel big arms are extended and each one ends by a handle 743 and 744. On these handles are installed a plurality of wireless command buttons for easy manipulation. The FIG. 246 is a top view of the embodiment of the manual griping device. In FIG. 247 is shown the griping device 745 installed on the lifting device 746. In FIG. 248 are shown the handles with their wireless buttons by which the operator controls the movements of the griping device (clamp & unclamp) and to the lifting device Up/Down, Forward/Rear and turn Right/Left.

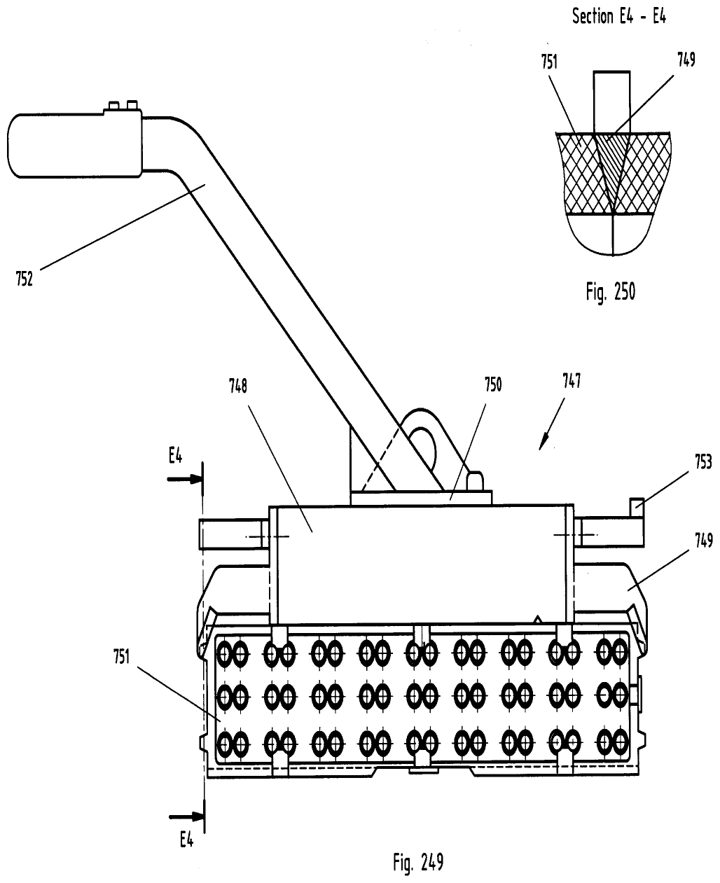

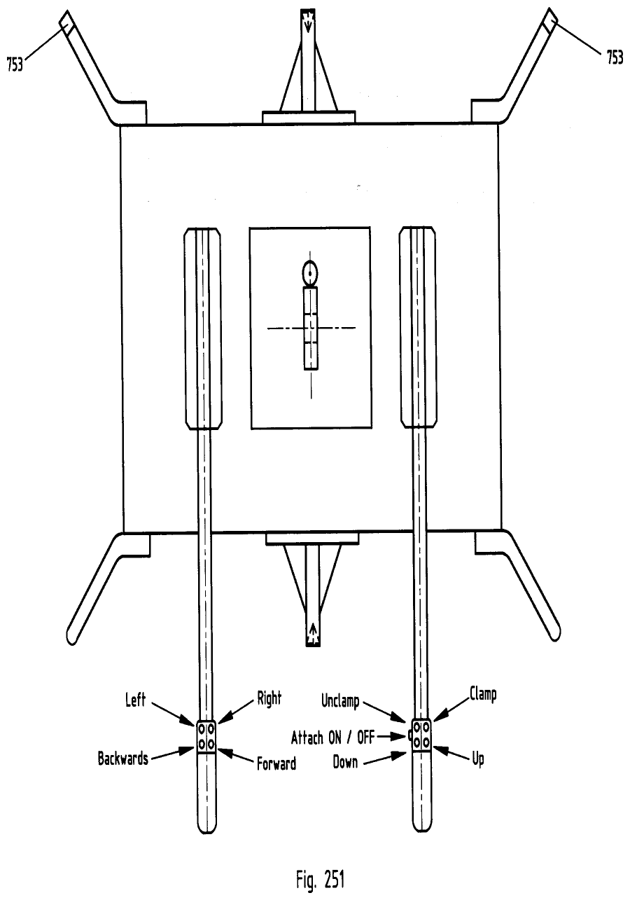

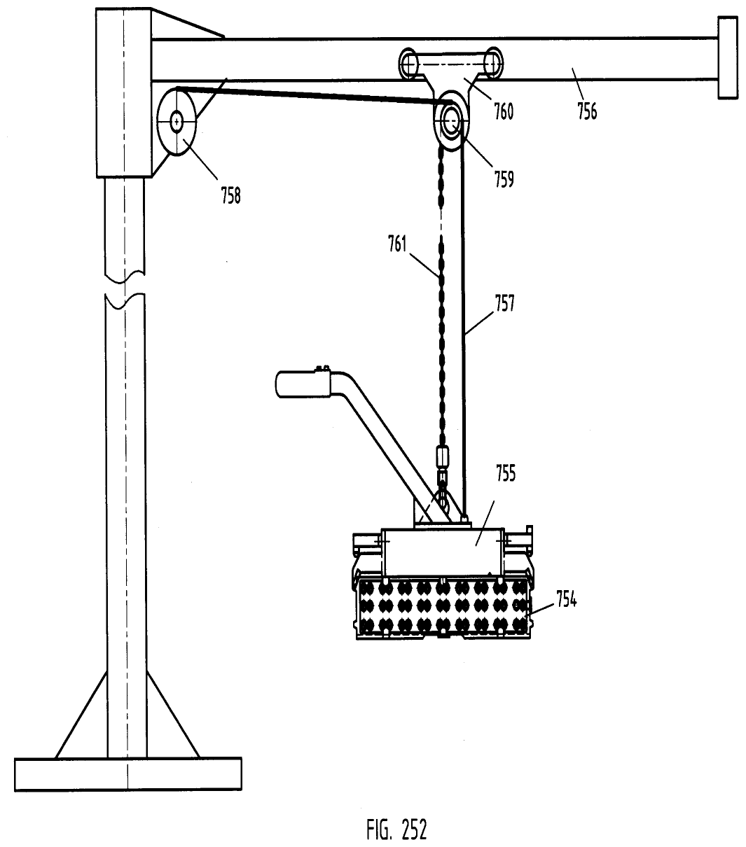

In FIG. 249 is shown another embodiment of a griping device 747, comprising an electromagnet 748, two opposite liners 749 and means to attach the electromagnet to the lifting device 750. The battery package 751 is clamped on the electromagnet 748 and it is aligned by the two tapered liners 749, which have a taper portion (log) entering into a taper portion (slot) of the battery package, making sure a correct position of the battery package on the griping device, see section E4-E4 in FIG. 250. Opposed to the device handles 752, on two extremities of the griping device 747 are installed two wireless proximity sensors 753, which emit a beep when the device is too closed to the vehicle body, avoiding in this way any collision and damage. The FIG. 251 shows a top view of the electromagnetic griping device. The FIG. 252 illustrates the battery package 754 attached to an electromagnetic griping device 755 installed on a lifting device 756. The electromagnet is powered by a cable 757, which is kept tensioned all the time by a spiral spring installed into the roll 758 via the roll 759 installed on the crane winches 760. In this way the electric cable stays always tensioned, parallel to the crane chain 761.

This kind of manual battery change equipment may be used at the beginning of the implementation of this kind of electric vehicles with quick-change battery system, when the volume is low and the manual battery change is the economic solution, insuring a reasonable battery change time. In the future, when the electric vehicles volume is greater, the automated battery change becomes the economic solution. For an automatic battery change the operator is replaced by a plurality robots. For this application a 5 axis robot may be used.

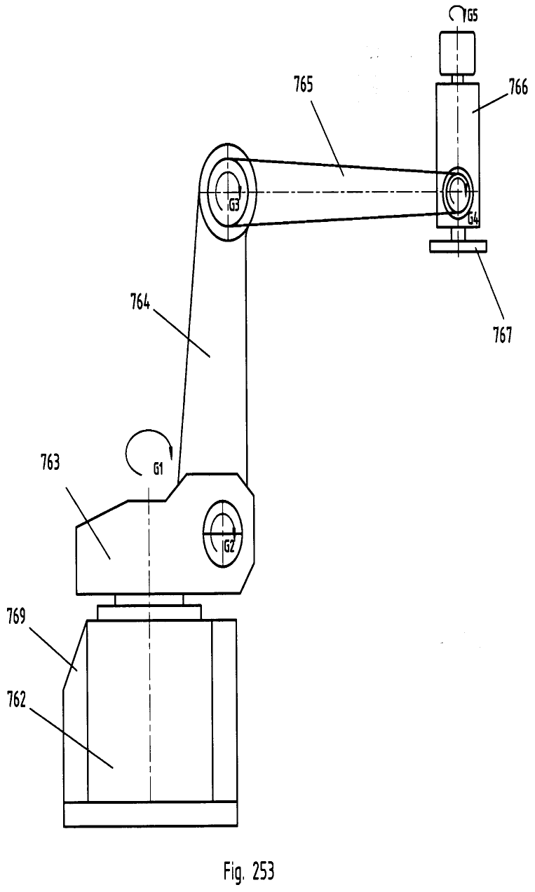

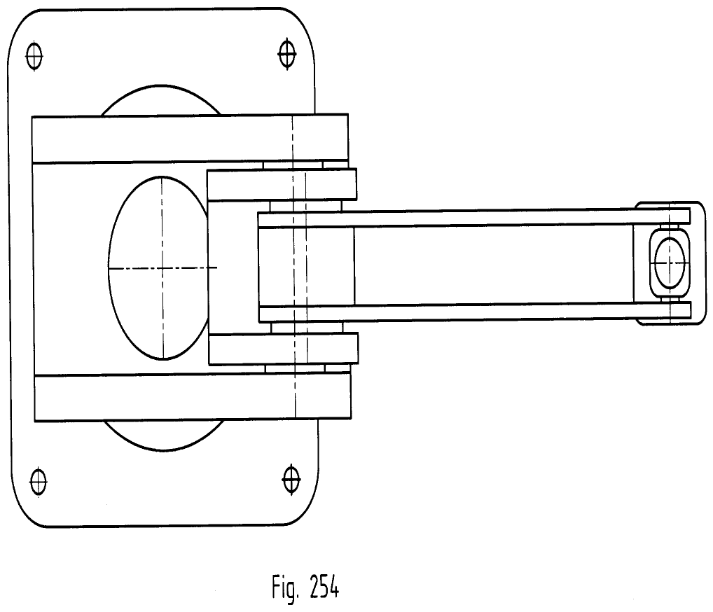

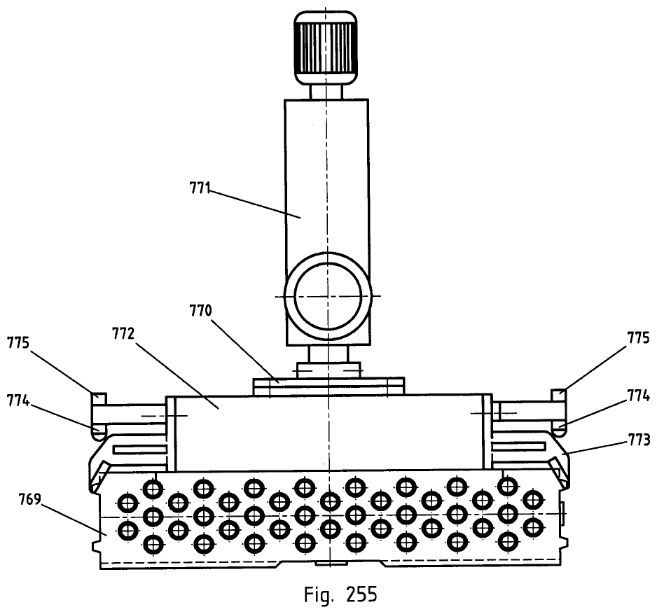

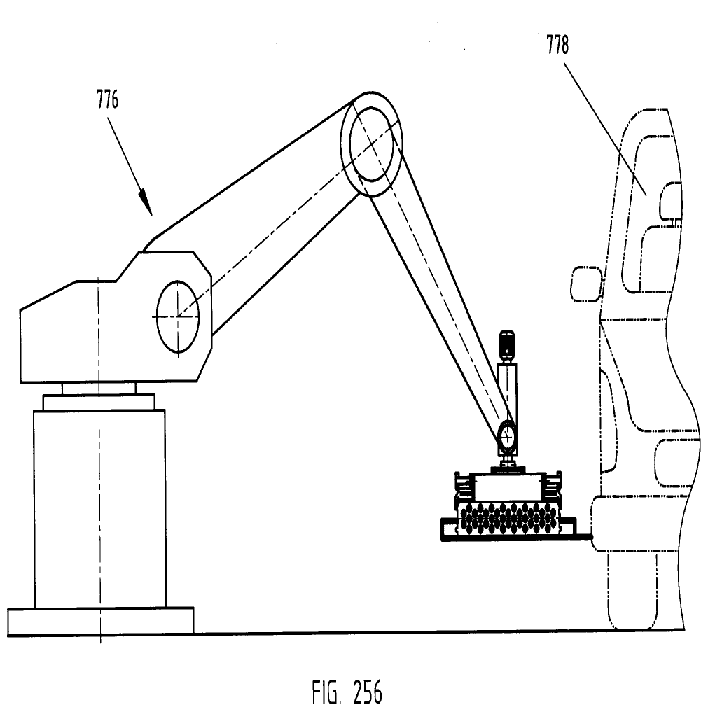

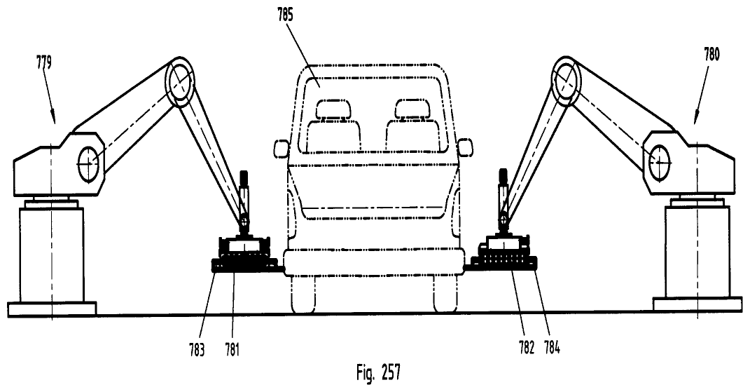

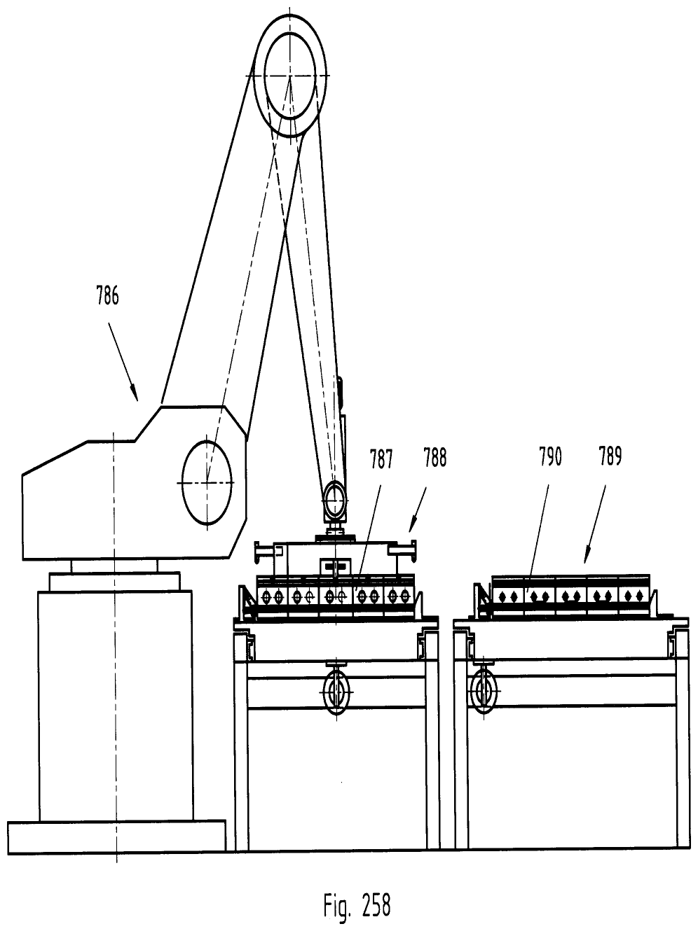

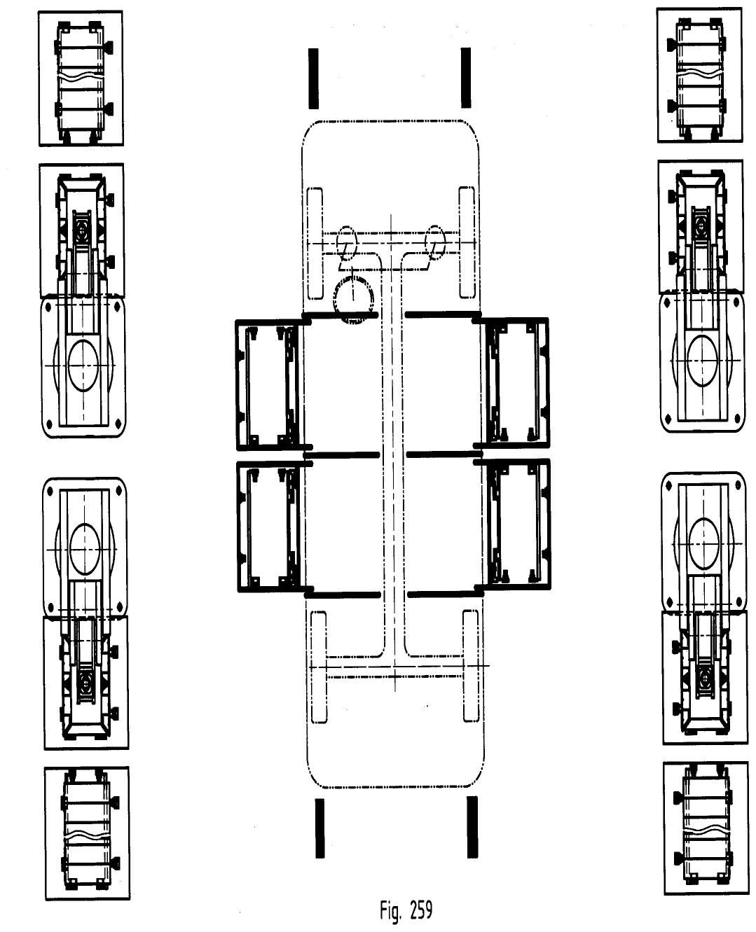

In FIG. 253 is illustrated a generic 5 axis battery change robot in a lateral view, comprising a base 762, a rotating member 763 turning on G1 axis, a primary arm 764, turning around the G2 axis, a secondary arm 765 turning on the G3 axis, a rotary head 766 rotating around the G4 axis and a platform 767 capable to turn around the G5 axis, on which is attached the battery gripping device. On the robot base 762 is built the robot controller 769 and all the electronics devices required. FIG. 254 is a top view of this 5 axis robot. For automate battery change, the best solution to grip the battery package is to use an electromagnetic griping device. The FIG. 255 shows a battery package 769 attached by an electromagnetic griping device 772 to the platform 770 mounted on the rotary head 771 of a 5 axis robot. The electromagnetic griping device is similar to the one for the manual device, having two liners 773, four cameras 774 installed on the electromagnetic device in a way to visualize the battery package edges and the vehicle drawer battery stoppers, and four proximity sensors 775 capable to control the position of the battery package and the griping device during the battery change, avoiding accidents and collisions. In FIG. 256 is illustrated the robot 776 at work for a lateral drawer of an electric vehicle 778. In FIG. 257 are shown two opposite robots 779 and 780 working simultaneously to change the battery package 781 and 782 of the opposite lateral drawers 783 and 784 of the same electric vehicle 785. The FIG. 258 shows a lateral view of the robot 786 placing the battery package 787 on the sub-station 788 used to dispose the empty battery package. It is shown as well the sub-station 789 used to keep in stand-by the full recharged batteries 790. The FIG. 259 shows a battery change line, having four battery change robots, two on each side of an electric vehicle. On this battery change line is shown the electric vehicle with all lateral drawers opened and empty in time that the four robots depose the empty battery packages on the dedicated sub-stations.

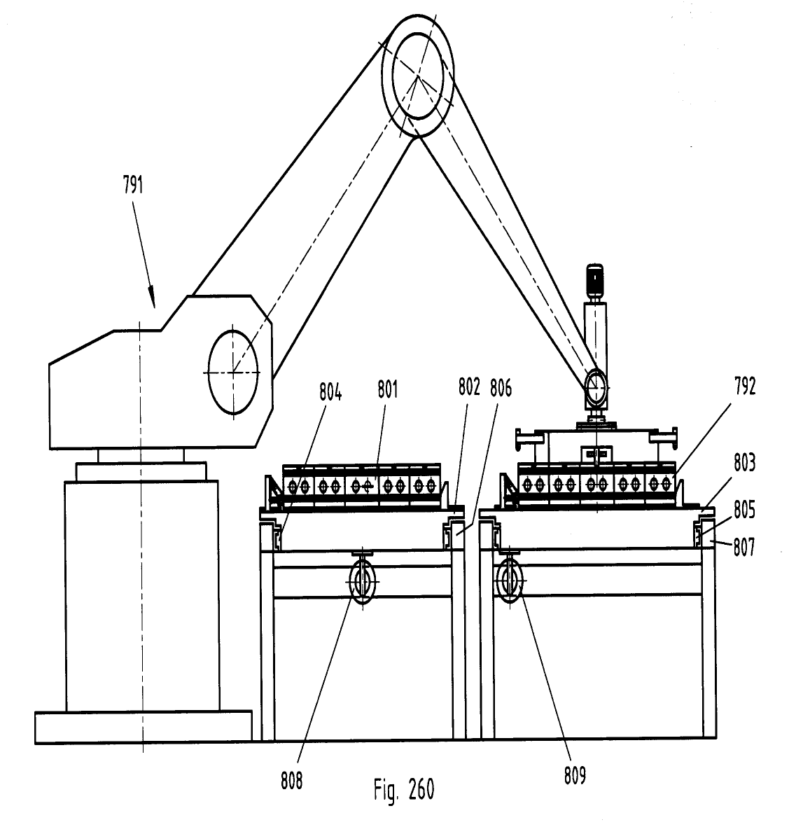

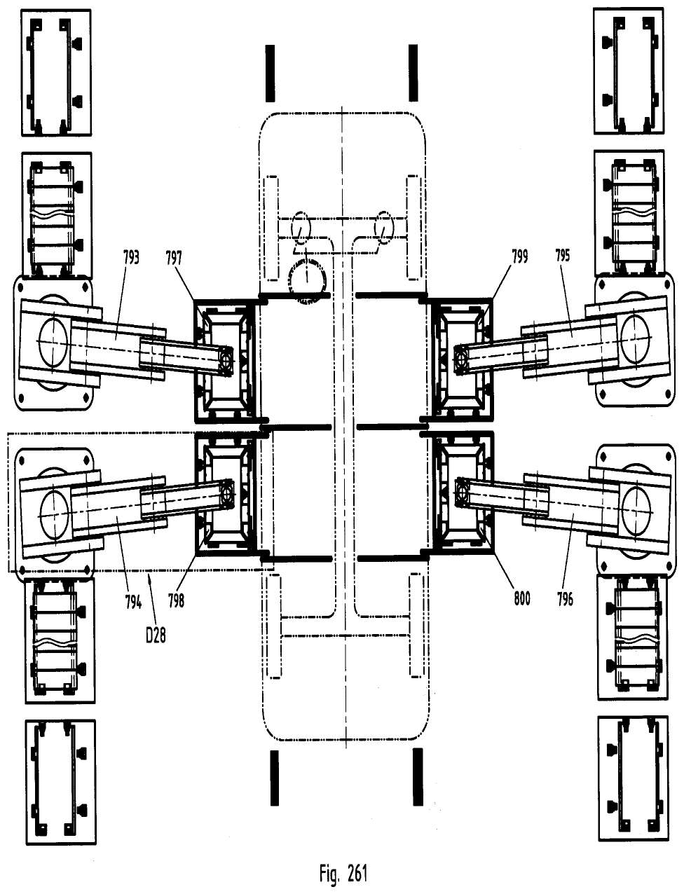

In FIG. 260 is illustrated another step of the battery change cycle, when the robot 791 is griping the full recharged battery 792 for change. The FIG. 261 shows the four robots of the battery change line 793, 794, 795 and 796 installing simultaneously the full recharge batteries 797, 798, 799 and 800 in the vehicle drawers.

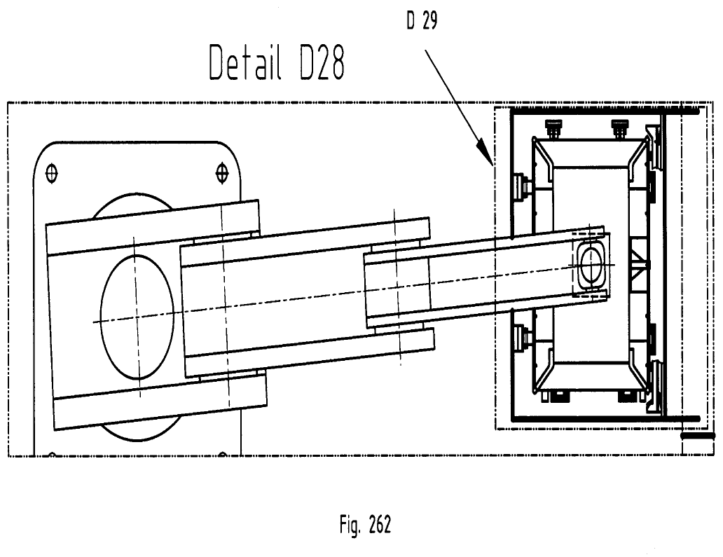

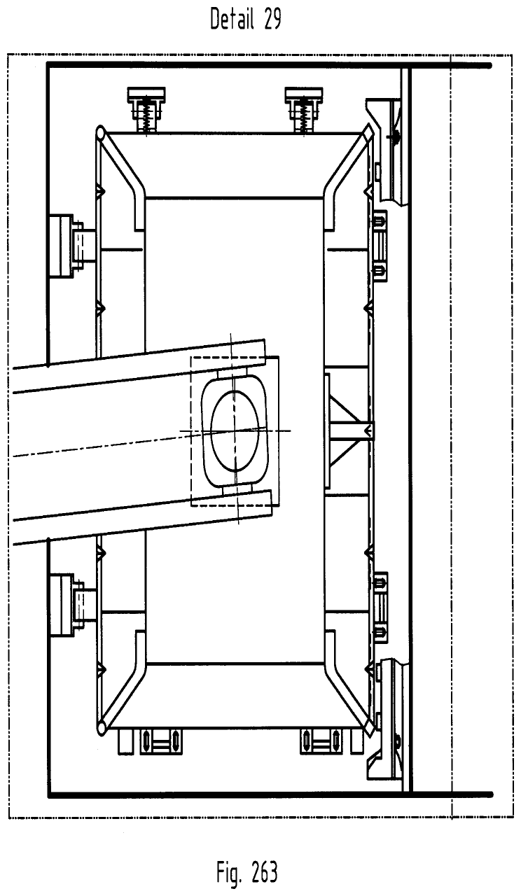

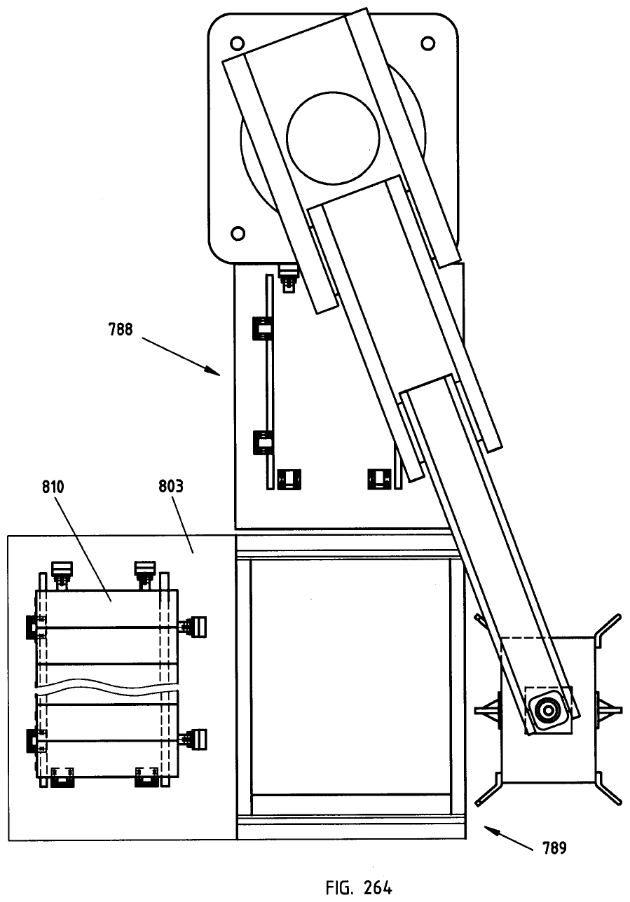

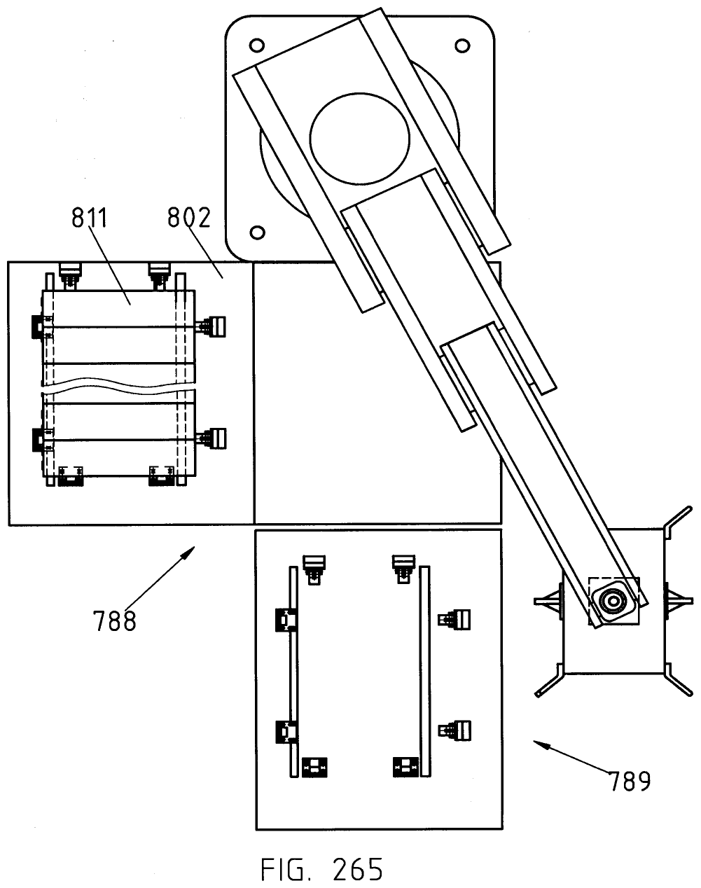

The FIG. 262 is the Detail D28 of the FIG. 261, and the FIG. 263 is the Detail D29 of the FIG. 262, showing an embodiment using all the previous embodiments for the electric vehicle drawers. As shown in FIG. 260, the empty battery package 801 and the full recharged battery package 792 are placed on the dedicated sub-stations on a sliding table 802 respective 803, which are capable to slide on a perpendicular direction to the battery change line on the side slides 804 and 805 installed on their respective supports 806 and 807. The pneumatic cylinders 808 and 809 move the sliding tables with the battery packages IN and OUT. In the OUT position of the sliding tables, the battery packages are into a position to be grasped by the storage robot of the battery change station and placed on the storage drawers. In FIG. 264 is shown the sub-station 789 with the sliding table 803 OUT, wright after it received the full recharged battery package 810, deposed by the storage robot on it. In FIG. 265 is shown the sub-station 789 without any battery package on it, after the full recharged battery package was installed on the electric vehicle, and the sub-station 788 with the sliding table 802 OUT, having the empty battery package 811 prepared to be taken by the storage robot and placed into a storage drawer for recharge.

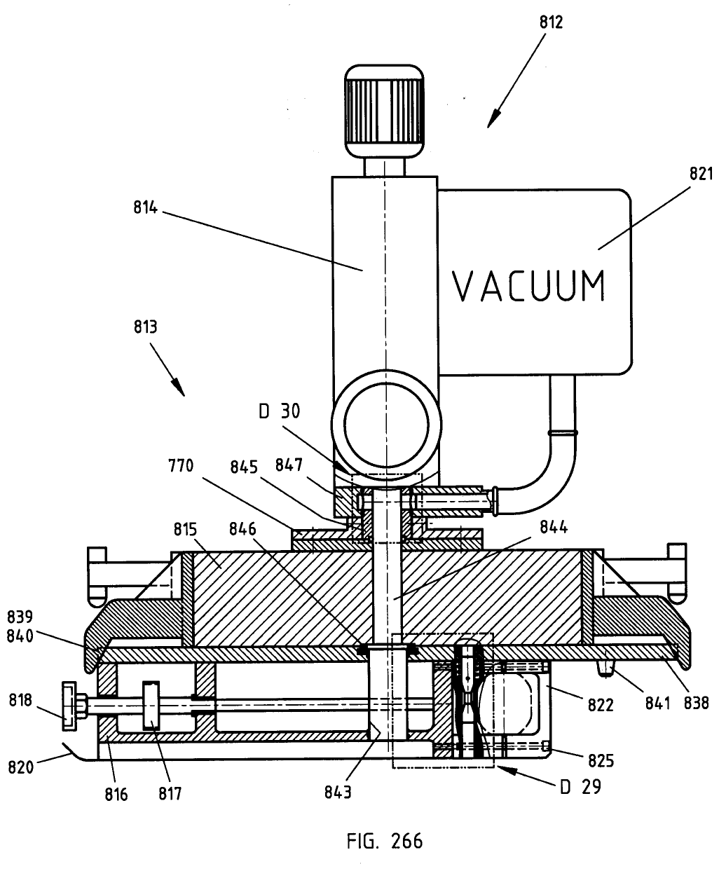

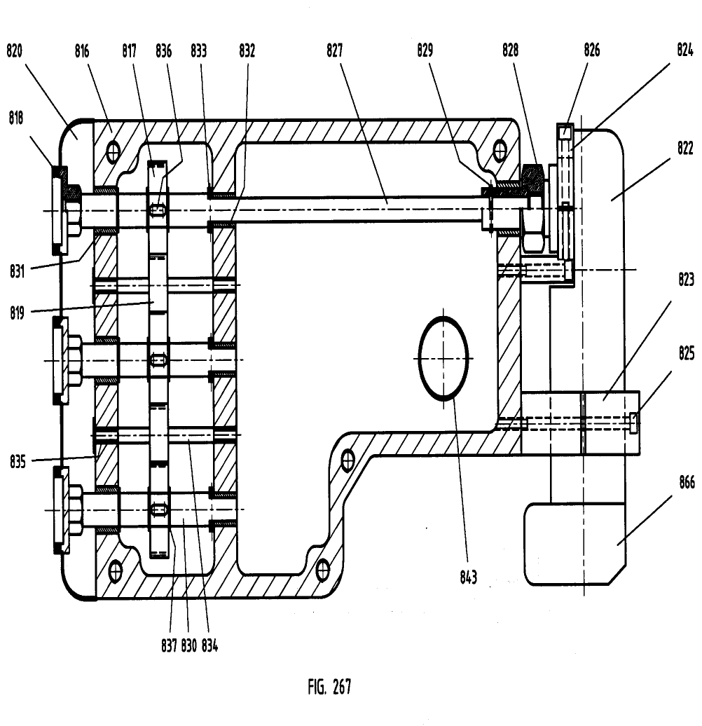

In case of an automated battery change station, for contacts of the contact plates and for batteries terminals, a special cleaning device is required. For side battery terminals and their appropriate contact plates mounted on the rear wall of the drawers in a vertical plane, the automate cleaning is done by the 5 axis robot 812 using a cleaning device 813, see FIG. 266. The cleaning device 813 is attached to the rotary head 814 of the robot by the same electromagnet 815 used to manipulate the battery packages. The cleaning device consists in a case 816 including a plurality of cylindrical gears 817 (see FIG. 267 also) mounted on the same axis with a plurality of wire brushes 818 installed outside of the case 816, a plurality of intermediary cylindrical gears 819, which transmit the rotation to all wire brushes 818, a dust collector 820, which communicates to a vacuum cleaner 821 installed on the rotary head 814 of the robot and an actuator 822, which in this embodiment may be an electrical grinder. As can be seen in FIG. 267 the electrical grinder 822 is attached to the cleaning device case by the brackets 823 and 824 using some bolts 825 and 826 and to the main axis of the cleaning device 827 by a connecting member 828 and by a spring pin 829.

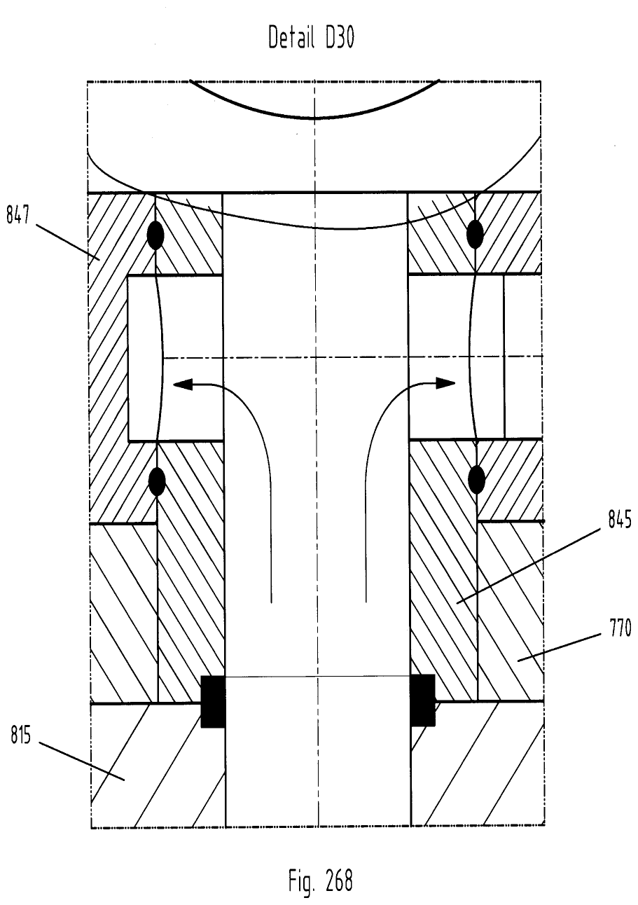

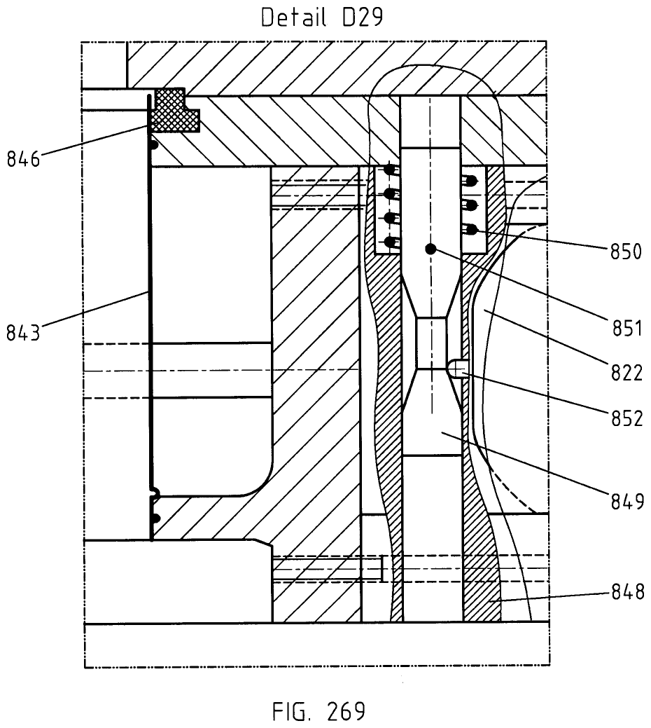

Each wire brush is installed on a “working axis” 830, which turns on the sliding bearing 831 and 832 and on an axial bearing 833. The intermediary axis 834 turn on slide bearings 835. The cylindrical gears 817 are installed on the “working axis” 827 & 830 by parallel keys 836 and they are kept in place by elastic rings 837. The intermediary cylindrical gears 819 are press-fit mounted on the intermediary axis 834. The “working axis” have a threaded end on which the wire brushes 818 are installed. The case 816 is closed by a cover plate 838 made on a magnetic material. In order to control the position of the cleaning device with respect to the rotary head of the robot, the cover plate 838 has two symmetrical taper slots 839 (the same kind of slots as the battery modules) to accommodate the log 840 of the electromagnet 815. Underneath of the cover plate 838 are installed two taper pins 841 which control the cleaning device position on its support. These two taper pins enter into the corresponding holes made in the cleaning device support, when the cleaning device is disposed, after cleaning operation. The dust collector 820 is installed underneath of the case 816 and communicates with the vacuum cleaner 821 by the tube 843, which traverses the cleaning device, by a central hole 844 of the electromagnet 815 and a series of holes traversing the platform 770 and the shaft 845 of the rotary head 814 as shown as well in FIG. 268 which is the Detail D30 of FIG. 266. The tube 843 is sealed on the cleaning device case 816 and on the cover plate 838 by the “O” rings. The gasket 846 is placed on top of the cover plate 838 ensuring the seal between the cleaning device and the electromagnet 815. On the shaft 845 of the rotary head 814 there is a central hole, which communicates with a stationary circular collector 847, connected to the vacuum cleaner 821, by a plurality of radial holes. The electric grinder 822 is a wireless grinder, working with the battery 866. The grinder is turn on/off in the moment the cleaning device 813 is clamped or unclamped by the electromagnet 815, by a mechanism shown in Detail D29 of FIG. 266 in FIG. 269. This mechanism comprises the fixed member of the grinder attachment 848, having a cylindrical hole in which slides the magnetic plunger 849, an elastic element, which in this embodiment is a compression spring 850 pushing the plunger 849 via a spring pin 851. The plunger 849 has a portion with a smaller diameter than the both ends, and a taper portion makes the transition between the two diameters. This small diameter creates a gap inside of the hole of the grinder attachment member 848 on which enters the switch 852 of the grinder 822, which is in OFF position. When the cleaning device 813 is attached to the rotary head 814 of the robot, the electromagnet 815 attracts the magnetic plunger to it. The plunger 848 moves to the electromagnet, compressing the spring 849 and in the same time pushing with its taper portion the grinder switch 849 in the ON position. After the cleaning was done, when the robot deposes the cleaning device, by deactivating the electromagnet 815, the plunger 851 is released and the grinder 822 is turned OFF.

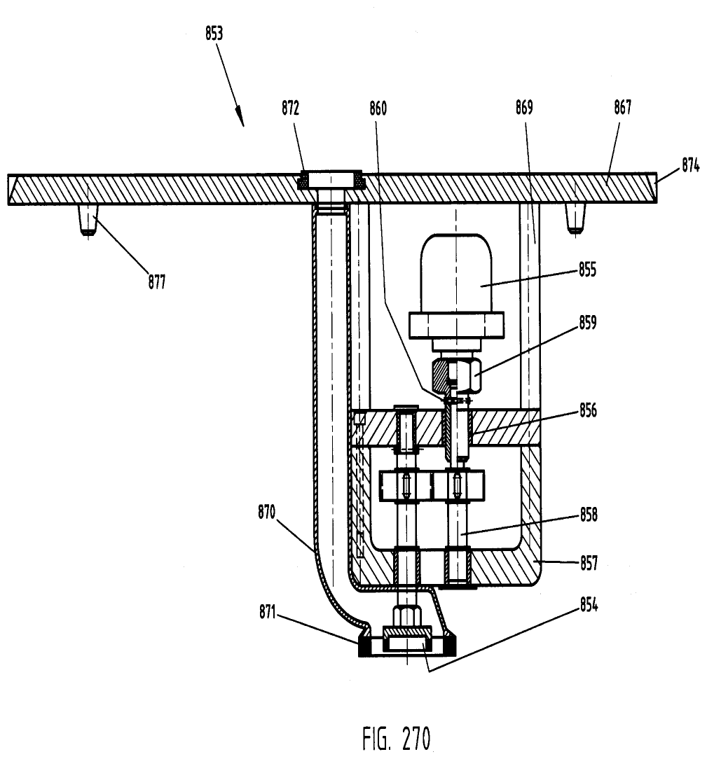

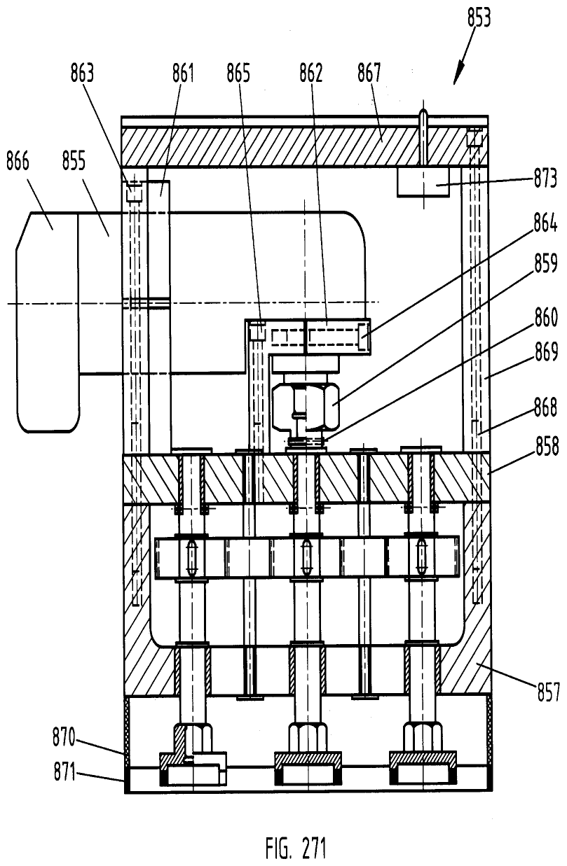

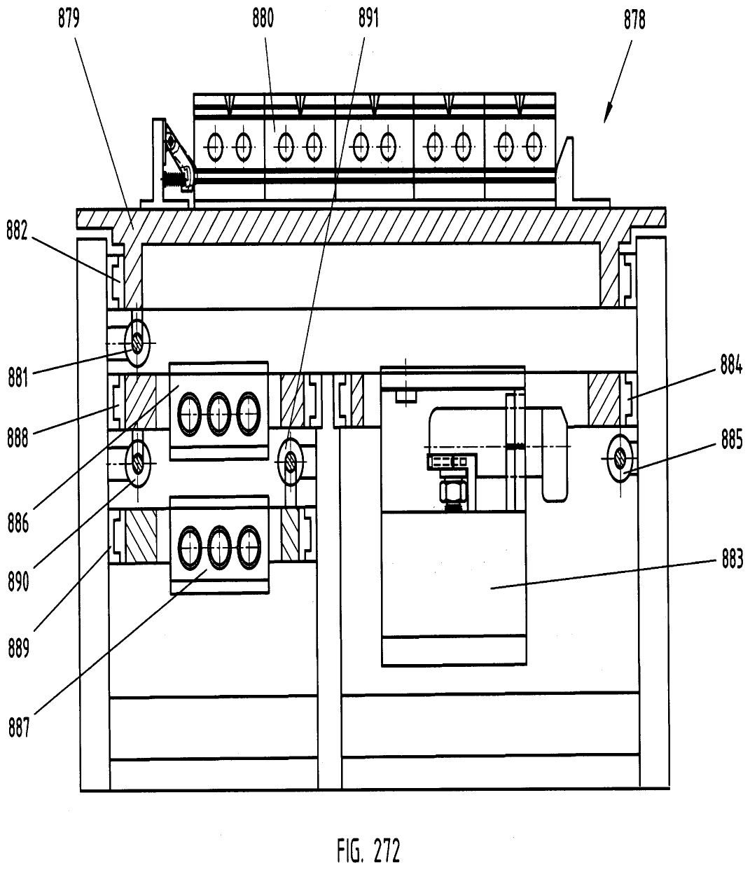

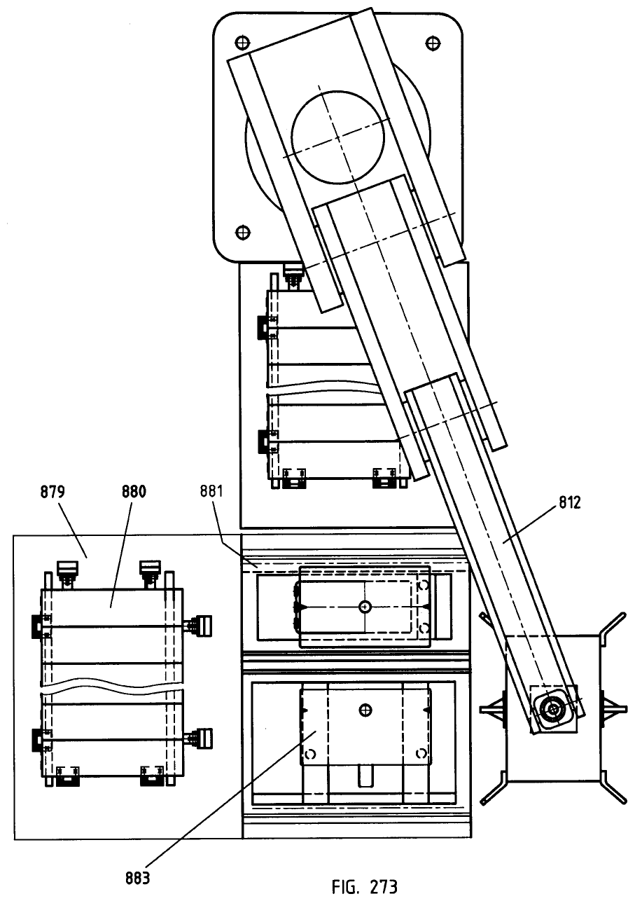

For the contact plate installed on the bottom of the drawers, used for the battery packages with bottom terminals active, the contact cleaning device is shown in FIG. 270 and FIG. 271. This contact cleaning device 853 is similar with the contact cleaning device 813 for side contacts. The essential difference consists in the fact that in this case the wire brushes 854 have a vertical axis. Therefore, the wireless electrical grinder 855 is installed on the cover 856 of the case 857, having a vertical grinding axis, acting on an intermediary axis 858. The electric grinder 855 is connected to the intermediary axis 858 by a connection member 859 via the spring pin 860, which is positioned outside of the cleaning device case 857 and the cover 856, in order to be able to assemble the connection member 859. The electric grinder is attached to the cover 856 by attaching means 861 and 862 using the 863, 864 and 865 bolts. The electric grinder is powered by the battery 866. On top of the electric grinder there is an attaching plate 867, which is made on a magnetic material, capable to be attached to the robot by the electromagnet 815. The case 857 with its cover 856 is attached to the attaching plate 867 by a plurality of bolts 868 and the spacers 869. The dust collector 870 ends with a kind of flexible, soft brush 871 around the wire brushes 854, and it is connected to the central hole of the electromagnet 815 via the attaching plate hole and the gasket 872. The electric grinder is turned ON/OFF by a switch 873 installed underneath of the attaching plate 867. In order to control the position of the cleaning device with respect to the rotary head of the robot, the attaching plate 867 has two symmetrical taper slots 874 on which the taper log 840 of the electromagnet 815 is entering (the same kind of slots as for the battery modules), (see FIG. 266 as well). Underneath of the attaching plate there are two tapered pins 877 serving to control the position of the cleaning device when it is deposed in its support after cleaning operation. In order to use the space of the battery change line efficiently, these cleaning devices are kept underneath of the sliding table of the sub-station 878 used to keep in stand-by the recharged battery package. In FIG. 272 is shown this sub-station 878 having on top the sliding table 879 on which is placed the battery package 880. The sliding table 879 may slide out laterally to the storage area activated by a pneumatic cylinder 881 using the side slides 882.

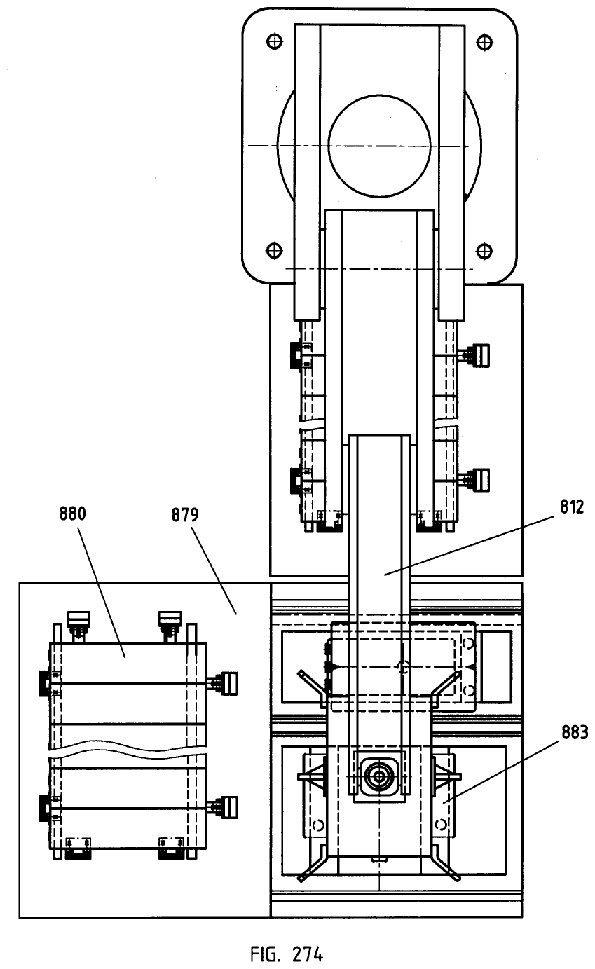

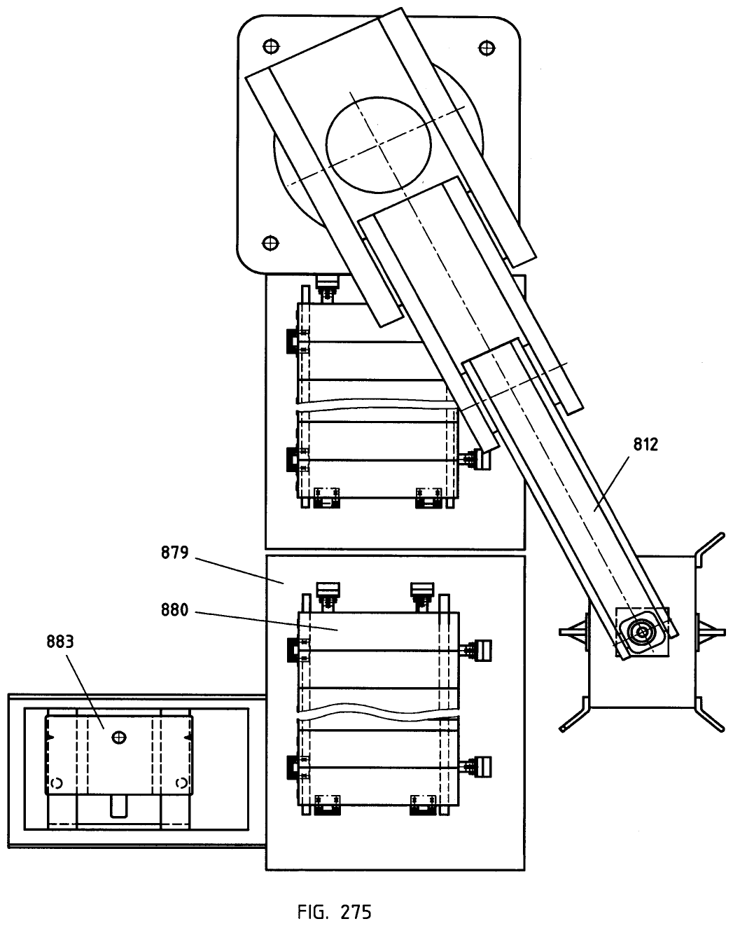

Underneath of the sliding table 879 are placed the cleaning devices. There is a unique cleaning device 883 used to clean the contacts of the contact plate installed into the vehicle drawers and into the storage drawers. This cleaning device is installed on a sliding support, capable to slide on the side slides 884 and moved IN and OUT by the pneumatic cylinder 885 (see FIG. 272). The cleaning device 883 is used by both robots—the battery change robot and the storage robot. The access to this cleaning device by the battery change robot is possible by moving OUT to the storage area the sliding table 879 by the pneumatic cylinder 881 and in this way creating free access to the cleaning device 883, by the top, see FIG. 273. In FIG. 274 can be seen the battery change robot 812 griping the cleaning device 883 in order to clean the contact plate bottom contacts of the vehicle drawer. In FIG. 275 is illustrated the sliding table 879 IN and the cleaning device 883 moved OUT by the pneumatic cylinder 885, being prepared to be used by the storage robot for cleaning the bottom contacts of contact plates installed on the storage drawers.

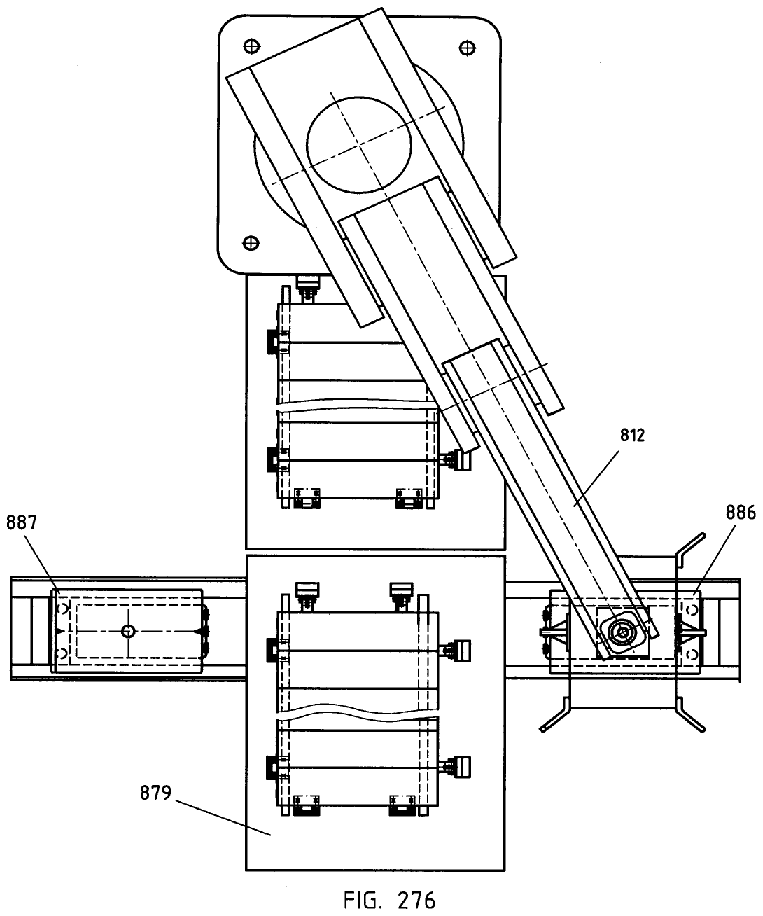

Underneath of the sliding table 879, there are also two identical cleaning devices (for side contacts) 886 and 887, one on top to another, see FIG. 272. Each of these cleaning devices are placed on a kind of drawer having side sliding elements 888 and 889, allowing to the cleaning devices to go out and make them accessible. One of them (ex. 886) activated by the pneumatic cylinder 890 slides out to the vehicle side, and another one (ex. 887) activated by the pneumatic cylinder 891 slides on the opposite direction to the storage area, see FIG. 276. In this example, the cleaning device 886 is used by the battery change robot 812 to clean the side contacts of the vehicle contact plates and the side contacts of the empty battery after its deposition outside of the vehicle. The another cleaning device 887 will be used by the storage robot to clean the side contacts of contact plates installed on the storage drawers. The use of two cleaning devices is necessary in case when the aim is to minimize the size of the battery change area, because in this way the sub-station 878 takes minimum space. It is possible to use one single cleaning device for side contacts, which slides into the storage area. In this case the battery change robot takes the cleaning device when it is in IN position, but it is required much more space in order to avoid collisions with the cameras, when it picks up the cleaning device 886.

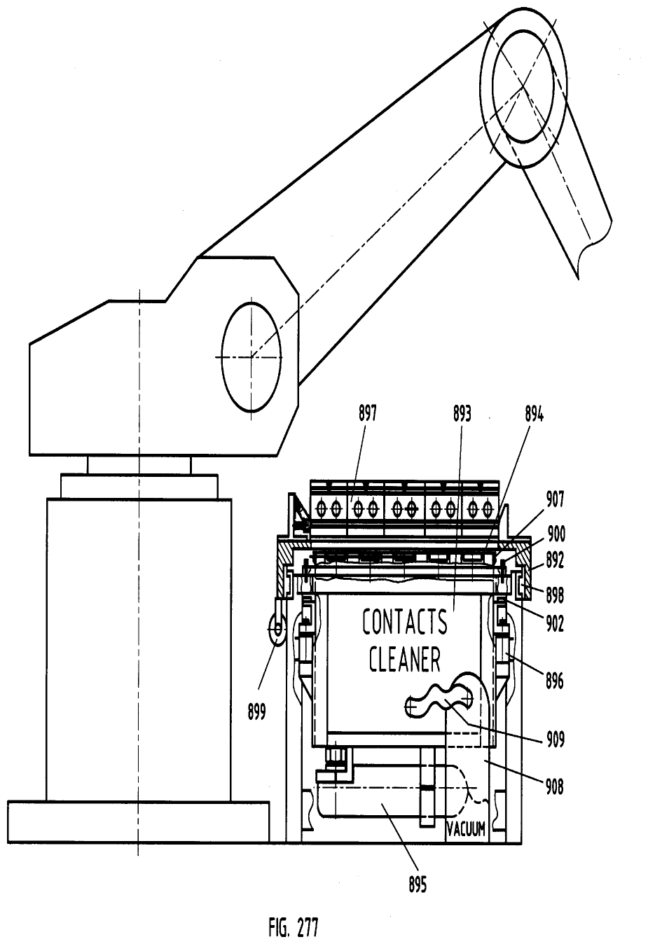

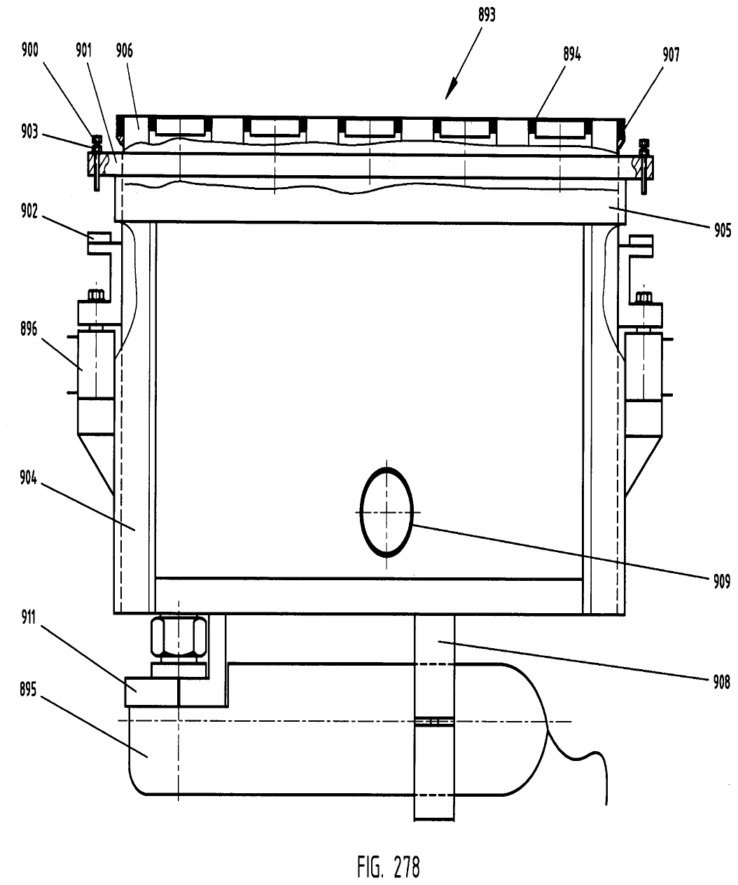

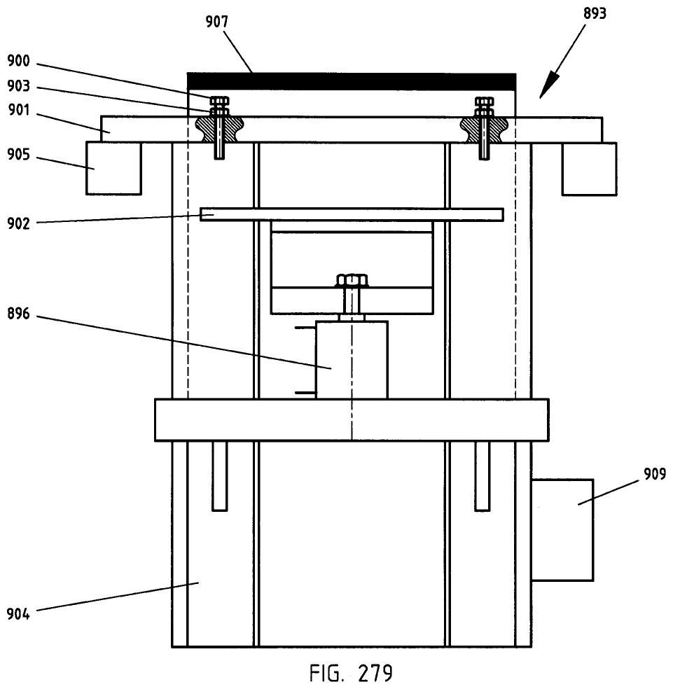

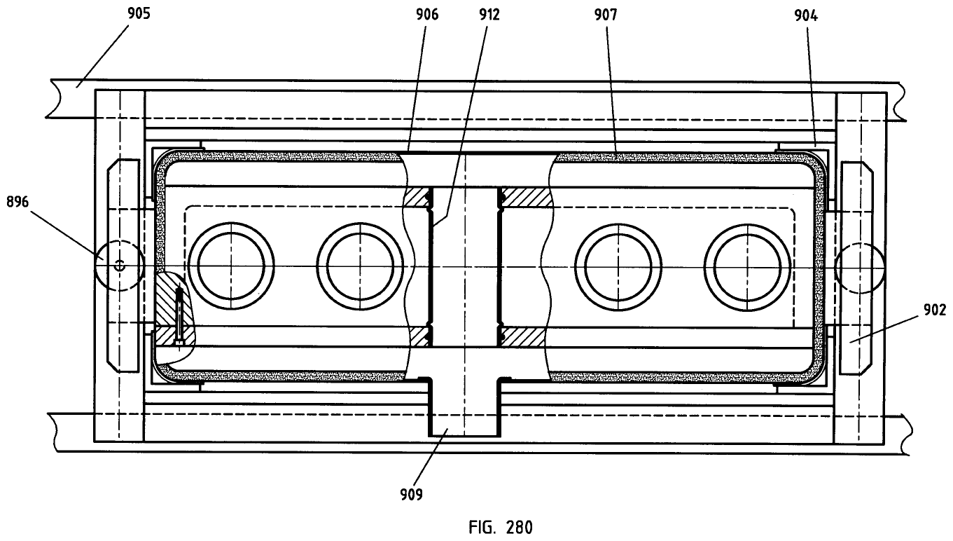

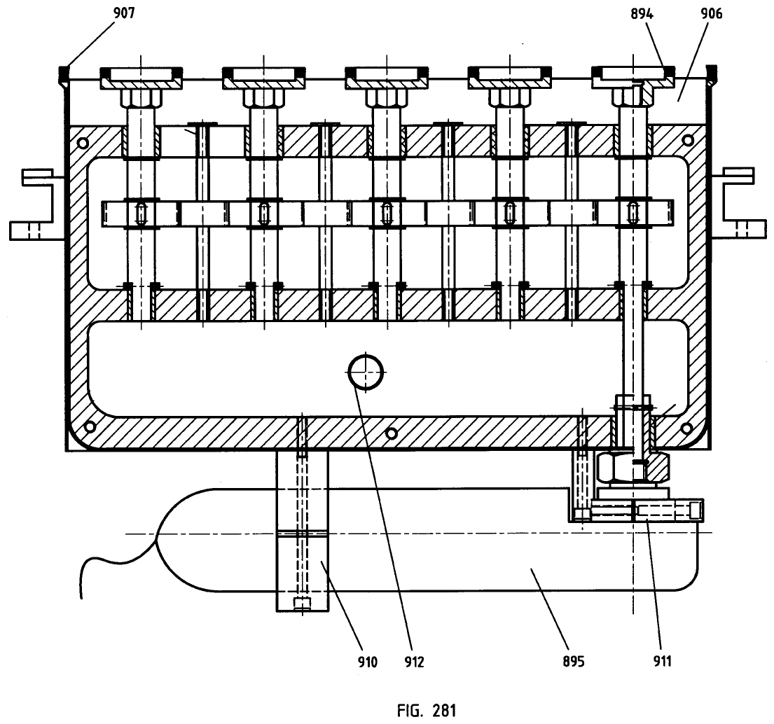

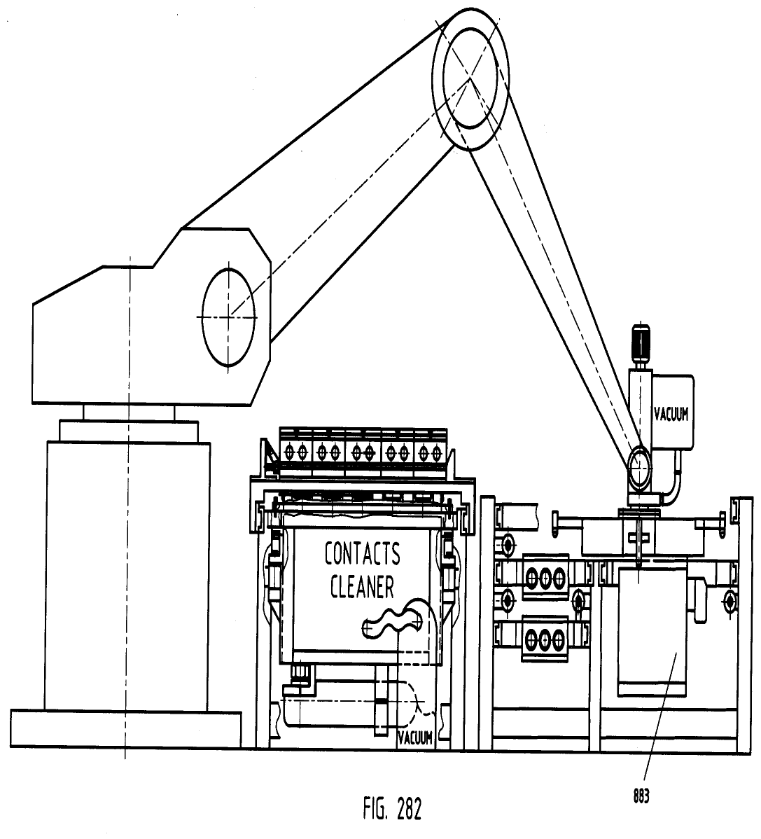

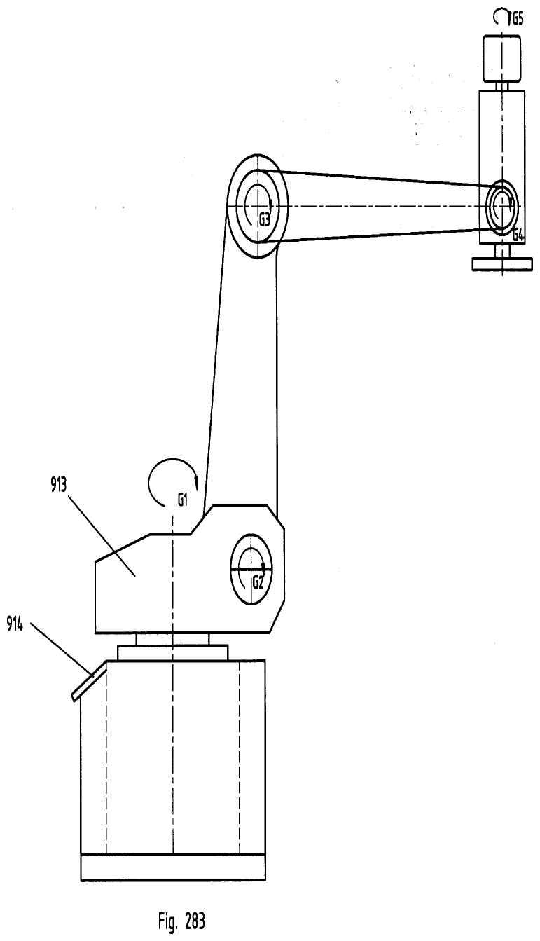

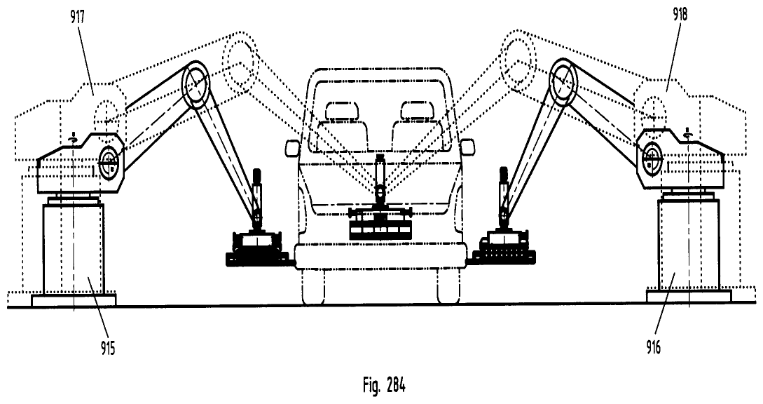

For the battery bottom terminals the cleaning device is similar with the cleaning device 883 used to clean the contacts of the contact plates installed on the vehicles for battery bottom terminals. As can be seen in FIG. 277, this cleaning device is installed underneath of the sliding hollow table 892 of the sub-station where the empty battery package is deposed. The table 892 has an opening portion in the area where the bottom terminals of the battery package arrive, creating free access from underneath to its bottom terminals. In this area is installed the cleaning device 893, with a plurality of vertical axis wire brushes 894 up. In the “no working position”, there is a gap between the bottom terminals of the battery package and the contact cleaning device wire brushes 894. During the cleaning operation, the brushes 894 are rotated by the electric grinder 895, the contact cleaning device 893 is pushed up by a plurality of little pneumatic cylinders 896, till the brushes touch the bottom terminals of the battery package. In order to clean all bottom battery package terminals, the entire table 892 having on it the battery package 897, slides OUT to the storage area on the side slides 898, activated by the pneumatic cylinder 899. So, the cleaning device is in a stationary position, and the battery package is moving during the cleaning operation. The height of the cleaning device brushes may be adjusted using the bolts 900 threaded in the traverse 901 and the stopper 902, see FIG. 277 to FIG. 281. The bolts 900 are locked in the wright position by the lock-nut 903. The entire cleaning device is sliding vertically within a kind of frame 904. The beams 905 support the cleaning device when it is retracted. All around the wire brushes 894 there is a dust collector 906 having on top a kind of flexible, soft brushes 907. This device is connected to a vacuum cleaner 908 installed stationary underneath of the table 892, by a vacuum connector 909, see FIG. 277. The FIG. 281 is a cross section on the axial plan of the wire brushes 894, showing the whole chain of gears of the transmission mechanism required. It is shown as well the attaching elements 910 and 911 for the electrical grinder. The dust tube 912 which links the two opposite compartments of the dust collector 906 is well shown in FIG. 280. The FIG. 282 illustrates a lateral view of the battery change robot, griping the cleaning device 883 for the bottom contacts of the contact plates of the electric vehicle. The control of these cleaning devices and of the sliding tables are included into the two robots program. In FIG. 283 is shown the battery change robot 913 having a control panel 914 for the manual operation and programing.

Up to here, the battery change robots presented were used to change the battery packages of the lateral drawers of cars (right and left). This has to be the most potential solution in the future for electric cars. But, if there are cars with front and rear drawers, the solution for an automate battery change line is to use on each side one small robot for one lateral drawer (915 for left lateral rear drawer and 916 for the right lateral front drawer), and one big robot, for the second lateral drawer and for the front or for the rear drawer (917 for left front lateral drawer and for the front drawer, and 918 for the right lateral rear drawer and for the rear drawer) as illustrated in FIG. 284.

Different electric vehicle makers may use different configurations of battery packages, therefore, even if the battery modules are standardized, the packages may be different, for different vehicles. So, it is necessary to accommodate the battery packages to each vehicle model. In order to be able to do this, in the loading utility, is required to have a packing and unpacking station. In the first time, when the volume is low, and the loading utilities are manual operated, the packing operation is easy to do by an operator on a horizontal press and the unpacking may be realized by using general purpose tools. When the volume increases, and the automation is required, for packing and unpacking operation an automate machine is a must.

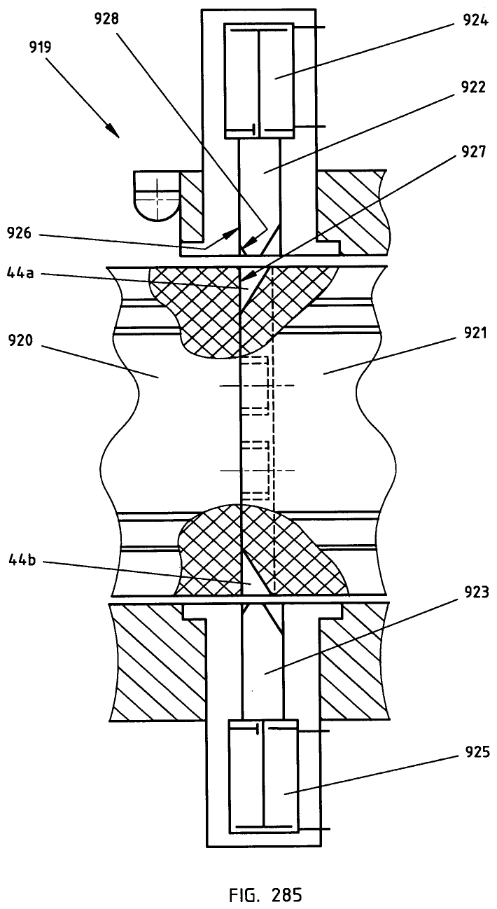

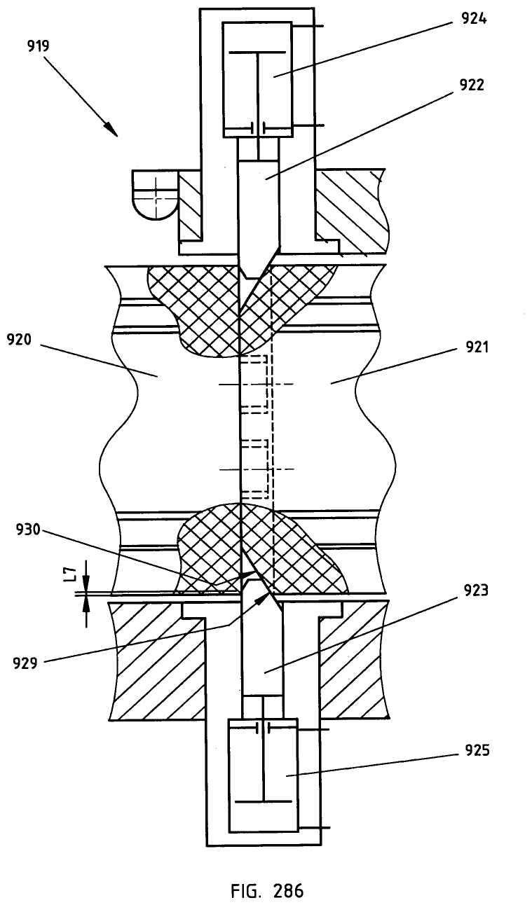

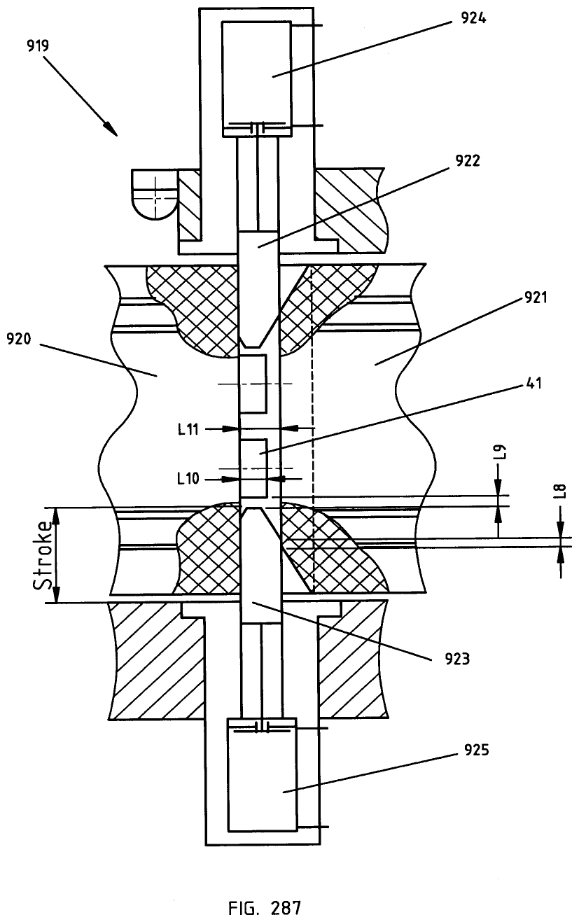

As described before, the battery package is designed with a plurality of pairs of unpacking taper slots 44 in opposite position, located on the boundary between two battery modules. By pushing simultaneously some taper punches into the opposite unpacking taper slots 44, the two modules will be taken apart. En embodiment of this unpacking principle is shown sequentially in FIG. 285 to FIG. 287. The battery package 919 comprising the two modules 920 and 921, and having the unpacking taper slots 44a and 44b in opposite position is shown packed in FIG. 285, where the superior taper punch 922 and the inferior taper punch 923 are retracted. The two punches 922 and 923, aligned with the unpacking slots 44a and 44b, are activated by the pneumatic cylinders 924 and 925. In FIG. 286 the two punches 922 and 923, pushed by the pneumatic cylinders 924 and 925, are shown in contact with the unpacking taper slots 44a & 44b, jest before of unpacking process (the two modules are still attached, no one is moved). The FIG. 287 shows the punches in ultimate position, for entire stroke of the pneumatic cylinders, when the two modules are detached. The taper punches 922 and 923 have a special geometry, see FIG. 285. They have a flat portion 926, which has to be aligned with the vertical surface 927 of the taper unpacking slots 44. In order to facilitate the entrance into the slot 44, without any damages, generated by a miss alignment, the punches 922 and 923 are designed with a little taper portion 928. On the opposite side of the punches 922 and 923 it is a bigger taper portion 929, see FIG. 286, but this one has to be in a way that when it touches the taper surface 930 of the unpacking taper slot 44, the punch is already engaged into the slot and its flat surface 926 is in contact with the flat surface 927 of the slot 44 on a length L7>0, see FIG. 286. In this way the force component on the perpendicular direction to the punch axis will be balanced by the contra-force generated on the opposite side on the flat surface 926 of the punches 922 and 923, and the punches will not be deformed. This force, acting axially on the big/small attaching plastic tubular cylinders 41 and 42, will push the module 921 out. In order to detach completely the module 921 from the module 920, the width L11 of punches 922 and 923 has to be greater than the height L10 of the tubular cylinder 41 and 42 (L11>L10), see FIG. 287. Also, when the punches are completely engaged, their taper portion is not anymore in contact with the battery module 921, passing by L8 the taper slot 44 (L8>0). It is necessary to keep a clearance L9 between the end of the punches 922 & 923 and the tubular cylinders 41 (L9>0). For packing, the principle consists in aligning the two modules and push them one against another using a press and a stopper. By pushing the battery modules against the stopper, the big/small attaching plastic tubular cylinders 41 and 42 will be deformed and the modules will be like stuck together creating the battery package.

Using these principles for packing and unpacking, depending on the solution adopted for each element, different devices can be designed. For each element, there are a multitude of potential solutions, such as following: fix or mobile and single or multiple stopper, fix or mobile, single or multiple superior or inferior punches, independent or dependent displacement of the mobile punches, hydraulic or screw-nut press, etc.

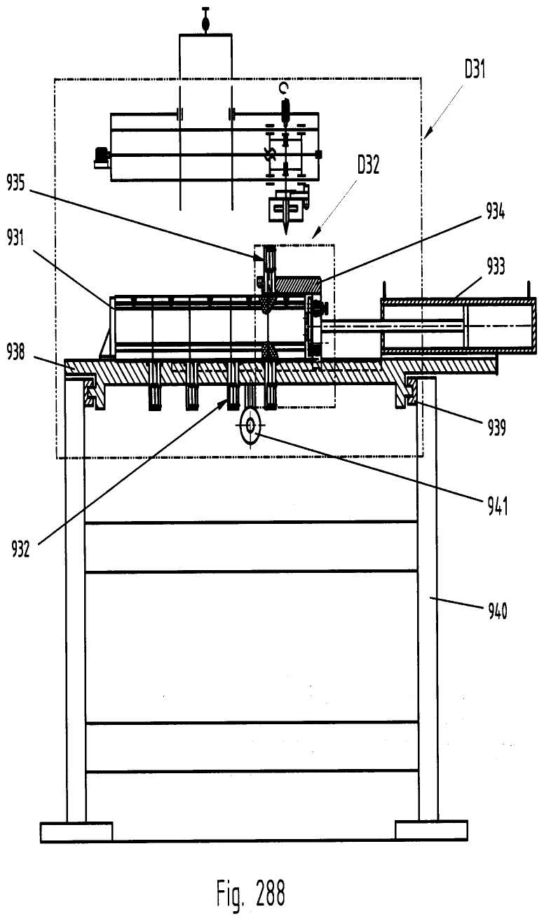

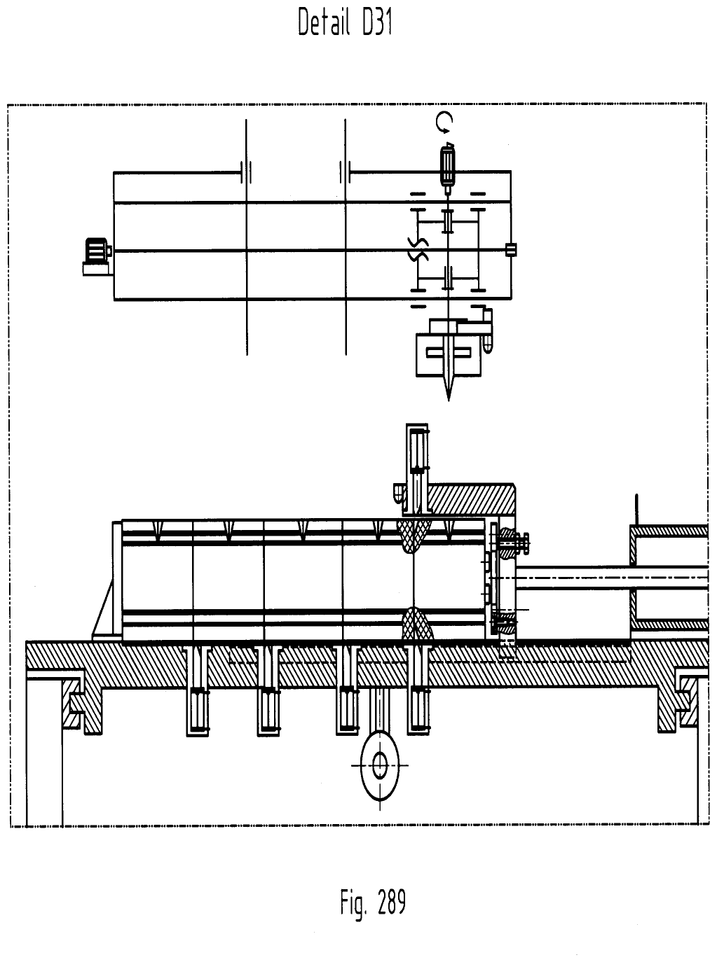

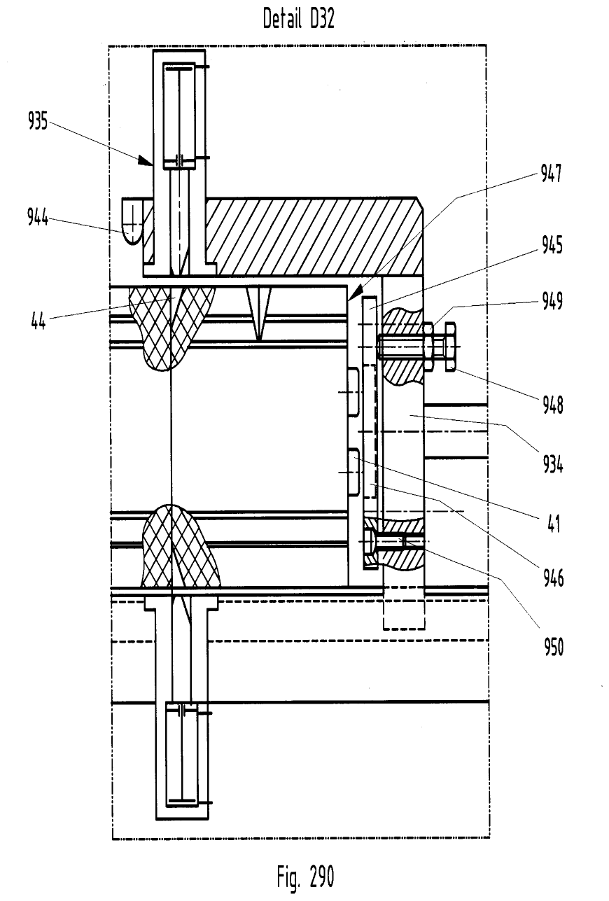

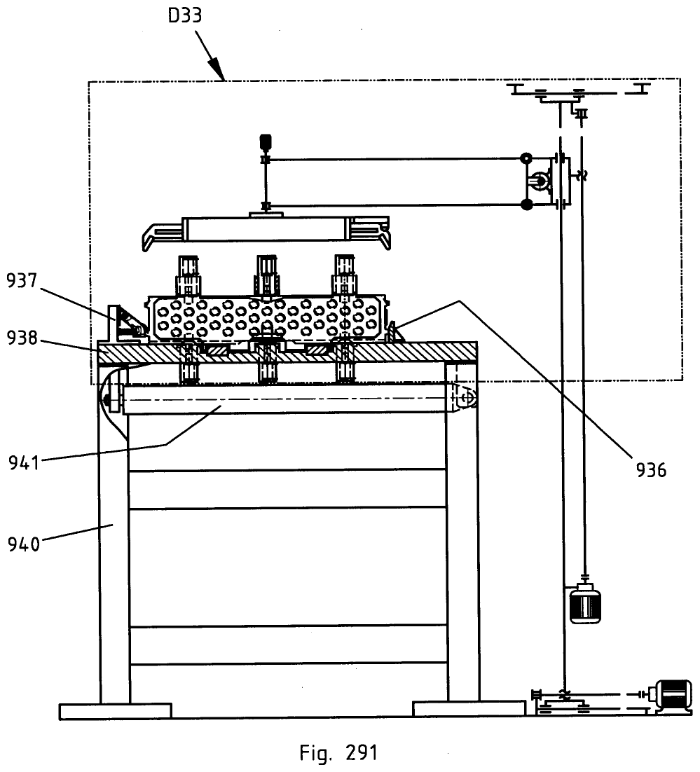

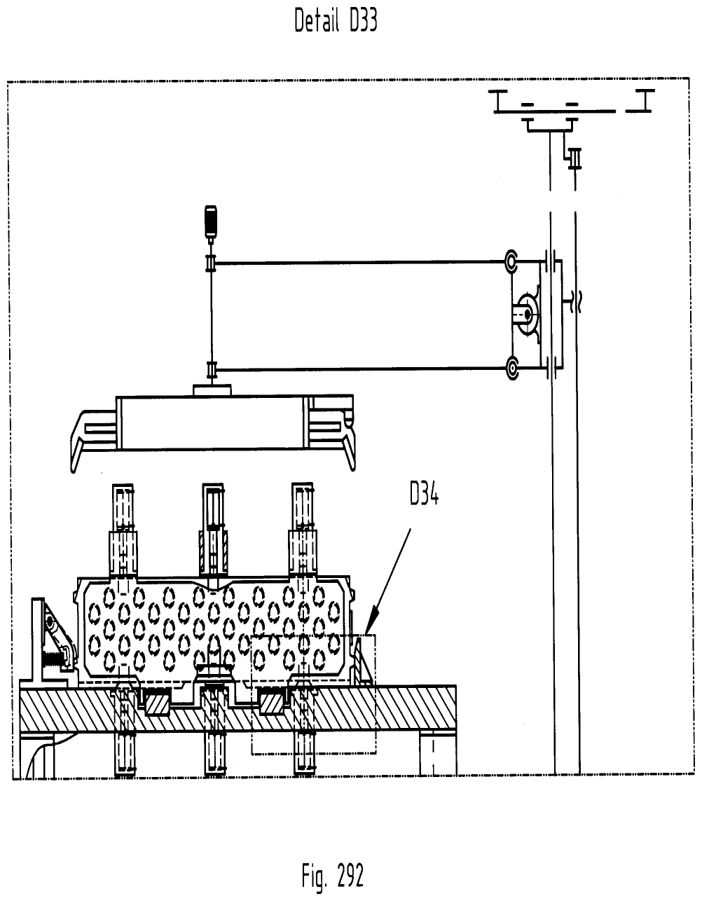

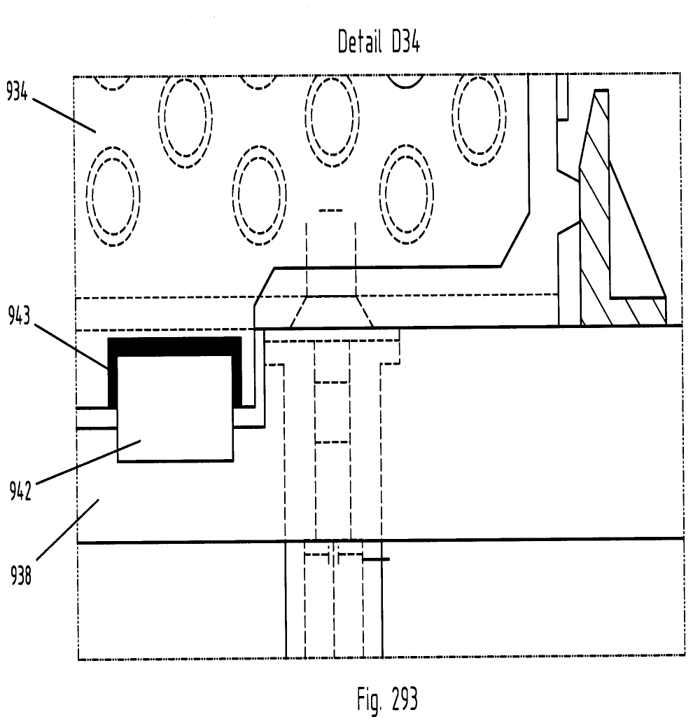

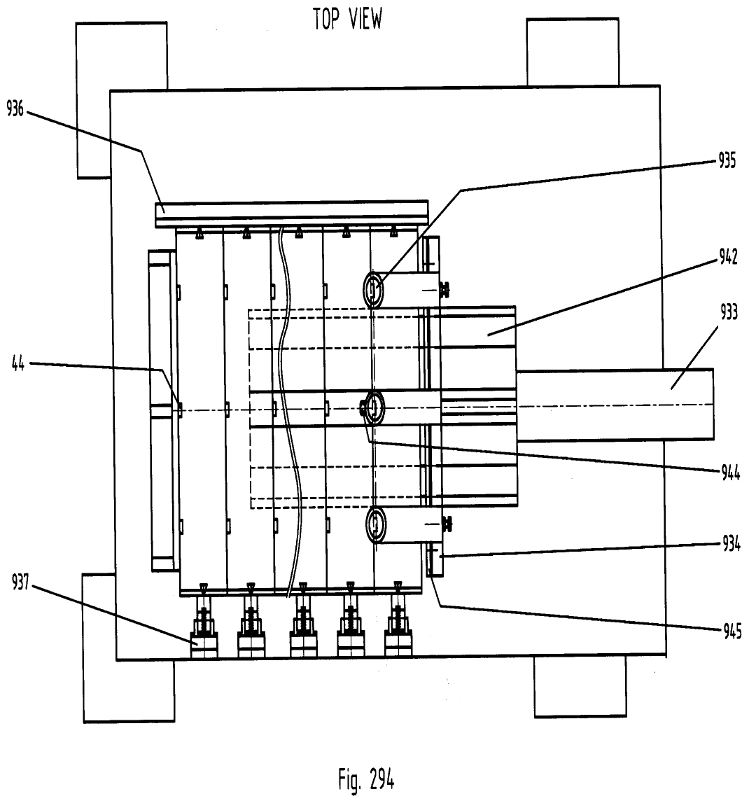

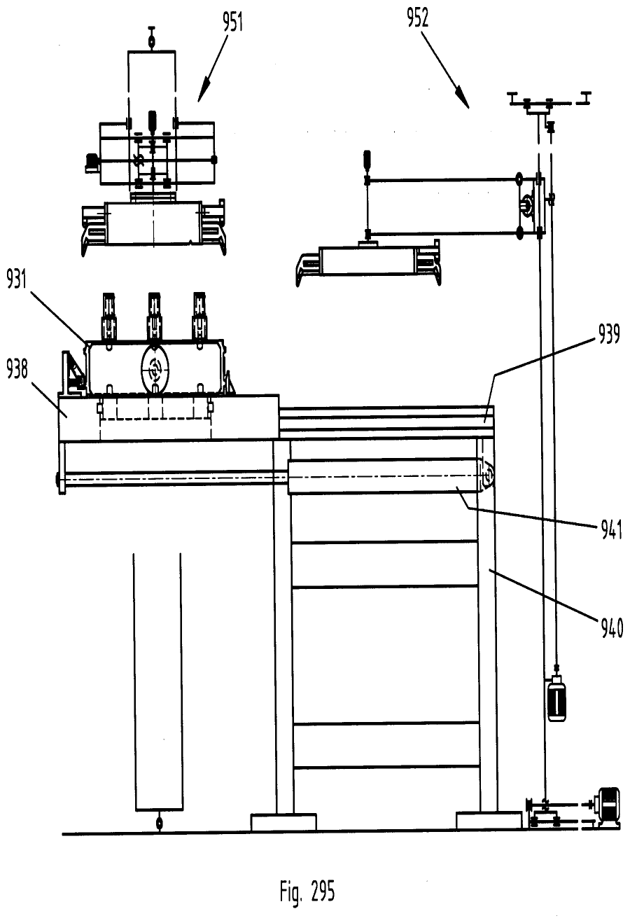

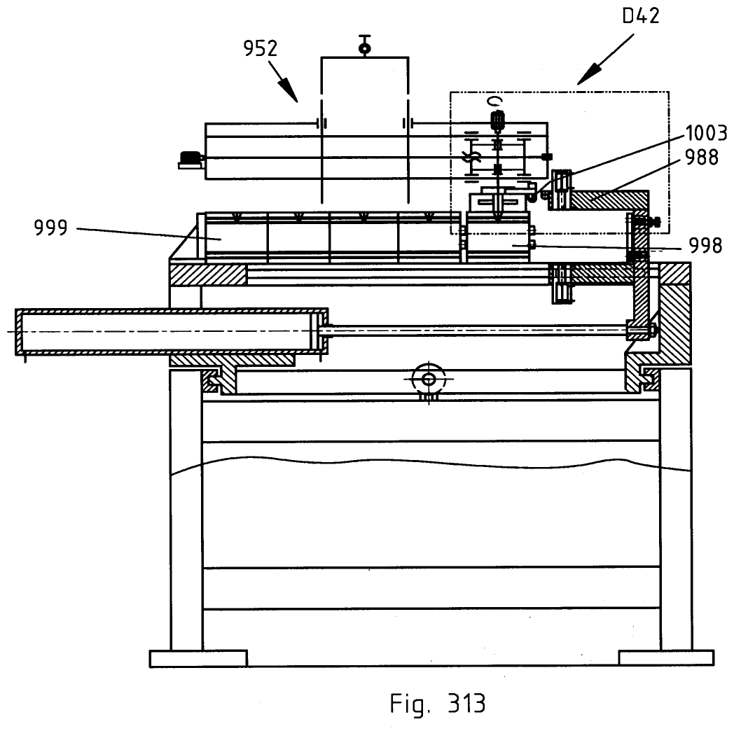

In FIG. 288 to FIG. 339 are illustrated the embodiments for different potential solution. In FIG. 288 to FIG. 294 is shown an embodiment for a packing and unpacking device comprising a fix stopper 931, a plurality of fix inferior pneumatic punches 932, a hydraulic cylinder 933 with linear motion control system, having attached on its piston a pushing head 934, on which is mounted a plurality of superior pneumatic punches 935. As shown in FIG. 291 and FIG. 294, the battery modules are aligned using a similar system as used on drawers, consisting of a fix liner 936 and a plurality of pushing devices 937. All these components are installed on a sliding table 938, having side slides 939 mounted on a solid structure 940 and moved IN & OUT by a pneumatic cylinder 941, see FIG. 288. The pushing head 934 is sliding on open slides comprising a sliding element 942 installed on the table 938, and sliding pads 943 attached to the pushing head, see FIG. 293. In order to well align the moving superior punches 935, see FIG. 290, in front of the pushing head is installed the camera 944, which visualize the taper slots 44 of the battery package and send the information to the linear motion control system of the hydraulic cylinder, to stop the punches 935 in the wright position. On the pushing head there are a pressure plate 945, mounted in front of the cylinder piston having a plurality of oval slots 946 greater in diameter and depth than the big attaching plastic tubular cylinders 41 of the battery module, creating a clearance between the plate 945 and the tubular cylinders 41. These oval slots 946 are aligned with the big attaching plastic tubular cylinders 41, allowing the contact of the pressure plate 945 with the battery module on the surface 947 and avoid punctual contacts on the big attaching plastic tubular cylinders 41. In order to have a full contact of the pressure plate 945 with the battery module on the surface 947, the pressure plate 945 is adjustable mounted on the pushing head 934 using a plurality of pressure screws 948 threaded into the pressure head 934 and locked by their lock-nuts 949, and the attaching screws 950, threaded on the pressure head 934 as well. By adjusting the pressure screws 948, it makes sure the pressure plate 945 seats on the full surface 947, even if the surface 947 is not perfectly perpendicular to the slides 942. The FIG. 294 is a top view of this embodiment. In order to be charged and discharged the device with a battery package, the sliding table 938 slides OUT activated by the pneumatic cylinder 941, being in a favourable position with respect to the storage robot 951, which is responsible to load and unload the pack/unpacking device with the battery packages, see FIG. 295. The single modules, unpacked or ready to be packed again, are manipulated by the single battery module storage robot 952. This robot takes the unpacked single battery modules and storage them on racks for single battery modules, or bring from these racks single modules which will be added to others, to create a new battery package.

The advantages of this embodiment is related to the fix components (stopper and inferior punches), which increase the device precision. The disadvantage consists in the fact there is an open slide for the pressure head, which is not very rigid and even if the pressure plate is adjustable, sometimes the full contact between the pressure plate and the surface 947 of the last battery module is not obtained.

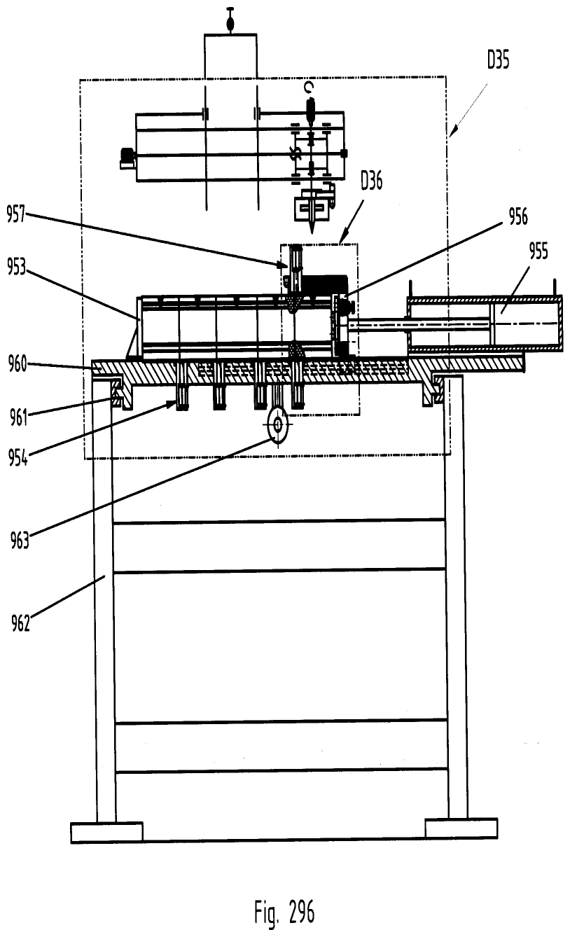

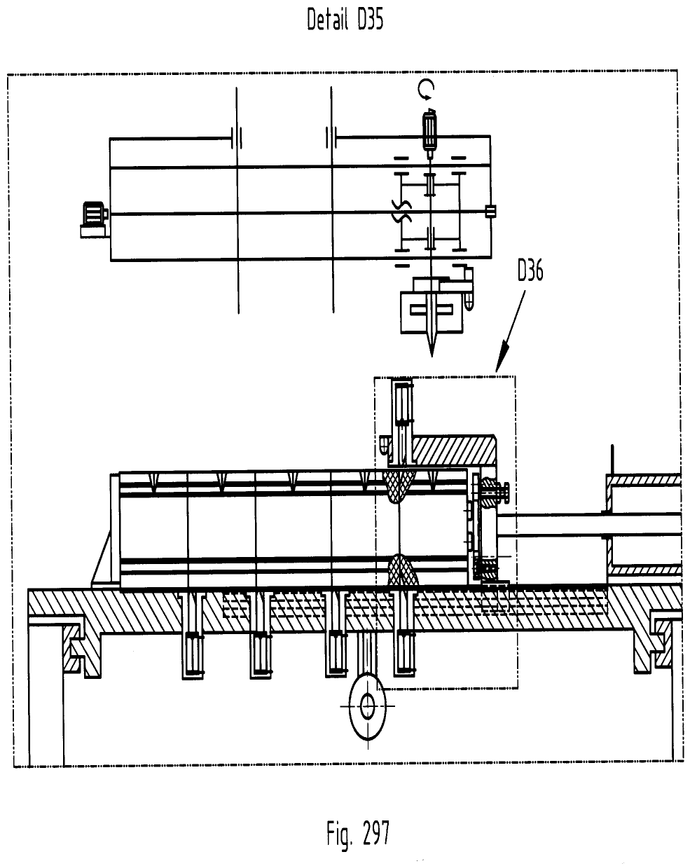

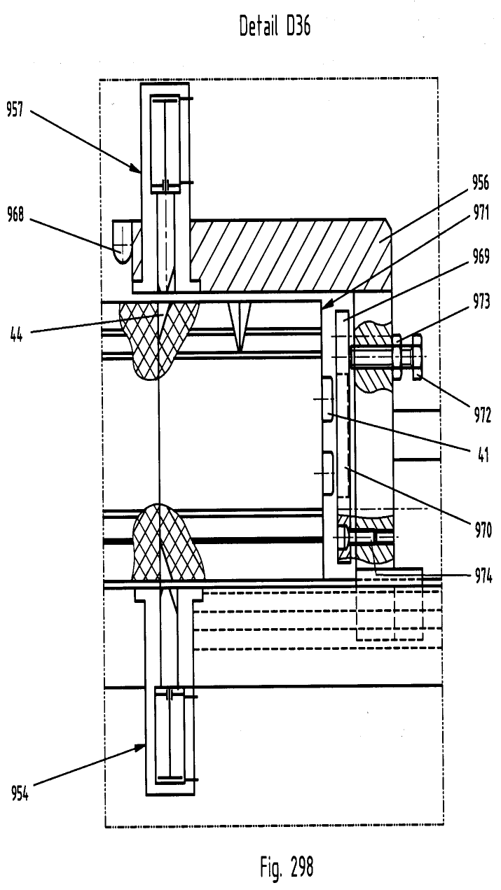

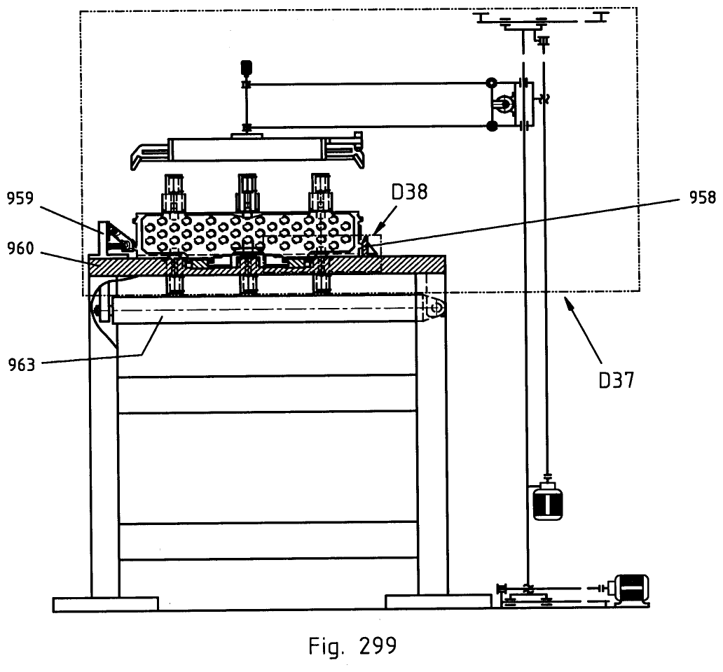

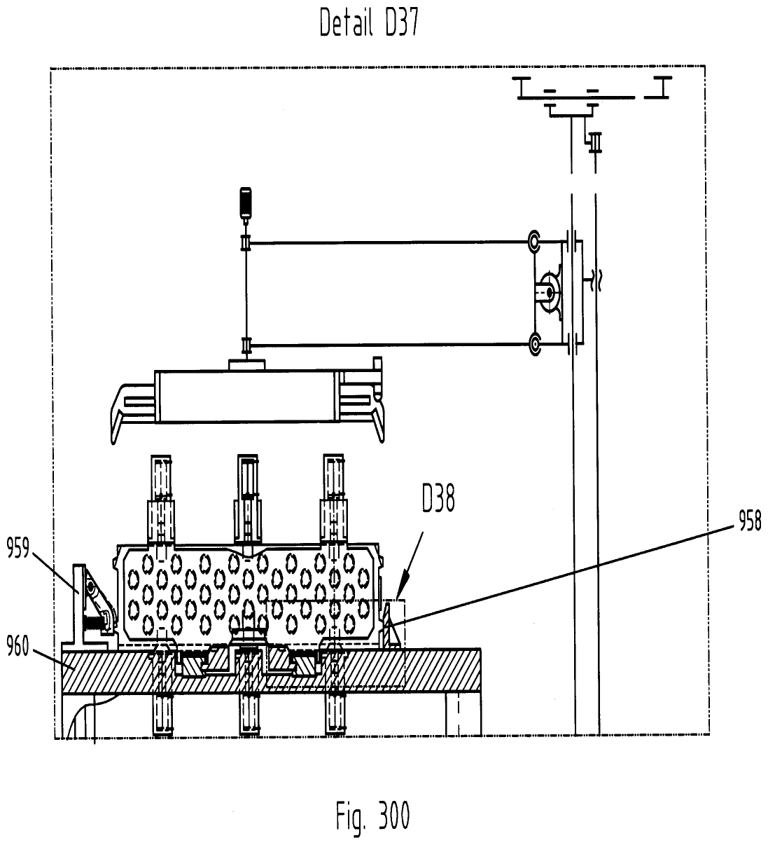

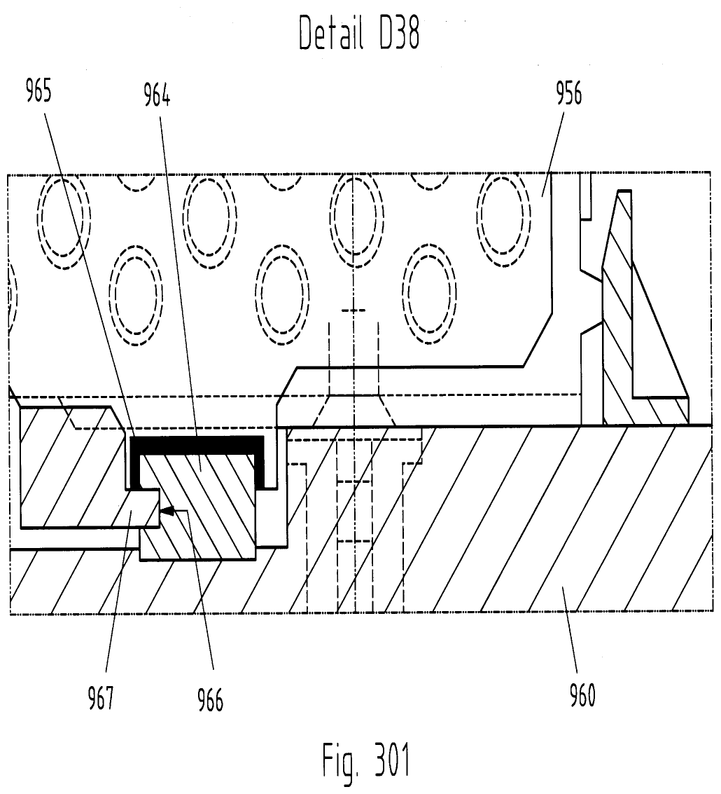

This inconvenient may be over passed by using a kind of sliding mechanism like in FIG. 301. The embodiment applying this principle is presented in FIG. 296 to FIG. 301 where is shown an embodiment for a packing and unpacking device comprising a fix stopper 953, a plurality of fix inferior pneumatic punches 954, a hydraulic cylinder 955 with linear motion control system, having attached on its piston a pushing head 956, on which is mounted a plurality of superior pneumatic punches 957. As shown in FIG. 299 and FIG. 300, the battery modules are aligned using a similar system as used on drawers, consisting of a fix liner 958 and a plurality of pushing devices 959. All these components are installed on a sliding table 960, having side slides 961 mounted on a solid structure 962 and moved IN & OUT by a pneumatic cylinder 963. The pushing head 956 is sliding on slides comprising a sliding element 964 installed on the sliding table 960, and sliding pads 965 attached to the pushing head 956, see FIG. 301. In order to increase the rigidity of these slides, the sliding element 964 has a longitudinal slot 966 in which is sliding a log kind of sliding element 967 attached to the pushing head 956. This is the difference between this embodiment and the previous one. In order to well align the moving superior punch 957 with the taper slots 44, see FIG. 298, in front of the pushing head 956 is installed the camera 968, which visualize the taper slots 44 of the battery package and send the information to the linear motion control system of the hydraulic cylinder 955, to stop the punches 957 in the wright position. On the pushing head there are a pressure plate 969, mounted in front of the piston of the cylinder 955, having a plurality of oval holes 970 greater in diameter and depth than the big attaching plastic tubular cylinder 41 of the battery module, creating a clearance between the plate 969 and the tubular cylinders 41. These holes are aligned with the big attaching plastic tubular cylinders 41, allowing the contact of the pressure plate 969 with the battery module on the surface 971 and avoid punctual contacts on the tubular cylinders 41. In order to have a full contact of the pressure plate 969 with the battery module on the surface 971, the pressure plate 969 is adjustable mounted on the pushing head 956 using a plurality of pressure screws 972 and their lock-nuts 973, and the attaching screws 974. By adjusting the pressure screws 972, it makes sure the pressure plate 969 seats on the full surface 971 during the packing operation, even if the surface 971 is not perfectly perpendicular to the slides 964. In order to charge and discharge the device with a battery packages, the sliding table 960 slides OUT activated by the pneumatic cylinder 963, see FIG. 299.

The advantages of this embodiment is related to the fix components (stopper and inferior punches), which increase precision of the device and to the more rigid slides for the pushing head. The disadvantage consists in the fact that there are many fix inferior punches (one for each taper slot 44 of the inferior side of the battery package), increasing the cost of the device. Also, there is any possibility for adjusting the inferior punches.

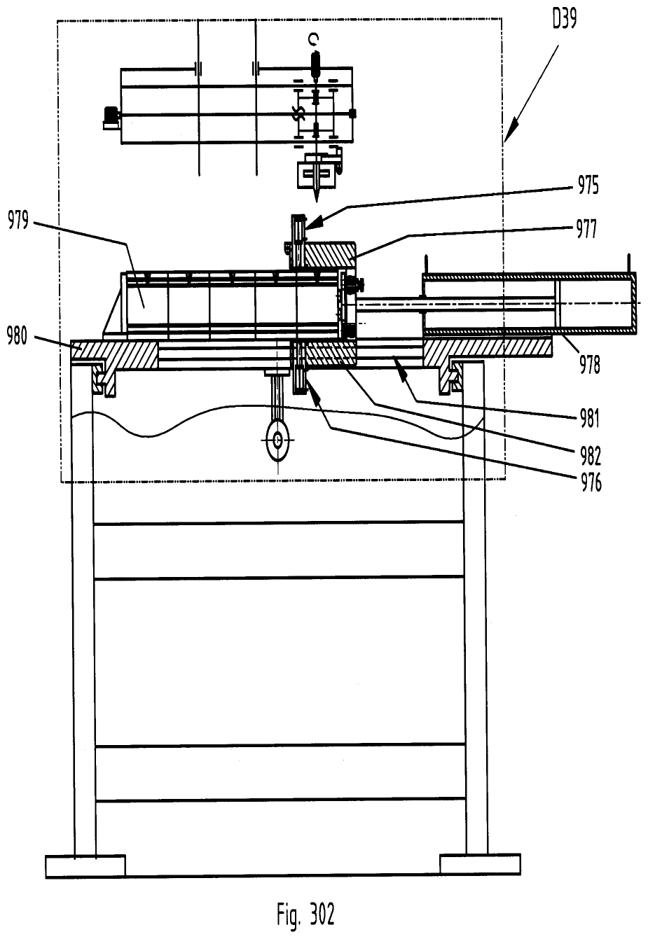

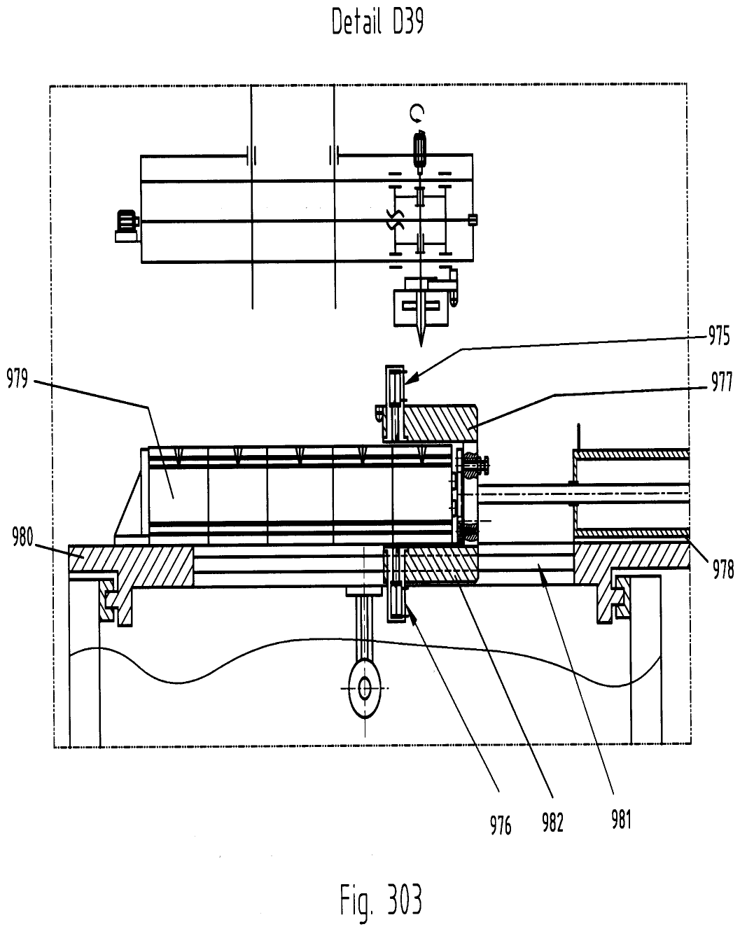

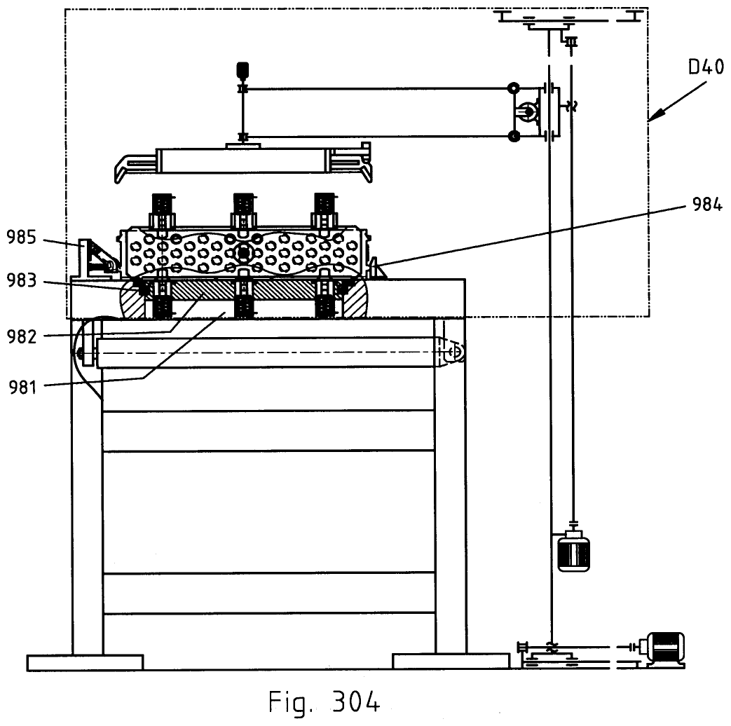

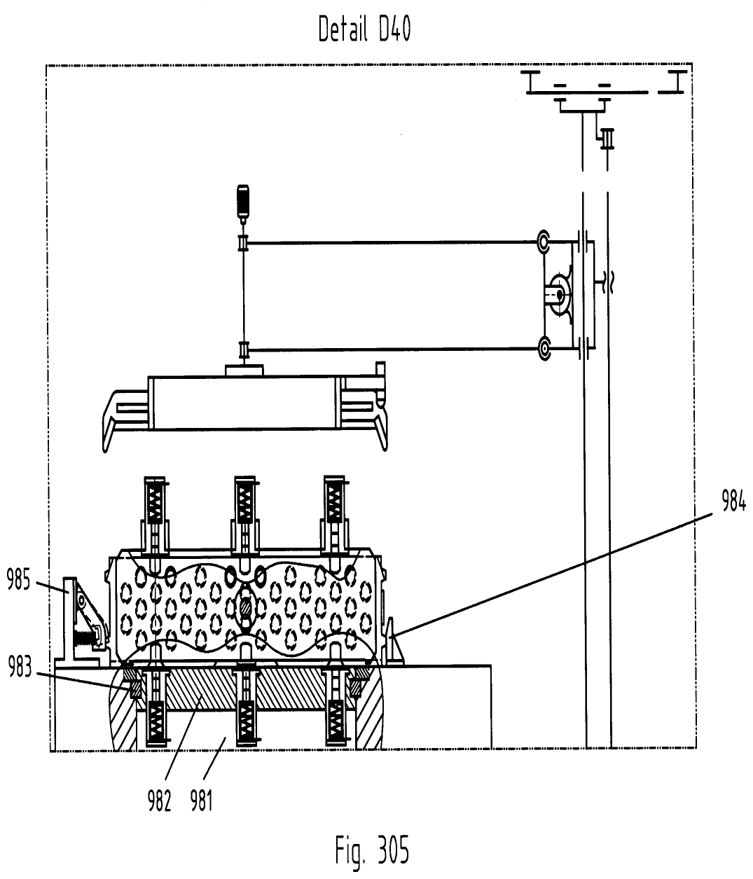

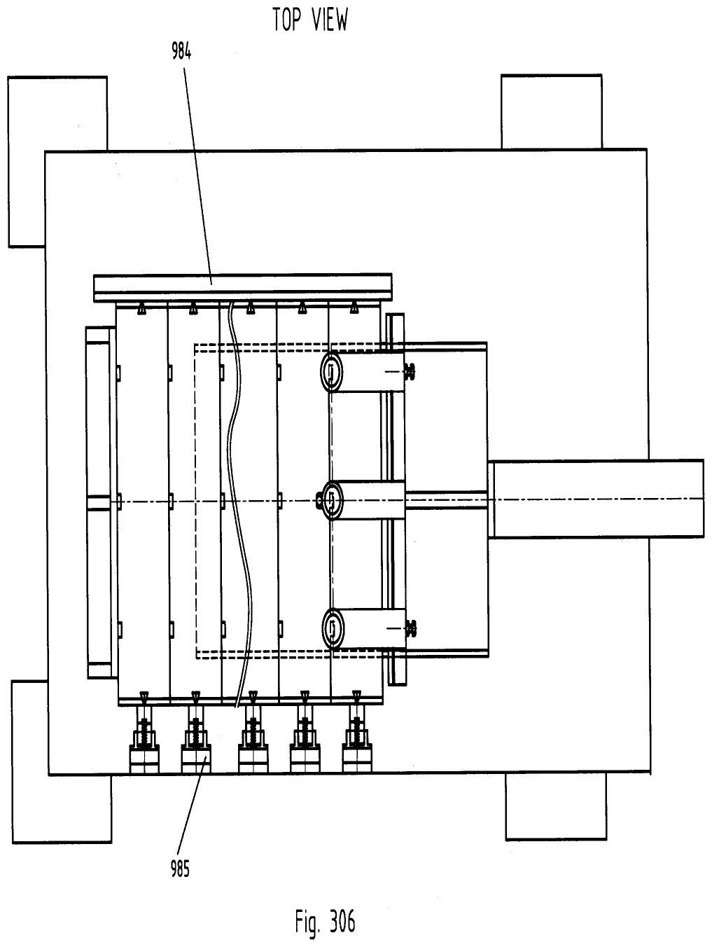

This inconvenient may be over passed by using moving inferior and superior punches. The embodiment applying this principle is presented in FIG. 302 to FIG. 305. As shown in FIG. 302 and FIG. 303, the superior punches 975 and the inferior punches 976 are both mounted on the pushing head 977, moved in different positions by the hydraulic cylinder 978 equipped with a the linear motion control system. The battery package 979 and the hydraulic cylinder 978 are installed on the hollow sliding table 980, which has an opening 981 in which enter the pushing head inferior aim 982. In order to increase the precision and the rigidity of the pushing head 977, its inferior arm 982 slides on the side slides 983 located on both sides of the table opening 981, see FIG. 304 and FIG. 305. The battery modules are aligned using a similar system as used on drawers, consisting of a fix liner 984 and a plurality of pushing devices 985, see FIG. 304, FIG. 305 and FIG. 306.

One of the advantages of these three embodiments presented here before consists in the fact that the hydraulic cylinder activating the pushing head of the device is positioned in line with the battery package, creating a direct pressing force on the module which will be attached. But, on another hand, this position of the hydraulic cylinder asks more space, increasing the size of the assembly. More the number of modules required for a battery package is high, more space is required for the packing/unpacking device.

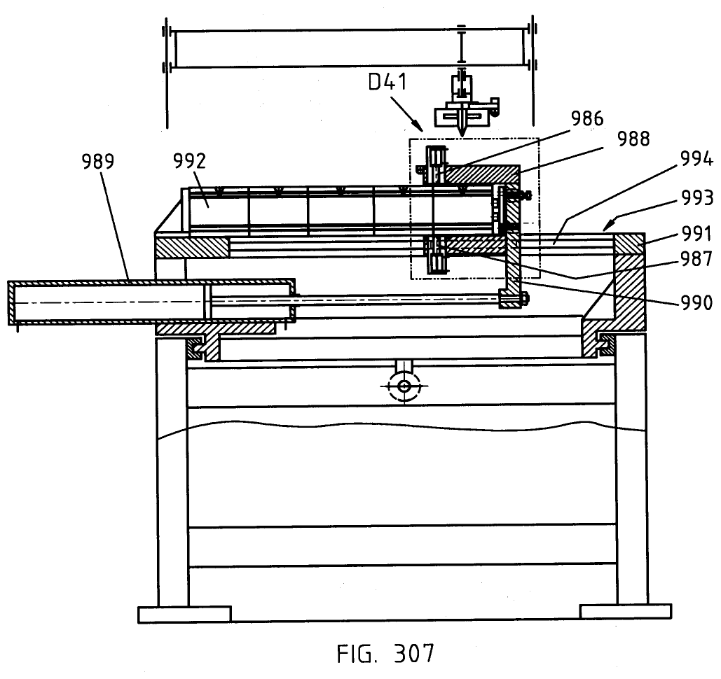

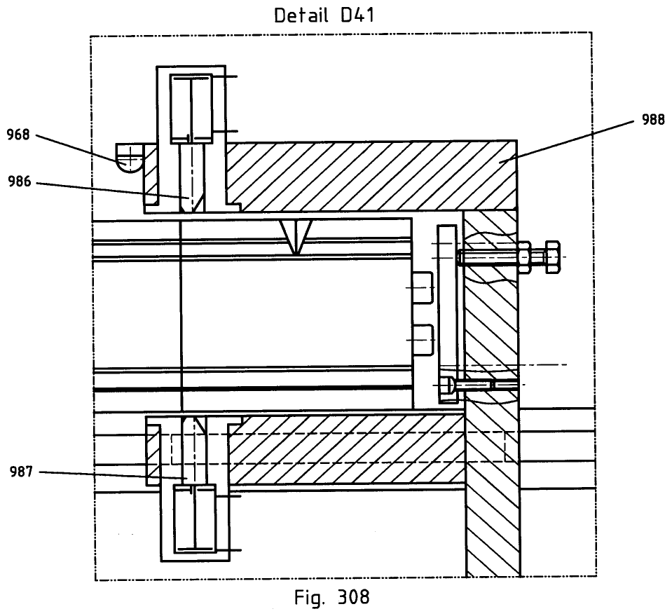

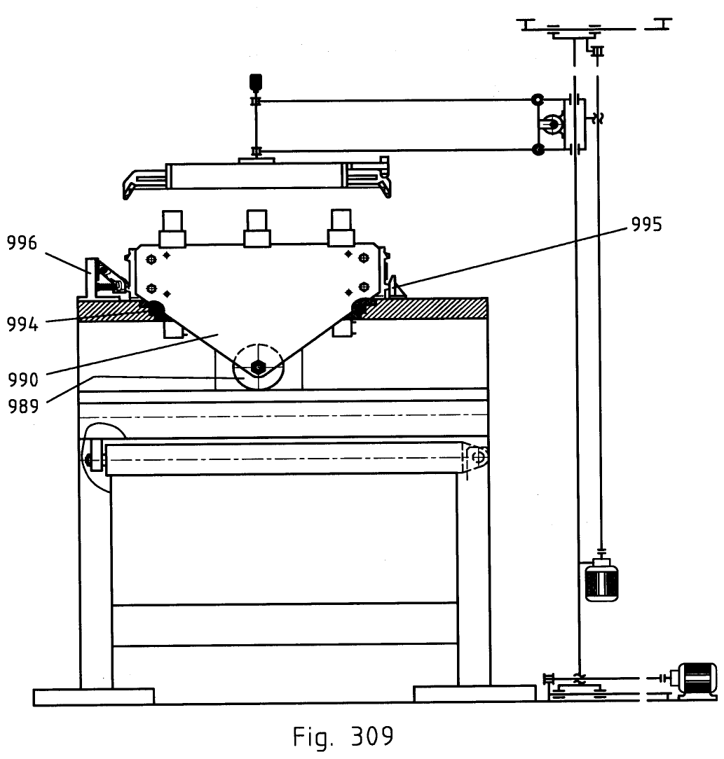

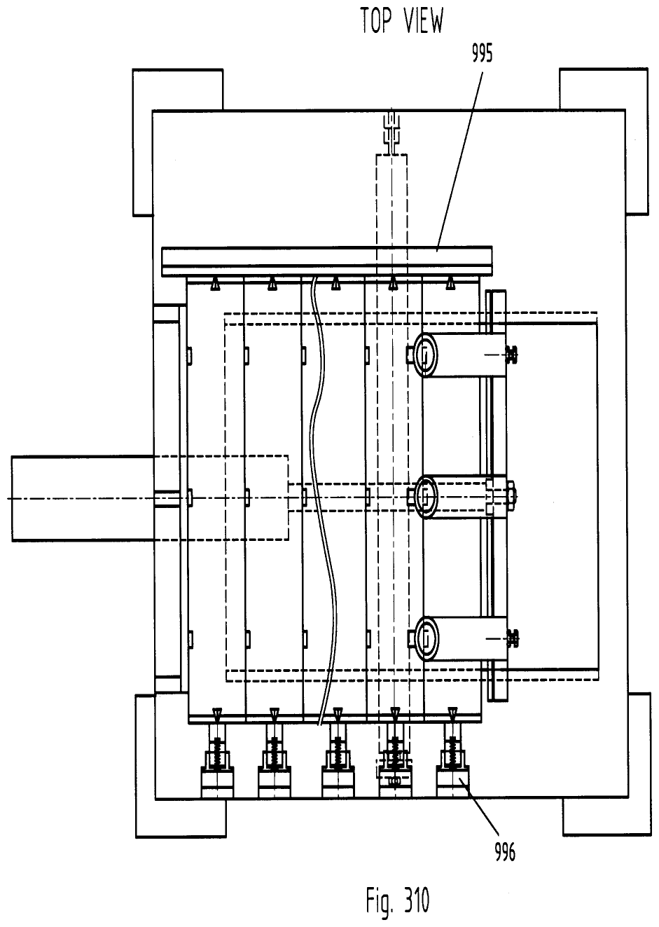

This inconvenient may be overpass by placing the hydraulic cylinder in parallel with the battery module, in this way reducing the size of the device. In FIG. 307 to FIG. 310 is illustrated en embodiment using a such hydraulic cylinder. The superior and the inferior punches 986 and 987 are both installed on the pushing head 988, which is attached to the hydraulic cylinder 989 by the plate 990. The hydraulic cylinder 989 is placed underneath of the table 991, parallel to the battery package 992. On the pushing head 988 is installed a camera 968, see FIG. 308, which send information to the linear motion control system of the hydraulic cylinder 989. The sliding table 991 has an opening 993 in which the pushing head 988 is sliding on the 994 side slides, see FIG. 307 and FIG. 309. The battery modules are aligned using a similar system as used on drawers, consisting of a fix liner 995 and a plurality of pushing devices 996, see FIG. 309 and FIG. 310.

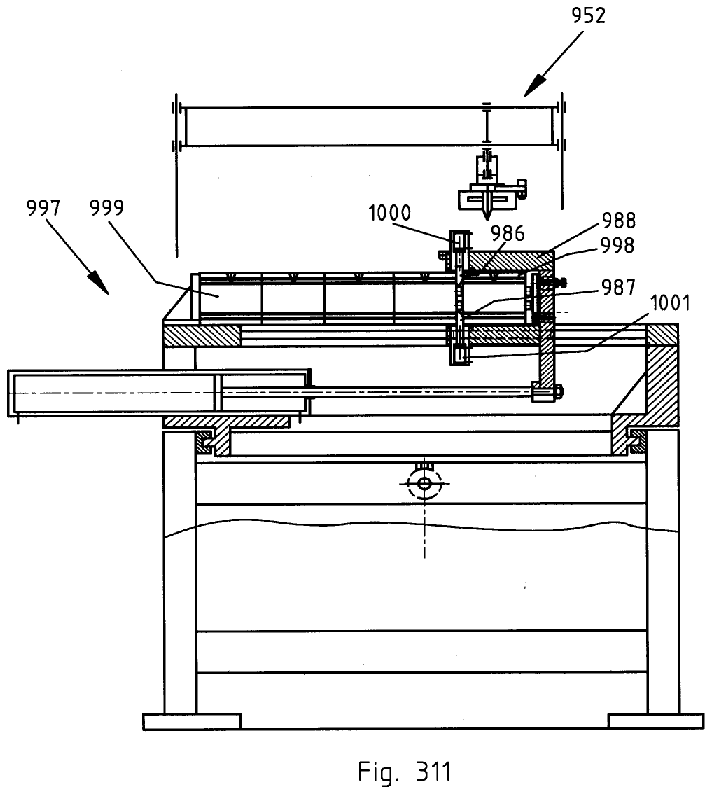

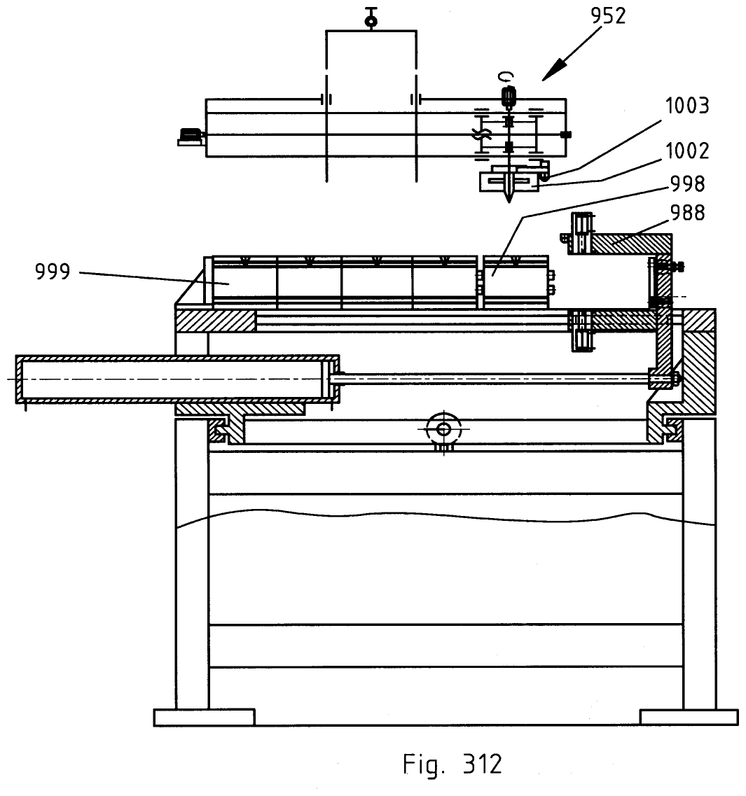

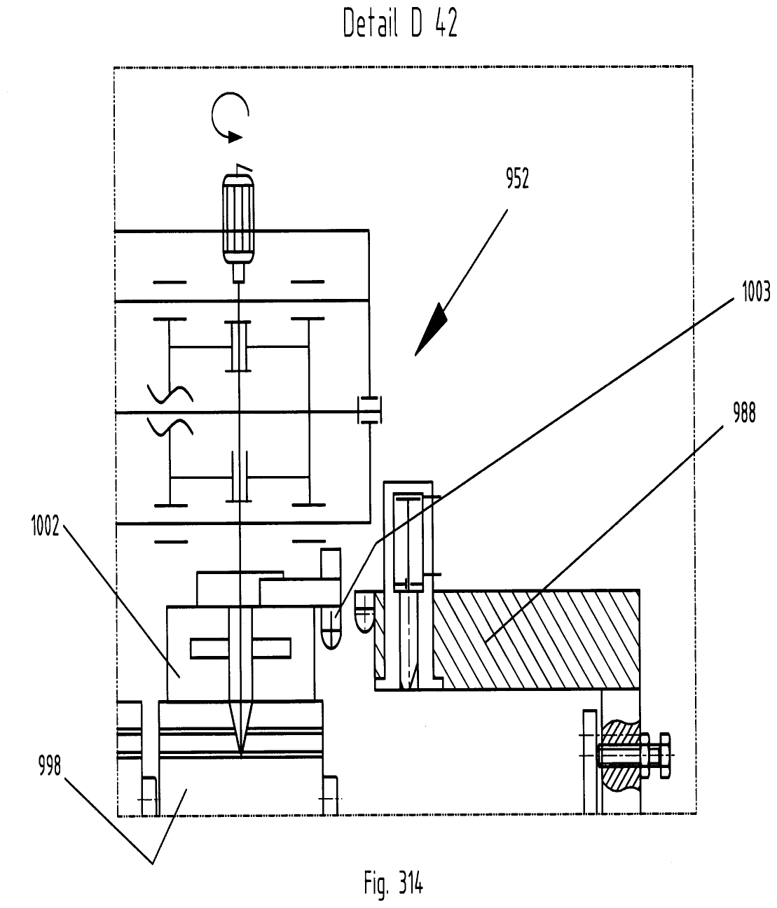

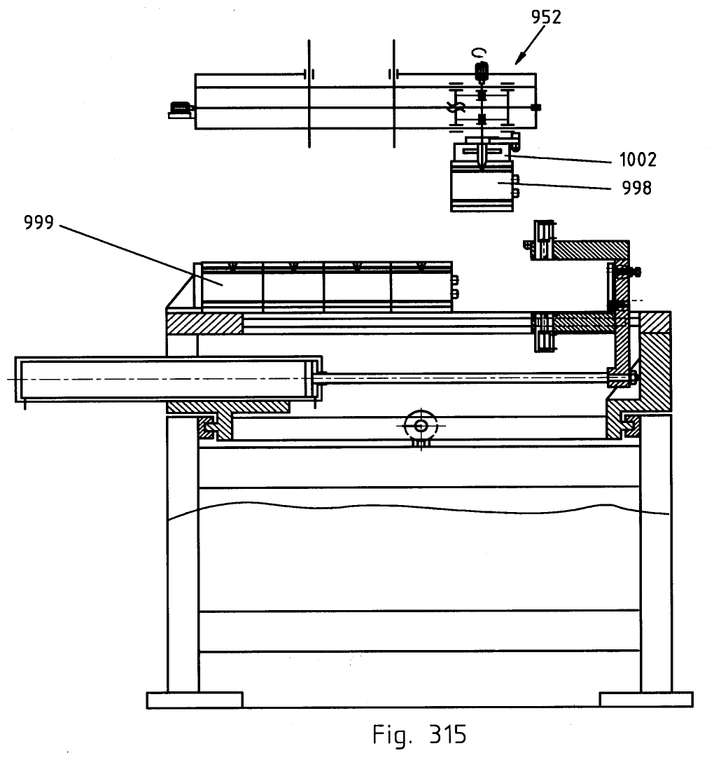

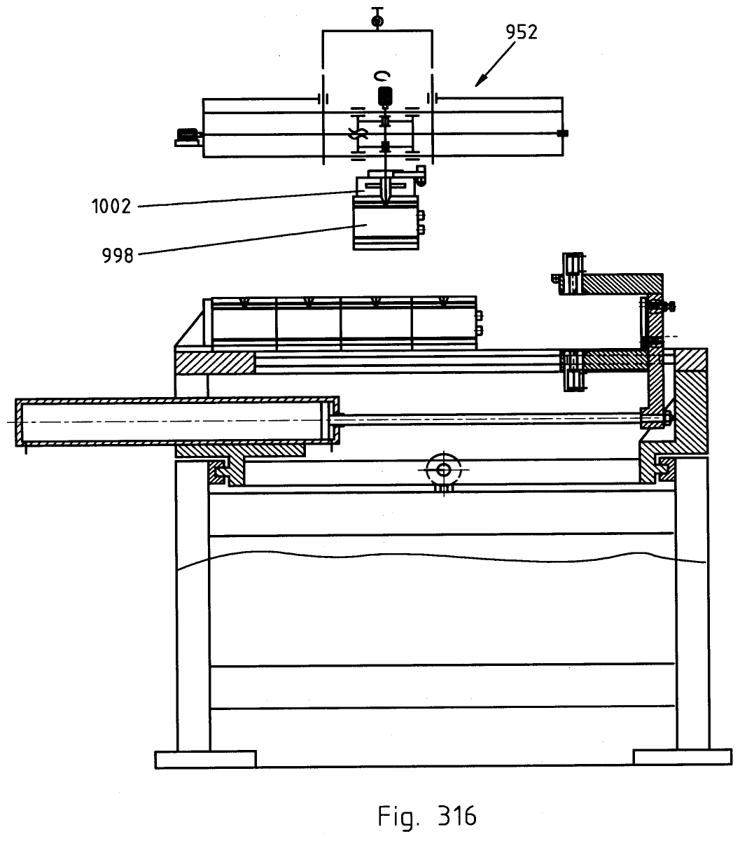

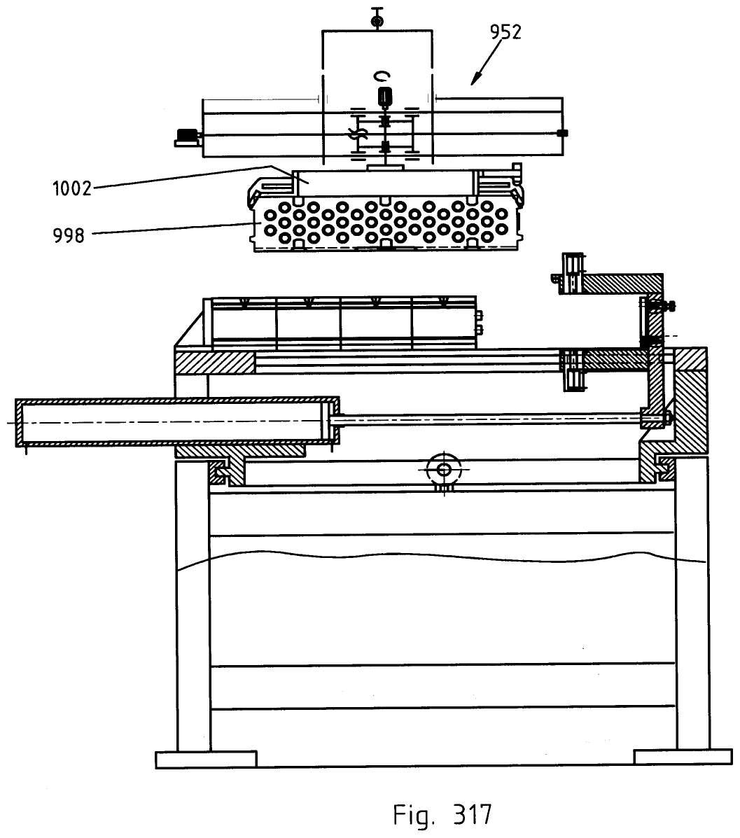

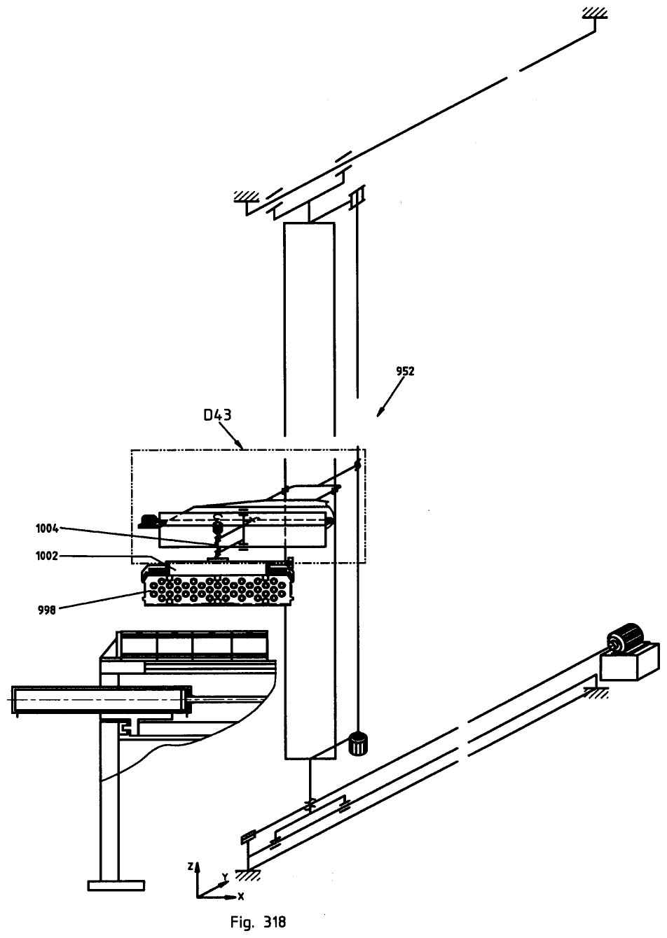

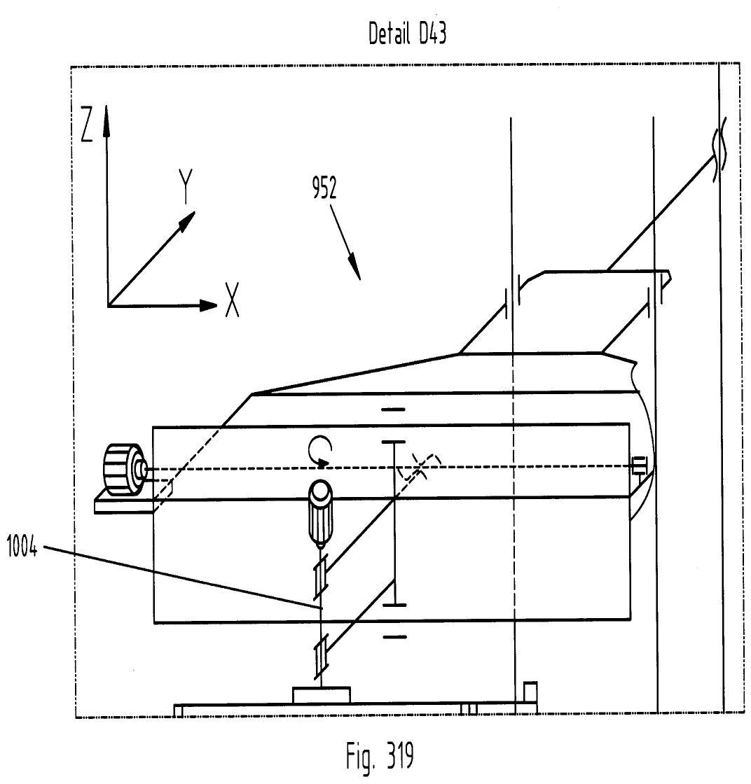

For this embodiment in FIG. 311 to FIG. 320 are illustrated different sequences of the unpacking process, step by step. In FIG. 311 is shown the packing/unpacking device 997 with the pushing head 988 in a position of unpacking the last module 998 of the battery package 999, having the punches 986 and 987 engaged into the battery package, pushed down and up by the pneumatic cylinders 1000 and 1001. The last module 998 is detached from the battery package 999. Next step, shown in FIG. 312, after the pushing head is retracted, the head 1002 of the single battery module storage robot 952 is brought in a stand-by position ready to take out the detached module 998 and store it into the racks for single modules. Next step is to attache the module 998 to the robot head 1002, using a camera 1003 installed on the robot head 1002, which send information to the robot controller, see FIG. 314 as well. Next step is to take out the module 998 from the device, see FIG. 315, and prepare its transportation to the rack of single modules, see FIG. 316 and FIG. 317. In FIG. 318 and FIG. 319 is shown the single battery module storage robot 952, which moves on 3 axis x, y, z and its head 1002 which turns around a vertical axis 1004.

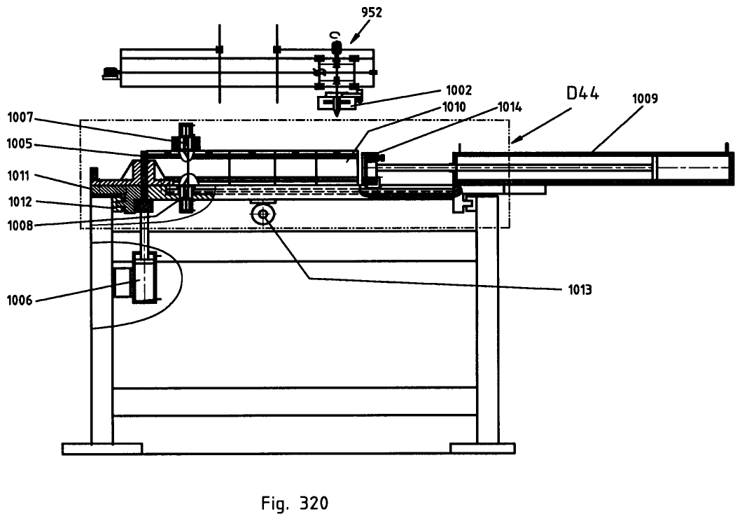

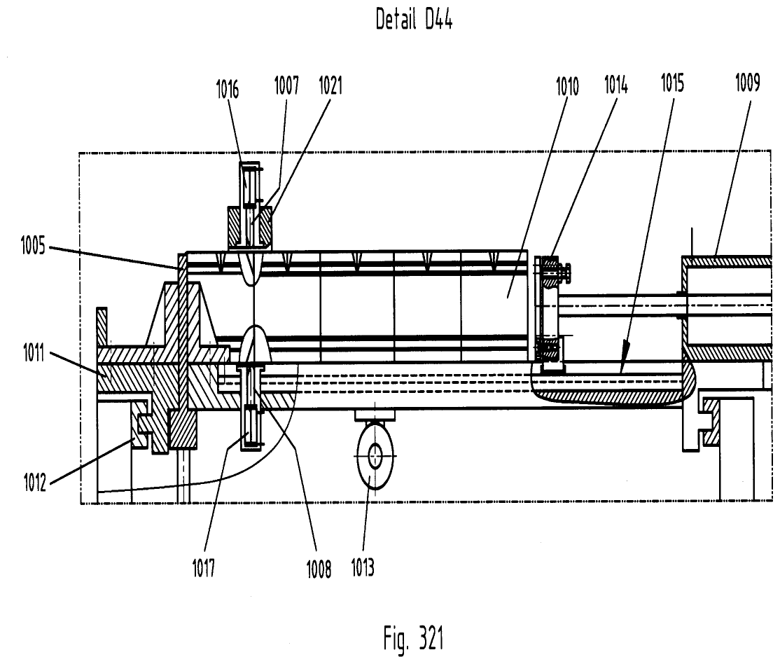

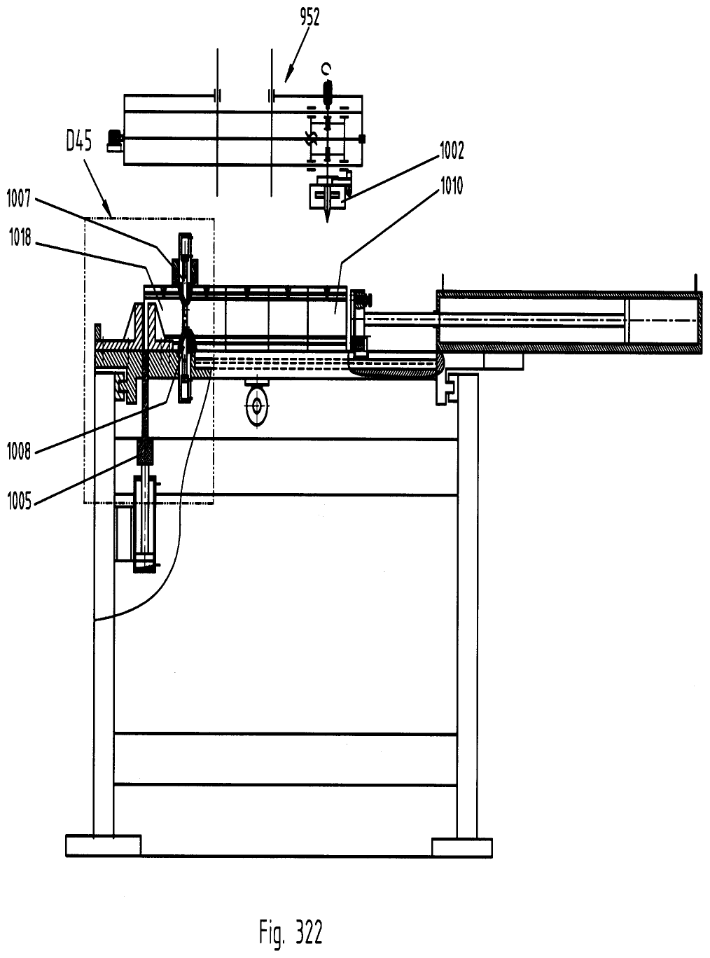

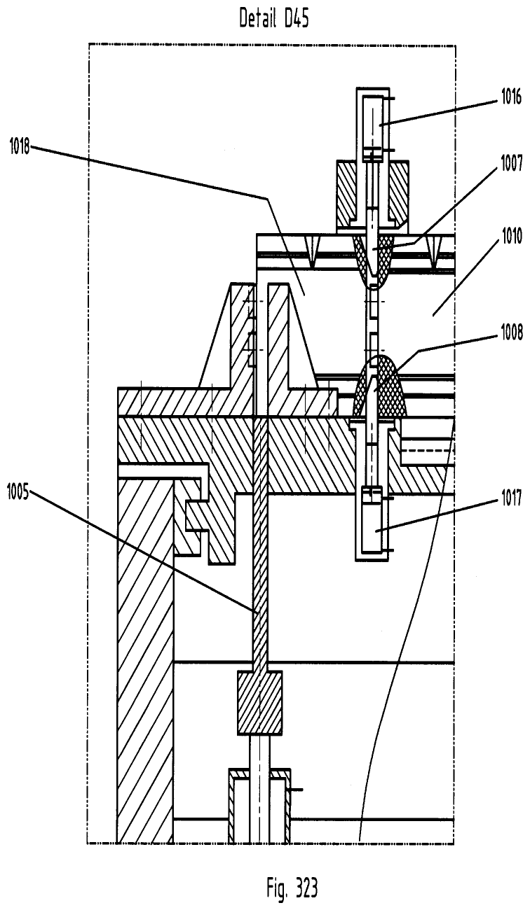

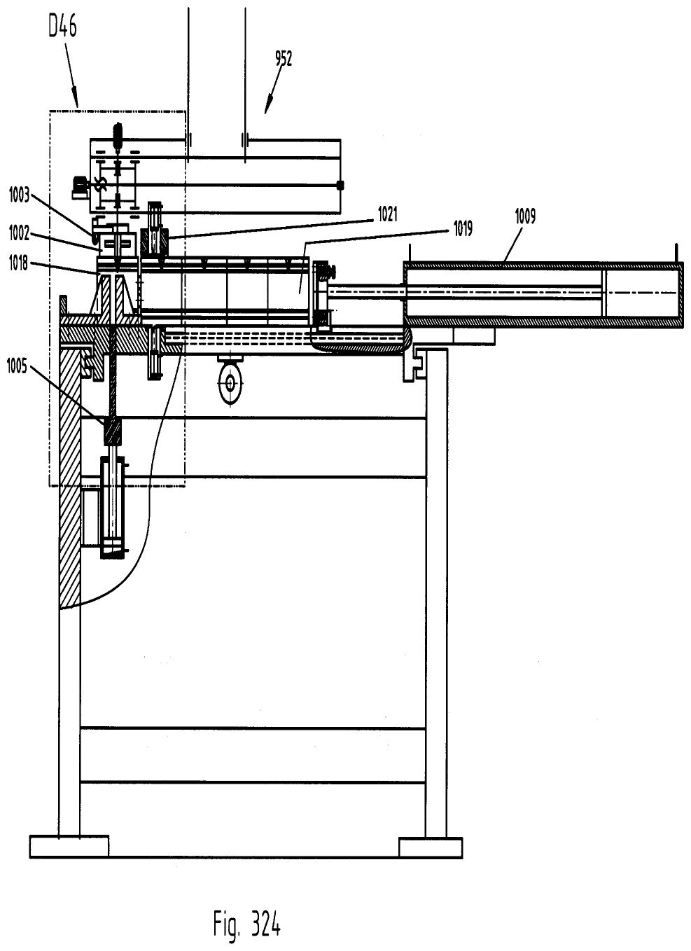

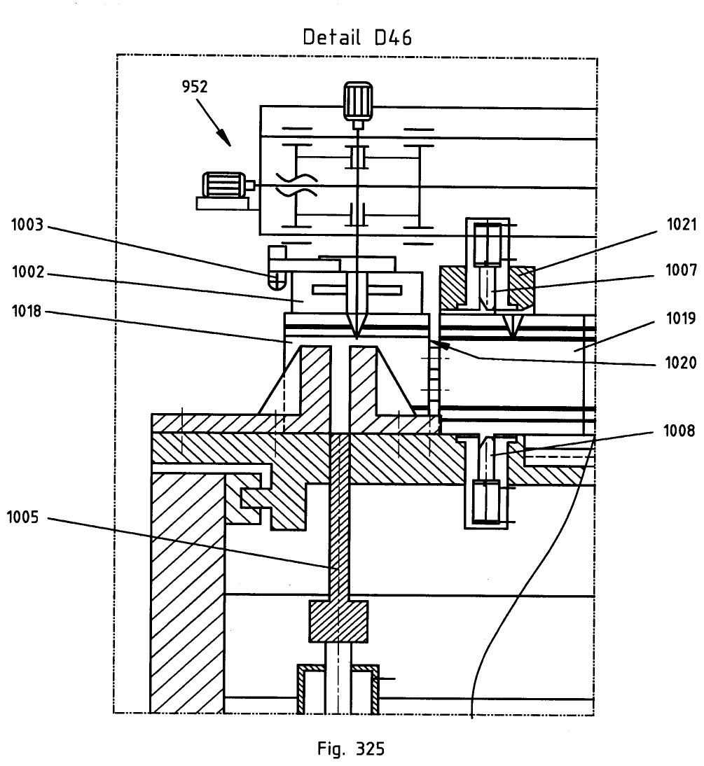

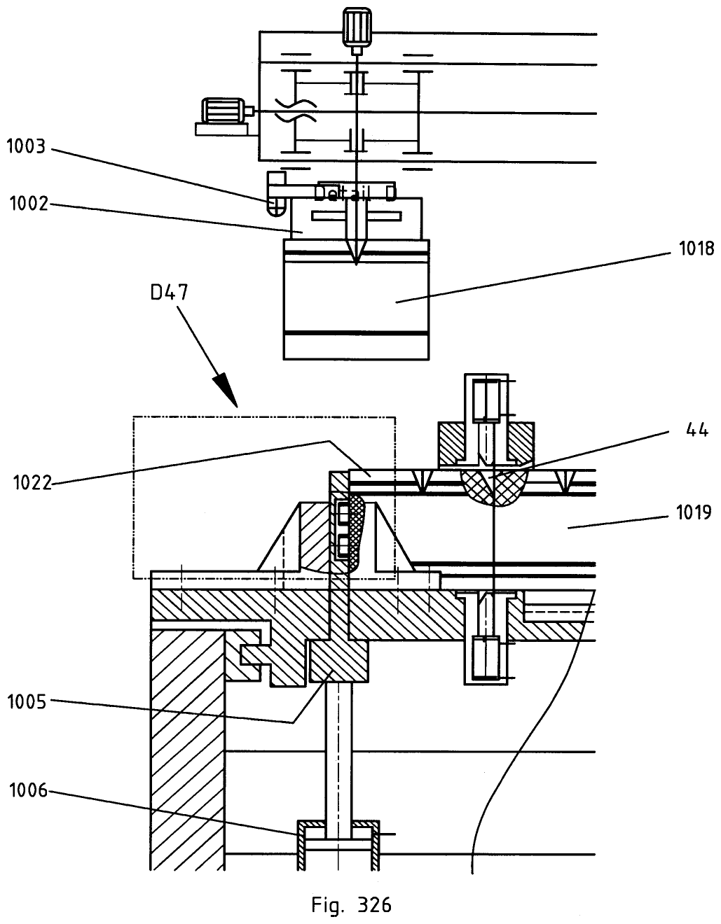

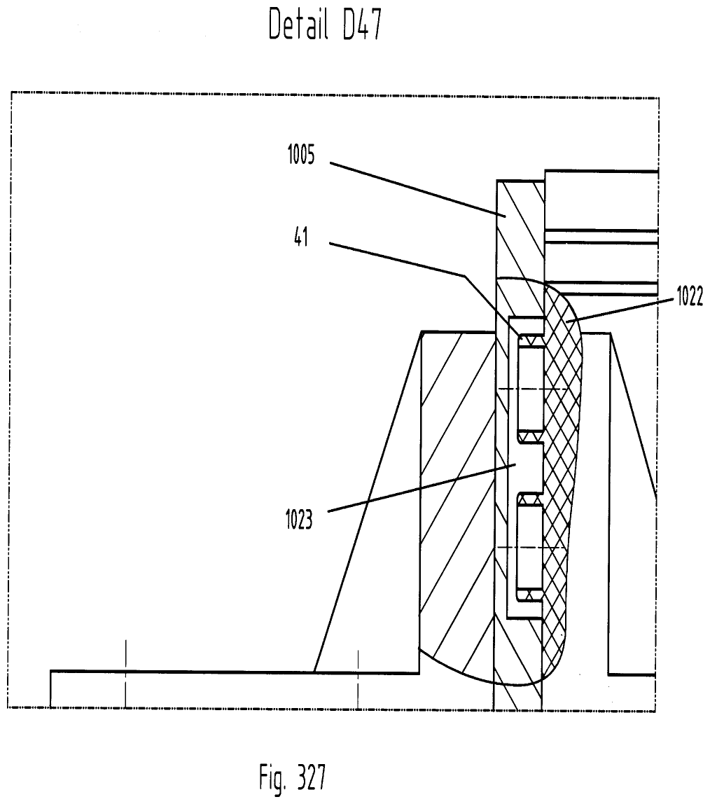

In FIG. 320 to FIG. 328 is illustrated an embodiment of a packing/unpacking device using a retractable stopper 1005 activated by the pneumatic cylinder 1006, a row of fix superior and inferior punch 1007 and 1008, and a hydraulic cylinder 1009 aligned with the battery package 1010, all mounted on the sliding table 1011, sliding on the side slides 1012, activated by the pneumatic cylinder 1013, see FIG. 320 and FIG. 321. For packing, the stopper 1005 remains always in the “UP” position, and one by one the modules are attached to the battery package by the hydraulic cylinder 1009, pushing axially on the big/small attaching plastic tubular cylinder 41 and 42, via a pushing plate 1014, which is sliding on the bottom open slides 1015, mounted on the table 1011. In the packing time, both, the superior and the inferior punches 1007 and 1008 are in retracted position. For unpacking, the stopper 1005 is retracted in the “DOWN” position, (see FIG. 322 and FIG. 323) and the punches 1007 and 1008 are pushed IN by their respective pneumatic cylinders 1016 and 1017, detaching the first module 1018 from the battery package 1010. With the stopper 1005 and both punches 1007 and 1008 retracted, the hydraulic cylinder pushes the rest of the battery package 1019 and the first module 1018 forward, till the back face 1020 of the first module passes the support 1021 of the superior punch row 1007, see FIG. 324 and FIG. 325. The next step is to approach the head 1002 using the camera 1003 and to attach the first module 1018 to the single battery module storage robot 952. After the module 1018 was taken away, see FIG. 326 and FIG. 327, the stopper 1005 is pushed “UP” by the pneumatic cylinder 1006 and with punches 1007 and 1008 retracted, the hydraulic cylinder 1009 pushes forward the remained battery package 1019 till it hits the stopper 1005. In this position, the tapper slots 44 of the actual first module 1022 are aligned with the punches 1007 and 1008 and another cycle of unpacking is ready to start. As shown in FIG. 326 and in FIG. 327, in order to protect the tubular cylinders 41 when the last battery module 1022 is in contact with the stopper 1005, in the stopper 1005 is created an opening 1023 in an oval slot shape. The FIG. 328 is a top view of this packing/unpacking device, showing the means to align the battery package by the liner 1024 and the pushing devices 1025, the supports 1026 on which the stopper 1005 is sliding, and the superior punches support 1021.

For all the embodiments presented up to here the press uses a long hydraulic cylinder, having the stroke greater than the length of the maximum battery package allowed to be packed/unpacked on this device. This may be a disadvantage by the cost of the hydraulic cylinder it self and by the space the device requires.

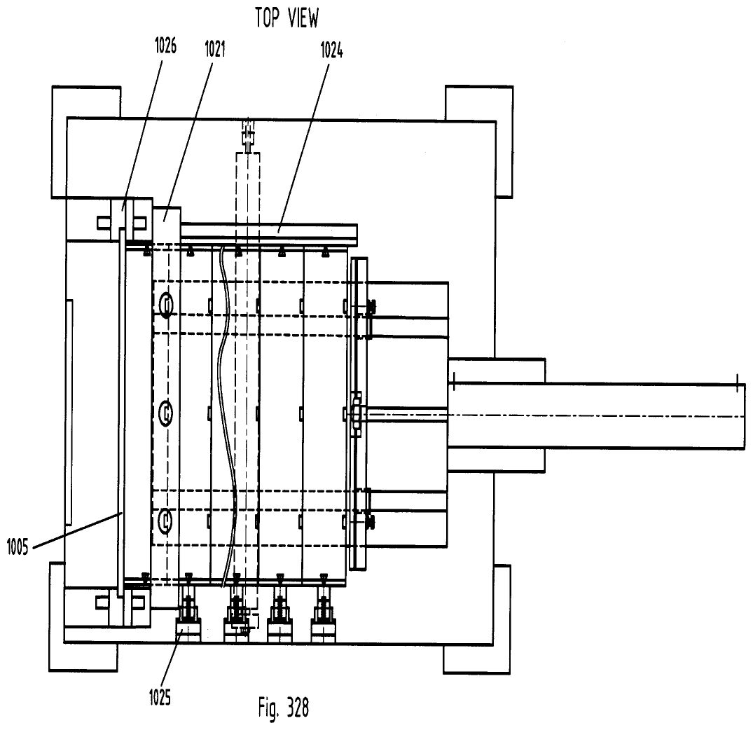

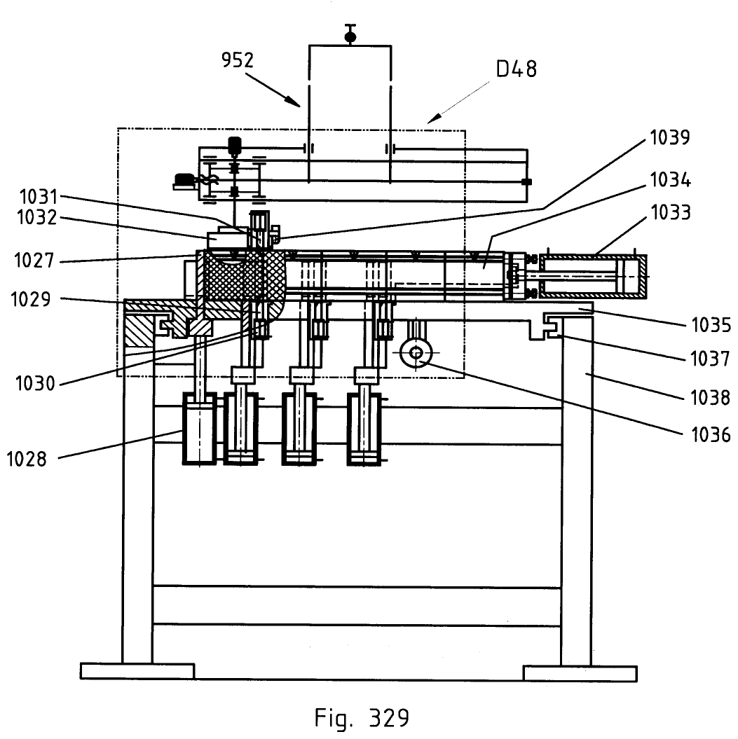

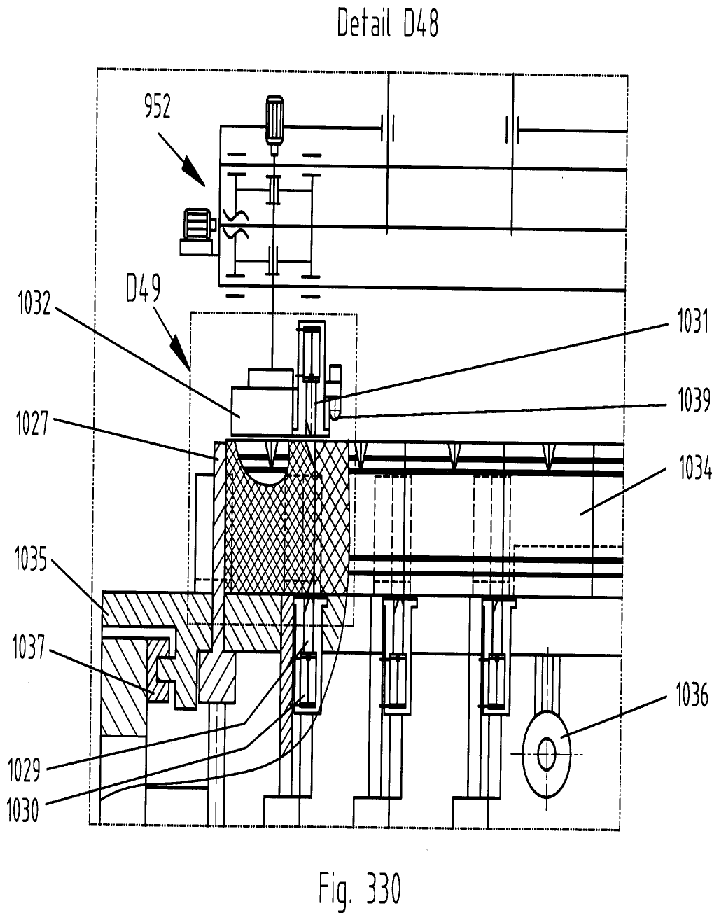

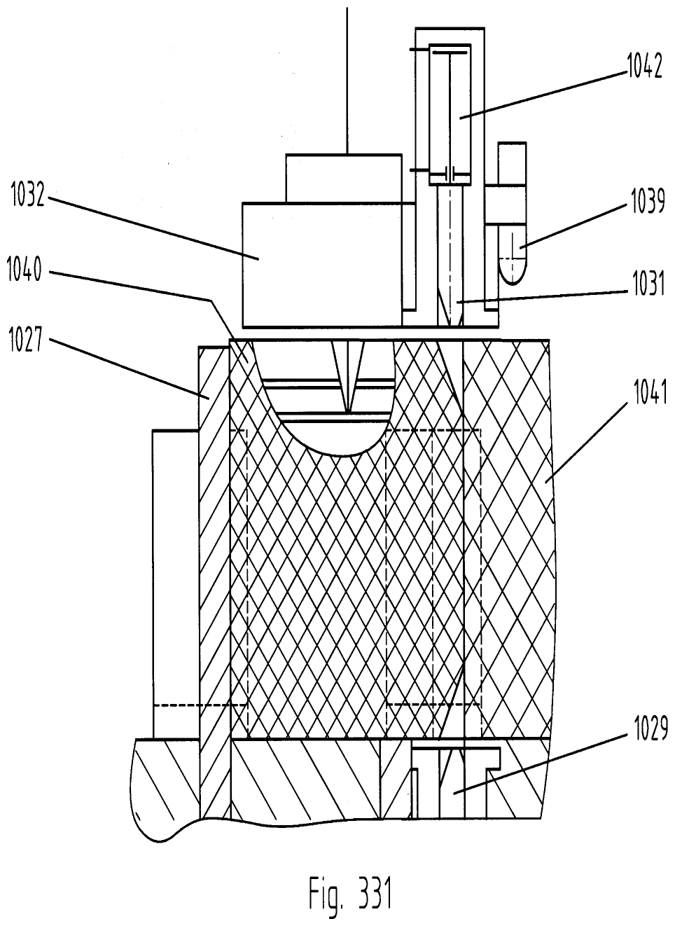

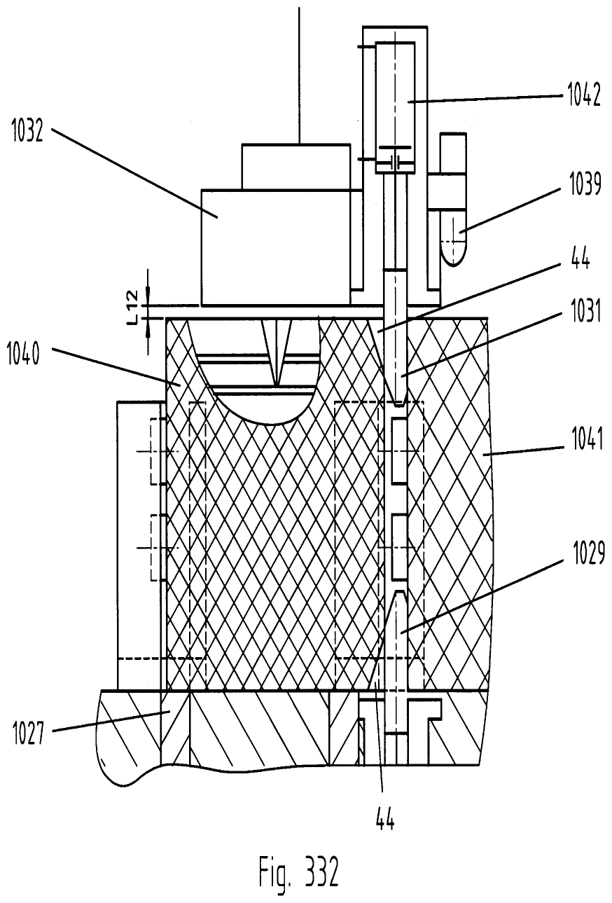

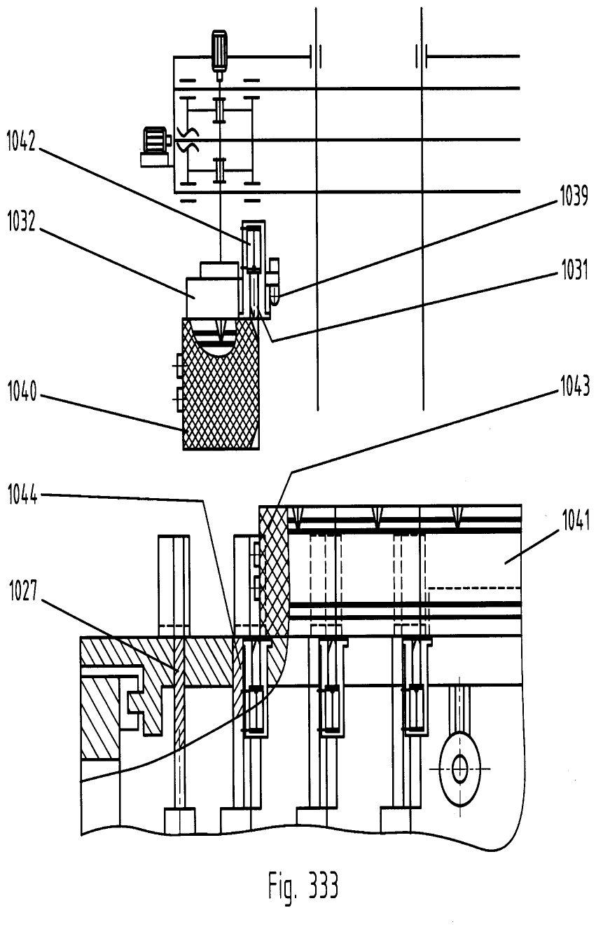

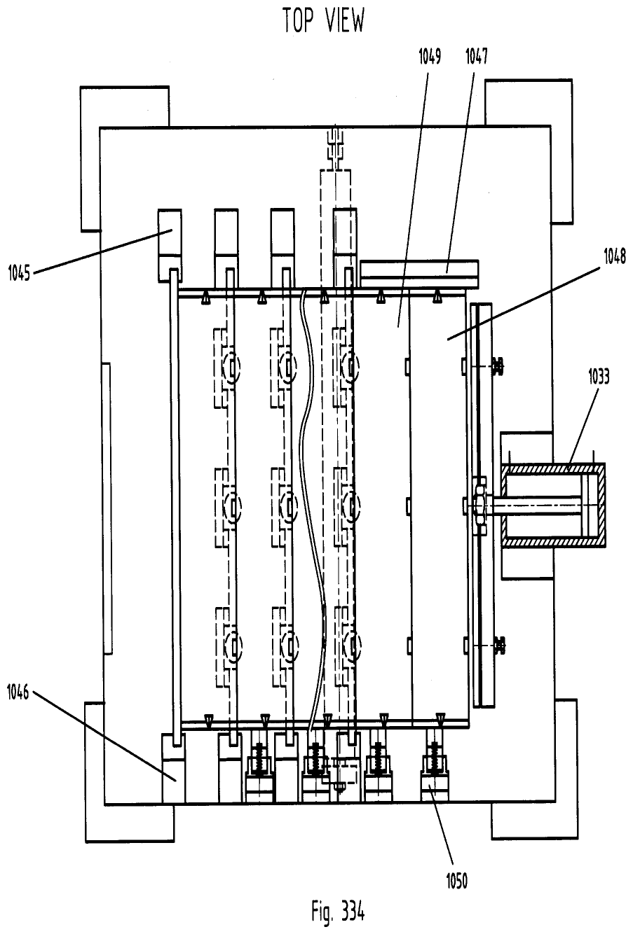

These disadvantages may be overpass by using a short hydraulic cylinder, just lightly longer than the length of one single battery module. In FIG. 329 to FIG. 337 is illustrated an embodiment using this kind of short hydraulic cylinder. In this embodiment, as shown in FIG. 329, FIG. 330 and FIG. 331, is used a plurality of rows of retractable stoppers 1027 activated by pneumatic cylinders 1028, a plurality of fixed inferior punches 1029, each punch being activated by a pneumatic cylinder 1030, a short hydraulic cylinder 1033 with linear motion control system, aligned with the battery package 1034. All these components are mounted on a sliding table 1035 activated by the pneumatic cylinder 1036, sliding on the side slide 1037, installed on the solid structure 1038. On the head 1032 of the single battery module storage robot 952 is attached a single row of superior mobile punches 1031 and a camera 1039, which send information to the robot controller in order to well positioning the head 1032 and the superior punches 1031—aligned with the taper slots 44 of the battery package. In FIG. 331 is shown in detail D49 the last stopper 1027 in the “UP” position, in contact with the last battery module 1040 of the battery package 1041, packed, the punches 1031 and 1029 retracted and the head 1032 of the single battery module storage robot 952 in contact with the last battery module 1040, before the unpacking operation. In FIG. 332 is shown the sequence of unpacking for the last module 1040, where the stopper 1027 is retracted, the punches 1029 and 1031 are pushed into the battery package taper slots 44, detaching the last module 1040 from the battery package 1041, pushing it on the side, in time that the robot head is up, realizing the clearance L12 between the battery module 1040 and the robot head 1032. After the punches 1031 are retracted, the robot moves down and laterally attaching the battery module 1040 and lifts it up, see FIG. 333. After the module 1040 is placed in the storage rack, the robot 952 returns to unpack the next module 1043, keeping the second row of stoppers 1044 in “down” position. The unpacking process is repeated. The FIG. 334 is a top view of this device showing the supports 1045 and 1046 of each stopper, the liner 1047 for the first two modules of a battery package 1048 and 1049 with their pushing devices 1050. For the rest of the modules, the stopper supports 1045 play the roll of liners, each of them having on opposite side a pushing device in order to keep the contact between the battery package and the liners.

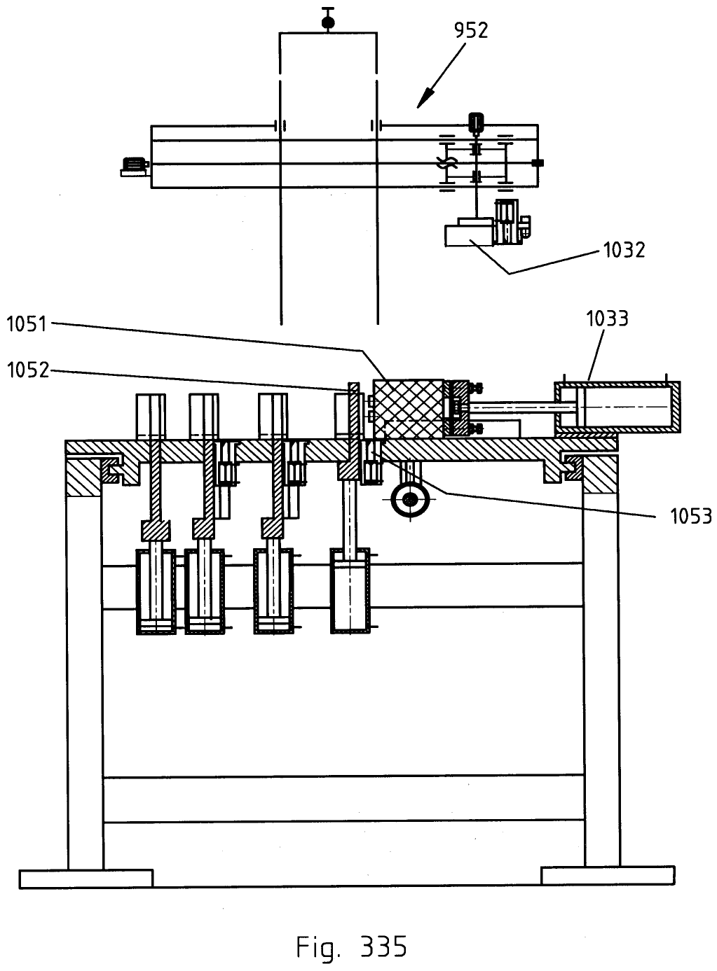

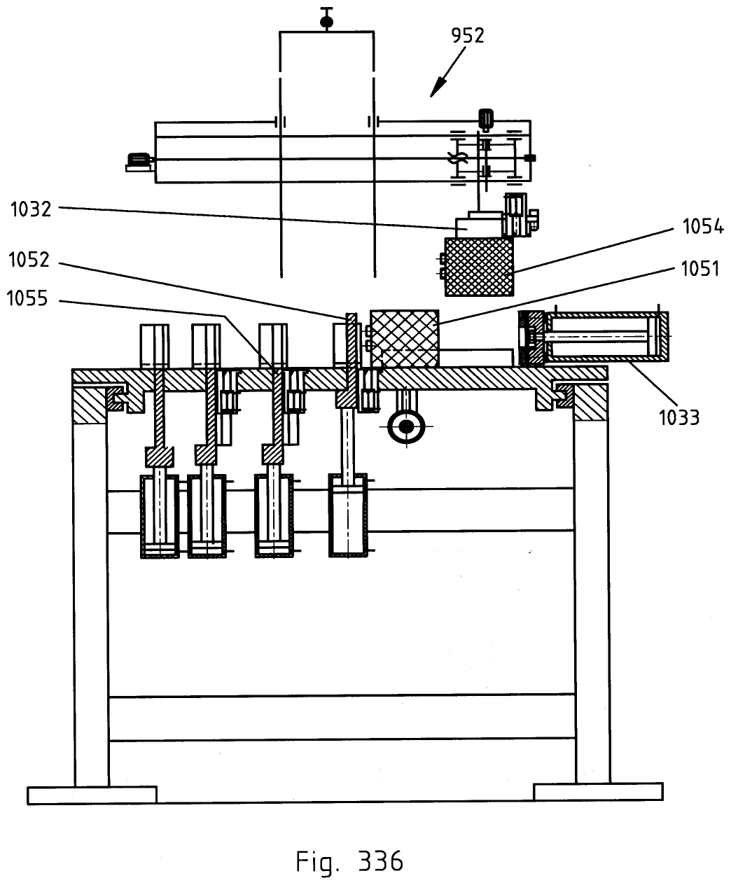

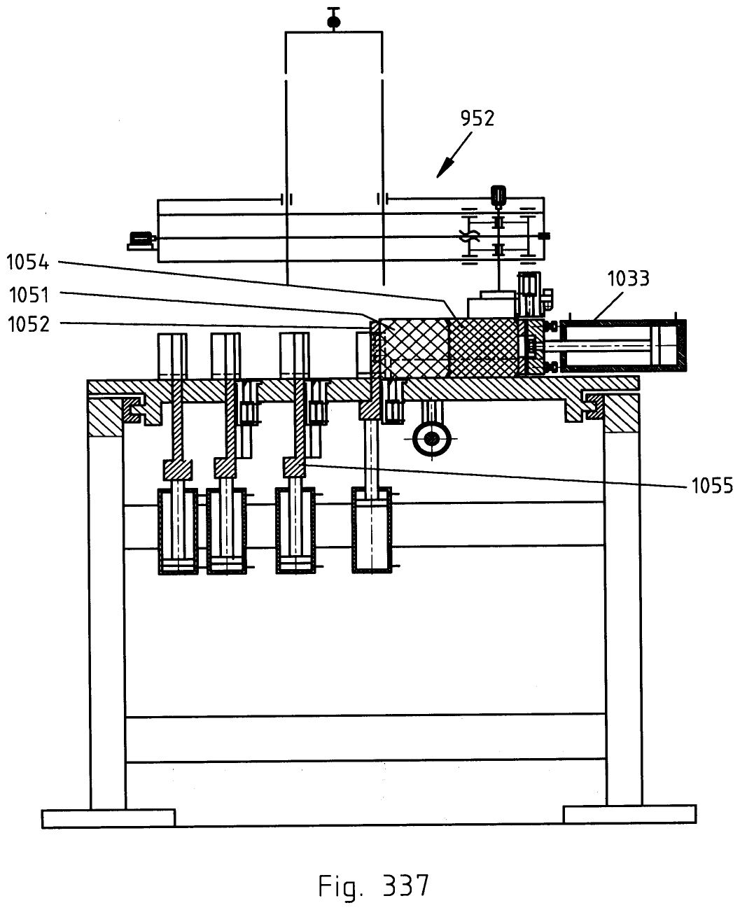

For this device, the packing process is illustrated sequentially in FIG. 335, FIG. 336 and FIG. 337. In FIG. 335 is shown the first module 1051 placed in front of the hydraulic cylinder 1033 and pushed forward, without touching the first stopper 1052. All inferior punches 1053 and the rest of stoppers are retracted. The next step, see FIG. 336, is to retract the hydraulic cylinder 1033 and to bring in front of it the second module 1054, by the robot 952.The next step, see FIG. 337, is to push the modules 1051 and the module 1054 against the first stopper 1052 and force and deform the attaching big/small attaching plastic tubular cylinders 41 and 42 in order to create the battery package. The next step is to retract the first stopper 1052 and push “up” the second stopper 1055, and push the battery package forward in the proximity of the second stopper 1055, creating space for the third module, after the hydraulic cylinder 1033 is retracted again. The third module will be placed in front of the hydraulic cylinder 1033 and it will be pushed and attached to the rest.

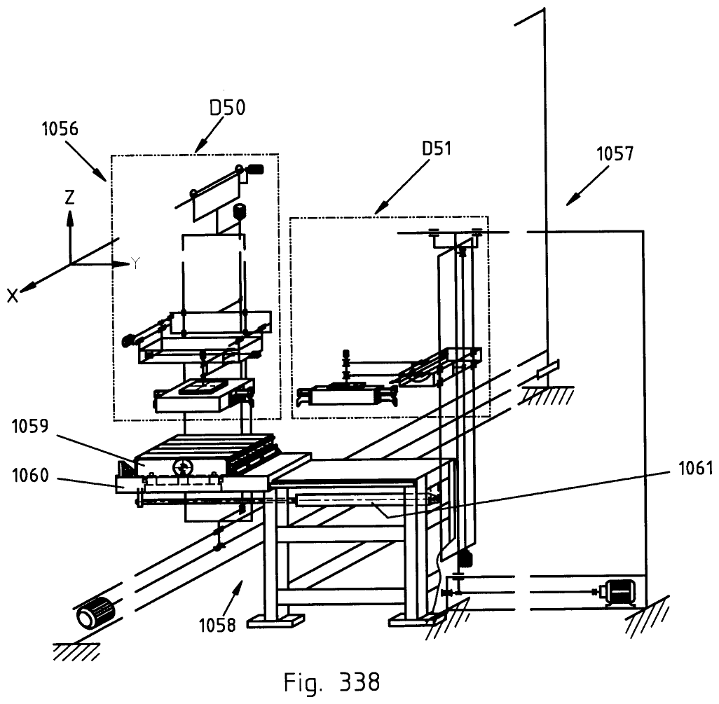

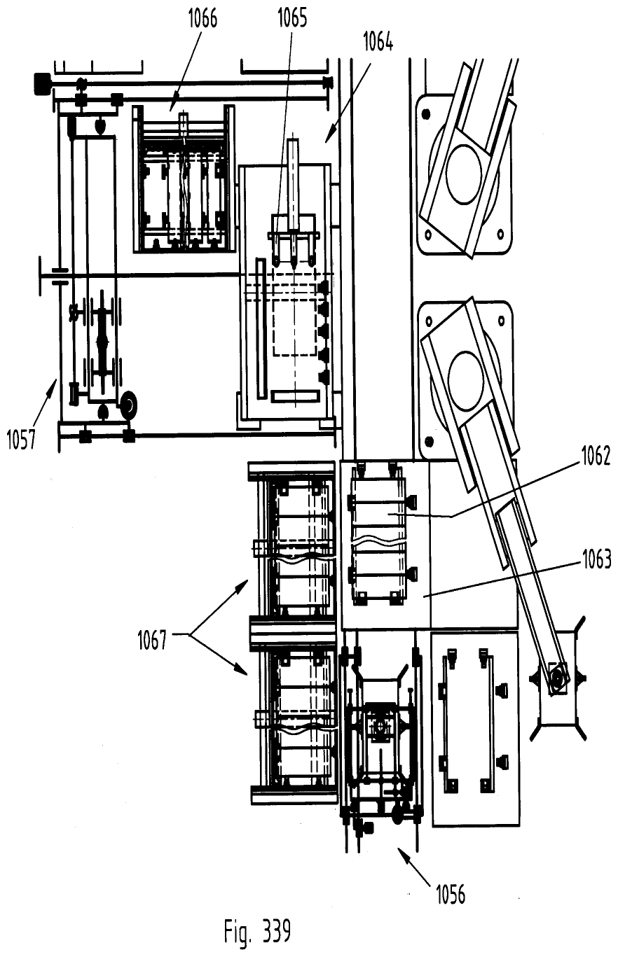

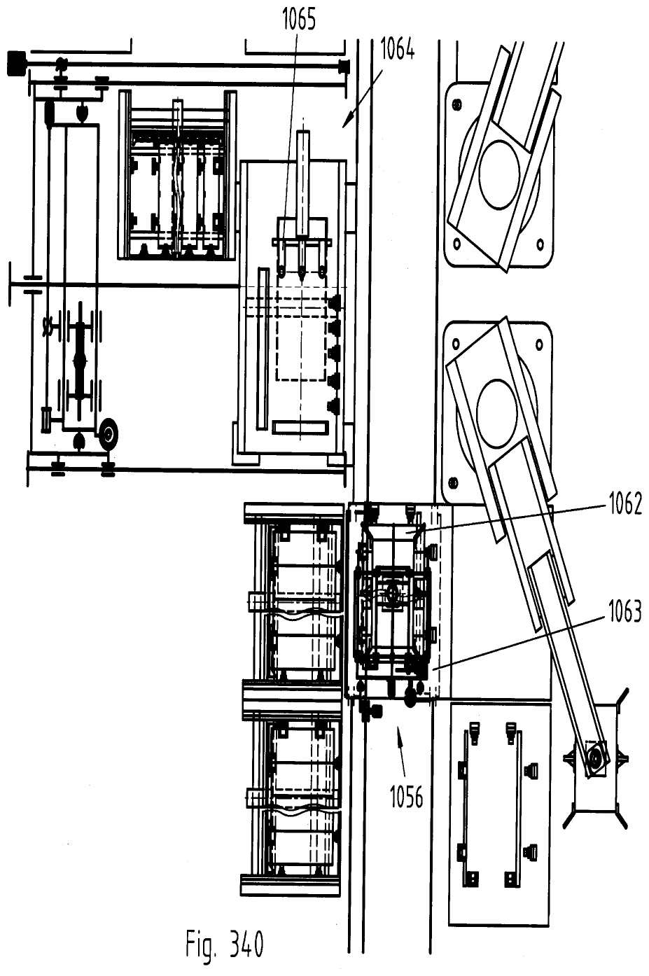

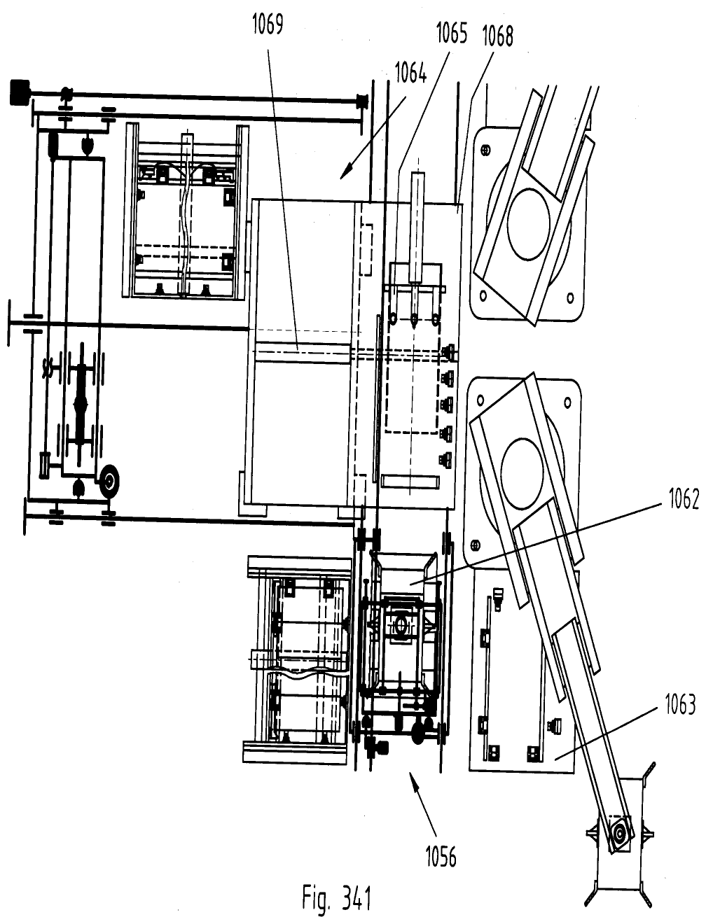

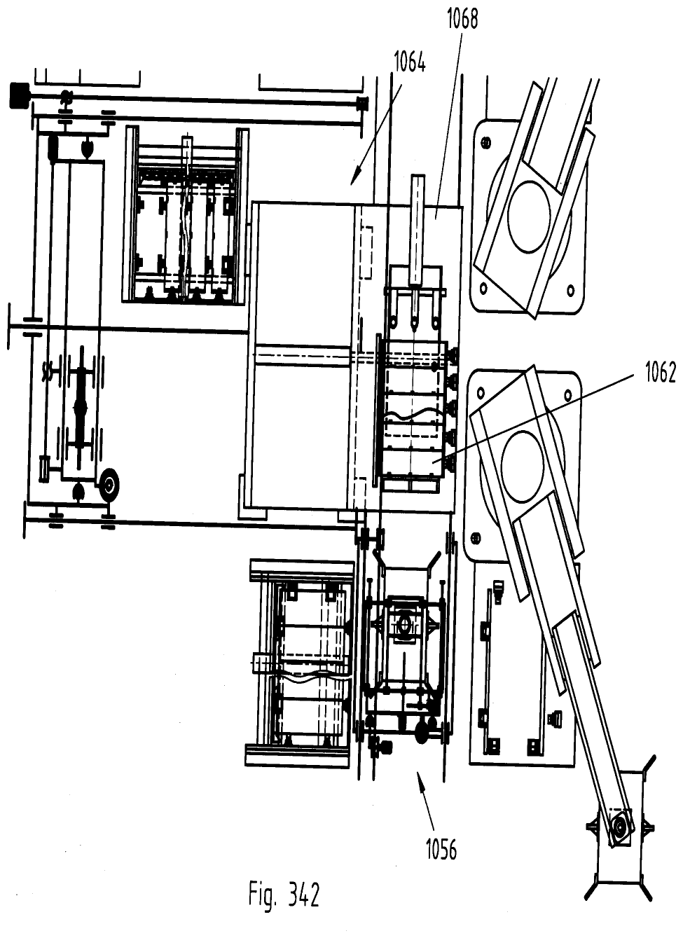

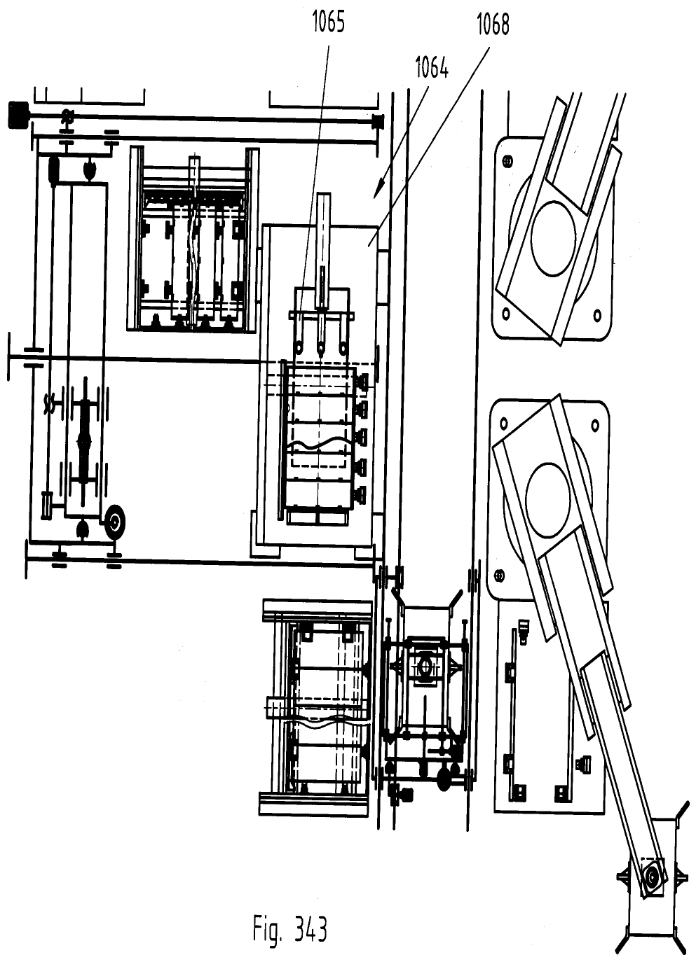

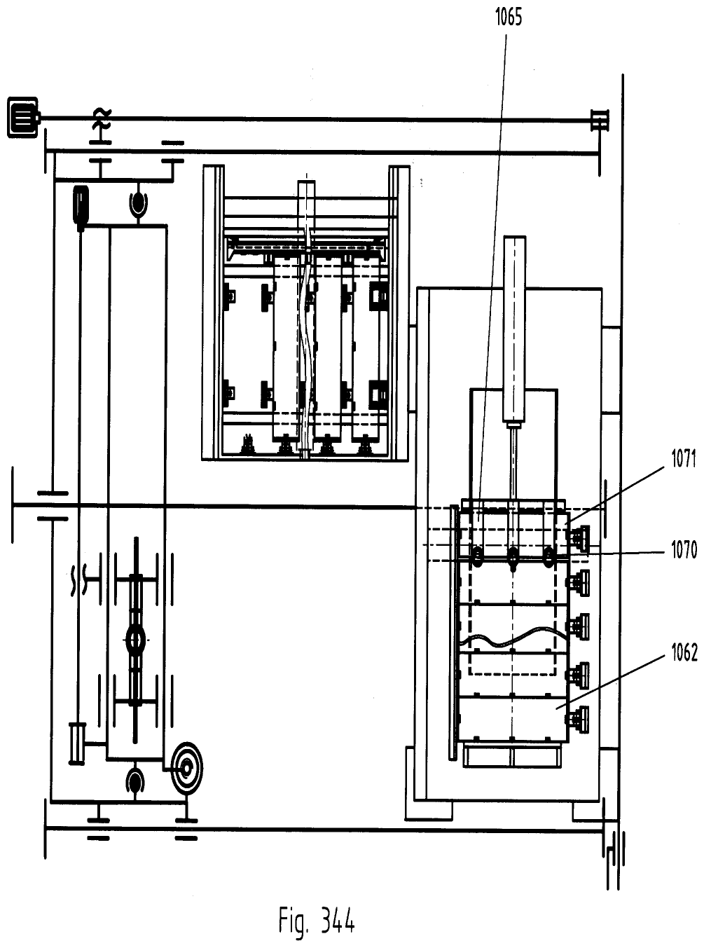

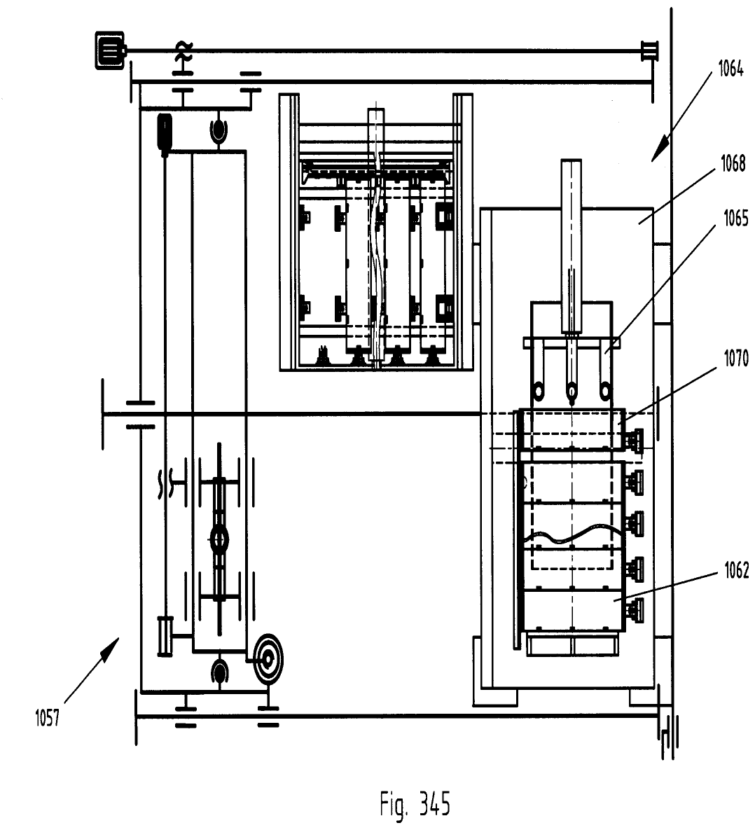

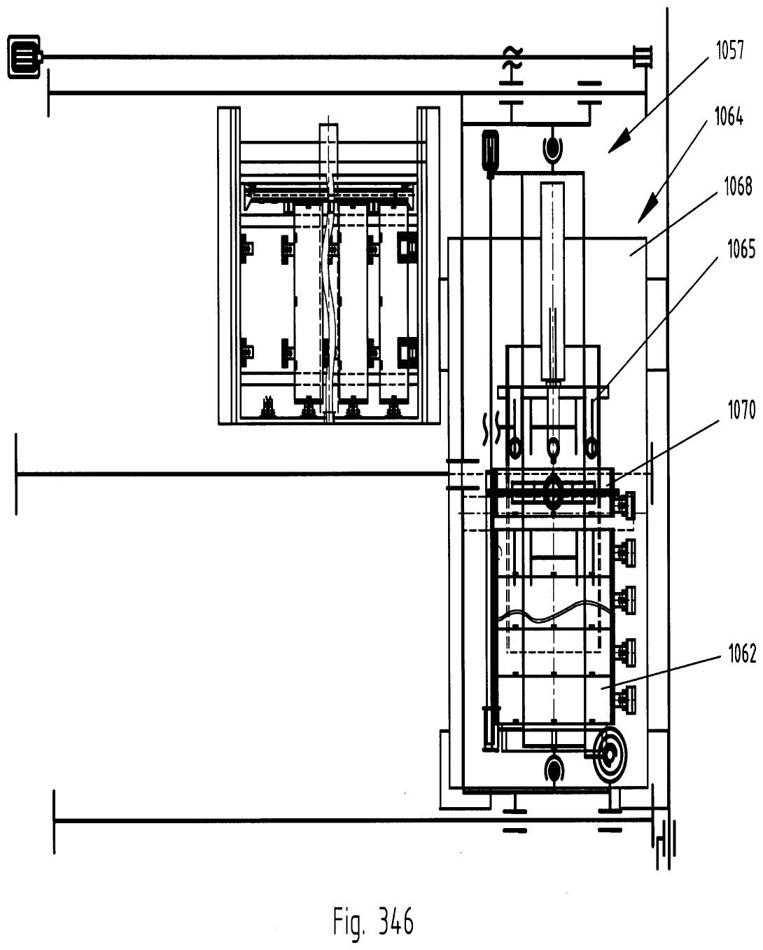

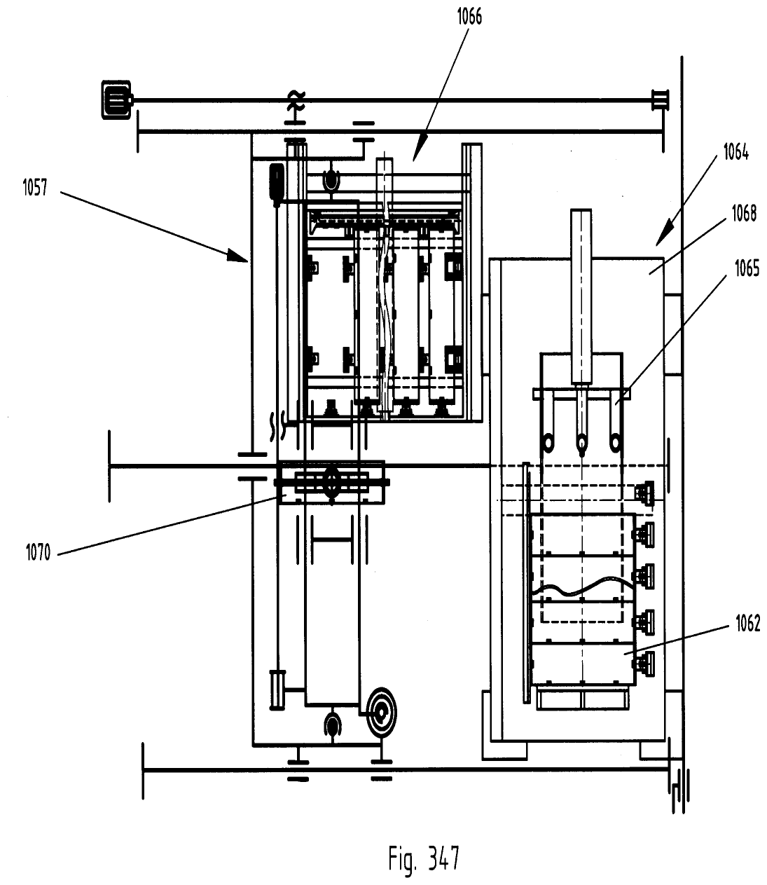

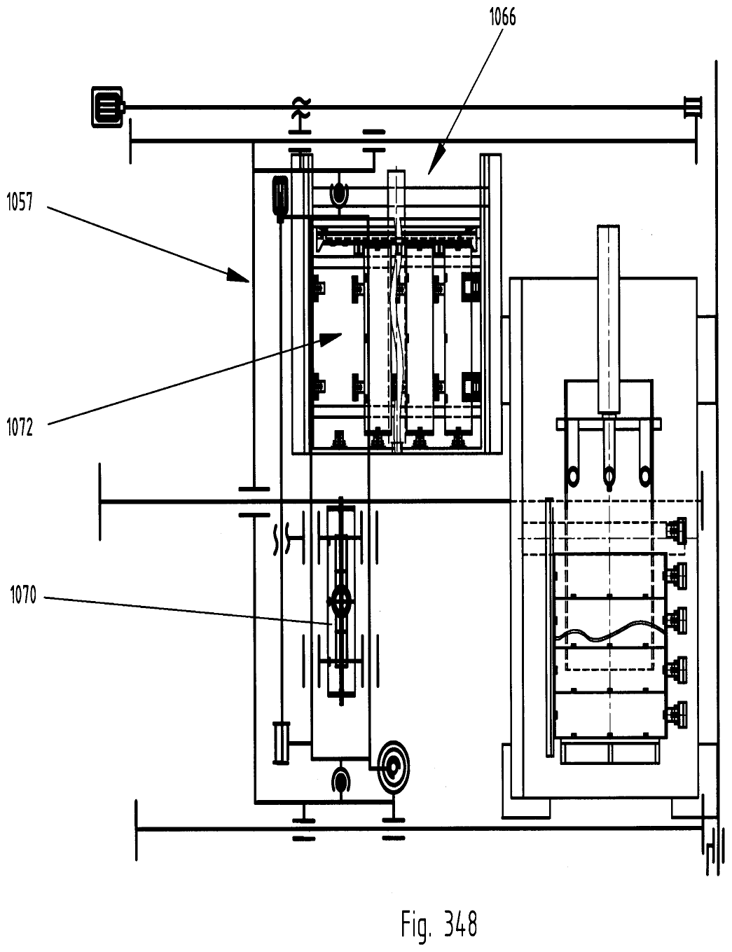

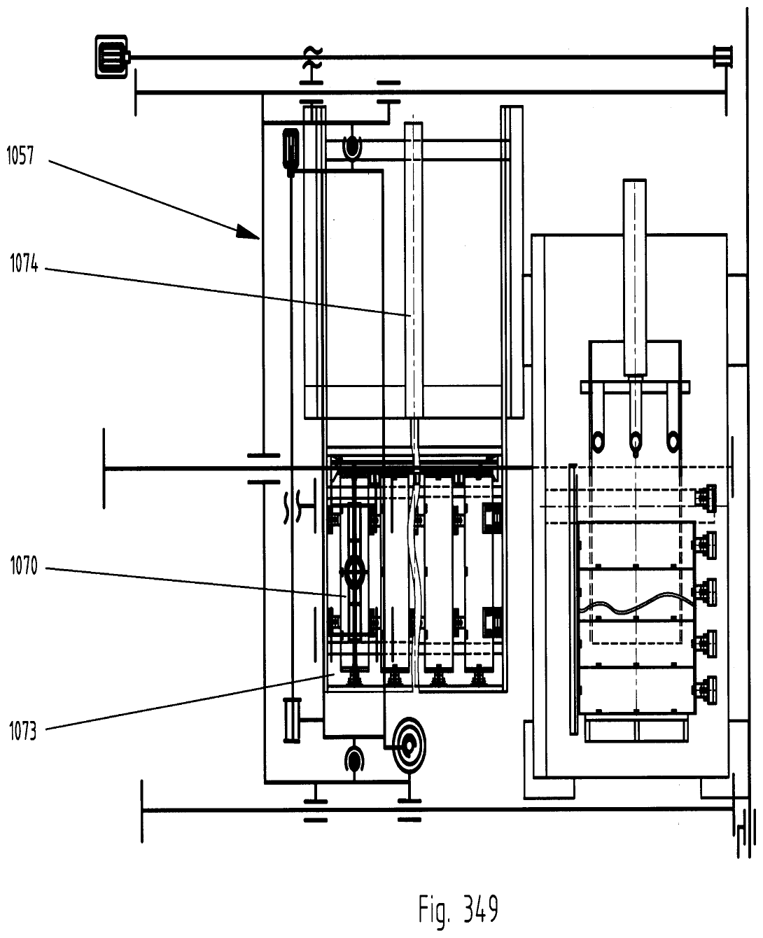

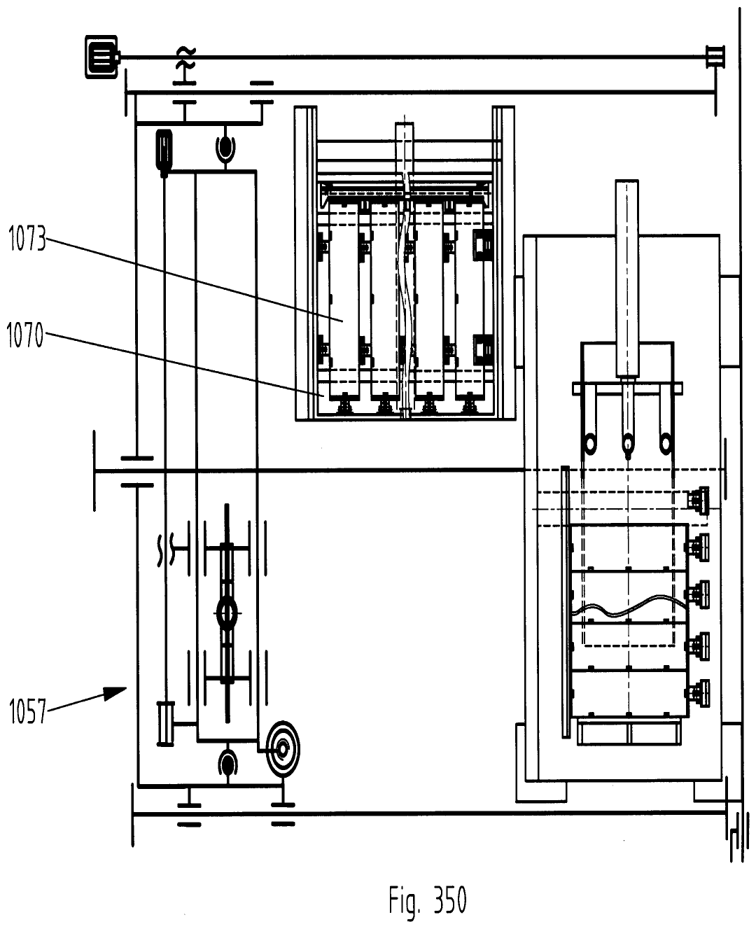

Inside of the battery storage station, including the packing/unpacking device, the battery packages are manipulated by the “storage robot” 1056 and the single modules, used for the packing/unpacking device, are manipulated by the “single module storage robot” 1057, see FIG. 338. The storage robot 1056 is used to move the battery packages from point to point into the storage station. For example, it brings the empty battery package from the sub-station where are disposed the empty battery packages by the battery change robot (or from any storage drawer of the storage station) to the unpacking device 1058 and it disposes this battery package 1059 on the device sliding table 1060, which is moved out activated by the pneumatic cylinder 1061. The sliding table 1060 is retracted and the unpacking process starts. Whatever the packing/unpacking device version is, on this device is detached/attached one module at a time, not more. So, on the proximity of the packing/unpacking device is required a rack for single battery modules. These single battery modules are manipulated from the packing/unpacking device to the rack for single battery modules and vice versus, by the single module storage robot 1057. In FIG. 339 to FIG. 350 is shown step by step the entire process of unpacking of an empty battery package taken out from an electric vehicle by a battery change robot. Therefore, in FIG. 339 is shown the empty battery package 1062 mounted on the sliding table 1063 moved out on the opposite direction to the battery change line, and in its proximity, the storage robot 1056 in the stand-by position. On the packing/unpacking device 1064 there is no battery or battery package at all, the pushing head 1065 is retracted, and the single battery module robot 1057 is retracted in stand-by position. The rack for single battery modules 1066 and the racks for battery packages 1067 have all drawers retracted. Next step is to move forward the storage robot 1056 and to take the empty battery package 1062 from the sliding table 1063, shown in FIG. 340. All the rest don't move. Next two steps are to retract the sliding table 1063 without any battery package on it, and to move out the sliding table 1068 of the packing/unpacking device 1064 activated by the pneumatic cylinder 1069, always having the pushing head 1065 retracted, see FIG. 341. Next two steps are to depose the empty battery package 1062 on the table 1068 of the packing/unpacking device 1064, and to retract the storage robot 1056, see FIG. 342. Next step is to retract the table 1068 of the packing/unpacking device 1064 with the pushing head 1065 retracted, see FIG. 343. Next step is to unpack the first module 1070 of the battery package 1062, by moving the pushing head 1065 and by activated the taper punched 1071, see FIG. 344. In FIG. 345 is shown the first module 1070 detached and the pushing head 1065 retracted and creating free way for the first module 1070 to be taken out by the robot 1057. Next step, shown in FIG. 346, is to move the single module storage robot 1057 over the detached module 1070 and take it out. In FIG. 347 is shown the single module storage robot 1057 with the first module 1070 moved out and preparing the storage of this module in one of the drawers of the rack for single modules 1066. After turning 90 degrees, the single module 1070 is placed by the robot 1057 close to the storage location 1072, see FIG. 348. The next two steps are shown in FIG. 449, illustrating the drawer 1073 of the single modules rack 1066 moved out by the pneumatic cylinder 1074 and the robot 1057 deposing the module 1070 on the drawer 1073. The last step is shown in FIG. 350 where the drawer 1073 is retracted into the rack 1066 with the module 1070 on it, and the robot 1057 is retracted in the stand-by position for the next action.

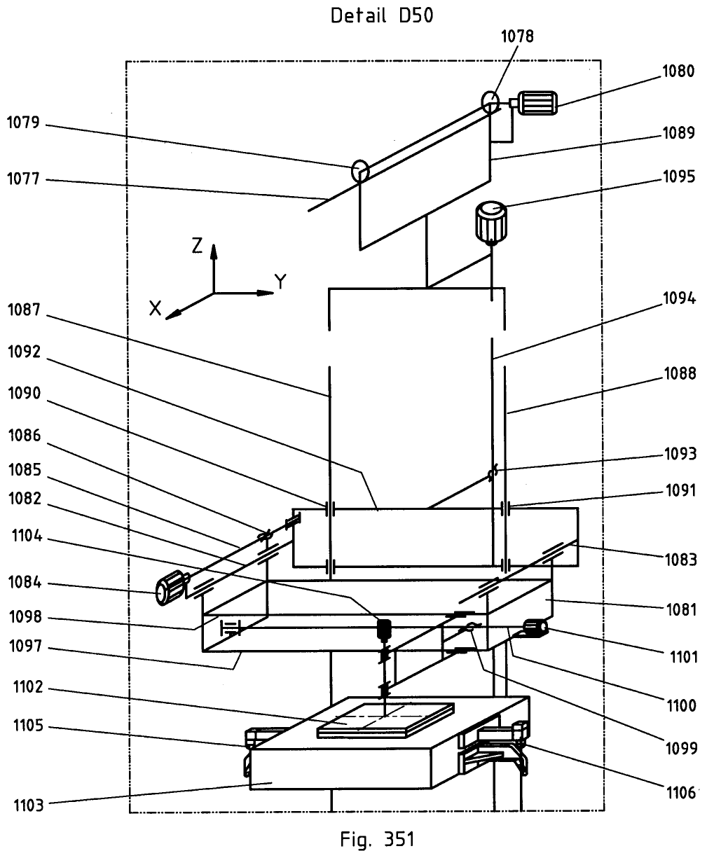

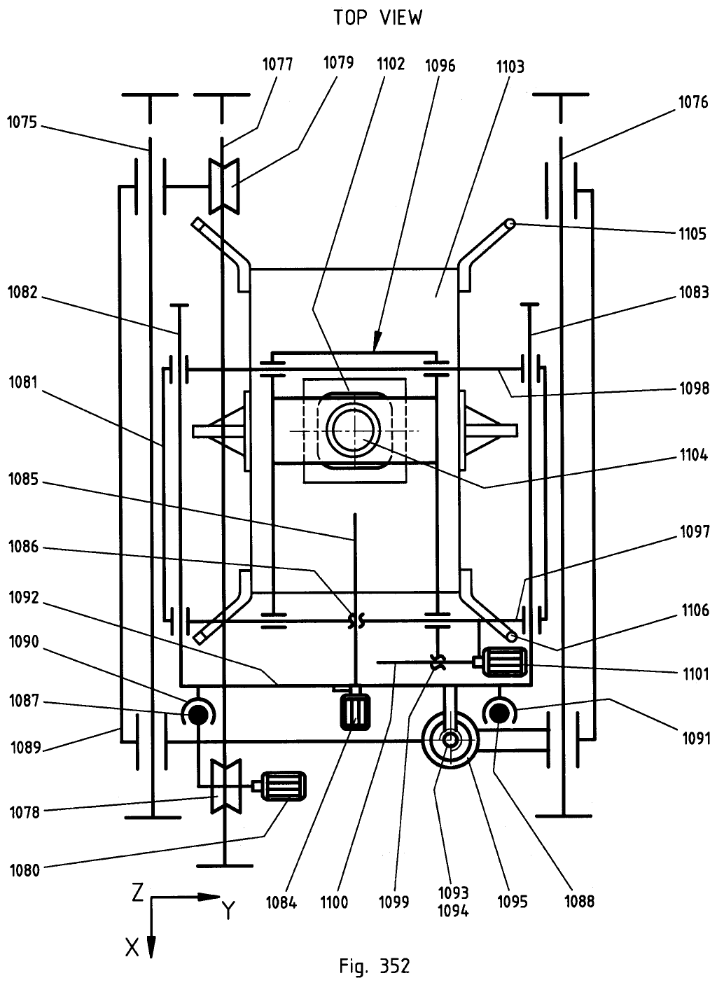

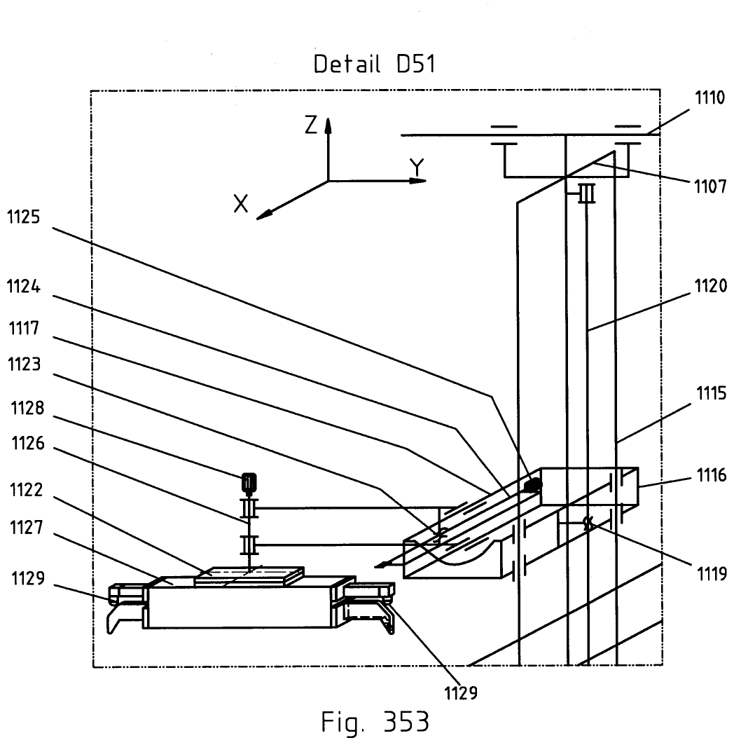

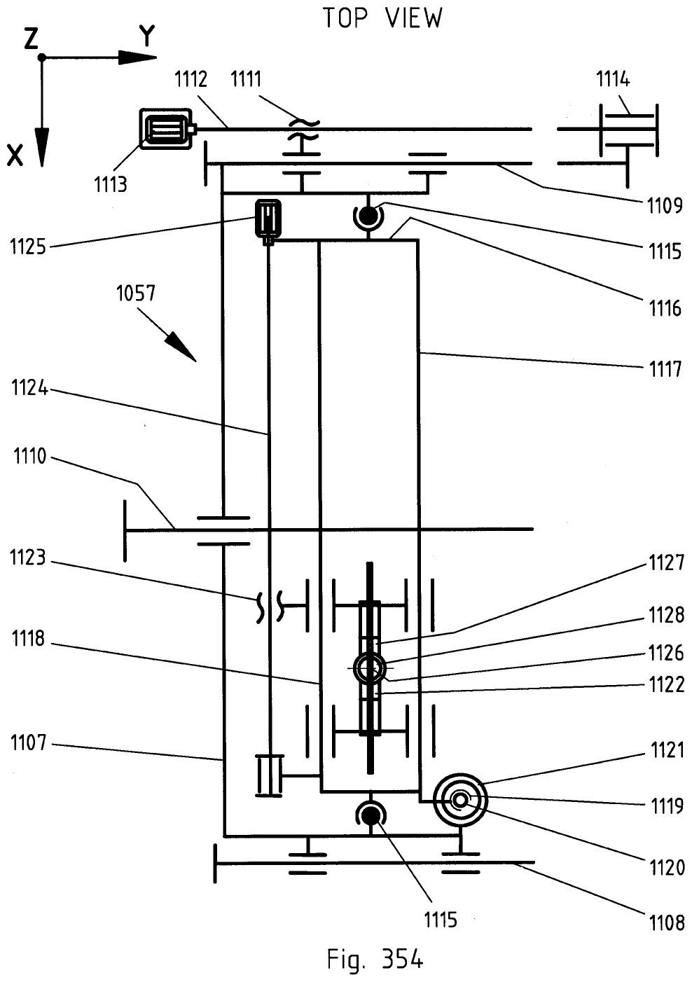

In order to provide all the required movements for battery packages and modules manipulation, these robots are 4 axis robots, capable to move on X, Y and Z directions and turn on a vertical axis. The structure of the storage robot 1056 is illustrated in FIG. 338, in the detail D50 shown in FIG. 351 and the top view of this robot 1056 is shown in FIG. 352. In the “X” direction there are two mechanisms, one for rapid movements using two bottom slide ways 1075 and 1076 and a top ray 1077 on which move two rolls 1078 and 1079, one of them, the roll 1078 being activated by the motor 1080. For fine displacements on the “X” direction, there is another mechanism 1081, sliding on the slide ways 1082 and 1083, being activated by the motor 1084, using a screw-nut mechanism comprising a screw 1085 and a nut 1086. The motor 1084 and the screw 1085 are attached to the frame 1092 and the nut 1086 is attached to the mechanism 1081. On “Z” direction, the storage robot uses two vertical columns 1087 and 1088 attached to a solid structure 1089 which is sliding on the slide ways 1075, and 1076 and rolls on the top ray 1077. On these vertical columns are sliding two sliding elements 1090 and 1091 attached to the frame 1092 which supports the slide ways 1082 and 1083. The vertical movement is realized by a screw-nut mechanism comprising the nut 1093 and the screw 1094, activated by the motor 1095. The motor 1095 and the screw 1093 are attached to the solid structure 1089 and the nut 1094 is attached to the frame 1092. On the “Y” direction, there is a mechanism 1096 sliding on two slide ways 1097 and 1098 mounted on the mechanism 1081. The movement on “Y” direction is realized by a screw-nut mechanism comprising the nut 1099 and the screw 1100, activated by the motor 1101. The motor 1101 and the screw 1100 are attached to the mechanism 1081 and the nut 1099 is attached to the mechanism 1096. On the mechanism 1096 is installed a rotary head 1102 having a vertical axis, capable to support the electromagnet 1103, which grips the battery packages, see the FIG. 351 as well. The rotation of the rotary head is realized by the motor 1104. On the electromagnet 1103 are installed two cameras 1105 and 1106, which transmit information to the robot controller, increasing the positioning accuracy. For security reasons, at the end of each sliding way there is a stopper. The structure of the single battery storage robot 1057 is illustrated in FIG. 338, in the detail D51 shown in FIG. 353 and the top view of this robot is shown in FIG. 354. In the “Y” direction there is a moving mechanisms, comprising a solid structure 1107 sliding on two bottom slide ways 1108 and 1109 and a top slide way 1110. The movement of the structure 1107 is realized by a screw-nut mechanism, having the nut 1111 and the screw 1112, which is activated by the motor 1113. The opposite end of the screw 1112 is supported by the support 1114 in order to minimize screw deformation and increase displacement accuracy. Rigidly attached on the solid structure 1107 are two vertical columns 1115, on which is sliding vertically the frame 1116 comprising two slide ways 1117 and 1118. The vertical movement of the frame 1116 is realized by the screw-nut mechanism, having the nut 1119 and the screw 1120 activated by the motor 1121. The motor 1121 is attached to the solid structure 1107 and the nut 1119 is attached to the frame 1116. On the slide ways 1117 and 1118 is sliding on the “X” direction a rotary head 1122 using a screw -nut mechanism, comprising the nut 1123 and the screw 1124 activated by the motor 1125. The rotary head 1122 has a vertical axis 1126, and attached on it is the electromagnet 1127 capable to grip a single battery module. The rotary head is rotated by the motor 1128, see FIG. 353 as well. On the electromagnet 1127 are installed two cameras 1129, which give information to the robot controller related to the rotary head 1122 position. For security reasons, at the end of each sliding way there is a stopper.

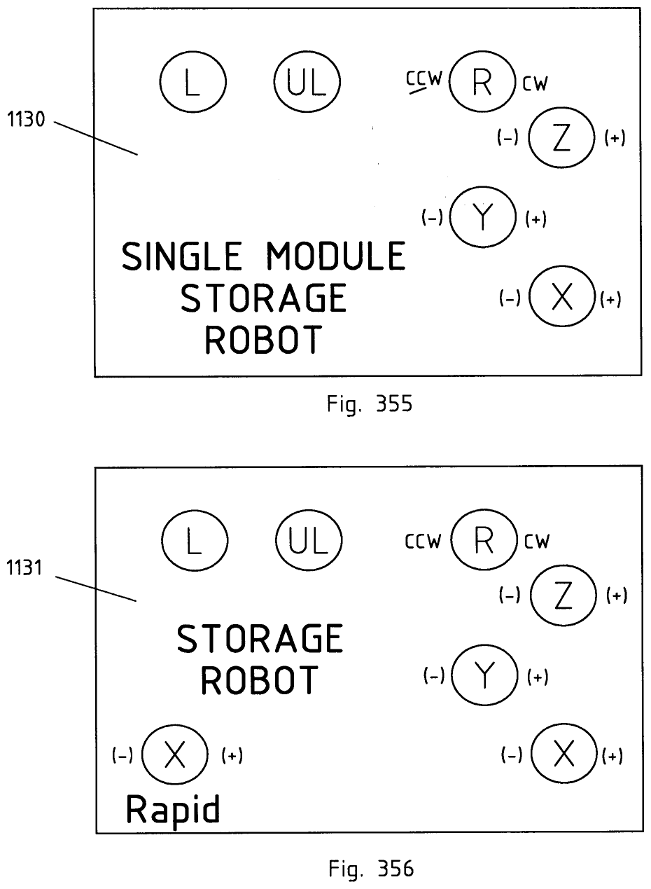

Each robot has its controller, which commands all the robot movements. The robots controllers are integrated into the loading utility programs including the programs of all three robots and the intelligent management battery change system (IMBC). For programing the robots in the “learn” mod, and to move them outside of their programs, a manual command may be realized by using manual control boxes, shown in FIG. 355 and FIG. 356. In FIG. 355 is shown the control box 1130 for the single battery module storage robot 1057, comprising three double buttons or sticks for the robot displacement on X, Y and Z direction, one double button or stick for the rotation of the rotary head CW and CCW, and two buttons for loading and unloading the battery module. In FIG. 356 is shown the command box 1131 for the storage robot 1056, comprising one double button or stick for rapid displacement on “X” direction and three double buttons or sticks for the fine robot displacement on X, Y and Z direction, one double button or stick for the rotation of the rotary head CW and CCW, and two buttons for loading and unloading the battery package.

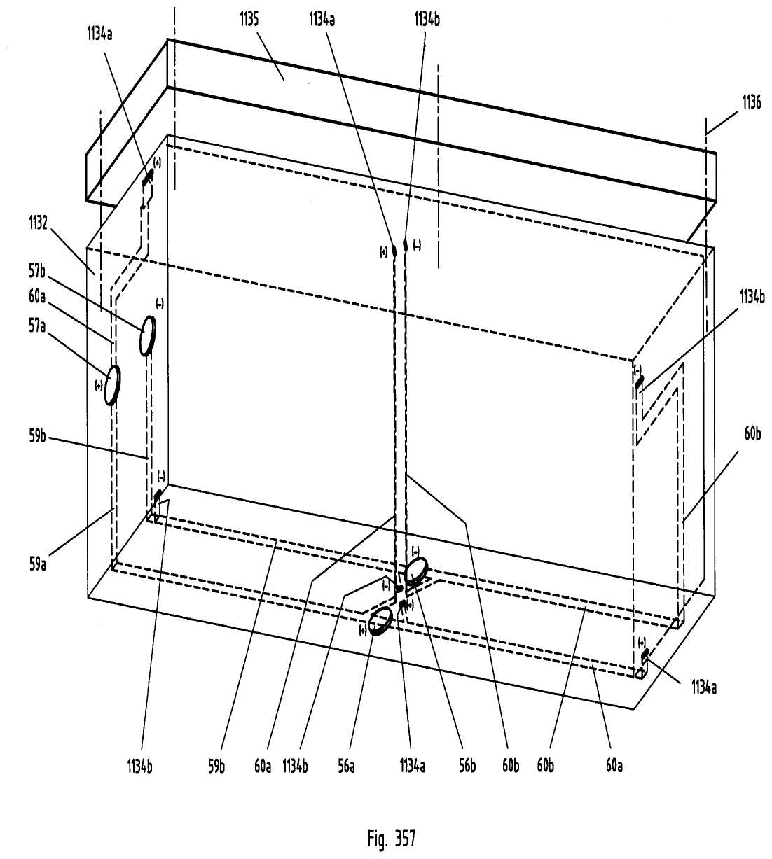

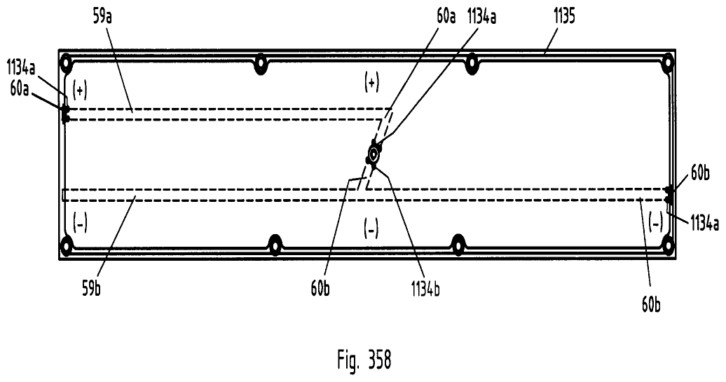

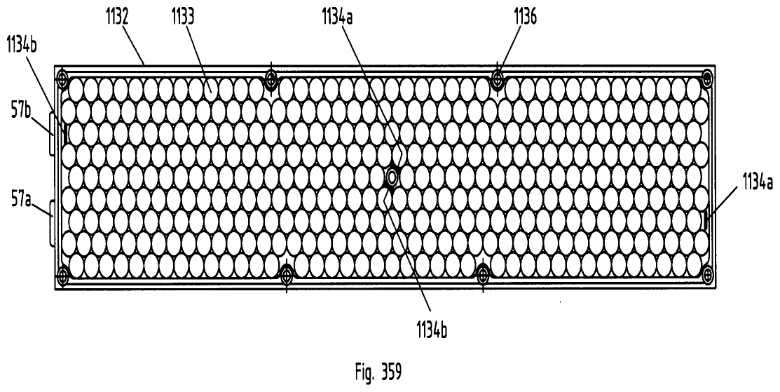

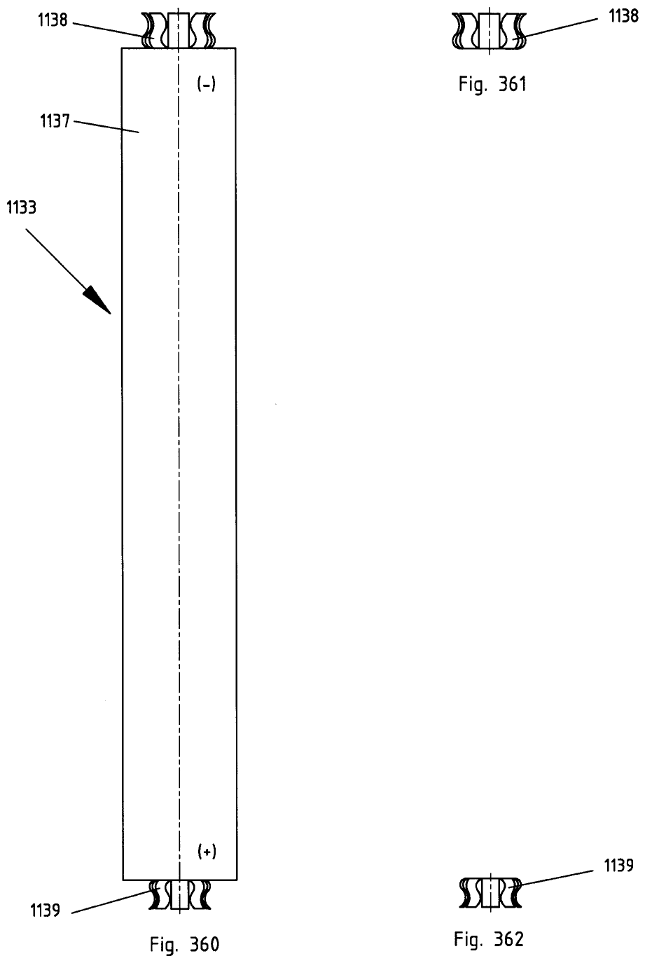

The electric vehicles performances are related to the performances of the battery package installed on the vehicle. These performances are related to many factors such as materials and shape, etc. One of the best performances may be obtained by using cylindrical shape battery elements. Each battery module may have a plurality of such cylindrical shape battery elements connected in different ways depending on the characteristics required for each application. Therefore, for the electric vehicles each battery module comprises a battery box 1132 having bottom battery terminals 56a and 56b and side terminals 57a and 57b, see FIG. 357, FIG. 358 and FIG. 359. Inside of the battery box 1132 there is a plurality of cylindrical battery elements 1133 connected in series or parallel each other by different kind of connectors. The bottom terminals 56a &56b and the side terminals 57a & 57b of the battery module are connected between each other by the connectors 59a and 59b. Many battery elements may be connected in series or parallel, creating groups of battery elements, each of them having a positive and a negative group terminal 1134a and 1134b. The group terminals 1134a and 1134b are connected to the 59a and 59b connectors by the connectors 60a and 60b. The battery box is closed by a cover 1135 using a plurality of bolts 1136 and nuts encased into the battery box walls. The battery element 1133 is shown in FIG. 360, comprising a battery body 1137, a negative contact 1138 and a positive contact 1139, each of these contacts having different size. In FIG. 361 and FIG. 362 are shown the details of these contacts.

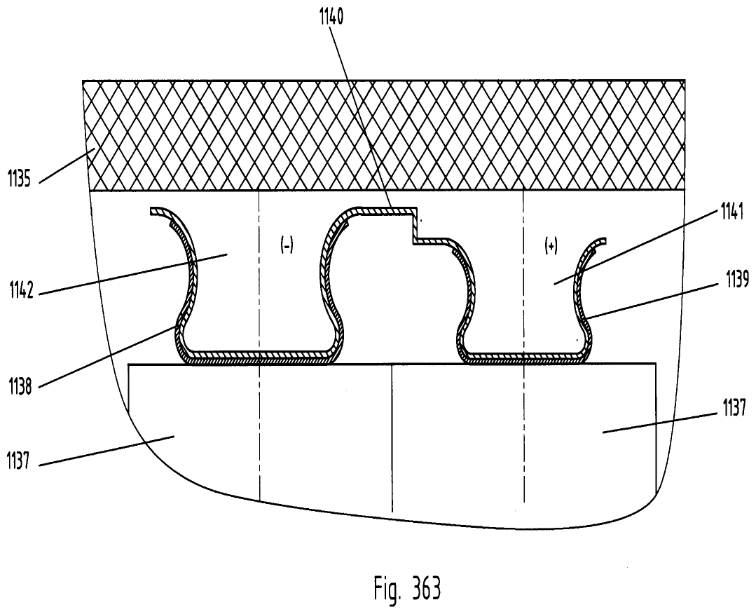

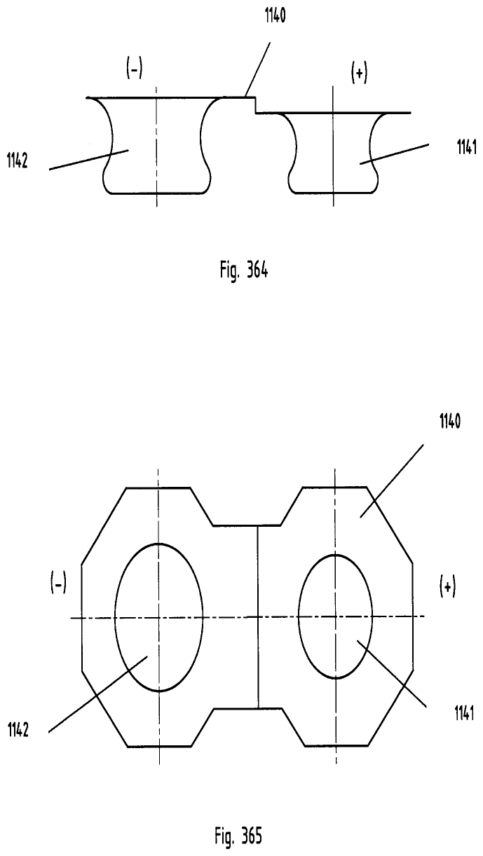

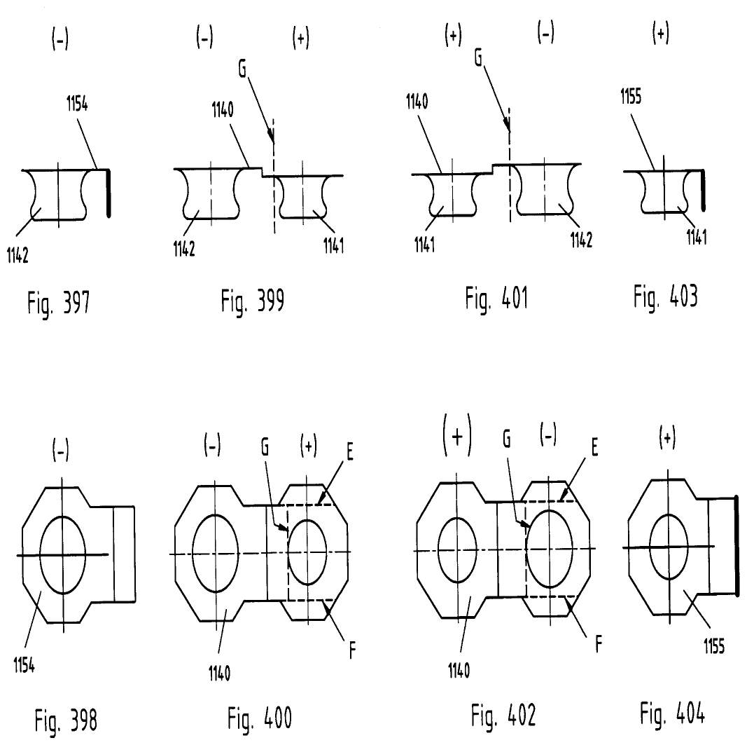

The electric circuit between two or more battery elements is created by connecting these battery elements together using a kind of quick-connectors, see FIG. 363 to FIG. 404. There are four categories of quick-connectors: series connectors, parallel connectors, mixed connectors and group terminal connectors. As can be seen in FIG. 360, both battery element contacts are “female” contacts, having a calibrated inside opened sphere portion shape, into which enters a “male” contact, which is a calibrated outside closed sphere portion shape of the contact, which is very rigid. In order to provide a good electrical contact the battery element female contacts are spring loaded, ensuring a certain contact pressure when the connectors are engaged.

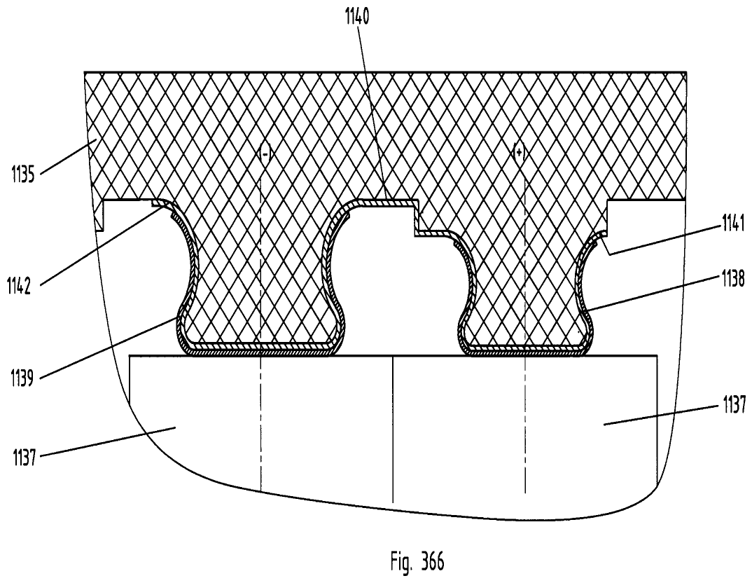

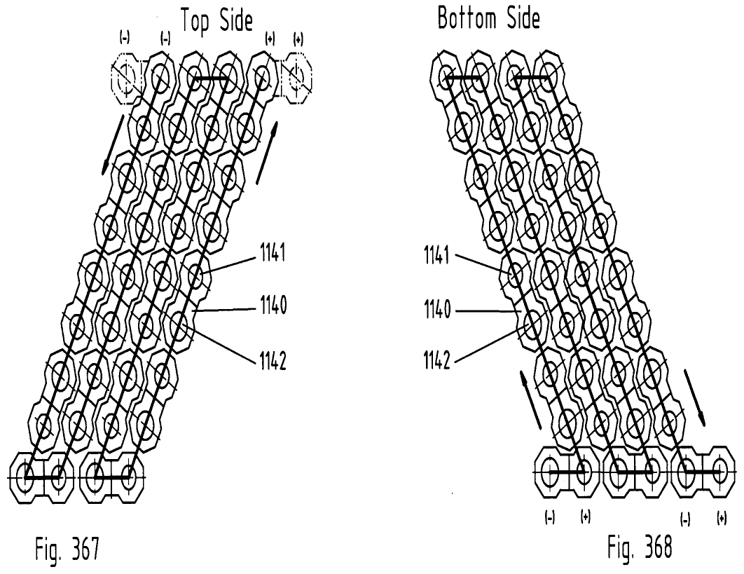

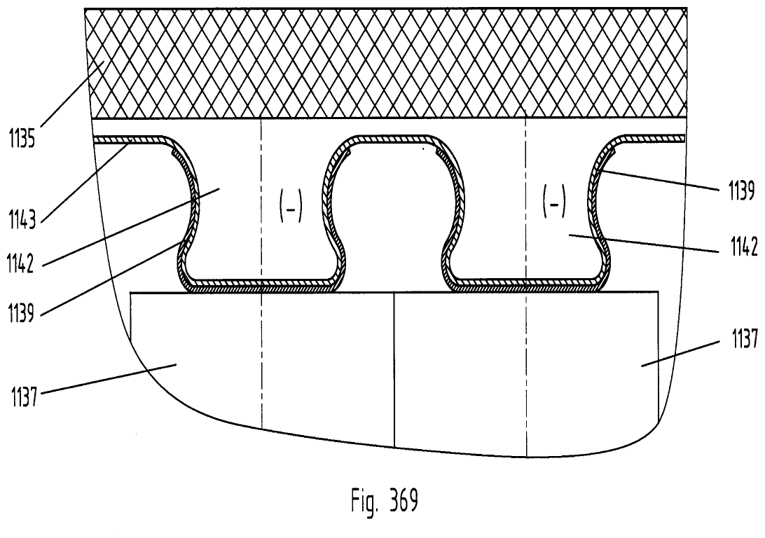

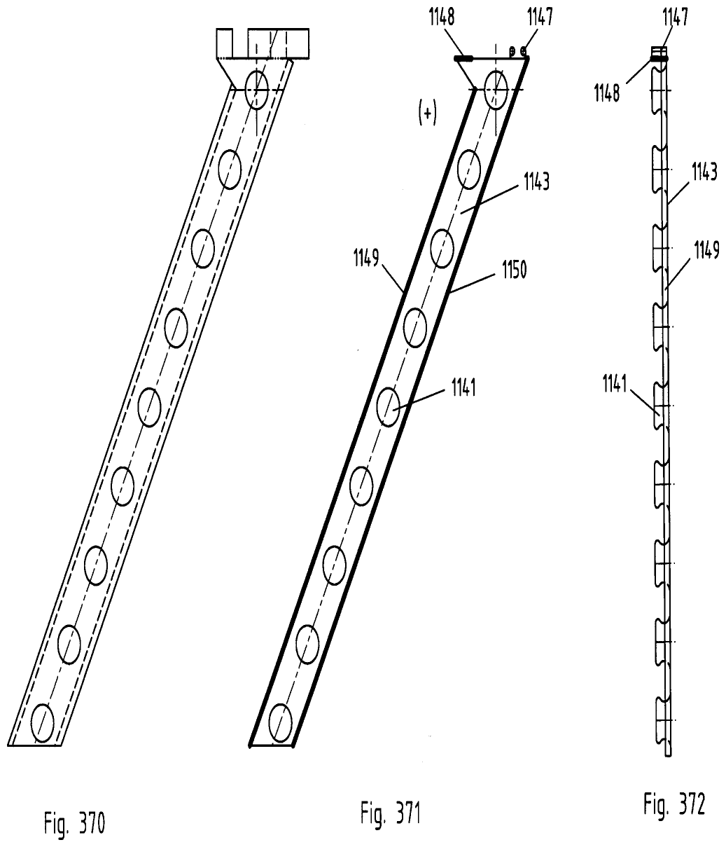

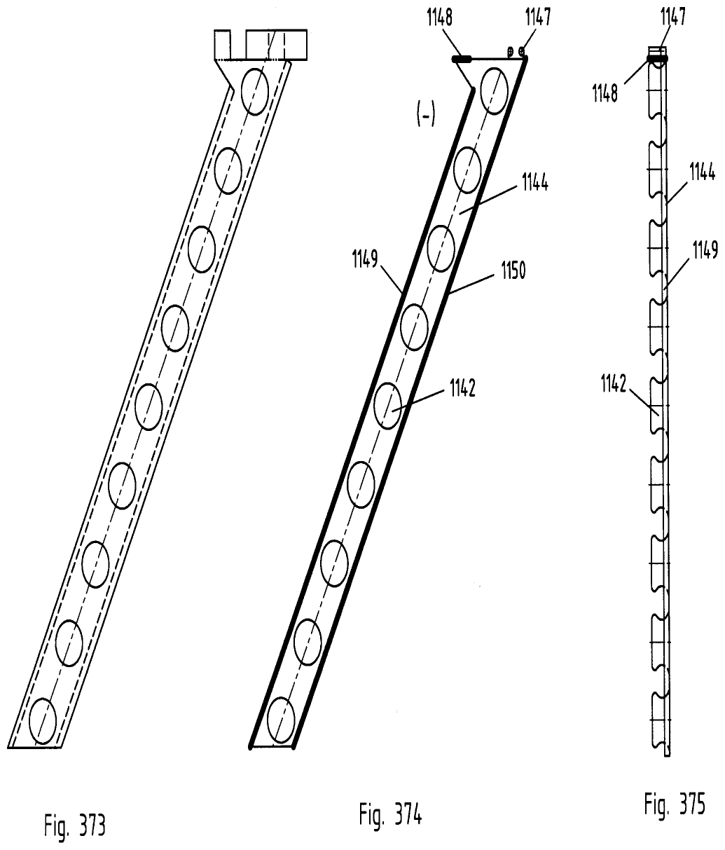

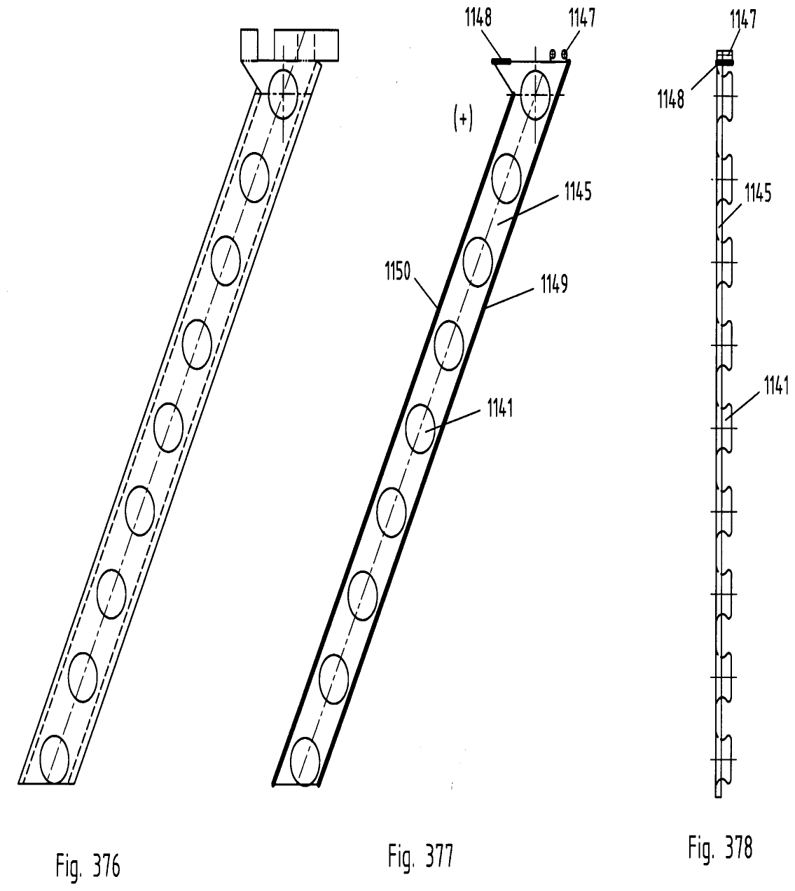

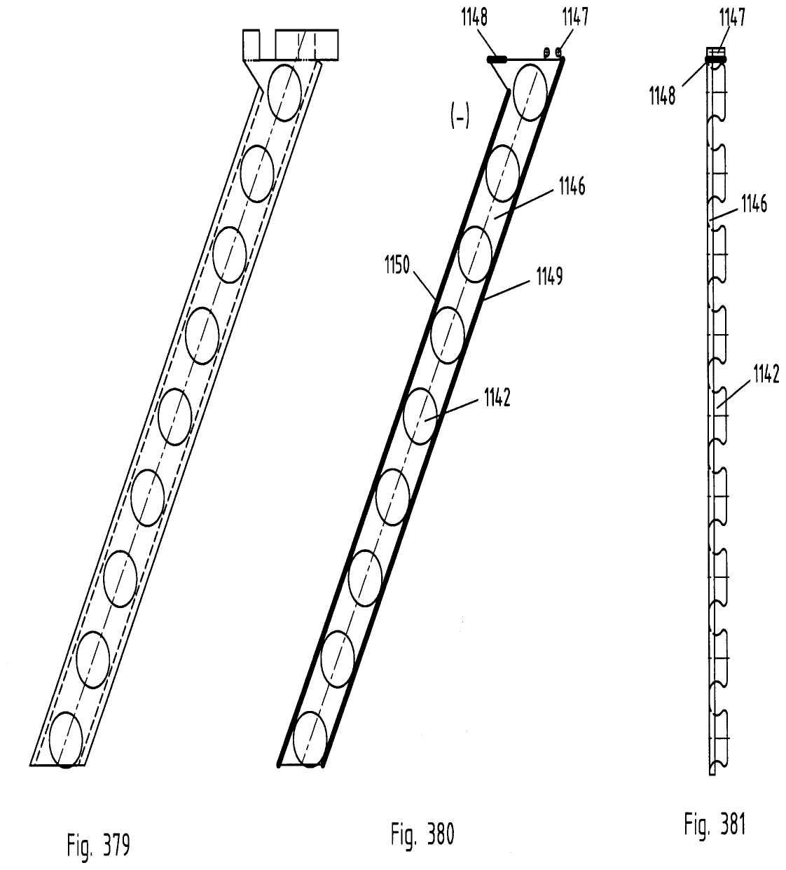

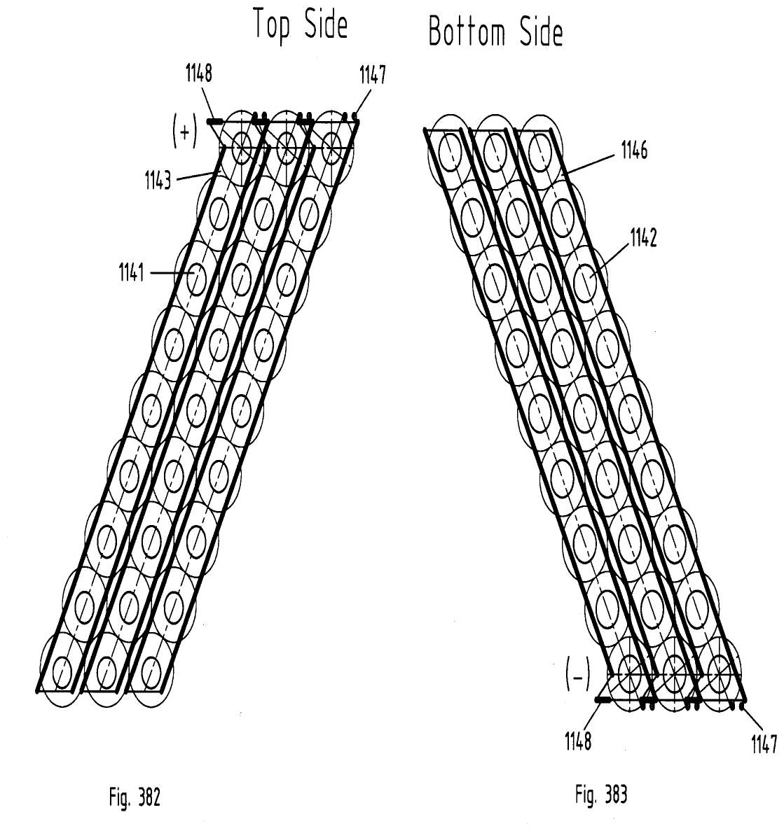

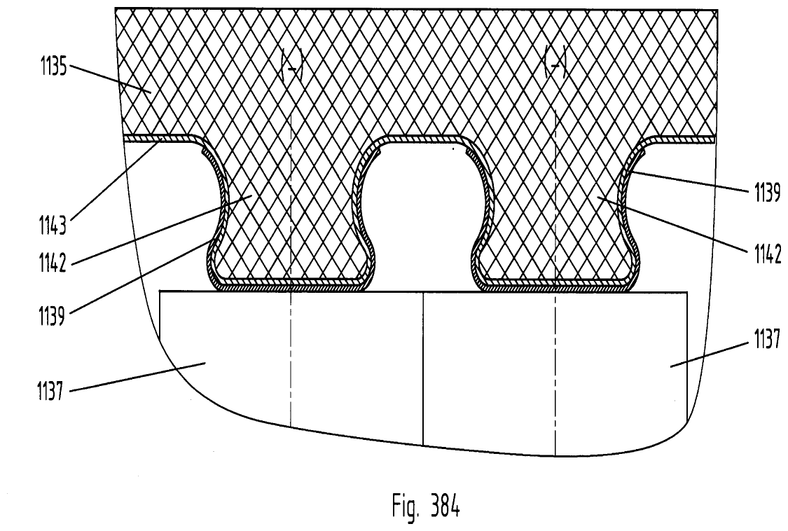

In order to easy identify the polarity of each battery element contact, the dimensions are different for the positive and for the negative contacts. In this document the negative contacts are bigger (in diameter and height) than the positive ones. So, for series connection the connectors 1140 are illustrated in FIG. 363 to FIG. 370. These connectors comprise one positive male contact 1141 (+) and one negative male contact 1142 (−). In order to be able to do any series connection (in any direction) without touching any other connector, the series connectors 1140 have a special shape. There are two possibilities to do these connections: using independent connectors see FIG. 363 or integrated connectors, see FIG. 366. The independent connectors are used as single parts, connecting individually each of them two battery elements, see FIG. 363. The integrated connectors are encapsulated into the battery box or battery cover realizing the connection of all battery elements engaged into this assemble. This kind of integrated connectors may be used for a group of battery elements connected in series, generating a cartridge of batteries. In FIG. 367 and FIG. 368 are shown the series connectors for a group of battery elements in top and bottom view. The special shape of the series connectors 1140 allows to avoid the touching of the connectors each other, therefore no short circuit. In FIG. 369 to FIG. 383 are illustrated parallel connectors. As shown in FIG. 369 these parallel connectors have all the male connectors the same—negative 1142 or positive 1141. These connectors are characterized by the fact that each connector has the same dimensions for all its male contacts, and they have on one end a portion to connect each other. Depending of the sign (+)/(−) and on the position of the parallel connectors (superior/inferior position), there are four basic shapes of parallel connectors, as following: positive superior connectors 1143 (FIG. 370 to FIG. 372), negative superior connectors 1144 (FIG. 373 to FIG. 375), positive inferior connectors 1145 (FIG. 376 to FIG. 378) and negative inferior connectors 1146 (FIG. 379 to FIG. 381). For each basic shape of the parallel connectors is illustrated the top view (in the middle) the side view (on the right) and the deployed of each shape (on the left), which represents the semi-finished of the final part. All parallel positive connectors (superior and inferior) have a plurality of positive male contacts 1141 and all parallel negative connectors have a plurality of negative male contacts 1142. All parallel (positive/negative and superior/inferior) connectors have on one end the female contact 1147 and the male contact 1148, serving to connect this kind of connectors together, see FIG. 382 and FIG. 383. In order to reenforce the parallel connectors, they have on each side of the contacts on the entire length the rims 1149 and 1150, created by bending both sides of the semi-product on the dash lines. The difference between the inferior and the superior parallel connectors consists in direction of embossing and bending the contacts. The parallel connectors may be independent, as those shown up to here, or integrated, see FIG. 384.

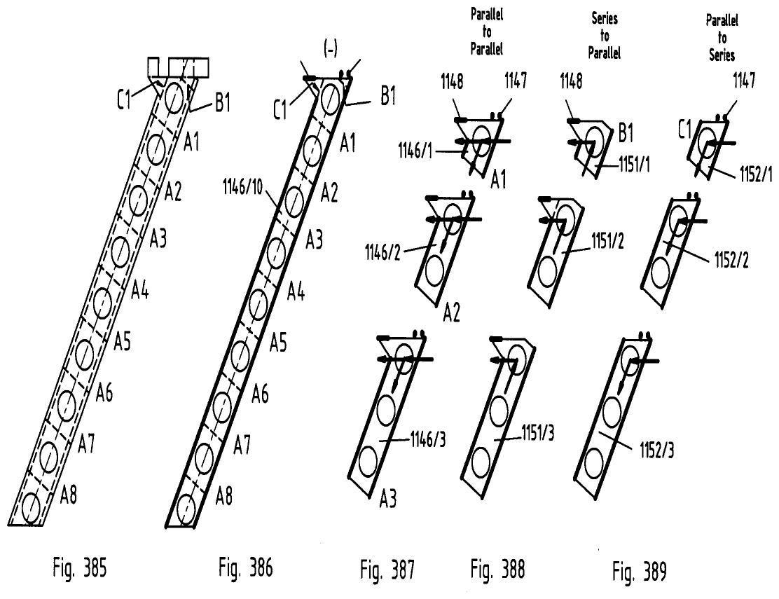

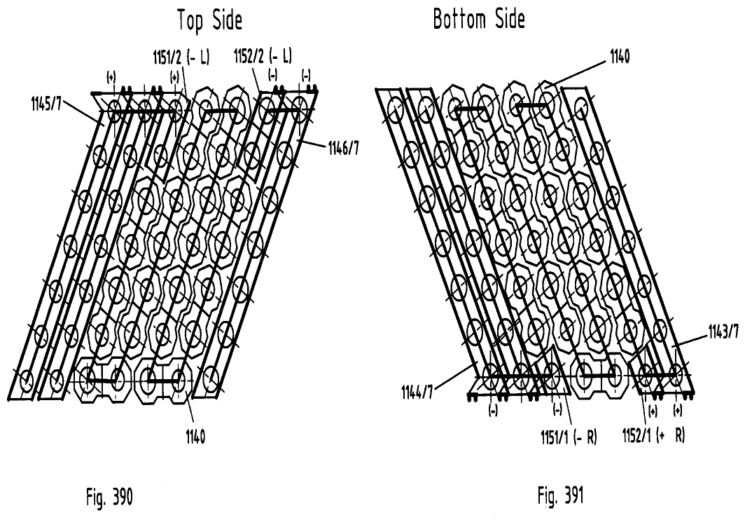

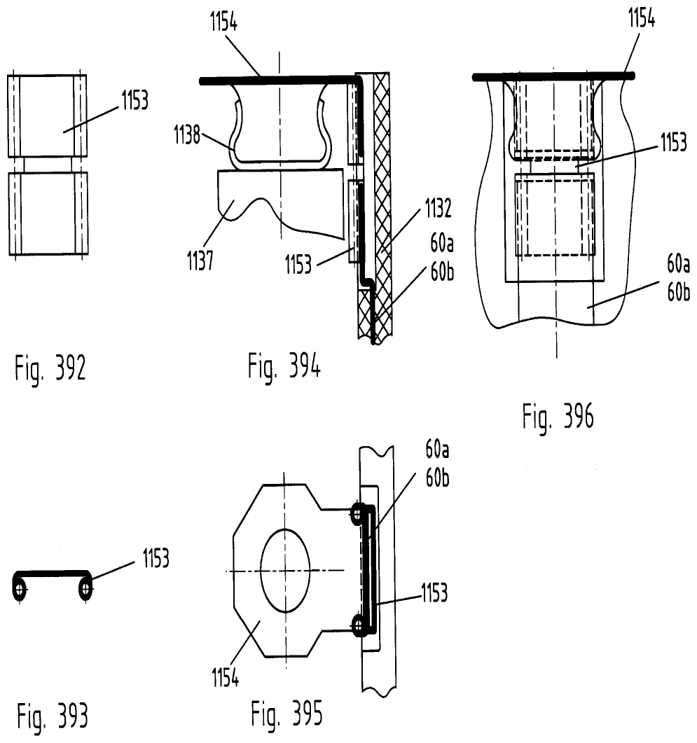

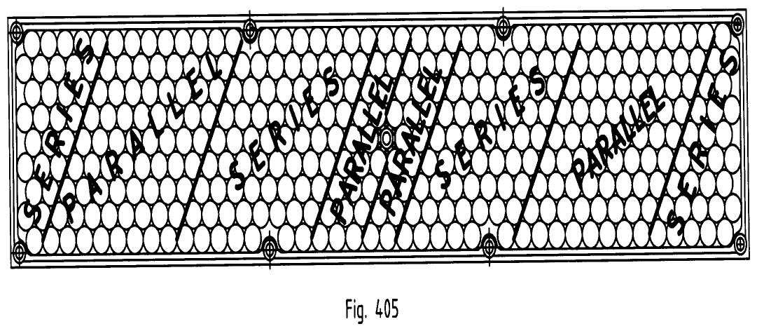

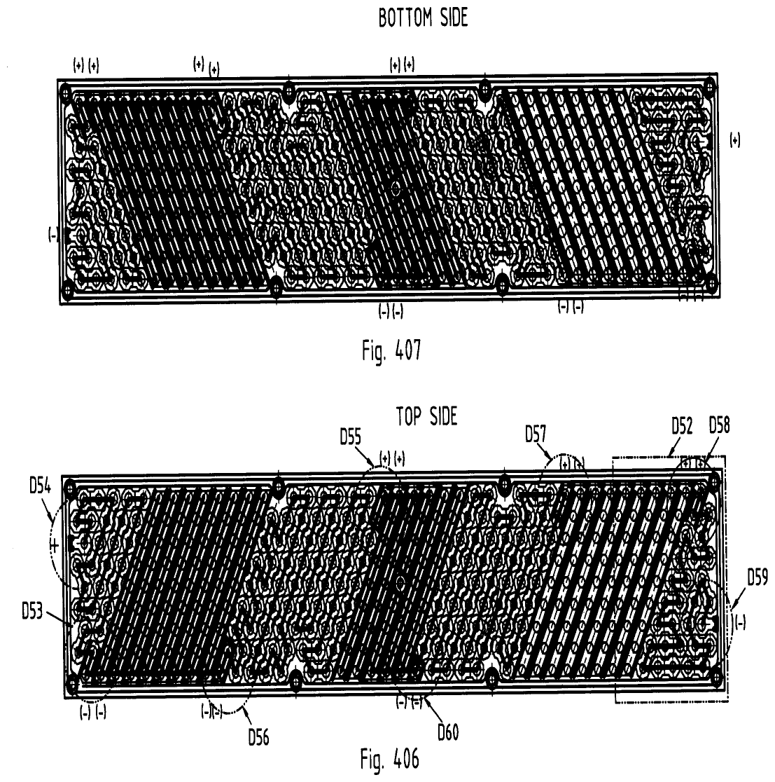

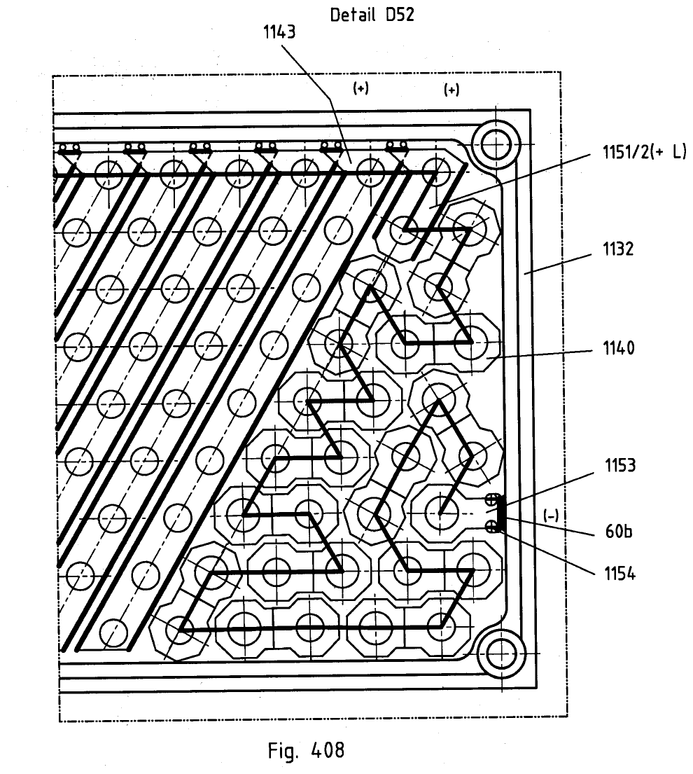

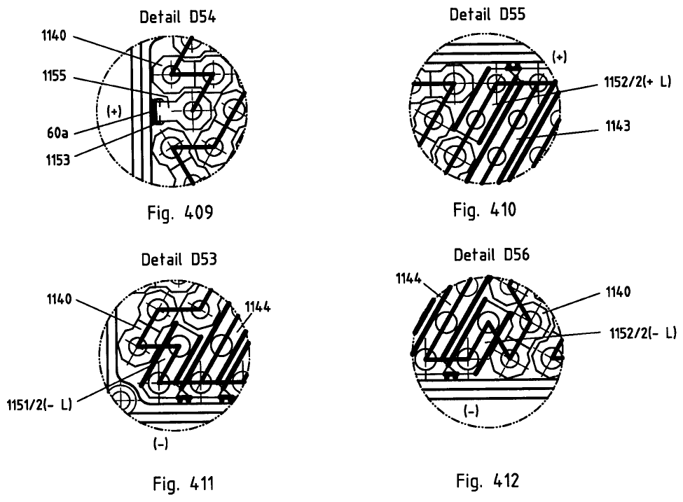

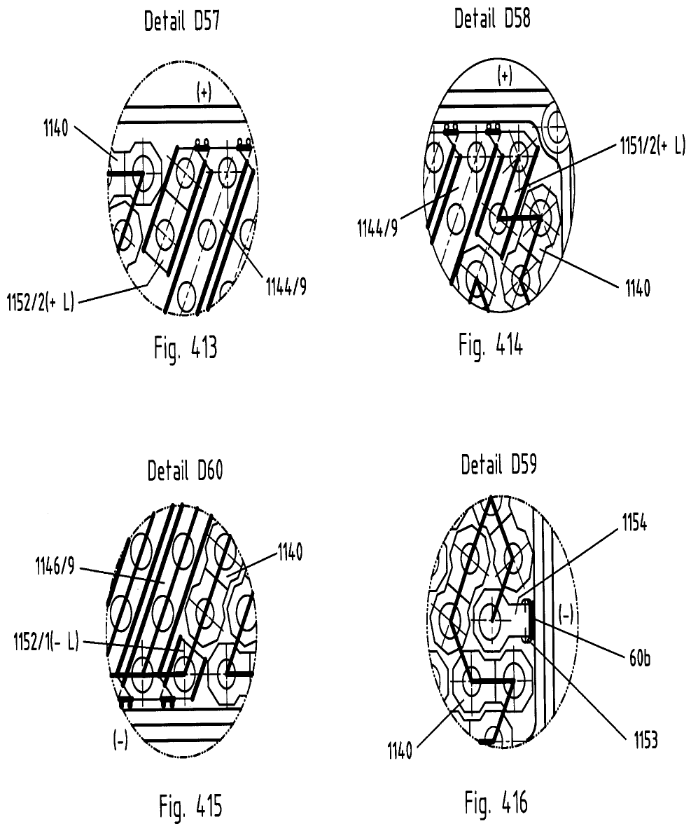

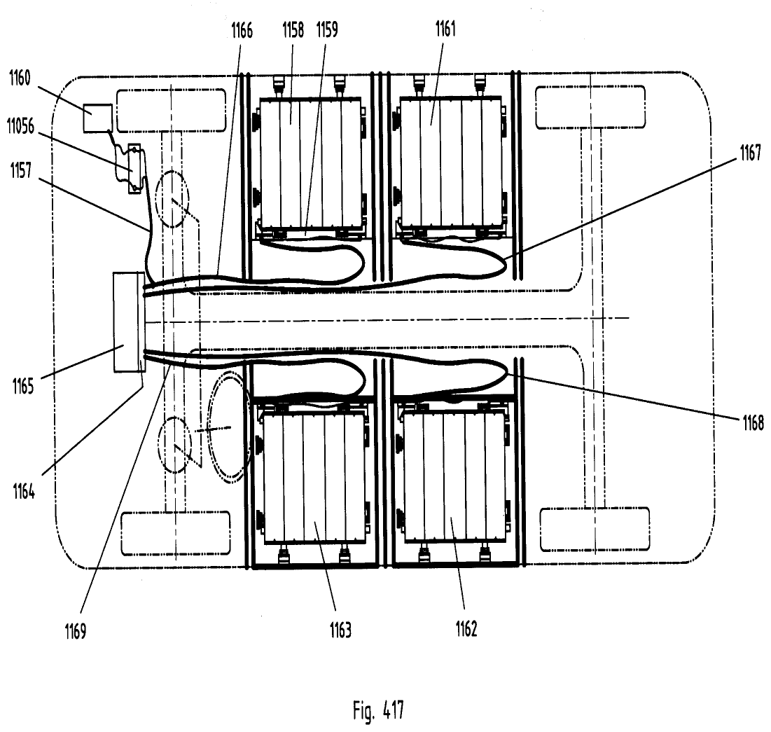

For a battery module, the battery elements may be connected in different ways depending on the performances required. The best scheme of connections may be established by an optimization computation. Generally, in a battery module can be different groups of battery elements connected in series, or in parallel and these groups may be them self connected each other in series or parallel. In order to be able to realize these combinations is necessary to have some specific connectors. The design of these connectors—mixed connectors depends on the connection required: parallel to parallel, parallel to series or series to parallel. Generally these mixed connectors are made from parallel connectors by cutting certain portions of them. As shown in FIG. 385 to FIG. 389, depending on the number of battery elements where the connection applies, can be one, two, three or any number of positive or negative contacts per connector, by cutting the respective parallel connector along the A1, A2, A3 etc. plan, see FIG. 385 and FIG. 386. For parallel to parallel, all the contacts are kept in place, see FIG. 387. For series to parallel, the female contact of the parallel contact has to be cut off, following the B1 direction, generating a connector type 1151, see FIG. 388. For parallel to series contacts, the male contact of the parallel contact has to be cut off, following the C1 direction, generating a connector type 1152, see FIG. 389. There are four kinds of such connectors: positive/negative (+/−) and left/right side (L/R). In FIG. 385 to FIG. 389 all are negative left side connectors (−L). In FIG. 390 and FIG. 391 are shown the top and the bottom side of the mixed contacts for a group of battery elements, using the appropriate kind of connectors. In order to connect groups of battery elements to the conductors 60a and 60b going to the battery module terminals, special connectors are required, which are shown in FIG. 392 to FIG. 396. Generally, for simplicity, the conductors 60a and 60b have a “male” type end. To be connected to another “male” ended connector, a double female connector 1153 is required, see FIG. 392, FIG. 393 and for the assembly FIG. 394 to FIG. 396. For the groups connected in parallel, the male connector 1148 is used without any alteration. For series connected groups, a special connector is required, made from the series connector 1140 by cutting it on the “E”, “F” and “G” direction as shown in FIG. 397 to FIG. 404. In this way, is obtained the negative connector 1154 (FIG. 397) and the positive connector 1155 (FIG. 403). In FIG. 405 is shown a battery module with a plurality of battery elements, connected in parallel, in series creating different groups, which are connected as well in parallel or in series each other. In FIG. 406 are illustrated the superior connectors and in FIG. 407, the inferior connectors required to realize the battery module presented in FIG. 405. In continue heavy line is illustrated the electric circuit on both sides. In FIG. 408 to FIG. 416 are illustrated different details of these connections, showing the cod of everyone.

Based on an optimization algorithm each electric vehicle producer will establish what is the optimum connection for the standardized battery modules in each battery package and the contact plate of each vehicle will be designed and connected each other in an appropriate way to answer to each particular requirements. Therefore, even if entire electric vehicle industry uses the same standardized battery modules, their connection may be different and specific to each kind of electric vehicle. Inside of the contact plate of each drawer, each module may be connected different (parallel, series or mixed) for every battery package, and the battery packages may be also connected in different ways generating to the main battery terminals of the electric vehicle an electric current with different characteristics.

For the electric vehicles using this technology—quick-change battery system, in order to ensure a permanent power on the vehicle—even in the time when the battery packages are taken out, is necessary to have a utility battery. This utility battery is an ordinary battery (even smaller than the actual ones used on the fuel vehicles), which is used during the battery change process and may be recharged after the battery change operation, from the recharged battery. In this way all the vehicle utilities systems are working without any interruption and the connection of the electric vehicle with the intelligent management battery change system (IMBC) is ensured. In FIG. 417 is illustrated an embodiment of an electric vehicle comprising as utility battery 1156 an ordinary battery, which may be connected by the cable 1157 to one of the modules of the nearest battery package 1158, using a special design of the associated contact plate 1159. This battery 1156 may be the electric source of the utilities unit 1160. The battery packages 1158, 1161, 1162 and 1163 are connected to the main terminal 1164 of the power unit 1165 of the vehicle, by the cables 1166, 1167, 1168, 1169. The length of each of these cables is long enough to generate a loop for each cable in order to follow the drawer when it goes out for battery change.

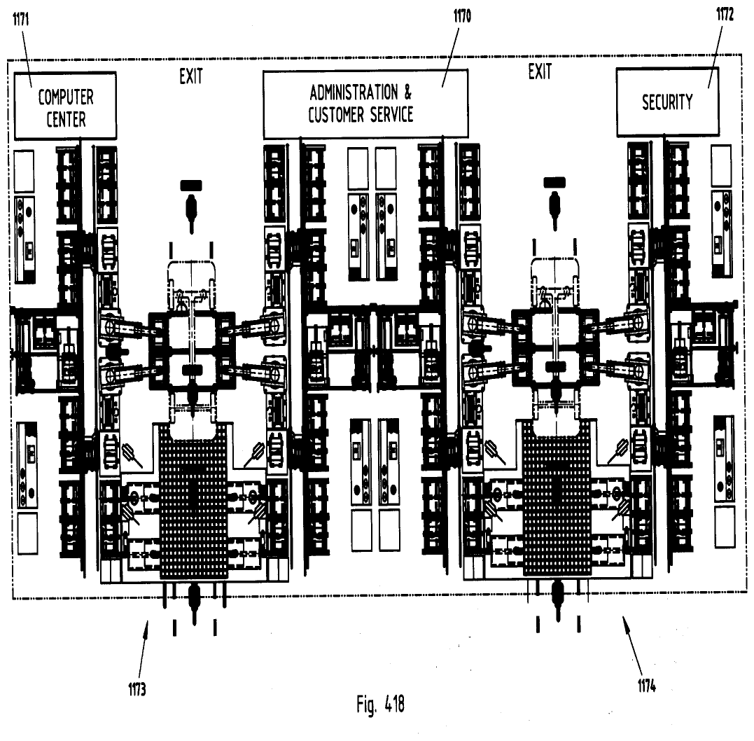

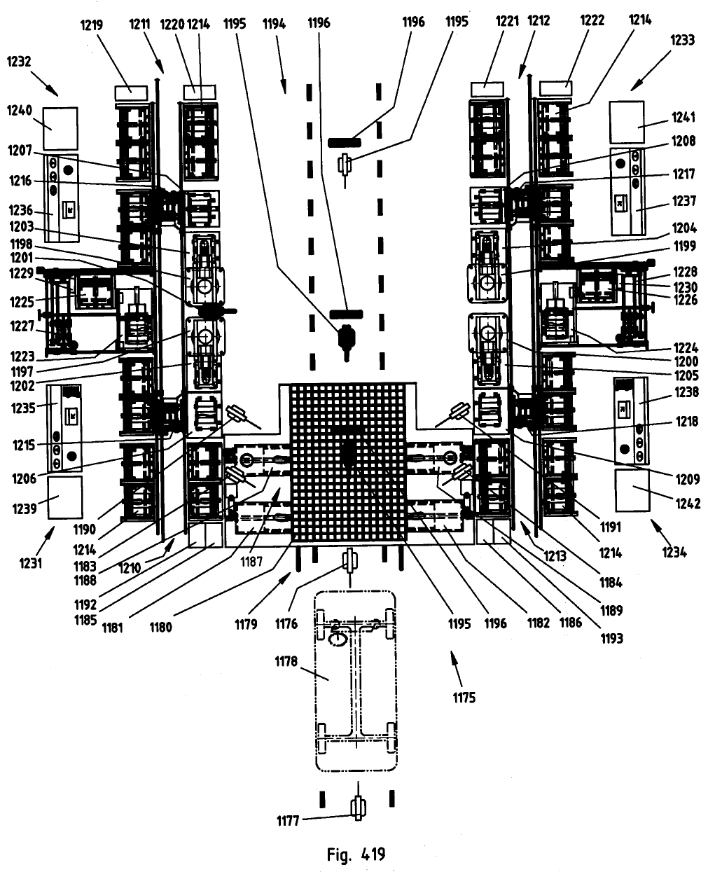

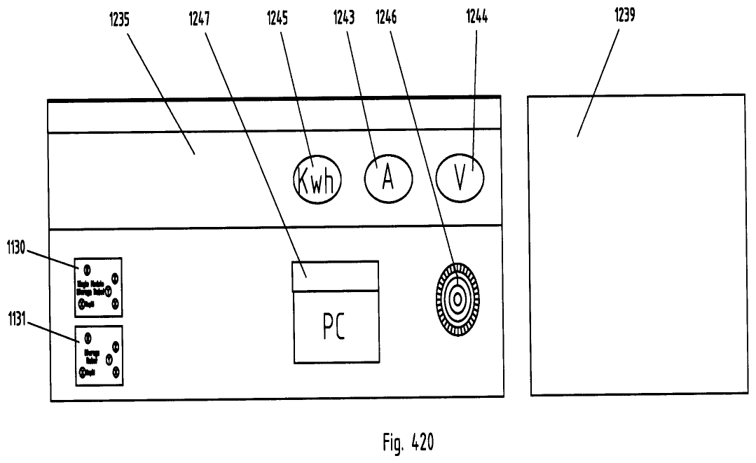

Considering all the aspects discussed herein, in FIG. 418 is illustrated an embodiment of an automated loading utility including two battery change automated lines. A such automated loading utility comprises an administration and customer service section 1170, a computer center 1171, a security section 1172, and two battery change lines 1173 and 1174. Each line comprises all the sections described herein before (see FIG. 419), as following: At the entrance is an inspection station 1175 having front and rear cameras 1176 and 1177 between which each electric vehicle 1178 has to be stopped for identification and other information (as described in detail before). Next is the cleaning section 1179 comprising a grilled floor 1180, two cleaning machines 1181 and 1182 positioned on each side of the vehicle 1178 and two cameras 1183 and 1184, capable to take useful information on the status of the battery drawers covers and on the vehicle position at every moment and communicate with the intelligent management battery change system (IMBC) and with the cleaning machines command units 1185 and 1186 in order to decide if is or not necessary to do the cleaning operation. Next is the dry station 1187 using high volume air blast, comprising two drying machines 1188 and 1189 and two cameras 1190 and 1191 one on each side of the vehicle. The cameras are in contact with the intelligent management battery change system (IMBC) and with the drying machines command units 1192 and 1193 to apply the wright decisions. As can be seen in FIG. 419 the cleaning station 1179 and the drying station 1187 are close each other, allowing to reduce considerably the required space for the line. Next is the battery change station 1194. In order to control the position and the speed of the vehicle inside the battery change station 1194 a plurality of cameras 1195 and TV sets 1196 are installed in front of the vehicle, giving useful information to the driver. In the battery change station 1194, four robots 1197, 1198, 1199 and 1200 (two on each side) manipulate the battery packages for change. The vehicle position is controlled by the camera 1201 focusing on the drawers covers of the vehicle, transmitting information to robots and to the driver in order to stop the vehicle in the optimum position with respect to the four robots. For each robot there is a receiving station 1202, 1203, 1204 and 1205 where the empty battery package will be deposed. As it was described before, underneath of the sliding table of each receiving station there is a contact cleaning device for the bottom contacts of the empty battery packages. Also, for each robot there is a stand-by station 1206, 1207, 1208, and 1209, where the full battery packages are deposed before the vehicle is arrived, waiting to be installed. Underneath of the sliding table of each stand-by station, there are two sliding drawers with a contact cleaning device for the side battery contacts, sliding in opposite direction each other, and a sliding drawer having a contact cleaning device for bottom contacts of the contact plates, sliding in an opposite direction of the vehicle. On each side of the line, on the proximity of each robot, there is a battery storage & recharge area, 1210, 1211, 1212 and 1213, where a plurality of racks 1214 are installed. The battery packages are transported and manipulated inside of each storage area by a storage robot 1215, 1216, 1217 and 1218. Each storage robot has a control unit 1219, 1220, 1221, and 1222. On each side of the line, there is a packing/unpacking device 1223 and 1224, and a rack 1225 and 1226 for single battery module, served by a single battery module storage robot 1227 and 1228, which manipulates the single modules used on the packing/unpacking device. Each single battery module storage robot has a control unit 1229 and 1230. Each storage area is equipped with a battery recharging station 1231, 1232, 1233 and 1234, comprising as well a control panel 1235, 1236, 1237 and 1238 and a power unit 1239, 1240, 1241 and 1242. In FIG. 420 is shown the 1231 recharging station. The power unit 1239 is equipped with battery recharging devices and all required electrical equipment to recharge empty battery packages installed on the storage racks. Every battery package installed in the storage drawer is in contact with the contact plate of the respective drawer. On the control panel 1235 there are all the required meters to measure the current Amps 1143, Voltage 1244 and energy in Kwh 1245, etc. In order to avoid to have all these apparatus for each contact plate installed on each drawer, there is only one meter for each current characteristic and a complex switch 1246, which switches from drawer to drawer. All the actual readings are recorded on a data base via a PC 1247, which is capable to communicate with the intelligent management battery change system (IMBC), transmitting and receiving information. On each control panel there are the boxes 1130 and 1131 for manual control of the two robots serving each area.

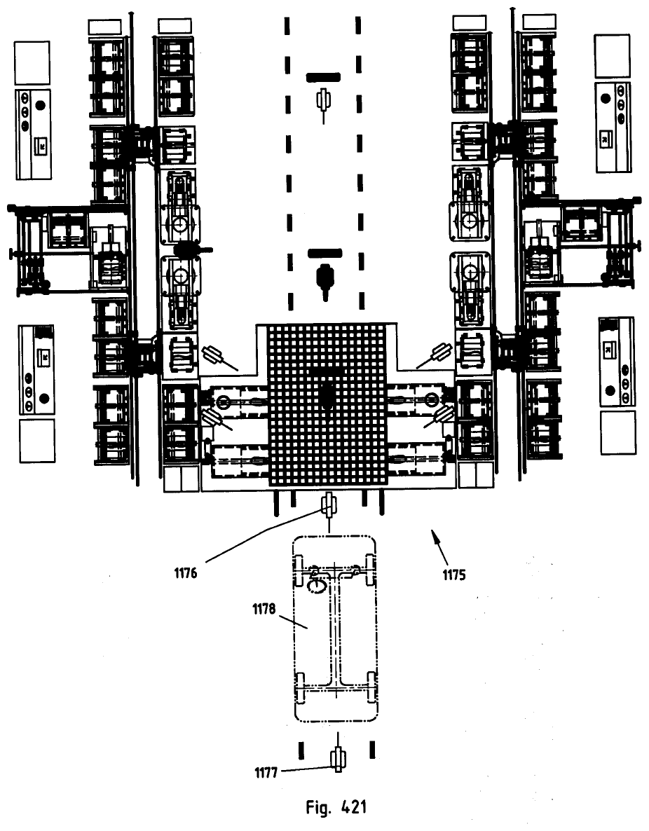

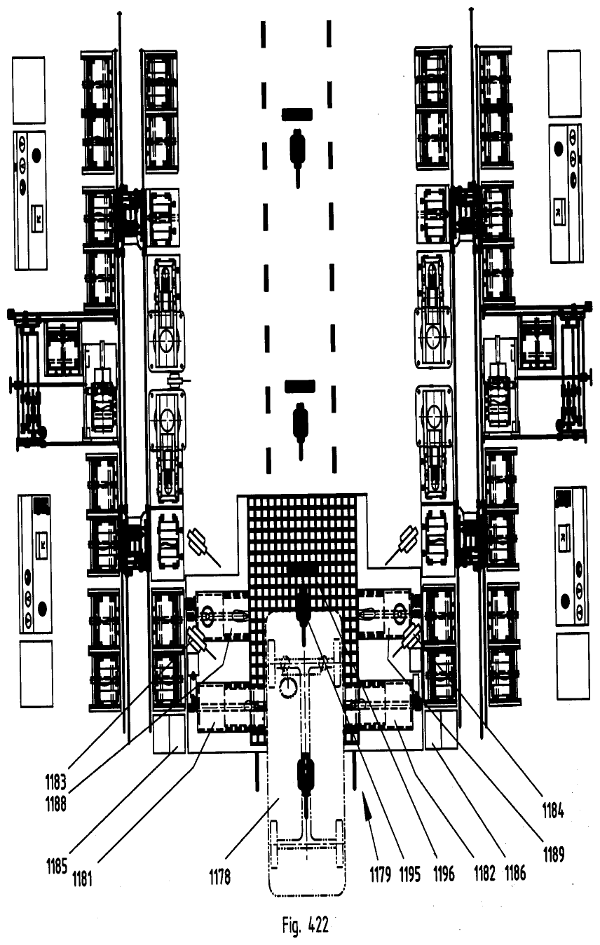

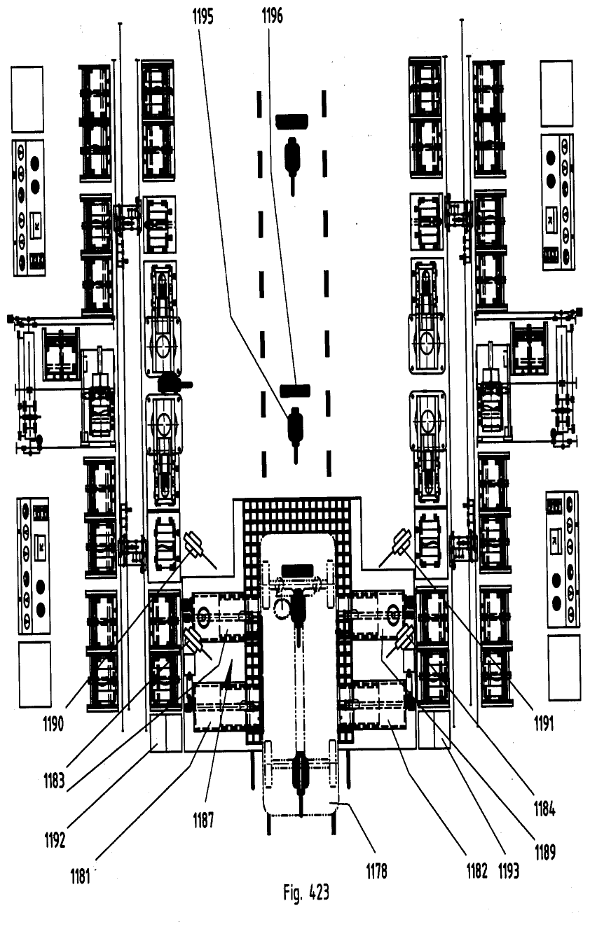

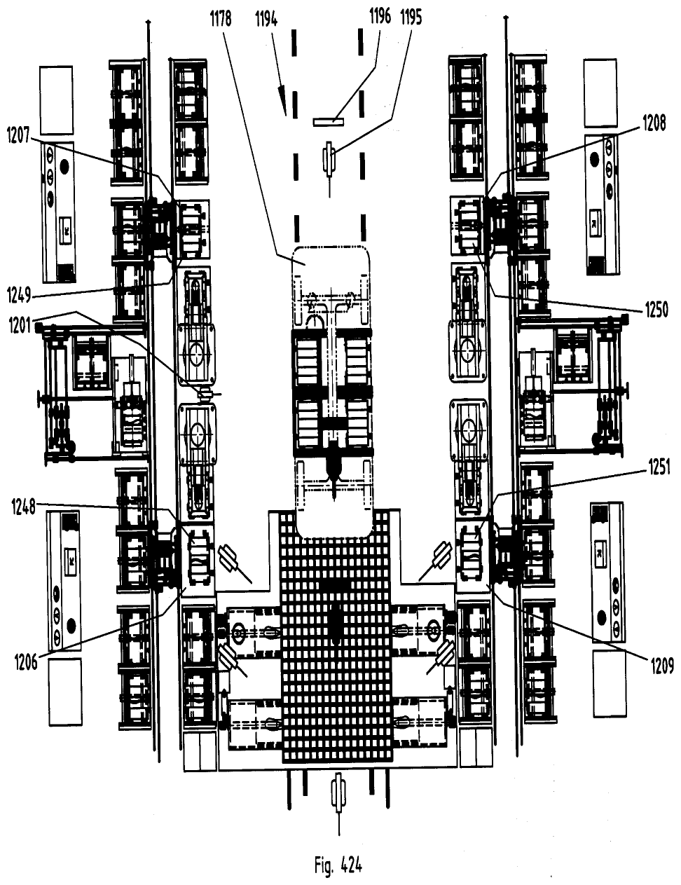

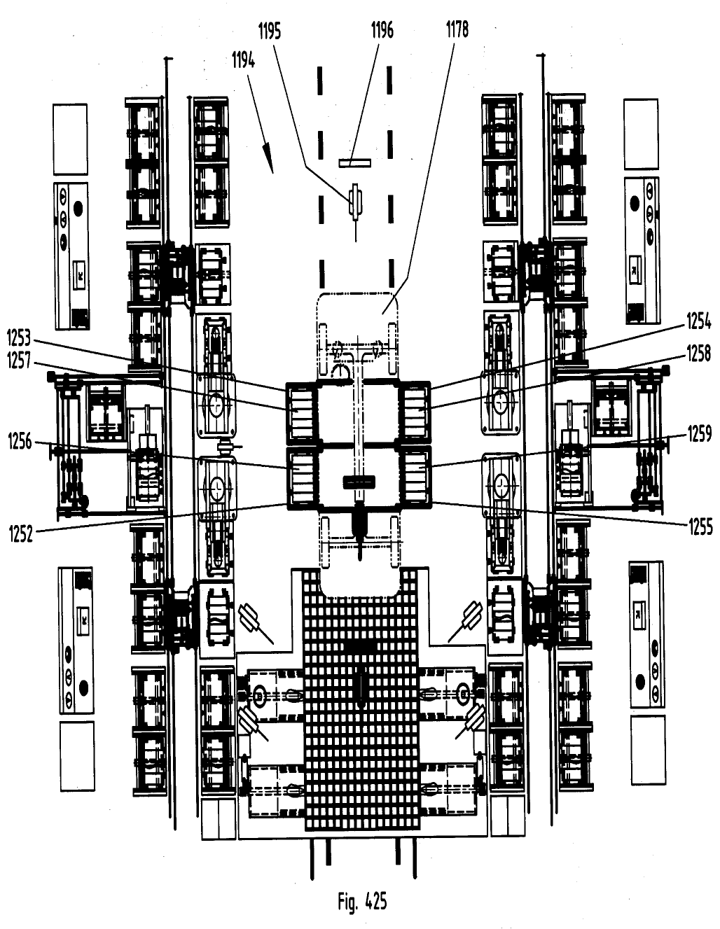

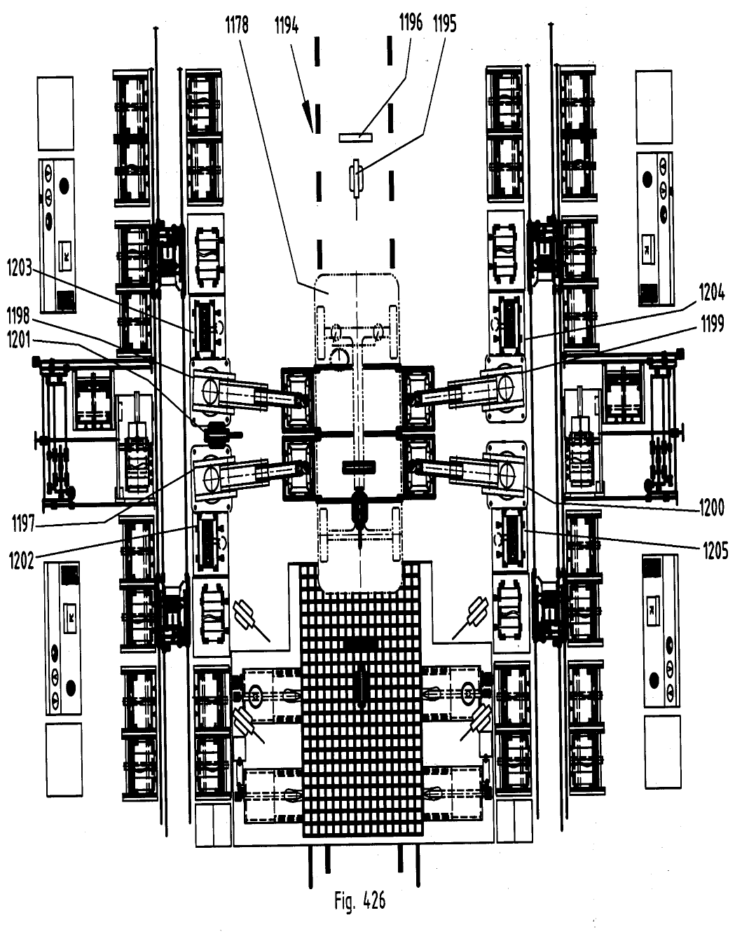

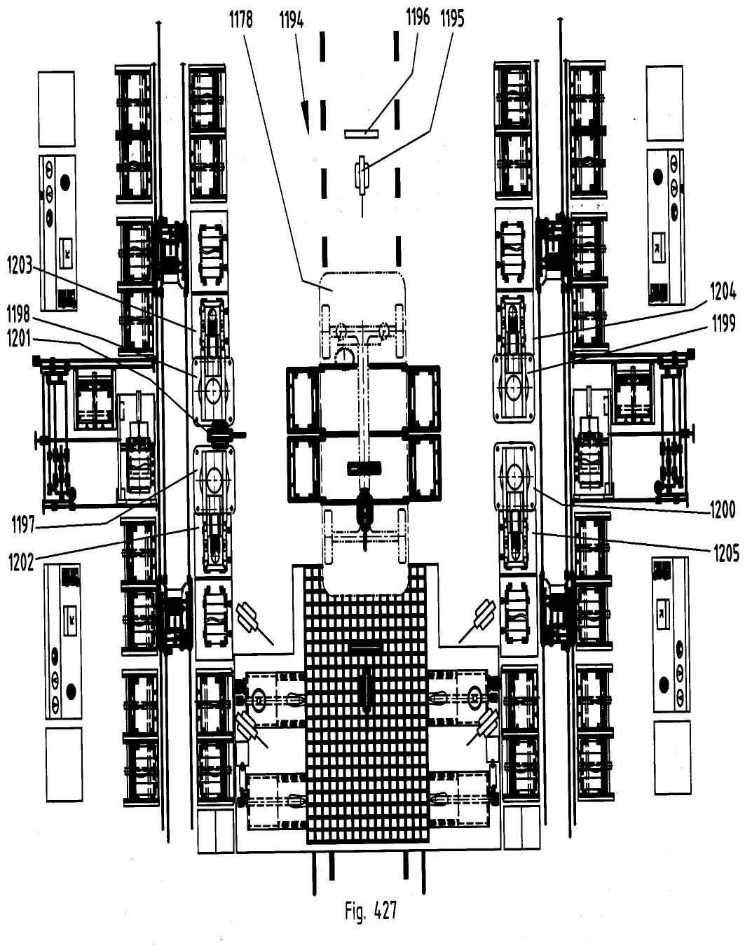

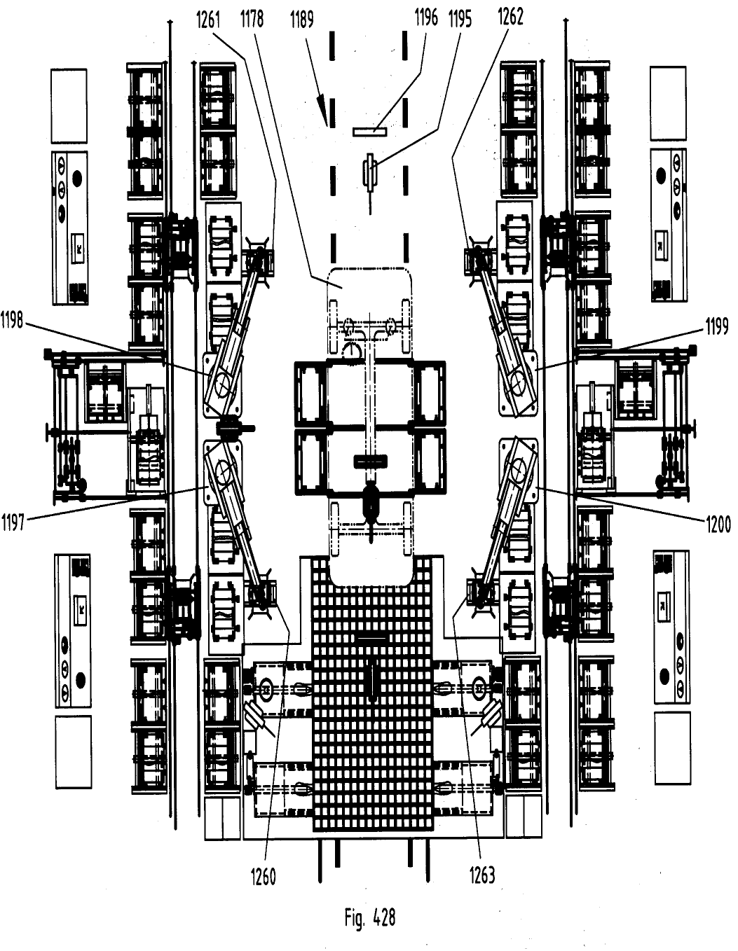

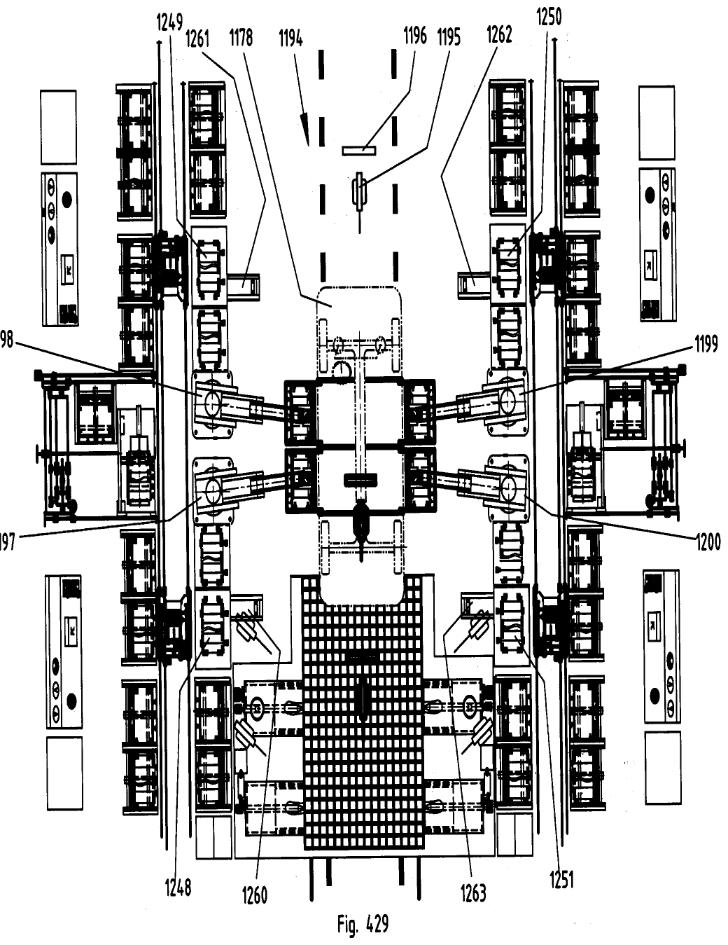

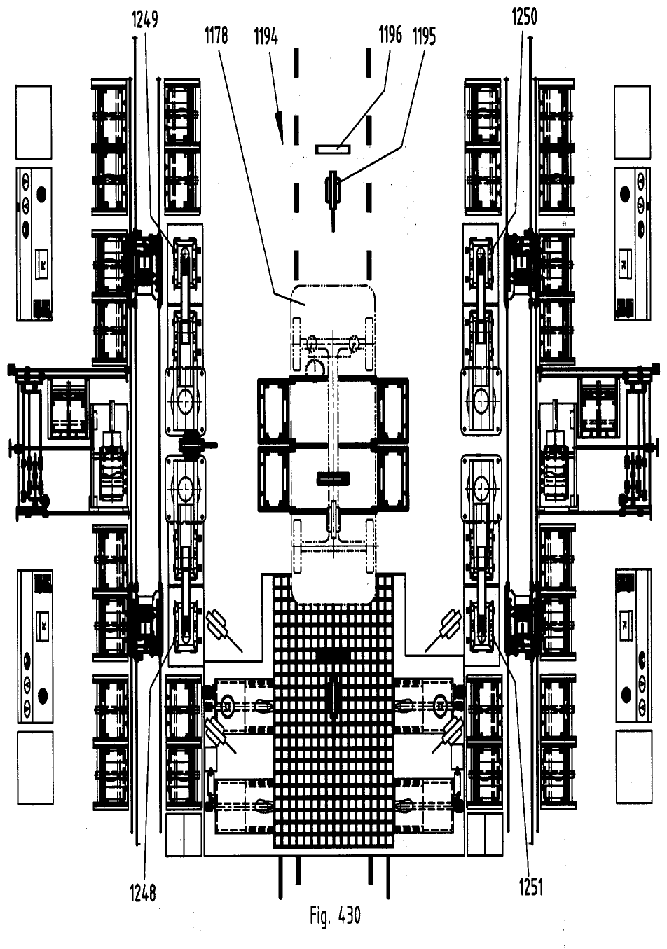

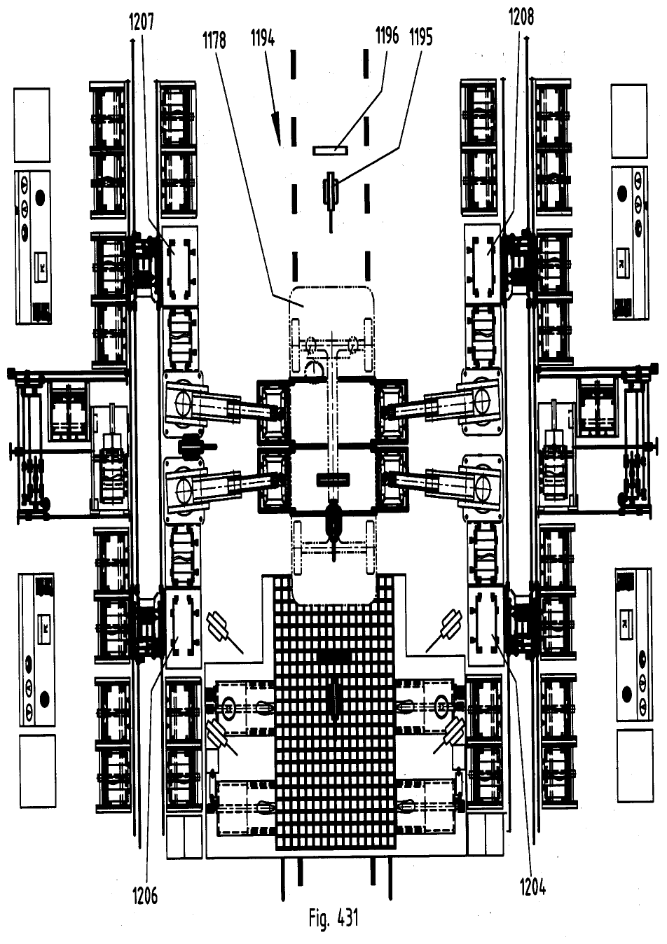

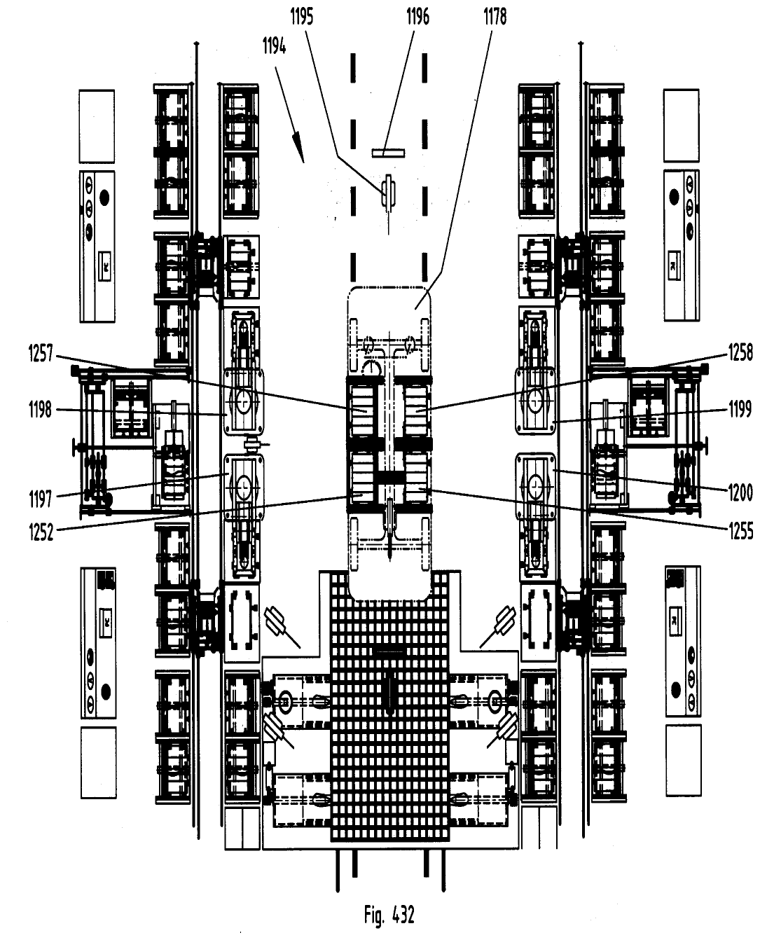

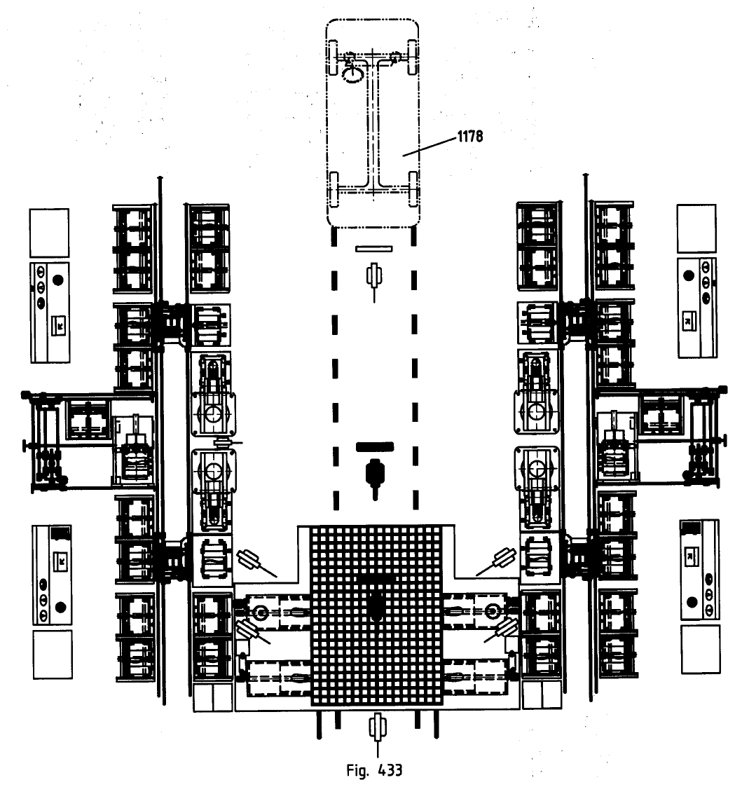

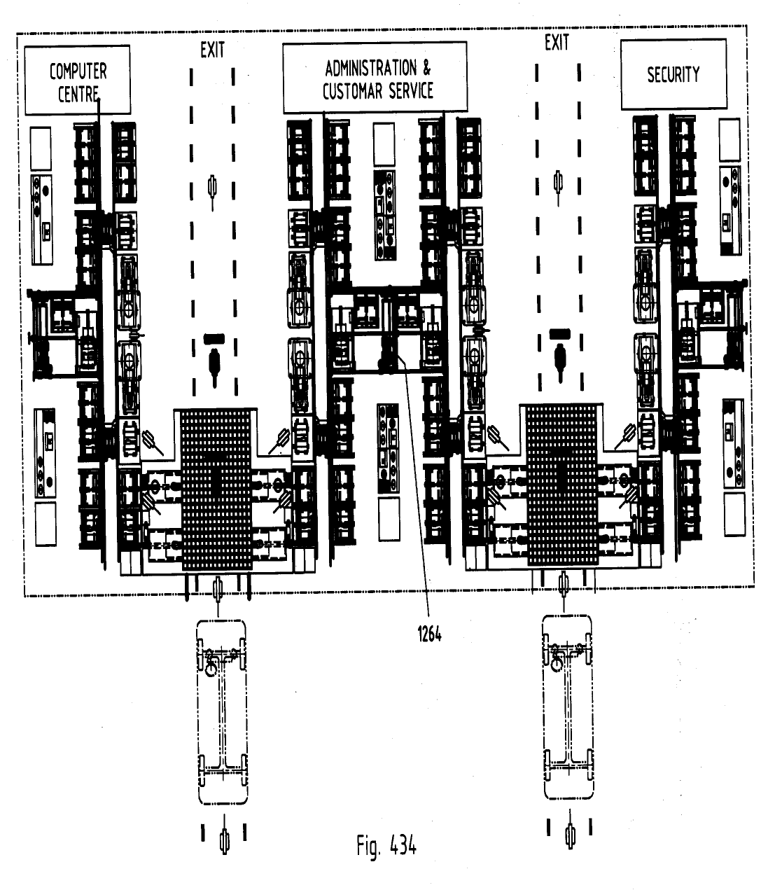

In FIG. 421 to FIG. 432 is illustrated step by step the battery change process inside of a loading utility, from Entrance to Exit. Therefore, in FIG. 421 is shown the electric vehicle 1178 at the Entrance to the battery change station on the inspection station 1175 and the two cameras 1176 and 1177. After the exchange of information between the driver and the intelligent management battery change system (IMBC) was finished, the vehicle enters into the cleaning station 1179, see FIG. 422, where at the beginning, the moving enclosure of the cleaning machines 1181 and 1182 are retracted to let the vehicle entering between the two opposite cleaning machines. After the vehicle is engaged into the cleaning station the moving enclosure of both cleaning machines moves forward bringing their brush kind portion in contact with the vehicle body. When the cameras 1183 and 1184 identify the wright position to start the cleaning, they send the signal to the controller and the cleaning process starts. The vehicle 1178 keeps moving with the speed indicated by the system on the screen of the TV set 1196. In all this time, the moving enclosure of the drying machines 1188 and 1189 are retracted. Next is the dry section 1187, see FIG. 423. When the vehicle 1178 is arrived in the wright position for drying process, the cameras 1190 and 1191 give the signal to the controller to move out the moving enclosure of the drying machines and starts the drying process. Because the drying machines 1188 and 1189 may be installed very closed to the cleaning machines 1181 and 1182, it is possible that all cleaning and drying machines are working simultaneously for awhile. The drying process occurs during the vehicle moving forwards as well. The cleaning and the drying process are stopped by a signal given by the cameras 1183 and 1184 for cleaning and the cameras 1190 and 1191 for the drying. Guided by the instructions displayed on the TV screen 1196, the vehicle 1178 goes forwards into the battery change station 1194 until the camera 1201 identify the wright position of the vehicle to change the battery packages, and send a signal to stop the vehicle, see FIG. 424. At this stage, all battery drawers of the electric vehicle are retracted and the recharged battery packages 1248, 1249, 1250 and 1251 are already on the stand-by position on the stand-by station 1206, 1207, 1208, 1209 of each robot. After the vehicle is stopped, the intelligent management battery change system (IMBC) send a message to the driver that the drawers can be opened, and the driver commands the drawers opening. In case that the driver or any of the passengers wants to stop the drawers opening the driver can intervene and stop the drawers opening. Also, the driver can command the drawers closing. Ones the battery drawers start opening, all vehicle doors are locked automatically, and stay locked until the battery change process is finished. Next step is to open all the battery drawers 1252, 1253, 1254 and 1255, unlock the battery packages 1256, 1257, 1258, and 1259, and be prepared to take out the empty battery packages from the vehicle, see FIG. 425. In this stage, all four robots are in stand-by position, waiting the end of drawer opening. The next step is to take out simultaneously the empty battery packages 1256, 1257, 1258, and 1259 from the electric vehicle 1178 by the robots 1197, 1198, 1199 and 1200, see FIG. 426. In FIG. 427 is shown the electric vehicle 1178 with empty battery drawers and the robots 1197, 1198, 1199 and 1200 deposing the battery packages on the receiving station 1202, 1203, 1204 and 1205, of each robot. Next step is to prepare the cleaning for the contacts of the contact plates of the electric vehicle 1178. Therefore, the drawers with the contact cleaning devices 1260, 1261, 1262 and 1263 slide out and the robots bring the cleaning devices, see FIG. 428. In FIG. 429 are shown the four robots cleaning the contacts of the contact plates into the vehicle drawers and the drawers for the cleaning device OUT. In FIG. 430 are shown the four robots after deposing the cleaning devices and preparing to take the recharged battery packages 1248, 1249, 1250 and 1251 to install them into the vehicle drawers. In FIG. 431 are shown all four robots installing the recharged battery packages into the vehicle drawers, and no batteries on the stand-by stations 1206, 1207, 1208 and 1209. In FIG. 432 is shown the electric vehicle 1178 with the recharged batteries 1248, 1249, 1250 and 1251 already installed on the vehicle and the battery drawers retracted, ready to leave. All four battery change robots are retracted in a stand-by position, ready to start a new cycle. The battery change process is finished. In case of any emergency situation, the driver may stop the battery change process and open the doors any time during the process. In FIG. 433 is shown the electric vehicle 1178 leaving the loading utility. At the end of the battery change process, the intelligent management battery change system (IMBC) communicates with the driver all the bill details and the payment is done automatically. So, in all this time of battery change process, the driver doesn't do anything, and in a very short time the loading utility is left with the full battery recharged and without any human intervention. In FIG. 434 is illustrated a loading utility comprising two battery change lines, where in order to reduce the investment and operating cost one single battery module storage robot was eliminated and the robot 1264 serves the two neighbouring lines.

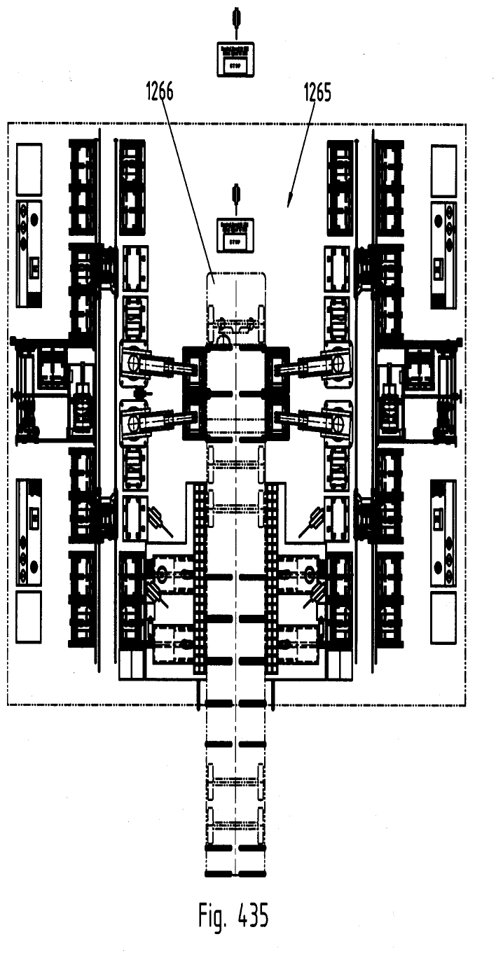

For trucks, buses and other heavy electric vehicles a similar loading utility may be designed, taking into consideration all the specifics of this kind of vehicles. In FIG. 435 is illustrated a battery change line 1265 for trucks, showing the truck 1266 on the sequence of installing the recharged battery packages by the four robots into the vehicle drawers.

Although the above description relates to specific preferred embodiments as preferred embodiment as presently contemplated by the inventor, it will be understood that the invention in its broad aspect includes mechanical and functional equivalents of the elements described and illustrated, which are within its spirit and scope as defined by the appended claims.

I claim:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. A battery quick-change method for electric vehicles capable to allow a quick battery changing, comprising steps of:
a) providing an Intelligent Management Battery Changing System WI-FI internet connected;
b) providing a battery quick-change electric vehicle having the capability of making easy accessible the powering battery packages installed on it, being continuously WI-FI internet connected, having an Electronic Identification Number recorded into a national data base, an audio system, a GPS system, a screen, a starting engine button capable of taking fingerprints, a camera installed in front of the driver capable of taking eyes print and a battery compartment defrost system installed on it;
c) providing a driver Iphone capable of being wireless connected to the said electric vehicle and WI-FI internet connected to the said Intelligent Management Battery Changing System;
d) providing a plurality of the said battery packages capable of being rapidly installed and secured on the said electric vehicle;
e) providing a loading utility capable of changing the discharged battery packages with full battery packages for the said electric vehicle and preparing and recharging the said discharged battery packages for a new installation;
f) opening the driver door of the said electric vehicle;
g) installing the driver on the driving seat;
h) identifying the driver;
i) starting the engine of the said electric vehicle;
j) identifying the said electric vehicle by its Electronic Identification Number when its engine is starting;
k) opening a session on the said Intelligent Management Battery Changing System and a road recording file in its data base, within the road folder of the said electric vehicle having the name identical with the said Electronic Identification Number of the said electric vehicle;
l) identifying and recording the actual location of the electric vehicle utilizing the GPS system of the said electric vehicle;
m) identifying and recording the vehicle actual batteries using their Electronic Identification Number comprising information about the producer, serial number and date;
n) identifying and recording the said actual batteries status—actual charge in KWH and in %;
o) identifying and recording the destination;
p) analyzing the best itinerary by the said GPS System;
q) making a vocal proposition of the best itinerary to the driver and displaying it on the said screen of the said electric vehicle;
r) negotiating the proposal with the driver;
s) approving the itinerary by the driver;
t) setting the electric vehicle GPS system on destination;
u) starting driving;
v) analyzing the best location for the loading utility by the said Intelligent Management Battery Changing System;
w) making a vocal proposition and displaying the best loading utility location to the driver;
x) handles negotiating the proposal;
y) handles approving the loading utility location by the driver;
z) setting the electric vehicle GPS system on the chosen loading utility location;
aa) continuing to drive to destination via chosen loading utility location;
ab) sending an order for the replacing batteries to the loading utility by the said Intelligent Management Battery Changing System;
ac) communicating to the driver the status of the replacing battery by the said Intelligent Management Battery Changing System;
ad) changing the destination or the itinerary by the driver?:
ae) if NO—continuing driving to the destination via chosen loading utility location and go to step ag);
af) if YES communicating the new destination and go to step o);
ag) approaching to the loading utility location;
ah) identifying the electric vehicle location about 15 minutes before to rich the loading utility location;
ai) rising a flag to start preparation of the replacing battery into the loading utility;
aj) turning “on” the battery compartment defrost system if necessary;
ak) entering into the loading utility;
al) changing the discharged batteries with the full charged batteries;
am) recording in the data base of the said Intelligent Management Battery Changing System of all information related to the said discharged batteries and the said full charged batteries;
an) calculating the difference of the charge between the said full charged batteries and the said discharged batteries;
ao) making the payment;
ap) leaving the loading utility;
aq) continuing to drive to the destination;
ar) arriving to the destination;
as) preparing the said discharged battery packages for a new installation outside of the electric vehicle into the said loading utility.

53. A battery quick-change method for electric vehicles defined in claim 52 wherein identifying the driver comprises steps of;
(a) pushing the start engine button;
(b) taking the fingerprint of the driver;
(c) analyzing if the actual fingerprint match with the recorded fingerprints associated to the actual said electric vehicle;
(d) if YES—recording in the actual said road recording file the driver ID, the Iphone number and the credit cart information associated to the actual ID—which are already recorded into the said data base of the said Intelligent Management Battery Changing System, continuing and going to step i), see claim 52;
(e) if NO—asking to the driver of providing his/her Iphone number and asking of scanning his/her driving licence and his/her credit card (both sides) utilizing the said eyes printing camera installed in front of the driver on the said electric vehicle;
(f) scanning the driving licence by the driver, confirming the accuracy of the picture by a sound signal received from the said Intelligent Management Battery Changing System and recording the information into the said data base of the said Intelligent Management Battery Changing System;
(g) scanning the both sides of the credit card by the driver, every time confirming the accuracy of the picture by a sound signal received from the said Intelligent Management Battery Changing System and recording the information into the said data base of the said Intelligent Management Battery Changing System, continuing and going to step i), see claim 52.

54. A battery quick-change method for electric vehicles defined in claim 52 wherein identifying the driver comprises steps of;
i. pushing the start engine button;
ii. asking the driver of taking the eyes print by looking to the said eyes printing camera installed in front of the driver on the said electric vehicle;
iii. taking an eyes print by the said eyes printing camera, confirming the accuracy of the picture by a sound signal received from the said Intelligent Management Battery Changing System and recording the information into the said data base of the said Intelligent Management Battery Changing System;
iv. analyzing if the actual eyes print match with the recorded eyes prints associated to the actual said electric vehicle;
v. if YES—recording the driver ID and the credit cart information associated to the actual ID in the actual said road recording file—which are already recorded into the said data base of the said Intelligent Management Battery Changing System, continuing and going to step i), see claim 52;
vi. if NO—asking to the driver of scanning his/her driving licence and his/her credit card (both sides) utilizing the said eyes printing camera installed in front of the driver on the said electric vehicle;
vii. scanning the driving licence by the driver, confirming the accuracy of the picture by a sound signal received from the said Intelligent Management Battery Changing System and recording the information into the said data base of the said Intelligent Management Battery Change System;
viii. scanning the both sides of the credit card by the driver, every time confirming the accuracy of the picture by a sound signal received from the said Intelligent Management Battery Change System and recording the information into the said data base of the said Intelligent Management Battery Changing System, continuing and going to step i), see claim 52.

55. A battery quick-change method for electric vehicles defined in claim 52 wherein the entering into the loading utility comprises steps of;
(a) checking-in by identifying the electric vehicle, the driver and the schedule;
(b) if the electric vehicle is scheduled, and if it's in time and the said full charged battery package is already prepared, than go to step (g);
(c) if it's not scheduled and if there are other electric vehicle waiting for battery changing, or if it is not in time, or the replacing battery package is not ready for change, than:
(d) receiving a message by the driver to go to the waiting area;
(e) conducting to the waiting area;
(f) waiting into the waiting area until receiving a message for moving into inspection area and go to step (g)
(g) moving into inspection area and inspecting, identifying and recording the batteries and their actual charge;
(h) receiving the permission to go inside the loading utility;
(i) opening the gate and conducting the said electric vehicle to one of the battery changing line of the said loading utility.

56. A battery quick-change method for electric vehicles defined in claim 52 wherein changing the said discharged batteries with the said full charged batteries comprises steps of:
moving the said electric vehicle into the battery changing section of the said loading utility;
stopping the said electric vehicle on the battery changing location of the said battery changing section of the said loading utility;
switching the vehicle gearbox into the parking mode position;
stopping the said electric vehicle engine;
locking all the said electric vehicle doors;
unlocking the said battery packages from the said electric vehicle body;
making accessible the said battery packages for changing;
taking out the discharged batteries from the said electric vehicle and manipulating the battery packages and depositing them on the battery receiving station of the said loading utility;
taking out the said full charged battery packages from the stand-by station of the said loading utility, manipulating and installing the said battery packages into the battery compartment of the said electric vehicle;
securing the said battery compartment and locking it;
starting the said vehicle engine;
starting driving to the loading utility exit.

57. A battery quick-change method for electric vehicles defined in claim 52 wherein changing the said discharged batteries with the said full charged batteries comprises steps of:
moving the said electric vehicle into the battery changing section of the said loading utility;
stopping the said electric vehicle on the battery changing location of the said battery changing section of the said loading utility;
switching the vehicle gearbox into the parking mode position;
stopping the said electric vehicle engine;
locking all the said electric vehicle doors;
unlocking the said battery packages from the said electric vehicle body;
making accessible the said battery packages for changing;
taking out the discharged batteries from the said electric vehicle and manipulating the battery packages and depositing them on the battery receiving station of the said loading utility;
cleaning the vehicle battery contacts using a vehicle battery cleaning device;
taking out the said full charged battery packages from the stand-by station of the said loading utility, manipulating and installing the said battery packages into the battery compartment of the said electric vehicle;
securing the said battery compartment and locking it;
starting the said vehicle engine;
starting driving to the loading utility exit.

58. A battery quick-change method for electric vehicles defined in claim 52 wherein changing the said discharged batteries with the said full charged batteries comprises steps of:
moving the said electric vehicle into the battery changing section of the said loading utility;
stopping the said electric vehicle on the battery changing location of the said battery changing section of the said loading utility;
partial washing the electric vehicle portion where the battery compartments will open utilizing a partial washing station equipped with a washing machine;
partial drying the electric vehicle portion where the battery compartments will open utilizing a partial drying station equipped with a drying machine;
switching the vehicle gearbox into the parking mode position;
stopping the said electric vehicle engine;
locking all the said electric vehicle doors;
unlocking the said battery packages from the said electric vehicle body;
making accessible the said battery packages for changing;
taking out the discharged batteries from the said electric vehicle, manipulating the battery packages and depositing them on the battery receiving station of the said loading utility;
cleaning the vehicle battery contacts using a vehicle battery cleaning device;
taking out the said full charged battery packages from the stand-by station of the said loading utility, manipulating and installing the said battery packages into the battery compartment of the said electric vehicle;
securing the said battery compartment and locking it;
starting the said vehicle engine;
starting driving to the loading utility exit.

59. A battery quick-change method for electric vehicles defined in claim 56 wherein taking out the discharged batteries from the said electric vehicle, manipulating the battery packages and depositing them on the battery receiving station of the said loading utility is a manual process using a manual lifting device.

60. A battery quick-change method for electric vehicles defined in claim 56 wherein taking out the said full charged battery packages from the stand-by station of the said loading utility, manipulating and installing the said battery packages into the battery compartment of the said electric vehicle is an automated process using an automated robot, which is integrated into the battery changing program of the said battery changing station and of the said Intelligent Management Battery Changing System.

61. A battery quick-change method for electric vehicles defined in claim 56 wherein taking out the discharged batteries from the said electric vehicle, manipulating the battery packages and depositing them on the battery receiving station of the said loading utility is an automated process using an automated robot, which is integrated into the battery changing program of the said battery changing station and of the said Intelligent Management Battery Changing System.

62. A battery quick-change method for electric vehicles defined in claim 56 wherein taking out the said full charged battery packages from the stand-by station of the said loading utility, manipulating and installing the said battery packages into the battery compartment of the said electric vehicle is a manual process using a manual lifting device.

63. A battery quick-change method for electric vehicles defined in claim 52 wherein preparing the said discharged battery packages for a new installation outside of the electric vehicle, into the said loading utility comprises steps of:
cleaning the discharged batteries contacts;
manipulating the said discharged batteries inside of the said loading utility;
storing the said batteries;
recharging the said batteries and recording all related information;
prepare the said full charged battery package for a new installation;
manipulating the said full charged batteries inside of the said loading utility disposing the said full charged battery package on the said stand-by station, waiting for a new installation.

64. A battery quick-change method for electric vehicles defined in claim 61 wherein manipulating the said discharged batteries inside of the said loading utility is a manual process using a manual lifting device.

65. A battery quick-change method for electric vehicles defined in claim 61 wherein manipulating the said discharged batteries inside of the said loading utility is an automated process using an automated robot, which is integrated into the battery preparation program of the battery recharging station of the said loading utility and of the said Intelligent Management Battery Changing System.

66. A battery quick-change method for electric vehicles defined in claim 61 wherein manipulating the said full charged batteries inside of the said loading utility is a manual process using a manual lifting device.

67. A battery quick-change method for electric vehicles defined in claim 61 wherein manipulating the said full charged batteries inside of the said loading utility is an automated process using an automated robot, which is integrated into the battery preparation program of the battery recharging station of the said loading utility and of the said Intelligent Management Battery Changing System.

68. A battery quick-change method for electric vehicles defined in claim 52 wherein making the payment comprises steps of:
communicating to the driver all details related to the payment;
vocal approving the payment by the driver;
sending the invoice to the driver on his/her Iphone;
making automatic payment using the driver credit card information;
receiving the invoice by the driver as a message on his/her Iphone.
